(19) United States
(12) Patent Application Publication
(10) Pub. No.: US 2016/0148307 A1
(43) Pub. Date: May 26, 2016

(54) Method of buying or selling items and a user interface to facilitate the same

(71) Applicant: PRANIL RAM, MAKATI CITY (PH)

(72) Inventors: PRANIL RAM, MAKATI CITY (PH); CRISPIN M. ALMODOVAR, SINGAPORE (SG)

(73) Assignee: PRANIL RAM, MAKATI CITY (PH)

(21) Appl. No.: 15/011,773

(22) Filed: Feb. 1, 2016

Related U.S. Application Data
(63) Continuation of application No. 14/691,850, filed on Apr. 21, 2015.
Application No. 14/691,850 is a continuation of application No. 14/319,025, filed on Jun. 30, 2014, now abandoned.
Application No. 14/319,025 is a continuation of application No. 13/932,140, filed on Jul. 1, 2013, now abandoned.
Application No. 13/932,140 is a continuation of application No. 13/417,259, filed on Mar. 11, 2012, now abandoned.
Application No. 13/417,259 is a continuation of application No. 12/880,079, filed on Sep. 11, 2010, now abandoned.
Application No. 12/880,079 is a continuation of application No. 10/527,400, filed on Mar. 11, 2005, now abandoned.
Application No. 10/527,400 is a continuation-in-part of application No. 12/035,670, filed on Feb. 22, 2008, now Pat. No. 7,797,226.
Application No. 12/035,670 is a continuation-in-part of application No. 12/267,639, filed on Nov. 10, 2008, now abandoned.
Application No. 10/527,400 is a continuation-in-part of application No. 09/897,437, filed on Jul. 3, 2001, now abandoned.
Application No. 09/897,437 is a continuation-in-part of application No. 09/892,891, filed on Jun. 28, 2001, now abandoned.

(30) Foreign Application Priority Data
Sep. 12, 2002 (CA) CA/2403300
Sep. 9, 2003 (CA) PCT/CA03/01377

(51) Int. Cl. G06Q 30/06

(52) U.S. Cl. CPC G06Q 30/0641

(57) ABSTRACT

A method of buying or selling items having at least one market and its associated processes are disclosed. The method includes the steps of, under control of a client system, displaying information identifying at least one item and a bid and/or ask price for the item in the market; and specifying transaction conditions based on a user directed position of a moveable icon, where the transaction conditions are related to the buying or selling of the identified item in the active market. Then, in response to an action of the user sending a user transaction request at the transaction conditions displayed at the time of said action, facilitating financial transactions for the user in accordance with the transaction conditions to complete the transaction. In this manner, the item may be bought or sold by the user at the transaction conditions specified. A user interface to facilitate this method is also disclosed. A quantity recommendation system to facilitate the quantity decision of a financial transaction is further disclosed.

This appl'n is a continuation of and claims priority to U.S. patent application Ser. No. 13/417,259 filed Mar. 11, 2012, which is a continuation of and claims priority to U.S. patent application Ser. No. 12/880,079 filed Sep. 11, 2010, which is a continuation of and claims priority to U.S. patent application Ser. No. 10/527,400 filed Mar. 11, 2005, which claims priority to PCT/CA03/01377 filed Sep. 9, 2003 which claims priority to CA 2,403,300 filed Sep. 12, 2002, and is further, a continuation-in-part of and claims priority to U.S. patent application Ser. No. 12/035,670 filed Feb. 22, 2008, Ser. No. 12/267,639 filed Nov. 10, 2008, Ser. No. 09/897,437 filed Jul. 3, 2001, and Ser. No. 09/892,891 filed Jun. 28, 2001, the entire contents of which are hereby incorporated by reference.

### FIELD OF THE INVENTION

The present invention relates to a method of buying or selling items having at least one active market, and a user interface to facilitate the same. In particular, the present invention relates to a method of buying and selling items that are being actively traded such as financial securities, durable goods, or other items.

### BACKGROUND OF THE INVENTION

In the past, there have been a number of trading systems used for allowing individuals to engage in real-time buying and selling of items such as securities. Although traditionally, such trading systems have involved face-to-face trading, for example on a trading floor, more recently computers and telecommunications systems have been used to permit trading activities to occur remote from the actual location of the trading floor through interactive computer-based transaction systems. There are to date a number of trading systems, used by a number of individuals, who engage in real time day-to-day or minute-to-minute security trading. Private individuals who engage in this activity are sometimes referred to as day traders. As well, many stock brokers have an interest or duty to observe the dynamics of the market, including price fluctuations and volume of trading in any security, and thus they also use computer-based trading or transaction systems. However, software which is available for use by such day traders and stock brokers typically requires considerable key stroke input, which delays getting information and executing orders. For example, Bank of Montreal's Investorline brokerage requires that a user shall first enter the ticker symbol for a selected security, then enter the price, then the number of shares, and finally click on a confirmation button.

At a basic level, a market requires the sellers' price and terms to sell a given quantity of product. The market participants also need to know the prices that buyers are willing to pay for an item. Often, the price per unit decreases if a larger quantity of product is under negotiation. When the buyers and sellers agree in price and quantity, a transaction or trade can occur. When the bid or ask prices are sufficiently close, trading activity in an item will usually become more active.

A quote is a type of data containing information about the buy and sell prices for the items traded on the market. Information about the activity of a market is disseminated (usually in real-time) in electronic format through data feeds. Separate data feeds are available for trades, quotes, news, and other useful information.

Buy and sell quotes on marketable products are disseminated in varying detail. In financial markets like the stock markets, basic quote information on securities is readily available over the Internet. For example, a basic quote on a security details the last trade price, the bid and ask price, and the change from the previous close. Often, the size of the bid and the ask, the trading day's high price and low price, the volume of the last trade, and the overall session volume is also provided.

A more detailed quote is available. The detailed quotes disseminated by the Nasdaq stock market are called “Nasdaq Level 2”, or simply “Level 2” quotes. This type of quote is of interest to more active traders because it allows them to track the activity of market makers that they believe to be price-trend setters. It also allows those with the capability, to buy and sell their positions quickly, when it becomes apparent from Level 2 information that the momentum of the markets has turned. With a Level 2 display, the identity of market makers and Electronic Communications Networks (ECNs) is disclosed and quote information on multiple market makers and ECNs are visible. However, not all exchanges or markets provide a quote information that allows any trader to view this detailed type of quote feed for all securities.

Still more detailed, are electronic market book or electronic limit order book quotes, which comprise order and quote information provided by some ECNs such as Island ECN and Archipelago ECN, and stock exchanges such as the Toronto Stock Exchange (TSE). The electronic limit order book can display individual or summary buy and sell orders listed on an ECN or exchange at each price point. A quote feed from the limit order book lists the number of buy and sell orders, the number of shares in each open order, and the bid or offer price. Orders are listed according to price and in time priority.

Not every quote feed from a stock exchange, stock market, Electronic Communications Network, or quote dissemination service supplies a suitable data feed capable of providing information on the quantity of a security available at each price level during any given instant in time. Exchanges sometimes provide restricted or subscription-based access to such information, while some market participants prefer to keep their market book details confidential. However, markets are becoming more competitive and readily available ECN quotes allow retail investors to access the same information as their institutional counterparts.

There has been a trend in recent years to trade stocks and options in m ore than one market or exchange. Depending on the opportunity and technology available, ECNs may also facilitate trading in a given security or commodity. When more than one market exists for a given product, there is a tendency to link the market information together and aggregate quote information and trading activity. The Nasdaq Level 2 data feed is a good example of this tendency.

Technology and computer networks make possible the linkage of the data feeds (quotes, trades, news, etc) and order-placement facilities of different markets. As a result of this linkage, bid and ask prices tend to track each other in different markets as financial intermediaries, such as arbitrageurs, trade products between markets when price discrepancies arise. Exchanges like the NYSE and stock markets, such as Nasdaq, have also made strategic alliances with overseas exchanges to promote trading activity and facilitate listing active securities in other countries. In the US, options on a given security are also quoted and traded in several option exchanges.

Quote data on securities is often presented in alphanumeric text format. When working with a basic quote, and more than one security is being monitored or traded, the quote data is displayed in prior art systems in text based multiple rows and columns of text similar to a spreadsheet or data presented in a table format. In this context the term text means letters or numbers that must be read and understood to be meaningful. Each row typically represents a different security, while columns display various textual data which represent the securities' symbol, bid, ask, last trade price, change from previous closing price, the volume, low price, and high price of the current trading session.

Existing trading systems, such as CyberTrader (a product of CyberTrader.com, which is a unit of Charles Schwab) and QCharts (a product of Qfeed.com, which is a unit of Lycos) typically display Level 2 data using a text-based spreadsheet or tabular approach. In this approach, the bids are listed together in one set of rows, and the asks are listed together in another set of rows. The two lists are usually shown side by side, with the bids on the left and the asks on the right. Each row of data shows three pieces of information: the market maker ID, which is a four-letter code uniquely identifying a market participant, the price of the bid or ask, and the size (i.e. the number of shares or lots) of the bid or ask. The bids are usually ranked so that the highest bid which is defined as the best bid is the first (i.e. top) row; while the asks are usually ranked so that the lowest ask which is defined as the best ask is the first row. A coloring scheme is usually applied to the rows, to distinguish rows with identical prices from rows with different prices. Rows with the same price are given the same background color, and rows with different prices are given different background colors. Moreover, rows with the same price (and thus background color) are said to belong to the same “price level”. The first “price level”, which corresponds to the rows with the best bid price and the best ask price (this collection of best bids and best asks is referred to as the “inside market”), is usually shown with a yellow background color, while the second “price level” is usually shown with a green background color for a typical Nasdaq Level 2 display.

It has become customary to combine the basic Level 2 display with a Level 1 display, and a Time and Sales display. Typically, Level 1 data (which consists of: summary information such as the last trade price, the size of the last trade, the best bid, the size of the best bid, the best ask, the size of the best ask, the trading volume, the highest price, the lowest price, the opening price, the closing price, and other related information) is displayed in the top section of the combined display. The Time and Sales display on the other hand is usually placed to the right of the Level 2 display. This latter type of display shows a scrolling list of trades as they occur. The time of the trade, the price, and the number of shares or lots traded are listed. It is customary for positive changes in the price to be shown in green, negative changes in red, and no change in gray.

Typically, the combined Level 1/Level 2/Time and Sales display is linked to a real-time data-feed, so that as new data arrives for either of the three component displays, the relevant display is updated accordingly. Although Nasdaq Level 2 data consists only of the best quotes from Nasdaq market makers and ECNs, third party data-feed providers (such as Hyperfeed) normally supplement the basic Nasdaq Level 2 montage with order book data from ECNs, as well as data from other stock exchanges and stock markets. The combined display is thus capable of displaying not just Nasdaq Level 2 data but also data coming from ECNs and other stock exchanges and stock markets. An enhanced quote and trade platform, Nasdaq Super-Montage, is due to be launched in the second half of year 2002. Although Nasdaq Super-Montage will offer enhanced quotes relative to Nasdaq Level 2 information, the presentation is expected to remain tabular and textual in nature.

The combined Level 1/Level 2/Time and Sales display suffers from a number of limitations. It is based on textual information, which needs to be read, in order to be understood. For a trader using such a display, it means spending a significant amount of time reading information from the display in order to interpret the dynamics of the market. Traders are interested in the “spread”, which is the price difference between the best bid and the best ask prices. In investment terminology, the “best bid” is the highest price a buyer is willing to pay, while the “best ask” is the lowest price at which a seller is willing to sell. It is often difficult to determine a securities spread from a rapidly changing textual display. Another limitation of the textual display is its inability to provide a visual correlation between the trader's orders and the current activity of the market.

As described in the preceding discussion, a text-based tabular presentation of trading data is often difficult to interpret. Discerning market dynamics or trader behaviour from the text based quote information of an individual stock or a group of stocks is also difficult. With experience from watching the stock ticker or quote display, some traders develop a sense of buyer and seller intent which assist them in speculating on the price direction of a given commodity or security.

The order placement process in many computer-based trading systems requires the user to interact with an order entry form, which is a collection of graphical elements (e.g. text input area, label, button, etc) through which the user issues commands and/or keys transaction data into the computer system. Once an order is placed, the status of the order and its relation to the market is typically not apparent. Similarly, desired changes to the resulting open order also take a forms-based approach, which increases the time spent on the process of changing an order as a result of the time necessary to refresh screens and download the revised data. The time taken to place a trade and to change an open order requires that a trader shift attention to the order entry form and its features, rather than to maintain a focus on the market or the security in question.

For securities, the minimum price variance (MPV) is the smallest increment by which the price of a security can change. The MPV is typically set by the primary marketplace for a given security or product.

A smaller minimum price variance (MPV) is the result of the US exchanges and stock markets adopting decimalization. Prior to decimalization, many US equities were traded and quoted at an MPV of 1/16 or 6.25 cents, meaning there were sixteen price points or “ticks” per dollar.

Take, for example, a hypothetical stock with a bid price of 45¼ and an ask price of 45 5/16. The spread between the “bid” and the “ask” is 1/16 or 6.25 cents per share. In contrast, when stocks trade in penny increments, the number of price points per dollar is 100, meaning that the bid and ask prices may be closer together. A smaller MPV generally results in narrower spreads because there are more price points and finer increments available to buy and sell a security. Option prices over $3.00 used to have an MPV of ⅛, allowing eight price points per dollar. With decimalization, option contract prices trade in 5 cent increments under $3.00, and in 10 cent increments above $3.00.

U.S. Pat. No. 6,058,379, issued May 2, 2000 in the name of Odom et al teaches a networked exchange method in which a commodity may be traded from a seller to a purchaser using an exchange processor. A mode of operations for an exchange is specified, a commodity is identified and listed, and the listing is accessed by a potential purchaser. The potential purchaser accesses the network-based exchange, a negotiation occurs by processing information generated by the potential purchaser; and at the conclusion of the negotiation the concluded negotiation is cleared. All of the transaction software is driven by the exchange where the transaction is concluded.

Belzberg U.S. Pat. No. 6,134,535, issued Oct. 17, 2000, teaches a computerized stock exchange trading system where a graphical user interface is employed to automatically format orders from a spreadsheet to an order entry system. Parameters such as a share symbol, price selection, order size, and transaction type, as well as other indicators for the trading order, may be chosen using the graphical user interface and a mouse. The interface may be programmed so that data concerning a group of shares may be read from a spreadsheet which is formulated into an order, or in response to a signal from the trader whereby an index or basket of shares may be traded substantially instantaneously.

U.S. Pat. No. 6,195,647, issued Feb. 27, 2001 to The Nasdaq Stock Market, Inc., in the name of Martyn et al. This patent teaches a data processing system for on-line transactions whereby securities may be traded, wherein any user may configure his or her display so as to employ certain functions and to show displays for any particular security. Additional information may be displayed, such as information about selected securities, trade activity may be monitored, a trade may be participated in, or reported. It is also possible for a user to display information for a selective set of securities on a continuously updated basis, where any of the securities can be easily selected from a displayed list. Certain information and functions associated with the selected security may also be displayed.

These prior art computer trading systems have suffered from a number of shortcomings to date. The chief shortcomings are the design of the user interface, the lack of a visual representation of the relationship between the quote information and the order information, and the general non-intuitive nature of such systems.

To date many brokerage firms allow their clients to access their trading accounts online or over the Internet. Such accounts are accessed through a dedicated application, a software object such as a java applet, or via an Internet browser such as Internet Explorer. This online connectivity allows brokerage clients to monitor their investment account, and obtain quotes, news, and research on their holdings or securities of interest.

In most instances, the cash or buying power of each client's account is accessible and can be determined online or on the internet. Similarly, estimates of the market value of a client's security holdings and the overall portfolio value may also be determined. Many online accounts also show the last trade price or closing price of a portfolio's securities and the profit or loss associated with each position. This information may be current and updated in real time or on a periodic basis such as once a day.

In order to facilitate a trade, the following information is typically necessary: the symbol or identity of the security, the order type of the transaction, the price of the transaction, the account to be used, the exchange or market where the transaction will occur, the time of the transaction, the transaction terms, the settlement terms, and the quantity or dollar value of the transaction. Market information and software tools exist to assist the trader in determining suitable values for some of the trading parameters listed above.

For example, brokerage firms and business news providers discuss stock investments and give advice as to the identity, price, and timing of various securities to buy, sell, or short. Software tools also assist the user to screen a group of stocks to identify investment candidates based on specific criteria. Technical analysis and charting techniques may also be used to evaluate specific securities or the broader market. Furthermore, the financial statements of companies as well as research reports from brokerage firms may be reviewed and analyzed to assess and time a potential investment.

However, determining the quantity parameter of a transaction, or number of shares of a given security to buy, sell, or short, is subject to a number of variables such as the identity of the security, its trading price range, the intended investment amount, and the transaction order type.

To determine an appropriate quantity for a buy order, the user should determine the cash or the buying power available in his account. The funds in a user's cash account, if sufficient, may be used to purchase a given quantity of a security. Typically, users can access a number of trading accounts to buy and sell securities depending on their brokerage privileges. For a margin, short, or option account, the user must satisfy the credit requirements of their brokerage or clearing firm. The buying power in a margin account allows the user to borrow funds and hence, buy more securities than using the cash account.

The following formula may be used to determine the shares or quantity of a security that may be purchased given the investment amount available for the transaction and the security's trading price:

Buy Quantity=(Transaction Investment amount)/(Relevant Security Price)

When the formula is processed, the resulting decimal output value represents the quantity of a security that can be purchased. This buy quantity may be rounded down to the nearest integer or lot size to serve as a practical quantity size for the transaction. Although stocks can be bought or sold in individual shares, they are often traded and quoted in lots of 100 shares. The Transaction Investment Amount variable may be reduced by the estimated commission cost and/or any fees associated with the transaction. With online brokerage accounts, the transaction commissions are typically in the $10 to $50 range in the US.

The Relevant Security Price variable associated with the quantity formula above is not necessarily the last traded price of an item or security. If the order is a limit order, the relevant security price may be the limit order price. If the last trade price is the closing price, and the security's opening trade is significantly above or below the previous session's closing price, the relevant security price may be the current session's opening bid price or ask price. This is especially the case if the user's order is a market order. Similarly, the bid price or the ask price may be used as the relevant security price if the security is illiquid and does not trade often.

In the case of a sell order, the maximum quantity that may be sold is typically the total number of shares or units available in the user's holdings inventory. However, in practical terms, if the user has a large quantity of shares to sell and/or the market for the shares is not very liquid, the user may affect the market price of the security if he tries to sell the large quantity of shares at once. Selling a large quantity at once may affect the bid price and ask price of the security as other traders become aware of a large seller and anticipate the market price of the security will fall. The market price of the security may also be affected if traders see that the shares bid cannot support the shares offered by one or more large sellers in the market.

A user may be motivated to sell a security due to a number of factors including unfavorable news on the security, the markets, the economy, or their personal situation. A seller may also desire to reduce or exit one security position to buy new or additional shares in another security whose price itself is always changing.

A short order involves selling a borrowed security at a high price in order to buy it back later at a lower price and hence profit from the trade. Typically, any security can be checked to see if it is short eligible from a list of short eligible stocks available from the user's brokerage firm. If a stock is not on the list, the brokerage can usually locate stock to borrow for a short sale. Brokerage accounts usually prevent a user from shorting a stock that cannot be borrowed.

Borrowing stock for a short sale carries risk. There is the potential for a client to lose more than 100 percent of the proceeds from the initial sale of the borrowed stock. This can occur because a security's price may not fall, but rather, could move higher indefinitely requiring the client to buy back the borrowed shares at a loss. The Uptick Rule for shorting stocks requires that the stock be shorted on an uptick. Brokerages also require a user to open a margin or short account in order to short stock. The margin rules for a short sale are different from that of a buy order.

As a result of these various influences and considerations, when a brokerage client or user desires to buy, sell (all or part of his holdings), or sell short the shares of a given security, the user's quantity decision is often based on impulse, intuition (i.e. “gut feeling”), or mere guesswork.

### SUMMARY OF THE INVENTION

What is needed is a simple elegant and useful graphical interface to permit individuals, remotely connected by computer and communications networks, to trade securities and the like. What is also needed is a method of buying and selling items, such as securities, that is fast, efficient, intuitive and user friendly. What is further needed is a method and apparatus which takes full advantage of recent advances in computer technology such as improvements in display technology, connectivity, bandwidth, and software standards and development tools.

Further, what is needed is a computational tool or a software application and method that is integrated into a trading application or brokerage software, and once configured by the brokerage client or user, can display a quantity recommendation for the number of shares or contracts to buy, sell, or sell short based on the identity of a security and the preference settings of the user. Such a tool would enable a user to apply common money management principles and other criteria to determine a suitable quantity of a security to buy, sell, or short.

What is also needed is a quantity recommendation tool that provides for: an intuitive, easy to use, user interface which may be integrated into an online trading application or available on an internet website; several simple methods for deriving a recommended quantity that permits a user to use dollar denominated units, percentage units, and quantity units to represent an order quantity; an easy method of entering and adjusting the various PG settings and preferences without the need for complex algorithms, mathematical techniques, and programming knowledge; flexible table interfaces that adapt to a multitude of decision parameters involving market data, account data, technical indicators, and the like; third party access to control the PG settings and plug-in preference data, or to provide input data to the PG or a plug-in to assist with a quantity recommendation; an output quantity that is available automatically and essentially instantaneously to the user once the PG has been configured; an output quantity that is presented visually, via an icon or a GUI object; an output quantity that may be manually modified or changed within the icon or GUI object; and an ability to facilitate a trading transaction via a drag-and-drop operation from the icon or GUI object.

The present invention is directed to a number of aspects as set out below. In one of its aspects, the present invention is directed to a method of configuring a user interface for the buying and selling of items, such as securities. The user interface is preferably connected to a source of real time market information, which provides the content for the interface. The interface itself is most preferably a form of graphical display, which presents the market information in a user friendly and visual form to facilitate the use of the information by the user. Most preferably the graphical display permits the information to be displayed in real time, with graphical representations on a grid corresponding to quantitative aspects of the information. For example, in a preferred embodiment, GUI objects are used to represent bid & ask prices on a pricing grid or pricing matrix termed the “Grid Proper”.

The Grid Proper consists of columns that typically represent one or more markets or market participants, rows which represent a range of trading prices for a security, and a two-dimensional array or cells formed by the intersection of the rows and columns of the Grid Proper. It is on the pricing grid where bid and ask quotes are plotted and where orders maybe placed or modified using a drag and drop method.

The present invention is directed to a graphical user-friendly trading interface which indicates not only current market conditions but, is most preferably dynamic and by being observed over a period of time, such dynamic display may indicate where a given market is trending towards with respect to the price of a particular item such as a security. In this way the user can easily and readily determine the spreads and the movement of prices. The present invention comprehends displaying at least one and preferably more items in at least one and preferably more active markets.

Another aspect of the present invention is the step of providing, for the user, a user directed GUI object to represent and display an order for said item. In the most preferred form, the price and/or the market parameter of the displayed orders will be a function of the position of the GUI object on the pricing grid. Most preferably, the present invention also permits the user to effectively drag and drop this GUI object onto the said Grid Proper. The step of dragging the order represents finding a price and market for the order that is acceptable to the user and the act of dropping the order represents facilitating a transaction request or placing an order at the transaction conditions represented in part by the location or position into which the moveable icon is dropped. In this manner, a selected trading order can be entered by merely placing the icon over a graphical representation, such as a grid cell representing a selected price and selected market for said item, and dropping the icon so as to effect the desired selected trading order without the need for any additional key stroke entries. In a similar fashion, an existing order's transaction conditions may be changed by dragging the GUI object representing the order to an alternative location on the Grid Proper corresponding to the new transaction conditions desired by the user.

### BRIEF DESCRIPTION OF THE DRAWINGS

Reference will now be made, by way of example only, to preferred embodiments of the present invention, by reference to the following figures, in which:

FIG. 1 shows a block diagram of the Grid Proper as a software object.

FIG. 2 is a block diagram of the software architecture of a front-end application.

FIG. 3 shows a typical combined Level 1, Level 2, and Time & Sales display contained within a tab page.

FIG. 4 shows a typical graphical layout of a front-end application showing various kinds of data.

FIG. 5 shows data typically found on the holdings tab displayed in a table.

FIG. 6 shows similar data to FIG. 5 in icon view.

FIG. 7 shows data typically found on the market order tab chosen from FIG. 4.

FIG. 8 shows data typically found on the limit order tab chosen from FIG. 4.

FIG. 9 shows data typically found on the stop order tab chosen from FIG. 4.

FIG. 10 shows data typically found on the change order tab chosen from FIG. 4.

FIG. 11 shows a representation of the open orders tab chosen from FIG. 4.

FIG. 12 shows similar data to FIG. 11, in icon view, with a right click pop-up menu activated for a selected buy order.

FIG. 13 shows a typical Grid Proper for a hypothetical stock with an open limit buy order plotted.

FIG. 14 shows similar data to FIG. 13, with an open stop-loss limit order and its associated stop price displayed.

FIG. 15 shows similar data to FIG. 13, with a right click pop-up menu having been activated for a selected limit buy order.

FIG. 16 shows a typical Grid Proper having a price axis with five-cent increments.

FIG. 17 shows a representation of the Replay function dialog box.

FIG. 18 is a representation of the special terms settings dialog box in which special terms criteria may be set for any transaction.

FIG. 19 shows a Grid Proper displaying an aggregate market, and cells corresponding to an orderly arrangement of prices.

FIG. 20 shows similar data to FIG. 19, the horizontal progression of prices alternating from left to right then right to left along the price axis.

FIG. 21 shows a Grid Proper similar to FIG. 19, displaying data for the same security in two different markets.

FIG. 22 shows a Grid Proper displaying data for four different markets with the left most market displaying data similar to FIG. 20.

FIG. 23 illustrates a Grid Proper employing a grid partition feature.

FIG. 24 shows a typical graphical layout of a front-end application adapted to run on a mobile device.

FIG. 25 shows a tab page displaying data for three different securities.

FIG. 26 shows a tab page similar to FIG. 25, with a chart display.

FIG. 27 shows a Grid Proper adapted to display a greater range of prices for a given security.

FIG. 28 shows a Grid Proper adapted for use in an auction market.

FIG. 29 shows a Grid Proper similar to FIG. 28, with multiple sellers and multiple buyers.

FIG. 30 shows a Grid Proper similar to FIG. 28, displaying data from multiple auction markets for the same item.

FIG. 31 shows a Grid Proper similar to FIG. 28, adapted to an auction ticketing scenario.

FIG. 32 shows a Grid Proper adapted for use in an auction ticketing scenario displaying individual bids and asks for select seats on an aircraft flight.

FIG. 33 shows a Grid Proper display for an auction on a specific seat, and a seat selection area displaying seat bids and status information for a range of seats.

FIG. 34 illustrates a Grid Proper adapted to show the cumulative effect of all trades occurring on the Grid Proper over a time interval.

FIG. 35 shows a Grid Proper similar to FIG. 34, with a distinct user selected time period for each column displayed.

FIG. 36 shows similar data to FIG. 13 and FIG. 19, adapted for display within a web browser.

FIG. 37 illustrates the display settings tab for the grid proper.

FIG. 38 shows a representation of a right click pop-up menu associated with a tab.

FIG. 39 shows a representation of an Alert Settings dialog box.

FIGS. 40A and 40B show the Grid Proper portion of FIGS. 13 and 19 respectively.

FIG. 41 is a high-level diagram showing various aspects of the Position Guide.

FIG. 42 is a flowchart of the Position Guide's basic mode of operation.

FIG. 43 shows an Implementation of the Position Guide as a software object.

FIG. 44 shows an implementation of the Position Guide as an application program.

FIG. 45 shows a plug-in architecture wherein plug-ins incorporate computation logic.

FIG. 46 shows a plug-in architecture wherein plug-ins do not incorporate computation logic.

FIG. 47 shows a “hybrid” plug-in architecture that combines features from the architectures shown in FIG. 45 and FIG. 46.

FIG. 48 shows a flowchart of the computation logic employed by a plug-in modeled after the plug-in architecture shown in FIG. 45.

FIG. 49 shows a flowchart of the computation logic employed by a Computation Module modeled after the plug-in architecture shown in FIG. 46.

FIG. 50 shows a flowchart of the computation logic employed by a Computation Module modeled after the plug-in architecture shown in FIG. 45.

FIG. 51 shows a flowchart of the computation logic employed by a Computation Module modeled after the plug-in architecture shown in FIG. 47.

FIG. 52 is a representation of the Position Guide Basic Output Settings panel.

FIG. 53 illustrates the Position Guide icon and its associated right click pop-up menu.

FIG. 54 is representative of an equity order entry form adapted for use with the Position Guide.

FIG. 55 is representative of the Position Guide Direct Output Settings panel.

FIG. 56 is representative of an alternative configuration method of specifying and allocating investment amounts for securities that are input to the Position Guide.

FIG. 57 is representative of an alternative method of specifying and allocating Position Guide portfolio amounts for various asset classes and mutual funds.

FIG. 58 is representative of a method of specifying and allocating portfolio amounts for equity securities and equity related categories.

FIG. 59 is representative of a method of specifying and allocating portfolio amounts for bond securities and bond related categories.

FIG. 60 is representative of a method of specifying and allocating portfolio amounts for option securities and options related categories.

FIG. 61 is representative of the Position Guide's detailed portfolio summary of a user's investment account.

FIG. 62 is representative of the Position Guide Profile Settings panel.

FIG. 63 displays a sample of PG interface tables, their use, and representative configurations as may pertain to a PG input security's trading price.

FIG. 64 displays a representative sample of PG table interfaces, their use, and configuration as may pertain to a user's account or activity level.

FIG. 65 displays a representative sample of PG table interfaces, their use, and configuration as may pertain to a PG input security's asset or category classification.

FIG. 66 displays a representative sample of PG table interfaces, their use, and configuration as may pertain to a user's profile information.

FIG. 67 displays a representative sample of PG table interfaces, their use, and configuration data as may pertain to a user's portfolio performance or a security's price performance.

FIG. 68 displays a representative sample of PG table interfaces, their use, and configuration as may pertain to a user's market sentiment.

FIG. 69 displays a representative sample of PG table interfaces, their use, and configuration as may pertain to the diversification of securities in a user's portfolio.

FIG. 70 displays a representative sample of PG table interfaces, their use, and configuration as may pertain to Index related data.

FIG. 71 displays a representative sample of PG table interfaces, their use, and configuration as may pertain to Technical Indicators, Financial Ratios, and Fundamental company data.

FIG. 72 displays a representative sample of PG table interfaces, their use, and configuration as may pertain to a time or date parameter of an order or transaction.

FIG. 73 displays a representative sample of PG table interfaces, their use, and configuration as may pertain to a given security's volume and liquidity measure.

FIG. 74 displays a representative sample of PG table interfaces, their use, and configuration as may pertain to an option order.

FIG. 75 displays a representative sample of PG table interfaces, their use, and configuration as may pertain to a third party source of specialized data.

FIG. 76 displays a representative sample of PG table interfaces, their use, and configuration as may pertain to the allocation of funds in an overall portfolio.

FIG. 77 is representative of the Position Guide Combined Table Output Settings panel.

FIG. 78 is representative of the Position Guide Edit Table Settings panel.

FIG. 79 is representative of the Position Guide Advanced Table Settings panel.

FIG. 80 is representative of the Position Guide Table Input Summary panel.

FIG. 81 represents the Position Guide Exempt Security Symbols panel.

FIG. 82 represents the Position Guide Permitted Security Symbols panel.

FIG. 83 represents the Position Guide Output Conditioning panel.

FIG. 84 is representative of the Position Guide Index Components panel.

FIG. 85 is representative of the Position Guide Index Settings panel.

FIG. 86 is representative of the Position Guide Table Selection panel.

FIG. 87 is representative of the Position Guide Alternative Table Output Settings panel.

FIG. 88 is representative of the Position Guide Alternative Direct Output Settings panel.

FIG. 89 displays an alternative Position Guide Output quantity presentation method.

FIG. 90 is representative of the Position Guide Panel and Feature Selection panel.

FIG. 91 shows a variation of the Position Guide Alternative Direct Output Settings panel of FIG. 88.

FIG. 92 is a representative of the Position Guide Edit Table Settings panel of FIG. 78 displaying a table with a portfolio amount output column.

FIG. 93 is representative of the Position Guide Alert dialog box.

FIG. 94 displays a representative sample of graphical PG table interfaces, their use, and configuration.

FIG. 95 is representative of the Open Order Settings dialog box.

### DETAILED DESCRIPTION OF THE PREFERRED EMBODIMENTS

In this application the following terms shall have the following meanings. The term “item” means anything that can be bought or sold. A primary example of an item is a financial instrument, such as a security, but the present invention comprehends all forms of vendible items such as auction items, tickets, seats, rentals, durable goods, perishable items, collectibles, and the like. The term “transaction conditions” comprehends all forms of transaction defining parameters, including, without limitation, price, market, quantity, total value, commission, currency, terms, and the like. The term “order” typically means data pertaining to a user's bid or offer, or an order for a security or auction. Order data includes without limitation data regarding the price at which a user will buy, sell, stop, or short an item, the size or quantity of an order, the identity of the user, and the duration that the user's order remains valid. The term “quote” means data pertaining to a quote or order other than a quote or order of the user of the present invention. Quote data for a specific item typically contains the bid and ask prices, the market identifier, the size of the order, and the like.

As explained in more detail below, transaction conditions can be derived from the position of a user directed moveable icon, or GUI object, on a graphical representation of the market, or markets, for an item. Transaction conditions can also be derived from user selected criteria relating to the transaction, from predetermined criteria held in a database and relating to the user, and from the user's preferences, settings, and the like.

A movable icon is any form of GUI object that can be positioned by a user. Most preferably, according to the present invention a graphical representation is one where the position of the movable or non-movable icon, such as its position in a pricing grid, is directly related to a numerical value, such as a price value, to display to the user, and through a glance, its association with other elements in the pricing grid. A graphical representation comprehends all representations of item information that do not rely solely on the numerical value to convey information, and in particular, are related to some or all of the visible aspects of the Grid Proper as described herein.

One aspect of the present invention improves on the utility of the traditional Level 2 or ECN quote display by “plotting” bids and asks for a particular security on a two-dimensional grid whose columns are typically labelled with market identifiers, and whose rows are labelled with price values. The grid functions like a mathematical “coordinate system”, wherein the vertical axis represents the range of prices that the security can have, and the horizontal axis represents the markets or market participants that trade in the security. The intersection of a row and a column defines a cell, which represents at least one specific market and at least one specific price level for a security. The price component of a cell may be regarded as a price bin representing at least one distinct price. The market component of a cell may be regarded as a market bin representing at least one distinct market. The grid thus appears as a two-dimensional array of cells resembling a checkerboard. This two-dimensional array of cells serves as the grid's “plotting surface”, where bids, asks, various orders and order types, and other information are plotted. This collection of GUI objects—consisting of the column and row labels and the two-dimensional array of cells—define the “Grid Proper” referred to henceforth in this document.

On the Grid Proper, bids and asks are represented by color-coded icons that are plotted on the Grid Proper's “plotting surface” (i.e. the array of cells). For example, a bid for MSFT on Island ECN at $61.45 is plotted on the cell which is the intersection of the “ISLD” column and the “61.45” row. As the bid and ask prices change dynamically and in real-time, the positions of the color-coded icons change accordingly, to reflect the change in prices graphically and in real-time. As an initial convention, blue rectangular icons represent bids while red rectangular icons represent asks. Additionally, the bid/ask icons can have text labels that show, for example, the size (i.e. the number of shares or lots) or a related market or security statistic available to the user and associated with the bid or ask icon.

Another aspect of present invention allows a user to better comprehend the spatial relationship between quotes in Level 2, or ECN type data, as the display is graphical and the price axis is linear and orderly. Graphical information is comprehended faster than textual information. One advantage of a visual approach of the Grid Proper over a text-based approach of the traditional Level 2 display employs can be shown by way of an example. In the traditional Level 2 display, the “spread” is not readily apparent and some users may require a calculator to determine it. On the other hand, in the Grid Proper the “spread” is simply the visual gap between the blue and the red rectangular icons representing the highest bid and the lowest ask prices respectively.

This method of plotting bids and asks on the Grid Proper is useful to traders, and as such it can replace the traditional method of displaying Nasdaq Level 2 data, ECN market book data, and other detailed quote information. In this configuration, the Grid Proper is typically implemented as a “software object”, as described in more detail hereafter.

A further aspect of the present invention improves on the utility of graphical quote presentation by also allowing a “drag and drop” method for order placement, order modification, and order cancellation on the graphical display. The Grid Proper is typically implemented as a component of an application program when this feature is added. However this is not always the case, as it is also possible to add this feature to a “software object” implementation of the Grid Proper. This application program is henceforth referred to in this document as the “front-end application” or simply “front-end”. Regardless of how the Grid Proper is implemented, as a software object, or as a front-end application, the user interactivity is essentially identical.

Existing on-line brokerage trading accounts typically use a forms-based approach to allow a client to place an order. These trading systems typically require users to go through the following routine when placing an order: (a) enter the ticker symbol, (b) enter the price, (c) enter the number of shares or lots, and then (d) click on a confirmation button.

This approach is also supported by the front-end of the present invention. Additionally, the front-end also allows the trader to use a “drag-and-drop” technique for placing orders. This technique builds on the previously described “checkerboard” metaphor, in that the act of placing, modifying, and cancelling an order is likened to the act of moving a checker piece into a position on the checkerboard, or taking the checker piece off of the checkerboard.

A user of the present invention has a number of options when placing a new order using the front-end. One option is to use the order-entry form, in which case the user will need to go through the same routine (for both buy and sell orders) as with existing on-line trading systems. A second option is the drag and drop method of placing a buy order. For example: (a) click on an icon representing cash or a quantity of shares, (b) select the investment amount or the number of shares to be purchased for the buy order (represented by an icon) from a pop-up window or suitable selection means, (c) drag the selected icon representing the buy order to the column associated with the preferred market, (d) select the price of the buy order by positioning the icon on the row representing the desired price level, and (e) drop the icon onto the cell defined by the selected column and row.

For a sell order, the following series of steps is applicable: (a) click on the icon representing an investment or an inventory of a security, (b) adjust the number of shares to be sold (represented by an icon) from a pop-up window or suitable selection means, (c) drag the selected icon representing the sell order to the column associated with the desired market, (d) select the price by positioning the icon on the row representing the desired price level, and (e) drop the icon on to the cell defined by the selected column and row. It should be apparent, that there may be variation in the order of these steps and some steps may be omitted, which would nevertheless, effectively accomplish order entry and order modification.

The options described above result in an order automatically transmitted to the back-end system, and an icon representing the order to be plotted on the Grid Proper. The order will be plotted on the column representing the specified market, and on the row representing the specified price. As an initial convention, the order icon may be displayed in a Green color to distinguish it from the bid and ask icons.

The method of plotting the trader's order and the current bids and asks (which are already plotted on the Grid Proper) for a security, is a further aspect of the present invention. This aspect provides the trader with a visual correlation between his orders and the current underlying activity of the market.

The drag-and-drop method is further applied to the procedure for modifying an existing order, and to the procedure for cancelling an existing order. For example, to modify (or “change”) an existing order's transaction conditions using the front-end, the user simply needs to select the icon representing the order. It is then dragged either to another column (market) and/or another row (price). To effect the transaction, the user simply drops the icon on the new cell location as defined by the selected row and column. A “change order” instruction is then automatically transmitted to a back-end system by the front-end. The processing and back-end details of the “change order” transaction are transparent to the user.

To cancel an existing order using the front-end, the user simply needs to select the icon representing the order, and then drag and drop it outside the area of the Grid Proper. An “order cancellation” instruction is then automatically transmitted to a back-end system by the front-end. As with the “change order” transaction, the details of the “order cancellation” transaction are completely transparent to the user.

In contrast, for existing trading systems, the procedure for modifying or cancelling an existing order typically makes use of the forms-based or a menu driven approach.

As a first preferred embodiment of the present invention, a software object implementing the functionality of the “Grid Proper” of the foregoing discussion is described. This software object uses an object-oriented design and is implemented using Microsoft Corporation's .NET Framework software platform and the C# programming language. However, the software object can also be implemented using other software design techniques, platform, and programming languages. For example, an alternative implementation may use the Java platform and programming language. Other alternatives include. Macromedia's Flash technology, Curl Corporation's Surge platform and Curl programming language, Adobe's Scalable Vector Graphics (SVG) technology, and the like.

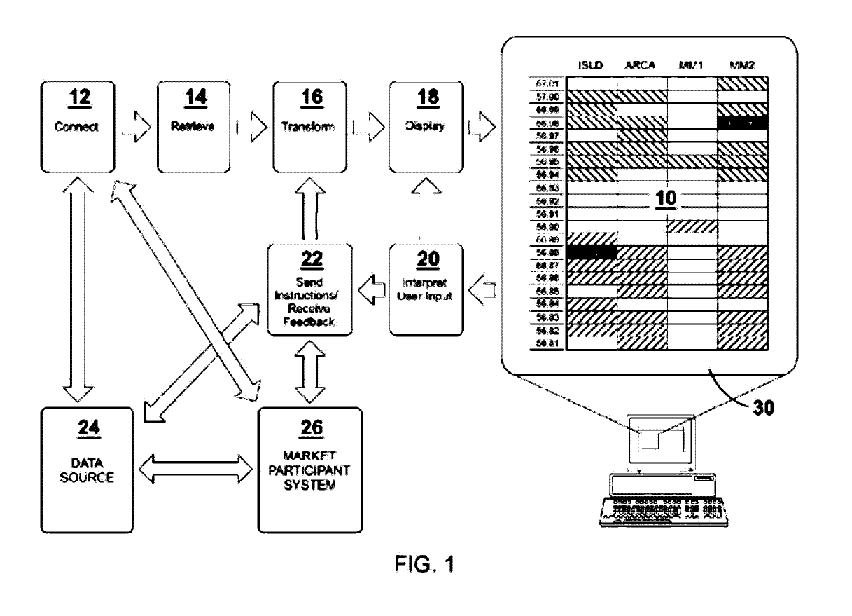

The software object, as illustrated in FIG. 1, executes on a computer and has two aspects: (1) its visual manifestation 10, which is displayed on the computer screen, and which a user sees and interacts with; and (2) its program logic, which is implemented in computer code. The software object's program logic includes six processes, which the software object employs to accomplish its tasks. However, it is also to be noted that the six processes noted below are only representative of all possible combinations of processes that the software object may employ.

The software object's visual manifestation is typically composed of one or more axes associated with dimensions of trading data, a drawing area, and fixed and movable GUI objects (icons, images, geometric shapes). The software object's visual manifestation is where trading data is graphically presented. This graphical presentation can employ several styles. The Grid Proper of the foregoing discussions corresponds to the software object's visual manifestation 10.

The software object's program logic consists of the following processes: (1) Connect process 12; (2) Retrieve process 14; (3) Transform process 16; (4) Display process 18; (5) Interpret User Input process 20; and (6) Send Instructions/Receive Feedback process 22.

The Connect process 12 is used by the software object to establish connections with one or more data sources, 24. This process uses standard communication protocols, such as TCP/IP, to establish a communication link between the software object and a data source.

The Retrieve process 14 is used by the software object to receive trading data from a data source 24. This process manages the integrity of the data packets coming from the data source.

The Transform process 16 is used by the software object to process the trading data it receives from data sources 24. This process performs data transformation procedures, when necessary, on the trading data received from a data source.

The Display process 18 is used by the software object to plot and render GUI objects, each one representing an order or a quote, on the software object's drawing area 30. This process involves drawing the row headers and column headers; drawing the two-dimensional array of cells; plotting bids and asks using data received from the data source, plotting orders submitted by the user; as well as displaying other related information.

The Interpret process 20 is used by the software object to receive and interpret inputs coming from the user. These inputs may be commands to change the graphical properties of the visual manifestation, inputs that request for trading data, or they may be inputs that effect a trading transaction. These inputs typically come from a suitable input device such as a mouse, a trackball, or a keyboard.

The Send Instructions/Receive Feedback process 22 is used by the software object to generate and transmit instructions (such as transaction instructions and requests for trading data), as a result of the user's interaction with specific elements of the software object's visual manifestation. These instructions are sent to the appropriate destination depending on the type of the instruction: for example transaction instructions are sent to a market participant system 26, while requests for trading data are sent to a data source 24. Furthermore this process 22 is responsible for receiving feedback data pertaining to the status of the previously transmitted instructions.

A Data Source 24 is any system that can supply trading data. It can be any or a combination of the following: securities exchanges, stock markets, currency markets, commodities exchanges, electronic communication networks (ECNs), brokerage firms, data feed providers, market simulation software, and trading data published on any suitable media (such as CD-ROM).

A Market Participant System 26 is any system that can receive, validate, route, and possibly execute trading orders. It can be any or a combination of the following: securities exchanges, stock markets, currency markets, commodities exchanges, electronic communication networks (ECNs), brokerage firms, order-entry firms, and market simulation software.

Often times, the Data Source 24 and the Market Participant System 26 are one and the same system. This is the case, for example when the Data Source is Island ECN, and the Market Participant System is also Island ECN.

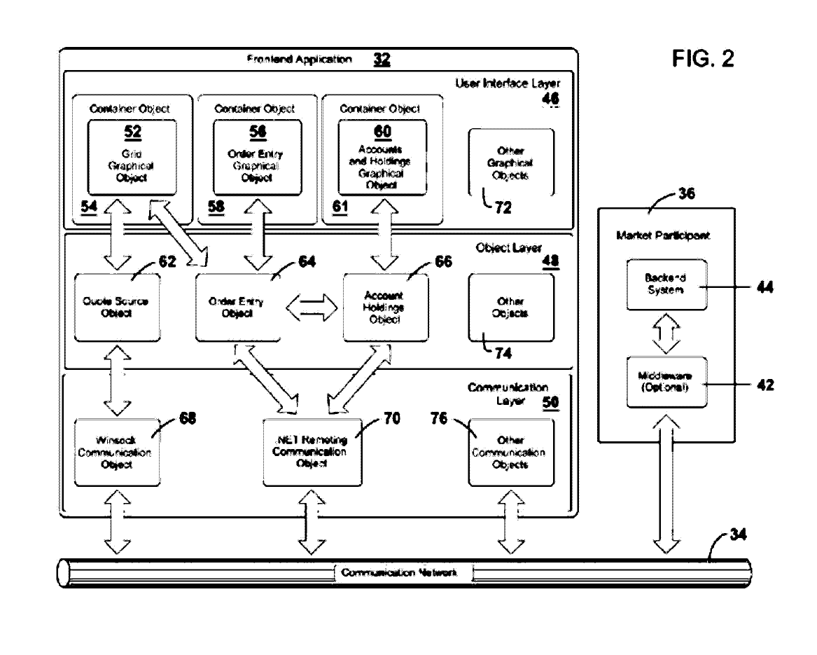

FIG. 2 shows the basic software architecture of a second preferred embodiment upon which the methods of the present invention can be practised. Turning now to FIG. 2, the internal architecture of the front-end 32, and the main program therein, is shown in terms of the functional blocks that are operable at the front-end 32.

The front-end 32 consists of a main executable program—which acts as the overall “controller” of the front-end—and several software building blocks called “components” or “objects”. In a Microsoft Windows implementation of the front-end, the main program is a .NET Windows Forms application, and the software components are .NET components. However, in an implementation of the front-end for other operating systems and application platforms, the architecture and the actual technologies used may be different. For example, for a UNIX implementation, the front-end can be a Java Swing application, and the software components can be JavaBeans™ components.

Unlike some monolithic Windows applications, which put together all functionality in a single package, the front-end of the present invention uses the flexibility of Microsoft Corporation's .NET Framework technology to organize functionality into self-contained, reusable software building blocks called “components” or “objects”. (Note: There is a difference between these two terms. A component is made up of one or more objects. However, the two terms are used interchangeably herein.) Each of these components or objects encapsulates distinct software functionality, and interacts with other components through clearly defined programmatic interfaces.

The front-end 32 is similar to conventional Microsoft Windows applications in that it adheres to the visual (e.g. menu structure, status bars, buttons, etc.) and behavioral (e.g. right click behavior, resize behavior, etc.) standards for Windows-based applications.

The front-end's main executable program controls and manages the application's various constituent objects. Furthermore the main program coordinates the operation of the objects, by passing messages between itself and the objects.

The core of the front-end however, is in the set of software objects implementing the application's functionality. These software objects fall into two categories: (1) graphical objects, and (2) non-graphical objects. Both types of objects encapsulate software functionality, but the graphical objects also display a visual interface. In .NET Framework terminology, these graphical objects are called “Windows Forms custom controls”, while the non-graphical objects are called “.NET components”.

The software objects are grouped together, according to functionality, into “layers”. As noted above, there are three layers: (1) the user interface layer 46, (2) the object layer 48, and (3) the communication layer 50.

An important software object is the grid graphical object 52. It plots trading data on a two-dimensional array of cells, which it draws dynamically. The grid graphical object receives its data in real-time (or close to real-time) from a source of information such as a quote server (not shown) which resides on the back-end 44; the data however, passes through the object layer 48 and the communication layer 50 first. The grid graphical object 52 also implements the graphical placement and modification of orders using a “drag-and-drop” method.

The grid graphical object 52 is hosted inside a container object 54, to facilitate the grouping of multiple instances of the grid graphical object, discussed hereafter. The container object 54 is a graphical user interface (GUI) element with the capability to “contain” other graphical objects. An example of a container object is a tab-based dialog object common in Microsoft Windows-based applications.

The order entry graphical object 56 is a compound object (i.e. object made up of several smaller objects) which users of the front-end interact with to post and modify an order (and its associated parameters). The order entry graphical object 56 is also hosted inside a container object 58.

The account and holdings graphical object 60 is another compound object that displays summary and detailed information about an account. This information includes the account balance, order status, account summary, etc. The account and holdings graphical object 60 is also hosted inside a container object 61.

An object layer 48 is shown which groups together components that perform business logic, and components that implement utility functions. The components in this layer: (1) validate users' actions performed on objects belonging to the user interface layer 46; (2) translate users' actions into commands, if applicable, to be sent to any appropriate back-end system via the communication layer 50; and (3) process return values, notification messages, transaction receipts, or confirmations or any other data sent by the back-end system through the communication layer 50. The object layer 48 serves as an abstraction layer that shields the user interface layer 46 from the implementation of the lower level communication layer 50.

Each of the graphical objects in the user interface layer 46 described can have a counterpart object in the object layer 48. The grid graphical object 52 has a quote source object counterpart 62, which encapsulates the logic necessary for requesting and receiving trading data such as Nasdaq Level 2 data, from the back-end system. The order entry graphical object 56 has an order entry object counterpart 64, which implements the logic and business rules necessary for posting buy, sell, change, cancel, and other types of orders to the back-end system, via the optional middleware 42. The account and holdings graphical object 60 has an account and holdings object counterpart 66, which implements the logic necessary for requesting, receiving, and updating account information from the back-end system.

The communication layer 50 consists of components that act as communication “gateways” between the front-end and a back-end system 44. The communication layer 50 translates messages coming from the object layer into the format required by the back-end system. That translation may be into .NET Remoting messages, but any suitable option for facilitating communication may be chosen. It is to be noted that although .NET Remoting is the primary protocol for main program 32 to middleware 42, communication, other suitable protocols such as Simple Object Access Protocol (SOAP) and Winsock can also be employed.

The communication layer 50 has one or more objects that implement the logic involved in translating requests and commands coming from the upper layers 46 & 48 of the front-end 32 into the format expected by the back-end system through the optional middleware 42. The communication objects also translate the data coming from the back-end system 44, through the optional middleware 42, into the format expected by the objects in the upper layers of the front-end 32. In FIG. 2, there are two communication objects: the Winsock communication object 68, which implements the logic for remote communication using the Microsoft Windows implementation of the Berkeley Software Distribution (BSD) Sockets protocol, and the .NET Remoting communication object 70, which implements the logic necessary for remote communication using the .NET Remoting protocol.

The communication layer 50 is designed to accommodate the “plug-and-play” addition and removal of communication components, each component implementing a specific type of communication protocol (e.g. .NET Remoting, SOAP, Winsock) for interfacing with the back-end system 44 through Communication Network 34. A market participant 36 manages the operation of the back-end system 44 and the optional middleware 42.

It will now be seen that the front-end 32 is an important second embodiment of the present invention, as it provides a graphically intuitive, fast, user-friendly application that any trader may use in order to get stock or other security quotes, manage their account with their respective brokerage firm or other market participant, place, modify, or cancel securities orders, track the status of those transactions, and track their current account status vis-à-vis any selected security, their cash position, and so on.

Typically, the front-end 32 operates on a Windows® platform, but not necessarily. Other platforms may also be employed, such as UNIX and Macintosh.

As will be discussed hereafter, the graphical display employs GUI objects to display trading data in a dynamic fashion, very intuitively, and allows the trader to buy, sell, modify or cancel securities orders, by interacting with the front-end using any suitable pointing device, such as mouse, to drag and drop GUI objects onto the Grid Proper.

Other objects 72, 74, 76 may be found on each of the respective user interface layer 46, object layer 48, and communication layer 50, as may be determined by a skilled programmer who is familiar with the technology and features of the present invention.

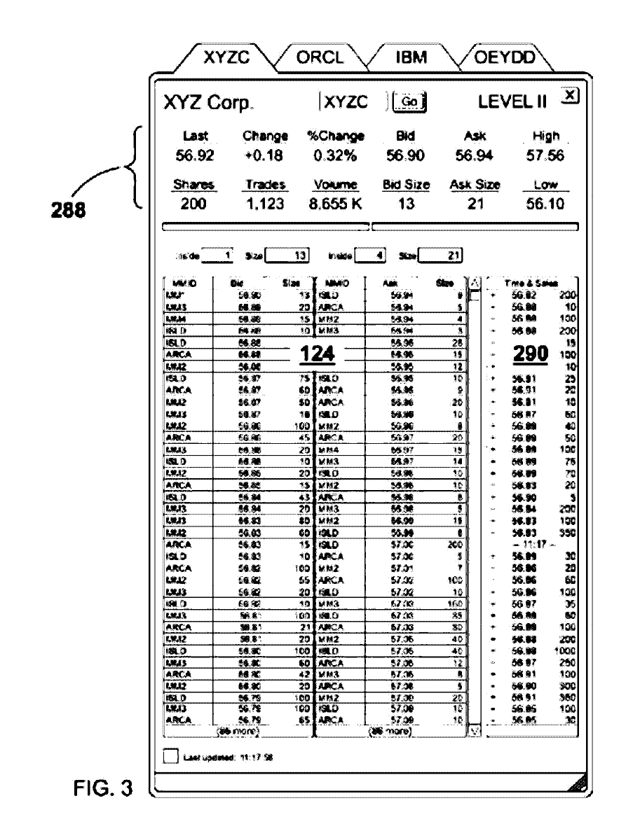

FIG. 3 shows a typical Nasdaq Level 2 display 124, with a Level 1 summary display 288, and a Time and Sales display 290. In a Nasdaq Level 2 display, the bid and/or ask price of the marker makers closest to the trading price of the security are shown. Typically, for each market maker, their bid price may be shown on the left side, and their ask price may be shown on the right side of the Nasdaq Level 2 display. If bid or ask data from an ECN are shown on a Nasdaq Level 2 display, as is the case in FIG. 3, the specific ECN's bid and ask quotes from its limit order book may appear at multiple rows on the bid side and the ask side of a Nasdaq Level 2 display. It is expected that Nasdaq SuperMontage quote displays will present data in a similar, albeit more extensive, manner when the Nasdaq SuperMontage system is introduced in October 2002.

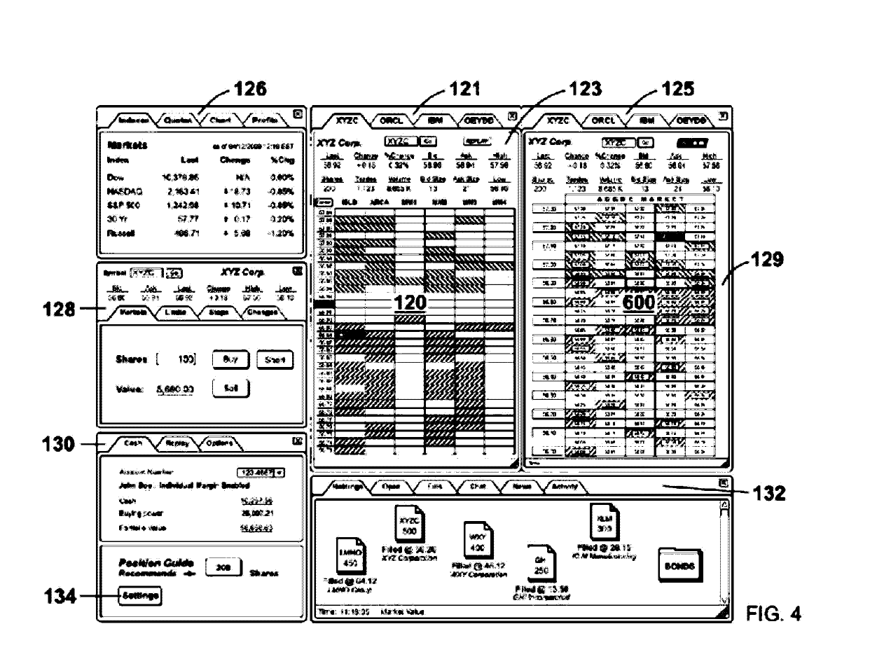

FIG. 4 shows one form of a user interface screen according to the present invention having a number of specific display panels down the left hand side and across the bottom together with two graphical representations 120 and 600.

Graphical representation 120, being the Grid Proper, is a graphical representation of order and quote data for hypothetical security XYZC contained in tab page 123. Graphical representation 600, is an alternative representation of the Grid Proper for hypothetical security XYZC contained in tab page 129.

Tab sets, 121 and 125 contain user selectable securities information of interest to the user. The display of one or more tab sets assists the user in categorizing, organizing, and displaying conveniently, the securities of interest at any given instance of time.

Shown in FIG. 4 are a number of other tab sets: 126, 128, 130, and 132. Also indicated is a Position Guide Settings Button 134.

The various tab sets allow access to data, permitting the user to set up, enter, monitor, modify, and cancel open orders, view filled orders, view market statistics, monitor a cash position or a portfolio, adjust Position Guide settings, adjust the user's interface preferences, interact with other users, and follow market developments, all as described hereafter.

Of course, tabs can be moved within tab sets and between tab sets, and may be renamed. Also, as is convention in a Microsoft Windows environment, tab pages can be positioned at any coordinate on the screen, and may dock and undock with other windows.

The Position Guide Setting Button 134 allows access to the Position Guide dialog box. The Position Guide recommends a suitable quantity of shares to buy, sell, or short for any given security, according to factors such as cash on hand, portfolio value, preference settings, as described hereafter.

The overall look and feel of the user interface may be controlled by a user preference configuration feature. Accordingly, the number of graphical representations that are displayed, the number of windows, the color and layout, as well as other parameters which are relevant to the overall look and feel of the application can be selected, according to the user's preference.

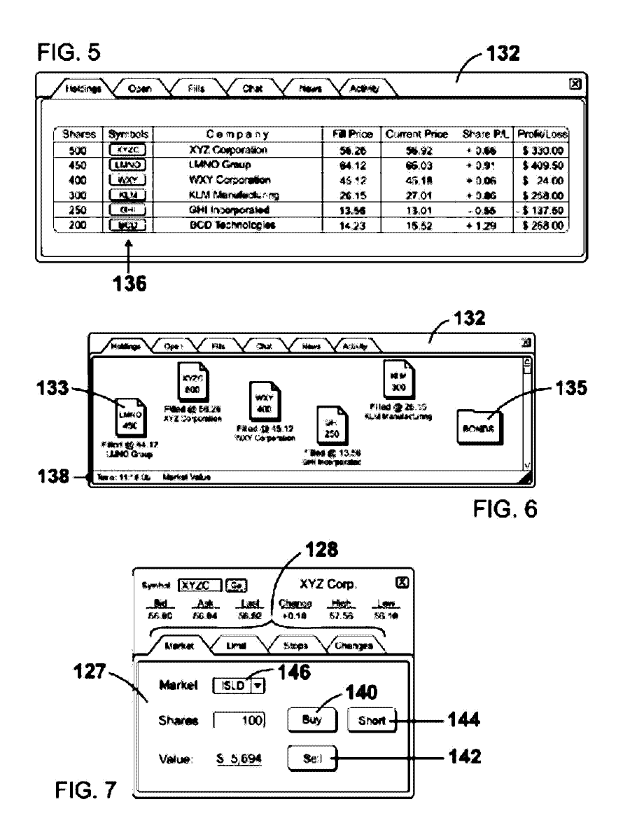

Turning now to FIGS. 5 and 6. A Holdings tab from tab set 132 is shown in greater detail in FIG. 5 and FIG. 6. In FIG. 5 the data is shown in tabular manner, while in FIG. 6, it is shown with separate icons for each position.

The significance is that an icon representing a security holding under the symbols column 136 in the tabular format of FIG. 5 can be dragged and dropped into an associated Grid Proper to effect a sell order. Likewise, any of the holding icons 133 shown in FIG. 6 can be dragged and dropped onto their respective Grid Proper. Security holdings, open orders, and the like may be categorized and grouped in folders. For example, folder icon 135 may contain details of the user's bond holdings.

Examination of FIG. 5 shows that 500 shares of XYZ Corporation are held in the user's portfolio; that they were purchased at 56.26 and that the current price is 56.92, up 0.66, for a profit of 330.00.

From FIG. 6, similar data is shown, but in a different, graphical view. The icons shown in FIG. 6 may be colored so as to show the type of security, the type of order that exists, the size of the order, or the profit or loss amount associated with the investment. For example, one color may be used to represent a short order, another color used to represent an option, or a margin purchase, or to indicate a profit or loss on individual positions. Each icon may further have data associated with it that may be revealed by holding a pointing device's cursor over the icon. The status bar 138 may also display data, as well as the current market price for the security if elected.

FIG. 7 illustrates a market order entry tab 127, chosen from tab set 128. This is a form-based representation; and it will be noted that there are buy, sell, and short buttons 140, 142, 144, respectively, which can be pressed or clicked so as to route an order to a given market. That market may be as shown at 146. Similarly, as can be particularly seen from FIG. 4, a buy, sell, or short button or icon 140, 142, or 144 can be dragged and dropped onto the Grid Proper 120, for the order to be routed to the selected market—in this case, ISLD.

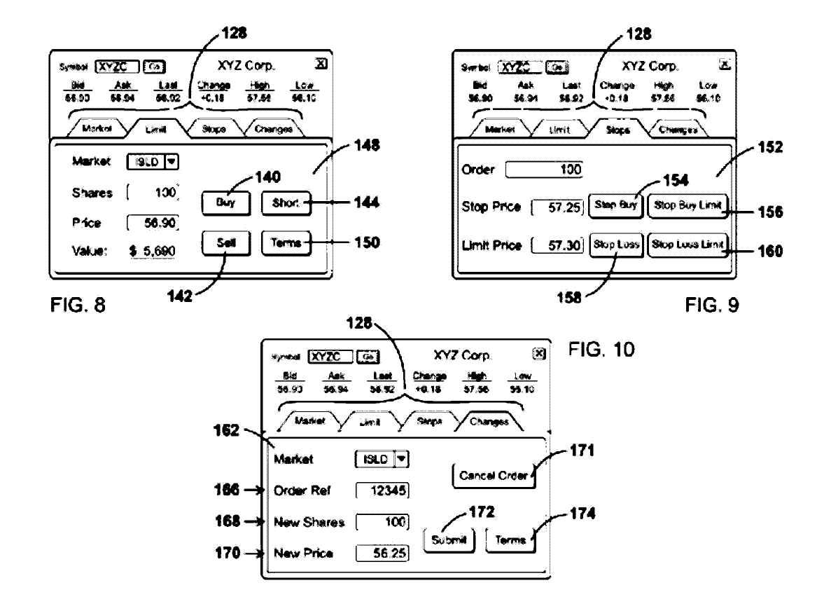

A similar tab is shown in FIG. 8, also selected from the tab set 128; but in this case, it is the limit order tab 148 that is selected. A further button, the terms button 150, is shown within the tab 148, which permits the trader to specify order execution terms. Also shown are buy, sell, and short buttons 140, 142, 144, respectively, which can be pressed or clicked so as to route an order to a given market.

Another tab page 152 from the tab set 128, is shown in FIG. 9, that is the stops tab or stop order entry tab.

The stops tab 152 shows four buttons 154, 156, 158, 160 which are labelled as stop buy, stop buy limit, stop-loss, and stop-loss limit buttons, respectively. An order input can be in terms of shares or an order reference number, so that a filled order can have a corresponding stop order associated with it. Stop orders are triggered when a lot has traded at the stop price. When a stop limit order has been entered, a graphical distinction may be shown between the cell representing the limit price of the order, and the cell representing the stop price trigger on a representative Grid Proper 120, of FIG. 4.

Another tab in the tab set 128 is a change order tab 162, shown in FIG. 10. This tab is employed so as to change any or all of the parameters of an open order, or cancel an open order. An open order is an order that has already been placed but not yet filled. Here, the order reference number 166 is shown, so as to identify an open order that is already in place. The new shares and new price are shown at 168 and 170, with the submit button 172 effecting the change order. Employing button 174 may adjust terms for the open order. Alternatively, the order may be cancelled by employing button 171. Changes may be made, of course, in respect of the volume, the price, or the market 162 through which the order was placed.

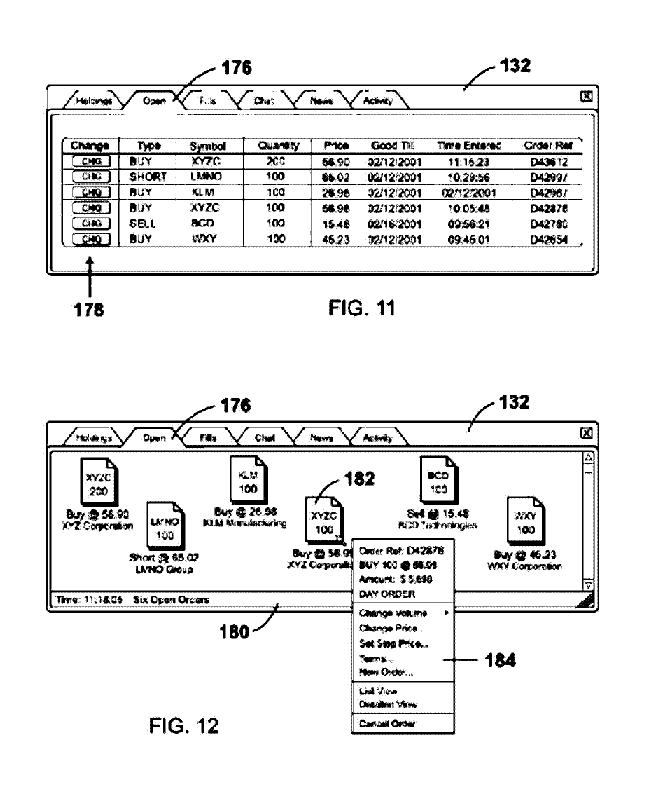

FIG. 11, shows a tab from the tab set 132, namely the open tab 176. FIG. 12 shows similar data, except in icon form; a right click on icon 182 has activated a pop-up menu 184 which permits open order parameters and terms to be changed or open orders to be cancelled; a status bar 180 is shown indicating that there are six open orders.

There is further provided a change column 178 shown in FIG. 11, which permits order parameters to be changed by selecting a change button associated with a specific open order, and which displays the order and the underlying security on its representative Grid Proper 120 of FIG. 4. The displayed order icon can be relocated on the Grid Proper to an alternate market and price bin or cell, so as to effect a price change and/or to submit an order to a different market.

Again, different colors may be employed to show the type of order such as a buy, sell, or short order.

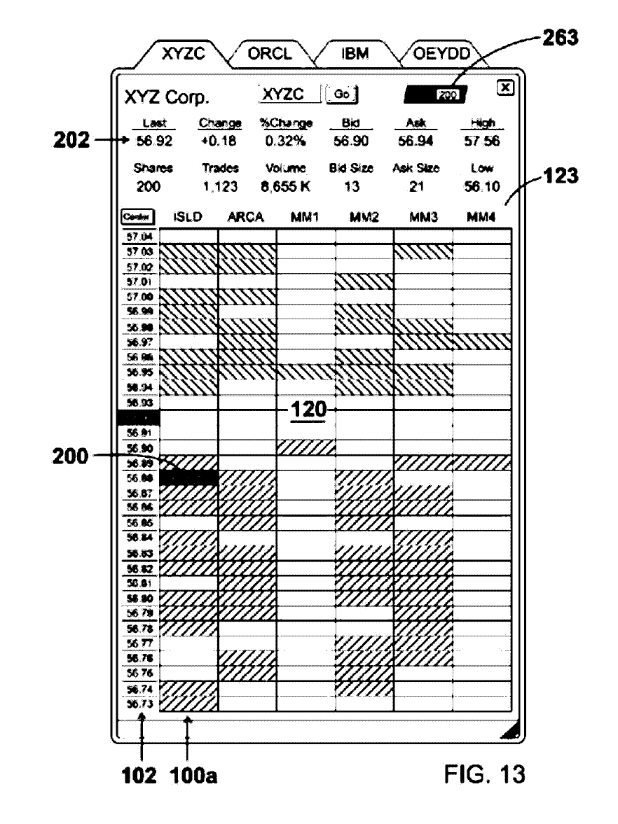

FIG. 13 details a tab page 123 displaying security data for a hypothetical security, XYZC. Reference is now made to how an open order is plotted on the Grid Proper 120. The open order 200 is a limit buy order for 200 shares of XYZC placed at 56.88. This is 0.04 below the last trade price on XYZC, as shown at 202 and as indicated on the price axis 102 at axis value 56.92. The market where the order is placed is Island ECN, as noted in the header for column 100a. To distinguish a user's order from the Market's bid/ask quotes, a contrasting texture or color is used or applied on the user's order. The optional label inside the order also helps identify the type of order and/or the quantity involved. In a similar manner, a limit sell order may be placed in a suitable market and in the upper portion of the Grid Proper 120 representing seller quotes or offer prices.

The user's order is plotted on the Grid Proper 120 in a number of ways. First, the order will be displayed or plotted automatically into a suitable grid if it is submitted from an order entry tab such as that shown in FIG. 8. Second, the order can be entered by dragging and dropping from the Position Guide icon 263, which recommends the quantity of shares to purchase. Third, the order can be dragged and dropped from its associated icon, for example 133, in the holdings tab, as seen in FIG. 6, or a similar account or order status tab.

The orders can be displayed on the Grid Proper 120 direct from the appropriate entry method, either through the order entry tabs 128, the account status tabs, 130 & 132 of FIG. 4, or the Position Guide 263. A delay may occur between the time an order is entered and the time it is validated. Order validation from the back-end is reflected visually on the Grid Proper. Alternatively, the order may be displayed as a first color or texture when the order is initially entered (before validation) on the Grid Proper, and a second color or texture after validation from the back-end. Alternatively, the buy order 200 may indicate a non-valid status until the back-end system validates the order.

A graphical representation of the Nasdaq level 2 display of FIG. 3 is shown in the Grid Proper 120 of FIG. 13. It should be understood that Nasdaq level 2 information and Nasdaq SuperMontage data may be represented on the Grid Proper using an alternative method to that displayed in FIG. 13.

In this disclosure, all reference to Nasdaq Level 2 data also pertains to similar applicable uses of Nasdaq SuperMontage data and any Alternative Display Facility (ADF) data approved by the SEC for displaying quote and order information. Similarly, all reference to Electronic Communication Networks (ECNs) data also pertains to similar applicable uses of any Exchange's or Market's electronic limit order book data used for displaying quote and order information.

Using said alternative method of displaying Nasdaq Level 2 data on the Grid Proper of FIG. 13, the column header information identifying the market associated with each column is not applicable. One column, for example the left most column of the Grid Proper may display graphically, all distinct bid and ask prices as shown in the Nasdaq Level 2 display of FIG. 3. Each cell which displays a bid or ask quote may also show the market maker ID associated with the quote as a text label.

When a bid or ask price from more than one market maker is quoted at the same price point of a Nasdaq Level 2 display, the display typically groups the market maker information in colored bands. In the alternative method display of Nasdaq Level 2 data on the Grid Proper, such multiple market maker quotes at a common price point is displayed individually in successive columns to the right of the first column. For example, if there are four (4) market makers with bids at $56.87 shown on the Nasdaq level 2 display, as shown in FIG. 3, the four market makers would be represented on the alternative method display of Nasdaq level 2 data, in four cells, each cell occupying one column, at price point $56.87.

In the alternative display method for displaying Nasdaq Level 2 data inside the Grid Proper, the bids and asks are initially plotted in the first column of the Grid Proper. When the cell onto which a bid or ask will be plotted is already “occupied” with an existing bid or ask, a new column is created and the bid or ask is plotted in this new column. Thus, the bids and asks appear to be “horizontally stacked” at some price points on the price axis. It should be understood that this alternative display method may be readily adapted to Nasdaq SuperMontage quote displays.

The Grid Proper may also be rendered in three dimensions. The first two dimensions are represented by the price axis and the market maker columns respectively. The third dimension may be thought of as the depth (or frequency distribution) of the number of bids, asks, total quote volume, or user orders on a specific price point and market maker.

In a 3D configuration, the Grid Proper is able to show how bids, asks, and orders are visually stacked on top of each other when they coincide on the same cell of the Grid Proper. Each bid, ask, or order may have additional visual properties such as text labels, which may all be rendered in three dimensions and visually resemble a three dimensional shape such as a cube or cylinder. Thus, in a 3D version, it is possible to visualize orders, select orders, and drag and drop orders from one location on the Grid Proper to another. Such 3D versions of the Grid Proper may be implemented using exiting 3D graphics libraries such as OpenGL, and DirectX.

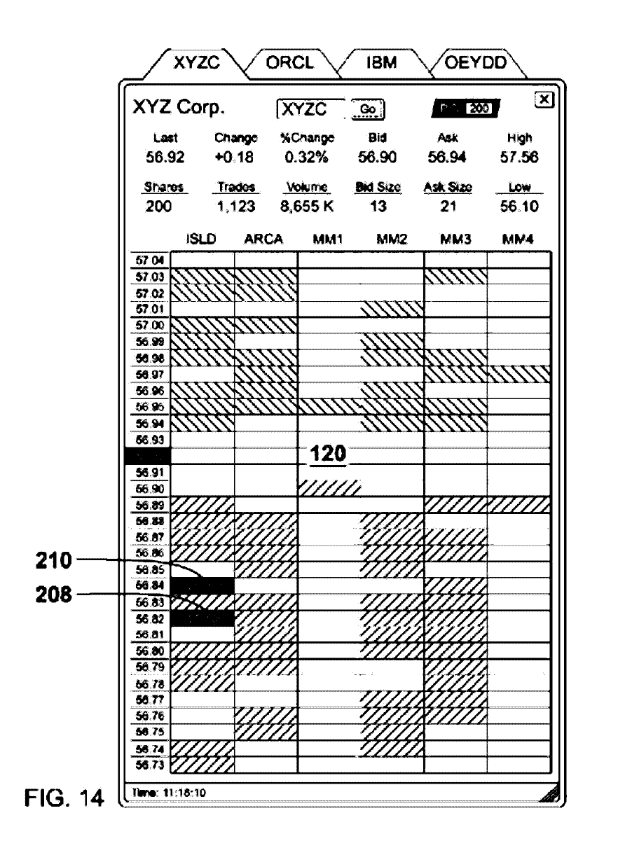

FIG. 14 shows a stop-loss limit order and its associated stop price 208 and limit price 210 on the Grid Proper 120. In this example, the stop price, which is the trigger price for the subsequent limit sell order, is $56.82. When one lot of the security has traded at or below the stop price 208, the associated limit sell order 210 is entered at $56.84. Both parameters, the stop price, and the limit sell price, can be changed by dragging and dropping its associated icon 208, 210 respectively. Text inside the order icons help identify the order type, quantity, and function of each cell.

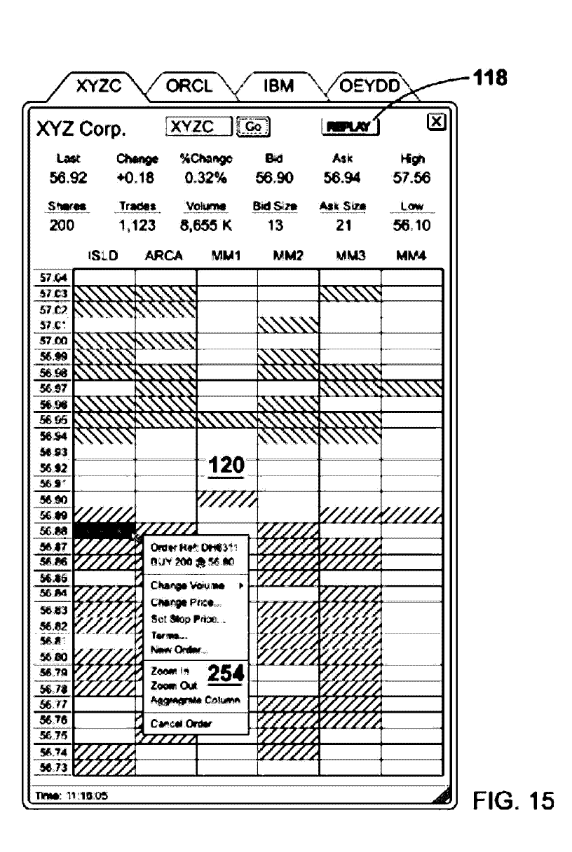

FIG. 15 is similar to FIG. 13, with a right click menu 254 activated for the buy order. The pop-up menu 254 is location and context sensitive, and allows the user to view order statistics, change order parameters, adjust price axis increments, set preferences, display an aggregate column, cancel an order, and the like. A Replay button 118 allows access to the Replay function settings of the interface.

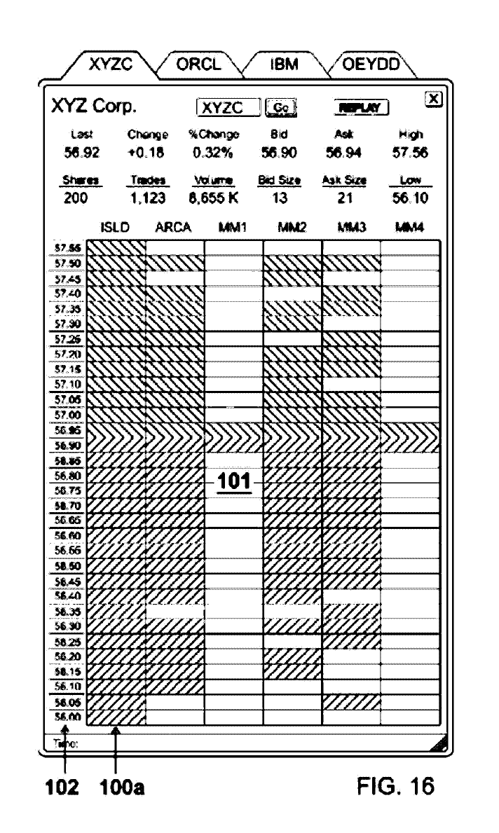

FIG. 16 is similar to that of FIG. 15 with the price axis 102 showing each row separated from adjacent rows by increments of five cents. While the price range shown in FIG. 15 is from 56.73 up to 57.04, the price range shown in FIG. 16 for the same security is from 56.00 to 57.55. Each five cent price bin cell in a five cent row will indicate quote or order data is present if one or more of the five distinct one cent price points that comprise the five cent price bin cell contain one or more quotes or orders associated with the five distinct price points represented by the cell.

It will be noted that each price bin or cell in column 100a of the Grid Proper 101 is filled. This indicates that there is at least one bid or ask quote within each five cent cell of the column 100a. On particularly active days, market volatility may require that the user view a wider price range in each row or cell than merely rows or cells separated by a security's MPV (Minimum Price Variance) of one cent for a typical equity. In FIG. 15, the price for XYZ Corp. is shown to vary in one cent intervals. However in FIG. 16, the price for XYZ Corp. is shown to vary in five cent intervals. The price axis' incremental value is a multiple of a security's MPV and may be specified by the user's preference.

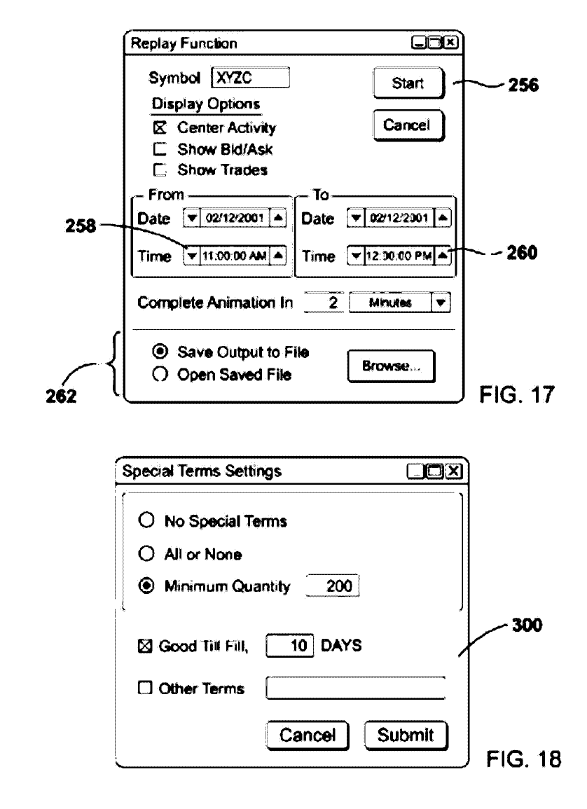

FIG. 17 is a representation of the Replay function dialog box 256. The Replay function provides a graphical playback of historical data and trading activity on the Grid Proper. If the historical time interval being reviewed is large, the playback speed can be accelerated. For example, if the historical time interval being reviewed is sixty minutes, as can be seen in FIG. 17 by calculating the time difference between the “From” and “To” headings 258 and 260 respectively, the user may adjust the playback time period, or speed, to view this interval over a shorter time interval, for example, two minutes, independent of how long the original recorded historical time interval was.

If the historical data or data file on the security is not resident on the user's computer, it may be downloaded from as suitable server. The Replay function uses actual historical quote data, or any suitably formatted data, to run the animation. The Replay function processes archived (historical) quote or order data that is available from the user's computer or from any suitable server. The record function also allows a user to store historical quote and order data on a local storage device in a suitable file format for a given security. Access to browse the user's computer to store or open a historical data file is made available via the settings area 262.

FIG. 18 shows a representation of the special terms settings dialog box 300. Special terms dictate how the order must be filled. Setting special terms is a common feature of trading applications. Special terms for an open order may be accessed and changed from the right click menu of an open order plotted on the Grid Proper 120, as shown at 254 in FIG. 15.

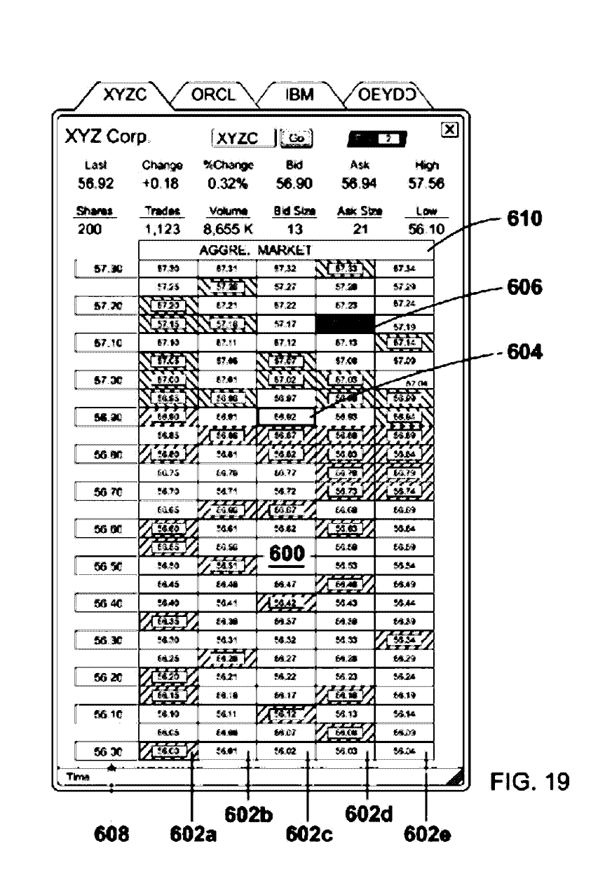

FIG. 19 details an alternative Grid Proper configuration 600. Each row presents five distinct price cells 602a to 602e. Prices progress higher along the price axis 608 from bottom to top, and from left to right. Such a Grid Proper arrangement may be used to represent a single market, or an aggregate market view 610 of one or more markets for a given security. By allowing each cell to represent a distinct price, a greater price range can be shown at one time than the displayed method associated with FIG. 13, and in more detail than the display method associated with FIG. 16. Bids and asks are displayed in their corresponding cells. The drag and drop trading approach is used to enter and modify orders as described earlier. The enhanced border at $56.92 represents the last trade 604 of a fictional XYZ Corp. in the Aggregate market. There is an open “Sell” limit order 606 at $57.18 for 2 lots of XYZ Corp. stock. Although the price axis 608 along the left progresses in five-cent increments, alternative price axis increments and alternative price bins for each cell may also be used.

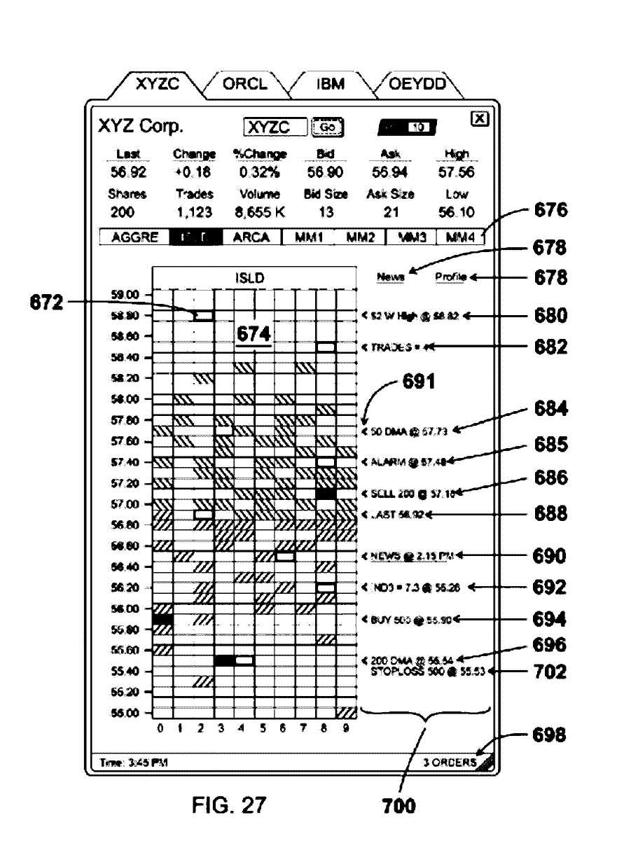

For example, the price axis 608 may progress from bottom to top in increments of 10 cents, with each corresponding row along the price axis having 10 cells, each cell representing a distinct price and separated from an adjacent cell on the same row by a 1 cent increment. Such a Grid Proper configuration is shown in FIG. 27. The term “expanded” is used to refer to Grid Proper configurations where a quote from a given market may appear to move from side to side as well as up and down on the Grid Proper.

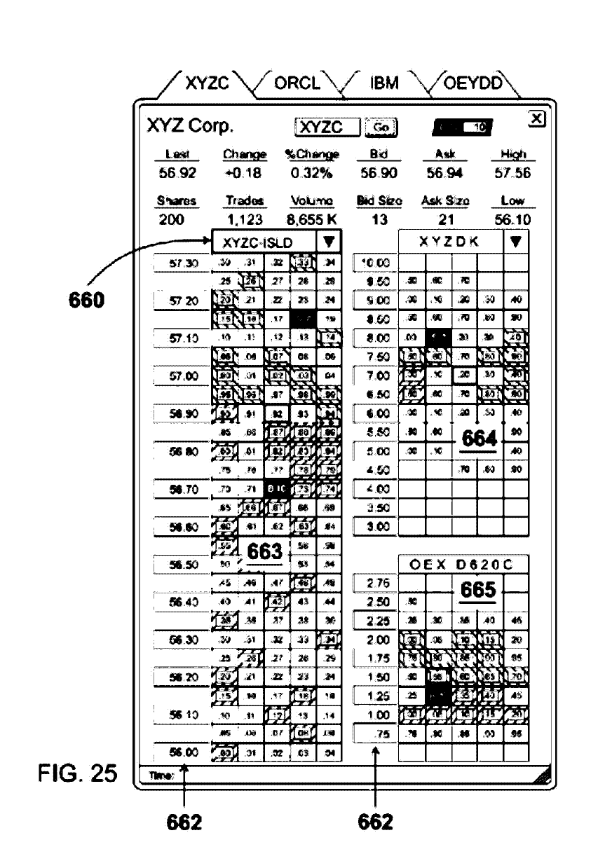

Similarly, the price axis 608 may progress from bottom to top in increments of 50 cents, with each corresponding row along the price axis having 5 cells, each cell representing a distinct range of prices and separated from an adjacent cell on the same row by a nominal 10 cent increment as each cell may hold a 10 cent range of price points. This type of Grid Proper configuration may be helpful, for example, in the options market where the minimum price variance (MPV) for options above $3.00 per contract is 10 cents. FIG. 25 shows just such a Grid Proper configuration 664.

When text labels inside each cell display the nominal or exact price represented by each cell, the price axis may be omitted as the text labels serve a similar purpose. When a security trades on only one market or exchange, or with only one market maker, the market header information 610 identifying the market may be omitted.

The Grid Proper displays of FIGS. 13, 16, 19, 20, 21, 25, 26, 27, and the like, may be readily adapted to display quotes from Nasdaq SuperMontage, ECNs, and alternative display facilities. The enhanced SuperMontage and ECN quotes may be shown on the Grid Proper from one market or market maker, or from multiple markets or market makers displayed simultaneously.

It should be understood that any Grid Proper display may occasionally display the highest priced bid cells at or above the price of the lowest priced ask cells. This situation may be due to a number of factors including errors in the data feed. For example, the data from a data feed may be corrupted, delayed, or may contain momentary aberrations in the refresh rate of all or a portion of the displayed data including the data's price parameter, time sequence, or market identifier information.

When more than one market, exchange, market maker, or ECN is displayed on a Grid Proper simultaneously, for example, when an aggregate view is presented, the bid and ask quote data may naturally overlap one another in such a fashion that one or more bid cells from one market, exchange, market maker, or ECN may appear at or higher in price than one or more ask cells from a different market, exchange, market maker, or ECN. The user may choose to ignore such visual discrepancies, or he may choose to filter the data in such a manner that ask cells may not be shown below the best bid displayed, and bid cells may not be shown above the best ask price displayed on a given Grid Proper.

A given cell on the Grid Proper may represent a range of price points or price increments, for a security or order. For example, a nominal 5 cent price bin may contain 5 price points. When one cell represents a range of price points, or a price bin, there may also arise situations when both bid and ask data are present simultaneously within said one cell. In order to distinguish such a situation where one cell may represent or display both bid and ask prices, the said one cell may be presented in a distinct color, texture, pattern, text label, style, or format.

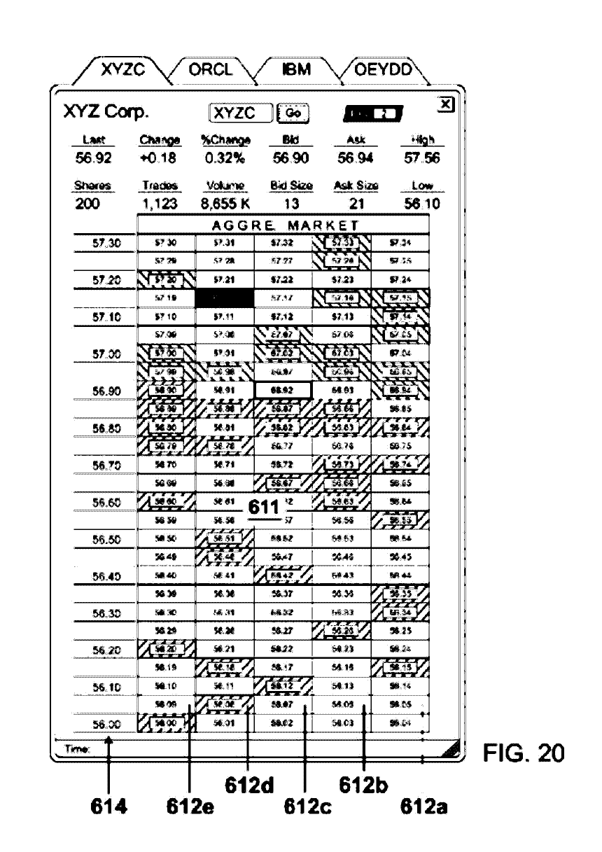

The purpose of the “expanded” Grid Proper configurations of FIGS. 19, 20, 21, 25, 26, 27, and the like, are to display detailed quote and order data over a larger price range than the Grid Proper configuration of FIG. 13 while efficiently using the available display area. The expanded Grid Proper configurations of FIGS. 19 and 20, do not require as frequent an adjustment to maintain the trading activity within the Grid Proper display over the course of the trading session, relative to the non-expanded Grid Proper configuration associated with FIG. 13.

An open order may be modified or repositioned on any Grid Proper using the drag and drop approach discussed previously. It should be understood that alternative methods of modifying or repositioning an open order on the Grid Proper may also be used. For example, an open order may be selected on the Grid Proper or through its icon representation, and a new distinct cell location on the Grid Proper may be clicked in order to reposition the open order to the said new distinct cell location. If there is only one open order on the Grid Proper, selecting the open order is an optional step, the order may be alternatively modified or repositioned simply by clicking on a cell in a different location on the Grid Proper. Similarly, an open order may be modified or repositioned on the Grid Proper by using the keyboard cursor arrows, or by selecting the open order and then using the keyboard cursor arrows.

There are also alternative methods of initiating and placing an order on the Grid Proper. For example, a cell may be selected on the Grid Proper corresponding to the intended limit order price and market destination for the intended order. A “Buy”, “Sell”, or “Short” button located near the Grid Proper is pressed which instructs the system to initiate a “Buy”, “Sell”, or “Short” order for the security associated with the Grid Proper, and at the PG Output quantity, price, and market associated with the selected cell. The resulting open order is displayed on the Grid Proper at the selected cell location.

It should be understood that a single “Order” button may also be used to initiate an order. If the intended price and market cell is selected on the buyer or “Bid” side of the Grid Proper, the system interprets the order as a “Buy” order. If the intended price and market cell is selected on the seller or “Ask” side of the Grid Proper, the system interprets the order as a “Sell” or “Short” order depending on the share inventory of the security in the user's portfolio. The remaining order parameters are derived as discussed in the previous paragraph.

As discussed previously, orders may be initiated using the Position Guide icon, by dragging and dropping the PG icon on a cell in the Grid Proper. The order type may be chosen prior to the drag and drop operation by “right-clicking” on the PG icon and selecting the order type. Alternatively, the order type may be selected automatically depending on the location of the cell where the PG icon is dropped. For example, if the PG icon is drag and dropped on a cell in the buyer or “Bid” side of the Grid Proper, the system interprets the order as a “Buy” order and the PG Output quantity is derived for a buy order. If the PG icon is drag and dropped on a cell in the seller or “Sell” side of the Grid Proper, the system interprets the order as a “Sell” or “Short” order, depending on the share inventory of the underlying security in the user's portfolio, and the PG Output quantity is derived for a sell or short order.

FIG. 20 is similar to FIG. 19 with the exception that the price of each cell does not follow a left to right progression on each row as prices progress along the price axis from the bottom to the top of the Grid Proper 611. Rather, the price progression “zigzags” as each subsequent row alternates direction from left to right and then right to left 612a to 612e as it moves along the price axis 614. The buy and sell quotes shown in FIG. 20 correspond to the buy and sell quotes shown in FIG. 19, however, the quotes are displayed in the alternating “zigzag” style in FIG. 20.

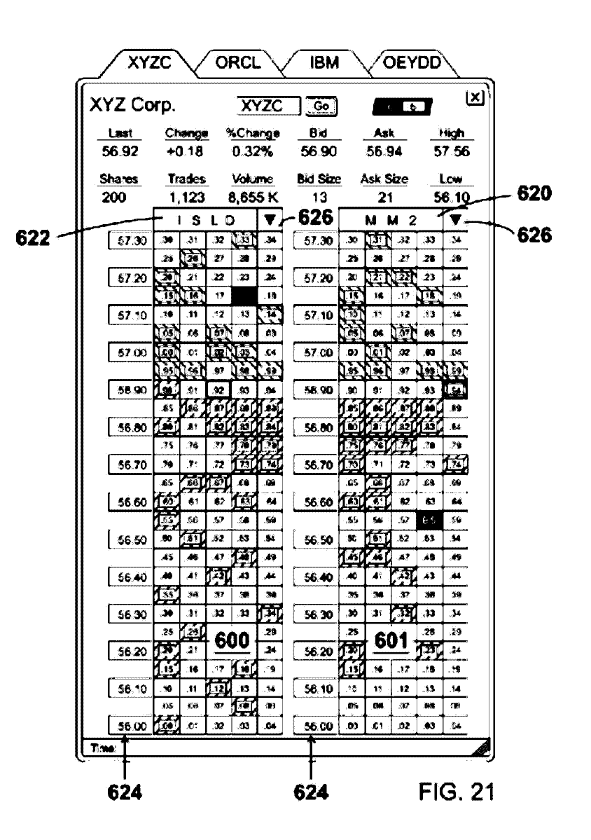

FIG. 21 is similar to FIG. 19 with the exception that data from two different markets 620, 622 are displayed simultaneously on their respective Grid Propers 601, 600 for the indicated security. The price axis 624 is duplicated for the second market for ease of reference. Drop down list indicator 626 adjacent to the text label of each market allows alternative markets to be selected for display. Buy and sell quotes, last trade information, and orders are displayed independently for each displayed market. The drag and drop trading method is used within, and between, the two Grid Propers 600, 601 representing their respective markets. Alternatively, the Grid Propers of the two markets can be displayed arranged one above the other rather than adjacent to each other as in FIG. 21.

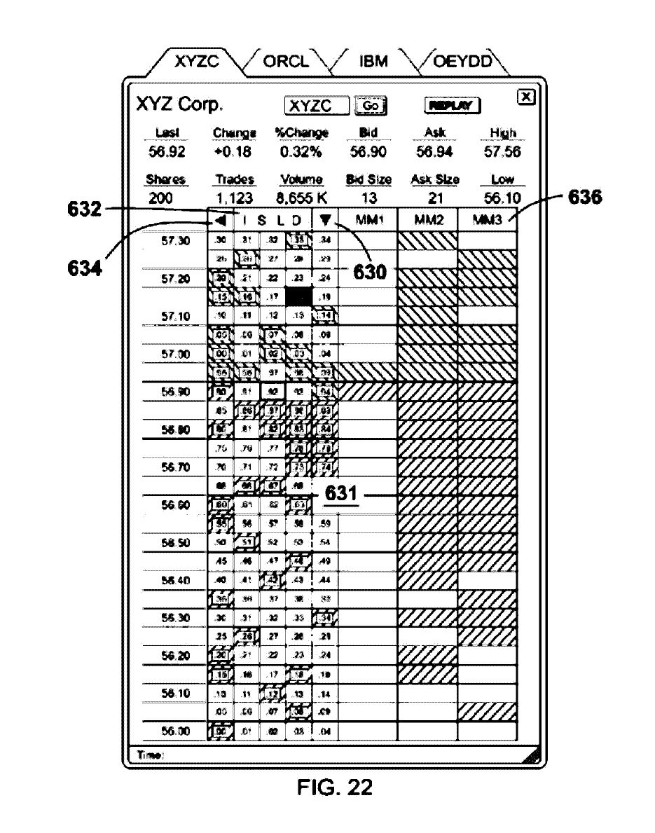

FIG. 22 is similar to FIG. 16 but displays a Grid Proper presentation 631 in which, a specific market such as the ISLD ECN market 632, has its price bin expanded from one five cent bin to five one cent bins to reveal more detailed order and quote information at each price increment of the security. The remaining markets, MM1, MM2, and MM3 636 maintain their five cent price bin corresponding to the price axis increment. A row indicator 634 adjacent to the market identifier label 632 functions to toggle the expanded one cent price bin representation of ISLD ECN with the standard five cent price bin view. Market selection is achieved via a drop down list 630.

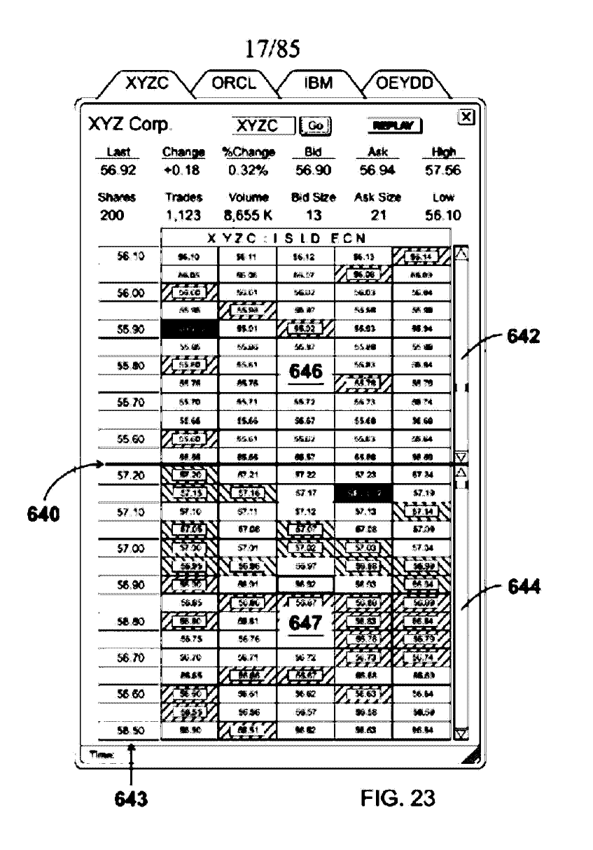

FIG. 23 is similar to FIG. 19 incorporating a grid partition or split grid feature, which allows the Grid Proper to be partitioned into two or more grid sections 646, 647 each representing a separate range of values along the price axis 643. The range of values may be selected by adjusting the position of the horizontal partition bar 640 and by using each grid section's scroll bars 642, 644 respectively. The drag and drop method of placing and modifying orders remains the same. The user may drag and drop orders within each grid section and from one grid section to the other. Alternatively, this partitioned grid view may show two markets separated by the adjustable horizontal partition bar 640. Moving the partition bar up or down allows the user to display more data for one market relative to the other.

Current advancements in mobile computing technology have led to the proliferation of portable computing devices such as PDAs, smart phones, and tablet PCs. The front-end application may be adapted to run on such a portable computing device. The front-end application (hereafter referred to as the “mobile front-end”) may be a smaller, compact version of the front-end application described in FIG. 4. The mobile front-end may also be implemented as a software object.

The mobile front-end connects to one or more data sources and one or more market participants through a suitable network connection.

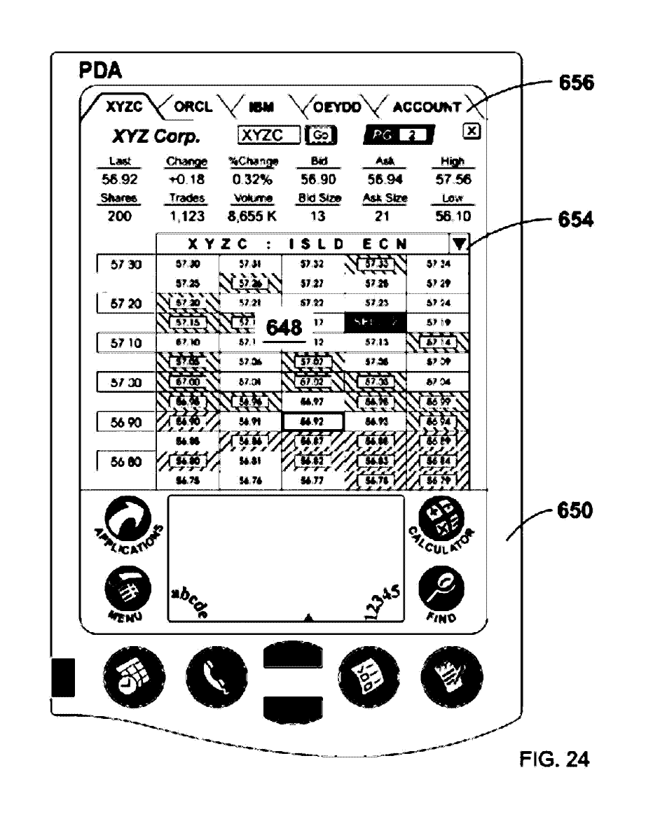

Turning now to FIG. 24, the portable computing device's hardware 650, and its operating system determine the user interaction methods available to the user. For example, the drag and drop method of interaction on a Palm PDA involves using a stylus and the following steps: locate a GUI object displayed on the screen, point to it with the stylus tip, touch the screen, drag the GUI object to a new location, and raise the stylus from the screen to drop the GUI object at that location.

The mobile front-end allows the user to perform the following tasks: place orders, modify orders, cancel orders, view account data, view trading data, and the like. A user may place an order through an order entry form, or by dragging and dropping a GUI object, such as from the Position Guide icon representing a recommendation quantity, to a location on the Grid Proper 648 representing the transaction conditions for the order.

Dragging and dropping an order icon from one location on the Grid Proper 648 to a new position representing a desired change will communicate to the back-end system to modify the open order. Similarly, dragging and dropping the order to a specified area of the display may be used to cancel an open order. The mobile front-end uses multiple tabs or tab pages to organize and present data such as an Account tab 656 containing data on the user's account status. The drop down list 654 allows a user to change the currently displayed market data from one market to another.

FIG. 25 is similar to FIG. 21 with the exception that multiple securities are shown on the display panel. This view may be used to monitor and trade related securities such as an option security and its underlying stock or index, or to display two or more securities in the same industry sector. In FIG. 25, XYZ Corp.'s equity Grid Proper 663 is displayed for ISLD ECN. To the right is displayed the Grid Proper 664 for XYZ Corp's April $55 Call Options. At the bottom right is shown the Grid Proper 665 of the S&P 100 index 620 April Calls. The header border area 660 around the ISLD market is distinguished relative to the others headers to indicate that the summary data and the Position Guide recommendation quantity pertains to this specific security and market. Drag and drop order placement and modification can be performed within each Grid Proper but as the displayed securities are not identical, orders cannot be moved between each security's Grid Proper. The price axis 662 and cell price increment of each Grid Proper is determined by the interface to show an appropriate range of data for each security displayed.

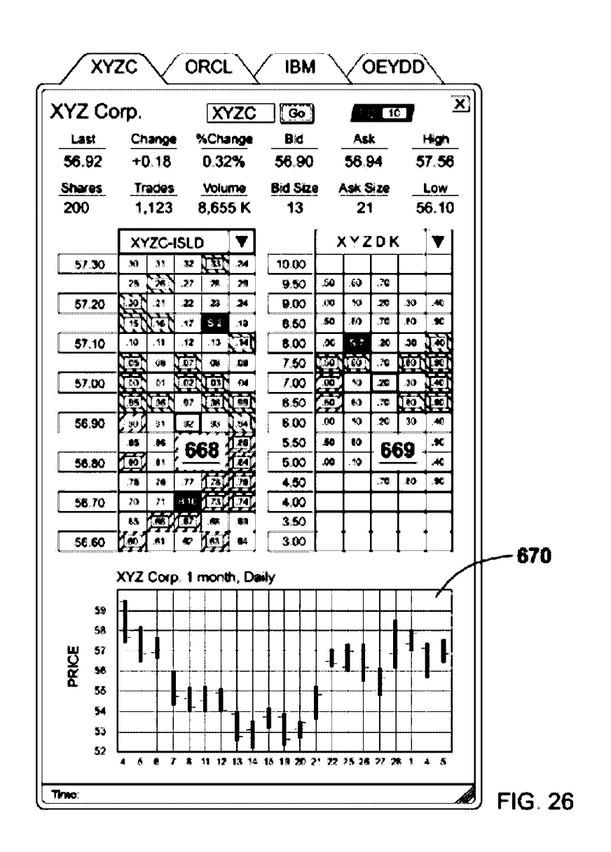

FIG. 26 is similar to FIG. 25 with the exception that it includes a chart display 670 of a security at the bottom of the tab page. In a similar fashion, information and interactive content related to the underlying security such as news, chat programs, research content, analysis, and company profile information may be shown on a portion of the tab page. Grouping content within the tab page of a given security, or related securities, is convenient and allows the user to pre-configure a specific presentation from security to security, and from one tab page to the next. Also displayed are the Grid Proper 668 of the equity security XYZ Corp., and the Grid Proper 669 of a related option security.

As described, the Grid Proper may be used to display bid and ask quotes, orders, and related visual cues such as comment cells, and border highlights. There are a number of situations which involve the use of border highlights such as an order's docking behavior as it is dragged on the Grid Proper, or the visual Alert cell border highlight that remains in position to indicate the location where an order has been filled, or where the last trade occurred on the Grid Proper.

Other examples of visual cues are the use of Marker cells and Indicator cells. There is a distinction between the two cell types. Marker cells may be dragged and dropped, or repositioned on the Grid Proper at the discretion of the user. The function of Indicator cells do not permit the user to directly change or alter the Indicator cell's location on the Grid Proper.

One example of a Marker cell is an Alarm cell. The Alarm cell will alert the user if one lot of shares trade at the price corresponding to its location. Hence, the Alarm cell may be dragged to any location on the Grid Proper and retain its functionality. Another example of a Marker cell is one that is associated with a formula. One input variable to such a formula may be the price of the security, and this price value may be input through the Grid Proper, by moving the Marker cell's location on the Grid Proper.

The output value of the Marker cell may be shown as a text label associated with the cell. For example, a Marker cell may be configured to show a 50 day moving average value. The location and price value associated with the Marker cell represents the most recent variable in the 50 day (50 variable) moving average formula. As the user moves the Marker cell on the Grid Proper, the output value of the Marker cell, displayed inside the cell, or as in FIG. 27, to the right of the Grid Proper, indicates how the 50 day moving average would fluctuate within the cell array range of the Grid Proper. Hence, the user may adjust the position to “goal-seek” and perform “what-if” type scenarios on the Marker cell output.

Indicator cells may also be programmed with formulas, which output values that may be displayed inside the Indicator cell or near the cell. However, Indicator cells may not be repositioned by the user. Rather, their position is set by the system based on the indicator cell's underlying process, and the cell's location is indicative of the output value associated with its underlying process.

For example, an Indicator cell programmed to display a security's 50 day moving average, would indicate the value, in real-time, on the Grid Proper at the location of the cell representing the calculated or processed value of the 50 day moving average. Although the 50 DMA can be shown through both Marker and Indicator cells, the former allows the user to see what the value of the 50 DMA would be over a range of prices on the Grid Proper, while the latter, displays the true real-time 50 DMA on the Grid Proper and does not permit any interactivity with the indication.

Indicator cells may indicate the value of a moving average, technical indicators, and statistics whose output value and meaning may be related to the location or position of a distinct cell or group of cells on the Grid Proper. The output of any technical indicator, which results in a price value, may be shown as an Indicator cell on the Grid Proper. Technical indicators, formulas, or a program may be used by Marker and Indicator cells and their underlying process.

In Marker cells, the position of the cell and an associated parameter, such as price, serves as an input to the Marker cell processes. The Marker cell output may be made available as a text label or a visual style, for example, at the Marker cell's location or nearby. For an Indicator cell, the position of the cell and an associated parameter, such as price, serves as an indication of the output value of the Indicator cell processes. The Indicator cell output may also be made available as a text label or a visual style, for example, at the Indicator cell's location or nearby.

Indicator cells may be used to display support and resistance price points on the Grid Proper in a manner similar to conventional technical charting techniques. One or more Indicator cells may indicate historical high or low price points of a security's trading range on the Grid Proper. This alerts the user to be especially vigilant and monitor trading activity near such high or low price points for signs of technical support or resistance.

Note that in the above example, the Indicator cell would lose its meaning if the user were able to move the Indicator cell throughout the Grid Proper. Since the Indicator cell was configured to indicate a historical high or low price of a security, and since historical data is a matter of record and cannot be changed, it does not serve a purpose, in this example, to allow the user to drag and drop such an Indicator cell arbitrarily. The user may, however, change the Indicator cell's underlying mathematical processes to effect a change in the position of the cell, but he may not do so through a direct manipulation of the Indicator cell itself. For example, he may not drag and drop the cell, or use keyboard cursor arrows, to move the selected Indicator cell to a different location. The user may cancel or hide the use of any Indicator cell or Marker cell, for example, with a right-click command at the Indicator or Marker cell's location.

Indicator cells may also be used to indicate suggested buy and sell price points for any security displayed on the Grid Proper. In this case, the indicator cells would serve merely as a visual and textual output indication of a third party plug-in program or application. The program would derive such buy and sell price points and provide the necessary output reflected through the Indicator cell.

A Marker cell's position on the Grid Proper may be used to input values to the Marker cell's underlying calculation process. Such input values may be related to the price of the security, the identity of the market, or data associated with the trading activity at the Marker cell's location. Marker cell output values may be indicated as a price, a volume, some parameter of a trade, or a percentage or ratio derived from a formula, a calculation process, or a computer program.

It should be understood that the purpose and output values of Marker and Indicator cells may be conveyed as text output, as visual textures, icons, colors, shading, or a combination of text and visual styles when the cells are plotted on the Grid Proper. It should be further understood that the user may select the manner of the output and its visual aspects to suit his preferences. Such text or visual styles may change dynamically and in real-time to reflect the status or current value of the Marker and Indicator cell's underlying processes.

The use of Marker and Indicator cells contemplates all uses of such a cell or group of cells to convey information of value to the user, expressed visually on the Grid Proper.

Marker cells are defined as user positioned and user configurable cells visually distinct from other cells on the Grid Proper. A Marker cell may have a different input and output value at each location where the user may choose to move the Marker cell. The Marker cell value may be derived from a technical formula, a market analysis program, or from a parameter of a security. Indicator cells are defined as user configurable but not user positioned cells visually distinct from other cells on the Grid Proper. Indicator cells are displayed on the Grid Proper by the front-end application.

Turning now to FIG. 27, where specific values and functions are shown and described as representative examples of features associated with the Grid Proper.

FIG. 27 is a presentation of the Grid Proper 674 adapted to display a greater array of cells and cell prices. To do so, the cell's size is reduced to an extent that it is not practical to display text labels inside each cell. The text labels and text descriptions of specifically indicated cells are set to one side, for example, the right side 700 of the Grid Proper and adjacent to the cell rows. The cell size, although small, is still of sufficient size to allow colors, textures, and markings to be applied to each cell to distinguish it from surrounding cells. Specific markers, indicators, and price points may be displayed on this expanded cell array and price range which will benefit the user. The text labels 700 typically reference to and associate with a specific cell on the Grid Proper.

Prices on the Grid Proper are referenced to a point on the vertical and horizontal price axis. For example, an identified cell 672 is referenced to 58.80 on the vertical price axis, and to “2” units on the horizontal price axis. Hence, the cell 672 represents a price point of 58.82 on the Grid Proper.

This expanded price range view of the security can be adapted to display aggregate or specific market data by selection process 676. Html links 678 provide market news or profile data on the security displayed. Prompt arrow 691 points to the specific row on the Grid Proper 674 containing the cell to which text label 684 references to. The Prompt arrow 691 and/or the text label 684 may be color coded to indicate what cell type, a Marker cell, an Indicator cell, or an Order cell the text label refers to.

Distinct Indicator cell 672 has a corresponding text label 680 indicating, for example, the 52 week high of the displayed security. Text label 682 is associated with a cell at a value of 58.58 on the Grid Proper 674 and may, for example, indicate a descriptive statistic, such as the number of trades that have occurred in the location of the Marker cell over a time period, such as two trading sessions.

Text label 684 identifies the 50 day moving average (DMA) of the security as 57.73. Shown is a corresponding Indicator cell at price point 57.73 on the Grid Proper. Similarly, there is a text label 696 indicating a 200 DMA value of 55.54, and a text label 702 indicating a stop-loss order for 500 shares at 55.53. Text label 685 indicates an Alarm Marker cell at 57.48 on the Grid Proper 674. The function of Alarm cells has been described previously.

Text label 686 indicates a 200 share sell order at 57.18, and text label 688 indicates the last trade at 56.92. News html link 690 references to a news release at 2:15 pm when the security was trading (as the news was released) at 56.56. Text label 694 indicates a 500 share buy order at 55.90. Text label 692 indicates a user-defined Marker cell at 56.28. The output value of the cell is 7.3 at cell location 56.28. The status bar 698 indicates there are three open orders on the Grid Proper.

A Marker cell may derive an output value at any location on the Grid Proper 674. For example, a Marker cell may indicate the profit or loss associated with an order at any point on the Grid Proper and hence, the user is able to quantify at which point the trade becomes unprofitable. Alternatively, key technical indicators such as a securities key support and resistance levels may be displayed by the use of less interactive Indicator cells.

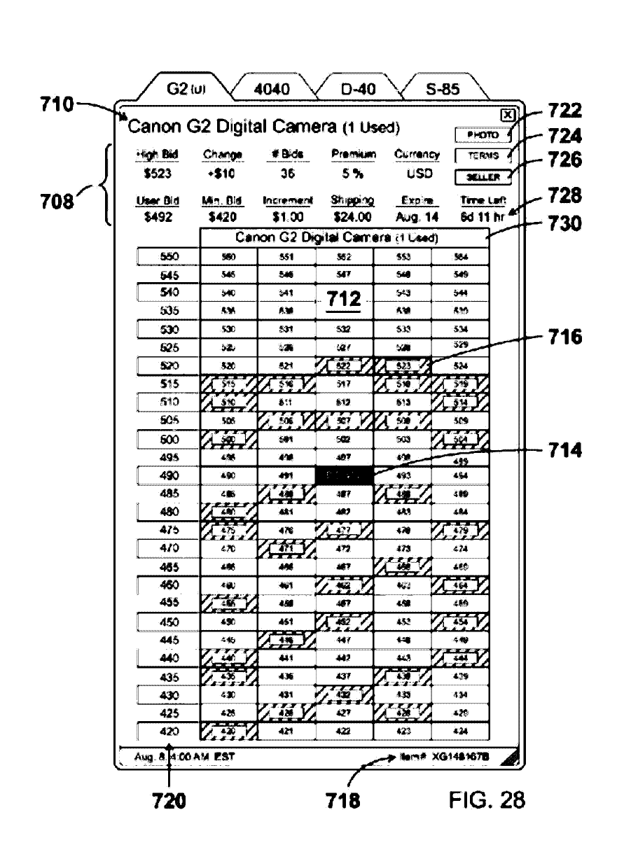

FIG. 28 is a configuration of the Grid Proper as used in an auction market involving one seller and multiple buyers. The workings of the tab page are best described by way of example. The item for auction is a used Canon digital camera 710 as labeled in the tab and Grid Proper column header area 730. Summary data area 708 identifies relevant auction statistics such as the high bid, the price change over a specified period of time, and the time remaining before the auction expires 728. The item number 718 is displayed in the status bar, and a photo of the item, the terms of the auction, and information on the seller of the item is available from buttons 722, 724, and 726, respectively.

The price axis 720 and the text label inside each cell of the Grid Proper 712 references to the cell prices, and the prices bid for the item. The text labels may be disabled as desired by the user. A bid 714 by the user is indicated at price point $492 and the current high bid 716 is indicated at price point $523. The user may choose to adjust his bid higher as the auction progresses using the drag and drop discussed earlier. Determination of the winning bid is based on the type of auction and the terms of the auction house.

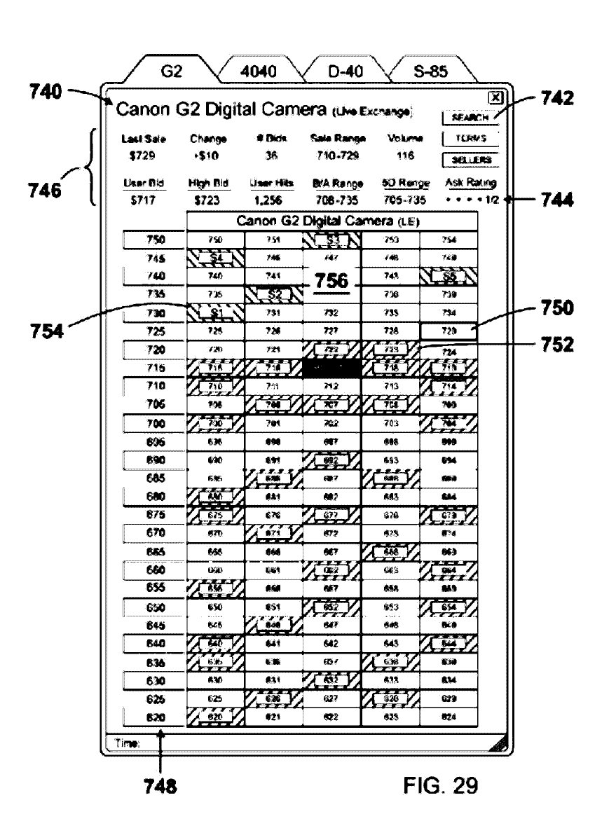

FIG. 29 is a configuration of the Grid Proper as used in a continuous auction market involving multiple sellers and multiple buyers transacting in essentially real time. Transactions occur, and bids and asks are plotted, similar to the workings of the securities market described and referenced to FIG. 19.

The item is a new Canon digital camera 740 as labeled. Summary data area 746 identifies relevant market statistics such as the last sale, the auction's price range over a specified period of time, and the number of users monitoring the activity of this market. The search button 742 allows the user to search and locate other items of interest being auctioned.

The price axis 748 and the text label inside each cell of the Grid Proper 756 references to the cell price, and the prices bid for the item. A bid by the user is indicated at price point $717 and the current high bid 752 is indicated at price point $723. The last transaction or trade 750 is indicated by the border highlight at price point $729. The seller or offer prices for the item are indicated in cells with text labels S1 to S5 on the Grid Proper. The lowest ask price 754 corresponds to cell S1 at price point $730. Buyer and Seller quality ratings may be incorporated into the summary area 746. A quality rating of the Seller 744 with the lowest offer price is indicated.

Buyers and sellers can adjust their pace on the Grid Proper 756 to reflect supply and demand conditions in this auction market. The user can modify or cancel his bid or offer price by dragging and dropping his order as disclosed previously. When a transaction occurs, arrangements to facilitate payment to the seller, and deliver the item to the proper address of the buyer complete the fulfillment and settlement of the transaction.

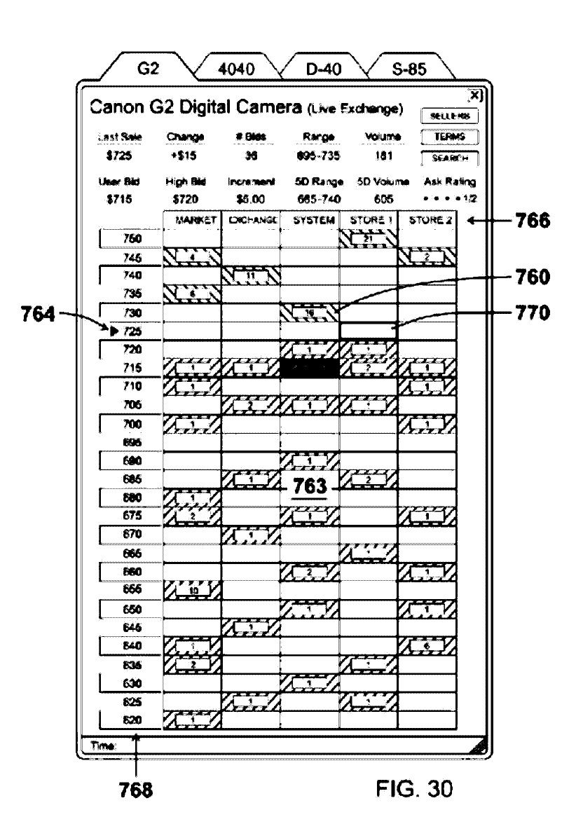

FIG. 30 is a variation of the auction market described in FIG. 29. A continuous auction market is shown involving multiple sellers and multiple buyers operating in real time to buy and sell a specific item. Differences in transaction terms and conditions between multiple market participants may make it impractical to combine bid and ask auction information into a single aggregate display as in FIG. 29. Column header area 766 indicates that each market participant is allocated its own column on the Grid Proper 763 to display bid and ask information specific to its market. Market participants may be individual stores, electronic networks, B2B or B2C exchanges, auction intermediaries, auction aggregators, and the like.

The reference price axis 768 is used to indicate the price of the item in $5 increments. Border highlight 770 identifies the item's last transaction price 764 and its associated market, “Store 1”. The high bid is at price point $720 in two markets: “System”, and “Store 1”. Both bids are for a quantity of one Item. The lowest ask price 760 is associated with a price point of $730 in the “System” market. The seller 760 has 16 items for sale at its best offer price.

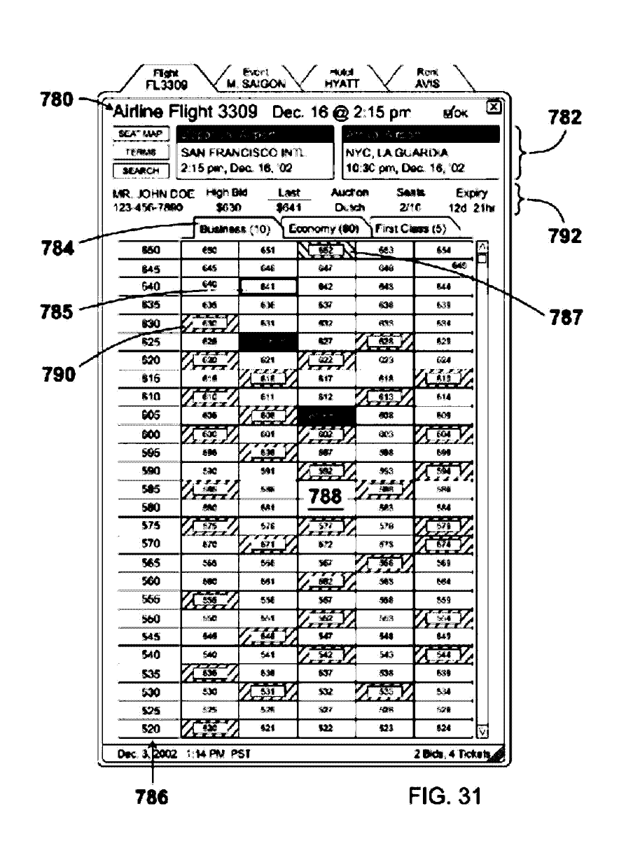

FIG. 31 is a variation of the tab page presentation as may be used in an auction or ticketing market involving one seller and many potential buyers. The workings of the tab page are described by way of example. The item for auction is a number of seats in each class of an airline flight. The flight name 780 is labeled in the tab and tab page. Summary data area 782 identifies relevant flight data such as departure and arrival times, and airport locations. Also displayed in the summary area are statistics related to the auction 792 such as the high bid, the type of auction, and the time remaining before the auction expires.

Tab set 784 allows the user to select which class of a flight, First Class, Business Class, or Economy Class, is of interest to him. The user may bid conveniently within each class for an allocation of one or more seats. Within the tab label 784, the number of seats available for the auction in each class is indicated. For example in Business Class, 10 seats are participating in a Dutch style auction.

Alternatively, each of the 10 seats, may be auctioned one at a time, or awarded one by one to the highest bidder at the end of each of 10 consecutive time intervals. The last awarded seat 785 may be indicated by a border highlight at price point $641. The lowest price a seat may be purchased outright from the airline, thus foregoing the auction process, is represented by the airline's offer price 787, indicated at price point $652.

The price axis 786 and the text label inside each cell of the Grid Proper 788 references the prices bid for the item. The text labels may be disabled as desired by the user. The user has bid on two seats for this flight; Both bids are in Business Class at price points $626 and $607 on the Grid Proper 788. The current high bid 790 is indicated at price point $630. The user may choose to adjust his bids higher or lower as the auction progresses by moving each bid by using the cursor arrows of the keyboard, or the drag and drop method discussed previously. Determination of the winning bids is based on the type of auction and the terms of the market. The actual seat assignment may take place on-line after a winning bid or off-line at a travel agent, or at the check-in counter of the airline prior to departure.

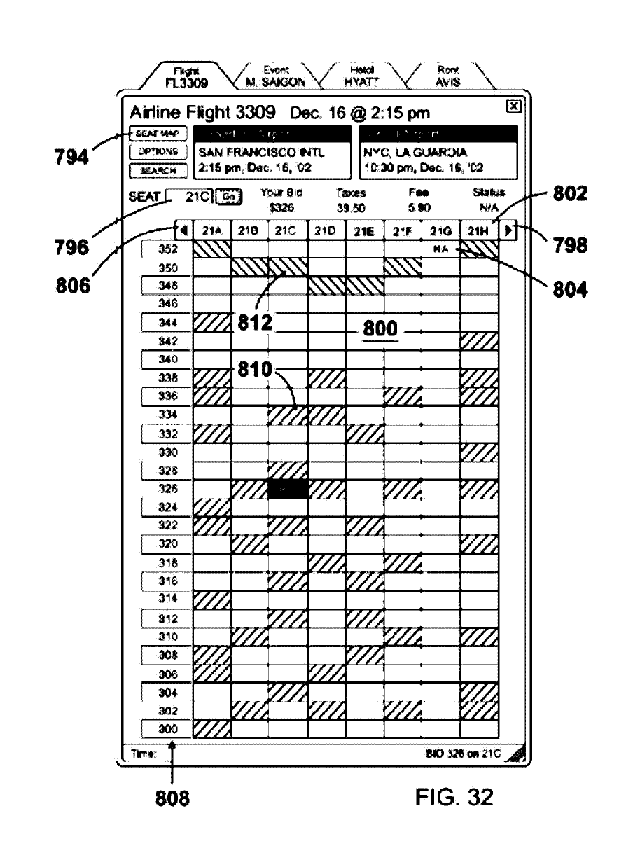

FIG. 32 is a variation of FIG. 31 as may be used in an auction or ticketing market involving the purchase of seats for a given event, or for transportation. Each seat available for auction is represented by its own column. For example, the items for auction maybe a selection of seats on an airline flight. Bids on individual seats are displayed on the Grid Proper 800. The user may locate a suitable seat to bid on from the seat map button 794, or the “go to seat” input box 796. The seat number identification associated with each seat auction is displayed in the column header area 802. Seats not involved in the auction or of no interest to the user may be hidden from view by a right click “hide” command available from the resulting column header pop-up menu. Navigation buttons 798, 806 allow the user to scroll through the seats available for auction. The order of the columns, or seats, may be automatically arranged according to location and class, or ranked according to the highest or lowest prices bid for each seat.

There is a user bid entered for seat 21C corresponding to price point $326 on the price axis 808. The high bid 810 on seat 21C corresponds to a price point of $334. When an optional offer price 812 is displayed for a specific seat, it means that seat may be purchased instantaneously, by moving the bid to the offer price point of $350. Once purchased, a seat is no longer available for auction and an Indication of its status may be displayed 804. All the seats participating in the auction may be awarded at one time, or alternatively, the highest bid seats may be awarded in succession at the end of each of a series of consecutive time intervals.

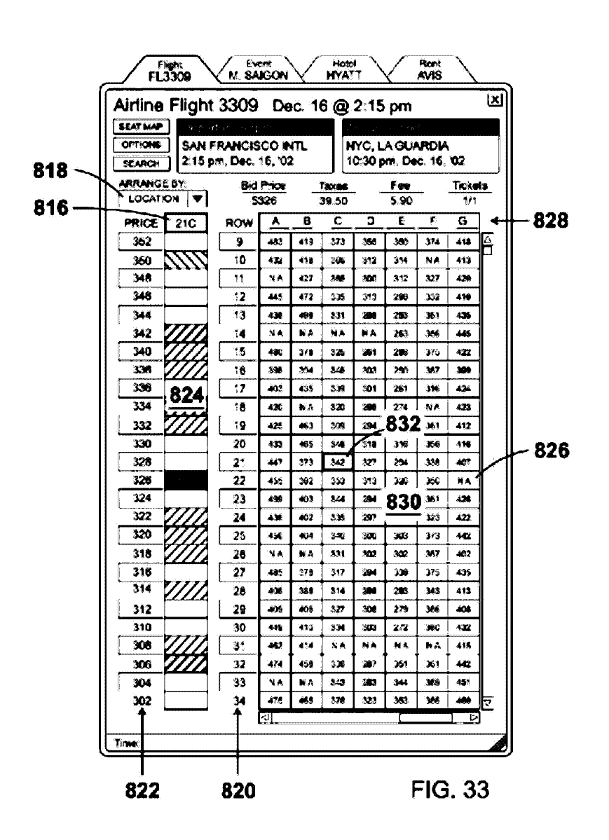

FIG. 33 is an alternative presentation of FIG. 32 as may be used in an auction or ticketing market involving, for example, the auctioning of a number of seats on an airline flight. Details of the flight are indicated at the top of the display panel.

The seat number is indicated in the Grid Proper's column header area 816. Bids on an individual seat, 21C, are displayed in Grid Proper 824 and reference to the price axis 822. The user may select a suitable seat to bid on from the seat selection area 830. Each cell in the seat selection area corresponds to a seat row 820 and a seat letter 828. Dash markings immediately below the seat letters “A” to “G” at 828 allows the user to identify the seat as a window or aisle seat for a given aircraft and its seating configuration.

If a seat in the seat selection area 830 is not available, a suitable indication is provided 826 in the seat's associated cell. Grid Proper 824, displays a user bid at price point $326, and a high bid at price point $342 on the price axis 822. The high bid price of $342 corresponds to a matching text label associated with seat “21C” in cell reference 832 of seat selection area 830. When an offer price is displayed in the Grid Proper 824, such as in this case at price point $350, it indicates that the selected seat, “21C”, for example, may be purchased immediately by placing a bid at the offer price.

The arrangement and display of seats in the seat selection area 830 may be ranked by highest bid, lowest bid, or seat location through selection process 818. If seats are arranged by bid price, the text label inside each cell of seat selection area 830, may refer to the seat number rather than the highest current bid price. This ranking feature assists the user to quickly identify the lowest bid seats. Alternatively, if the highest bid seats are awarded one at a time, at the end of a time interval, the user may locate those high bid seats about to be auctioned or next in-line to be awarded.

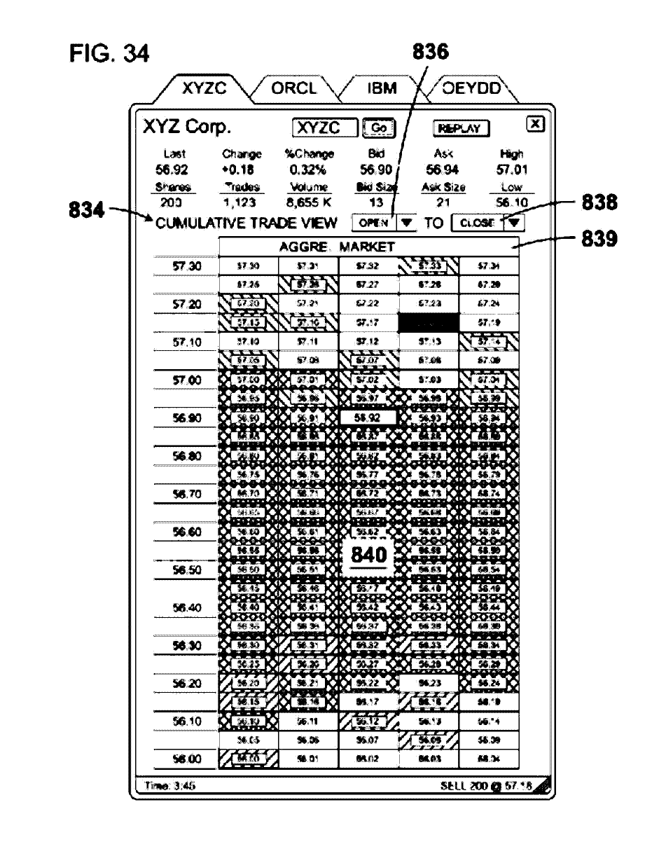

FIG. 34 provides a Cumulative Trade View presentation of FIG. 19. The Cumulative Trade View indicates the location of cells, and range of prices, in the Grid Proper 840 where trades have occurred over a specific time interval. This allows the user to determine the relative position of the last trade in relation to the entire range of prices the security has traded over in the time interval.

The Cumulative Trade View feature 834 is associated with a begin time 836 and an end time 838. For example, the begin time 836 is the opening time of the trading session, and the end time 838 is the closing time of the session. For other times during the current trading session, specific times may be listed in the drop down list 836 and 838. The cumulative trades displayed represent all trades in the aggregate market display 839 over the time interval specified. Text labels within each cell of the Grid Proper 840 indicate the price associated with each cell.

The text labels can also display, without limitation, the cumulative number of trades that have occurred, the number of open orders, the profit or loss associated with each cell, the cumulative volume of the trades, and the dollar value of the cumulative transactions at each cell and price point.

Existing buy and sell quotes are displayed on the Grid Proper 840 in cells where no trades have occurred. Also displayed on the Grid Proper 840 is a sell order for 2 lots or 200 shares at price point $57.18 and a border highlight indication representing the last trade price of the security at price point $56.92 in the Aggregate market display. The drag and drop method of placing and modifying orders may be used on the Grid Proper 840 as before.

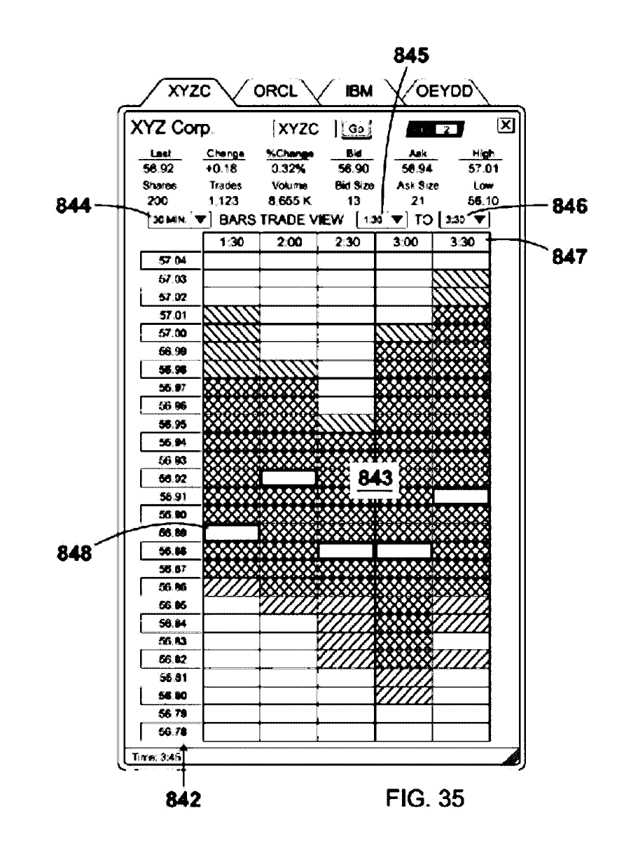

FIG. 35 provides a representation of the Bars Trade View of the Grid Proper. The Bars Trade View allocates a specific, user defined, time interval to each column in the Grid Proper display 843. Within each column, trades that have occurred during the column's specified time interval are displayed in Cumulative Trade View style with traded prices referenced to the price axis 842.

The drop down list 844 provides a convenient method of selecting the time interval associated with each column. In this instance, each column represents a 30-minute interval of time. The overall time interval shown is selected by using the drop down lists associated with the begin time 845, and the end time 846. The header information 847 of each column indicates that the five columns will show a cumulative trade interval from 1:30 p.m. to 4 p.m. in five distinct 30 minute columns. Referencing trade indicating cells to the price axis 842, we see that during the overall time interval, the security traded in a price range from $56.86 to $57.01. The ending bid and ask prices, and the last trade price 848, may remain displayed as the cumulative time display transitions from one column to the next and from one time interval to the next.

Text labels, disabled in this instance of the Grid Proper 843, may indicate the price, the cumulative number of trades that have occurred, the number of open orders, the cumulative volume of the trades, and the dollar value of the cumulative transactions at each cell. The drag and drop method of placing and modifying orders is applicable as before, but may be restricted to the current, real time, column of the display. A filled order may also be indicated in the column corresponding to the time interval when the order was filled.

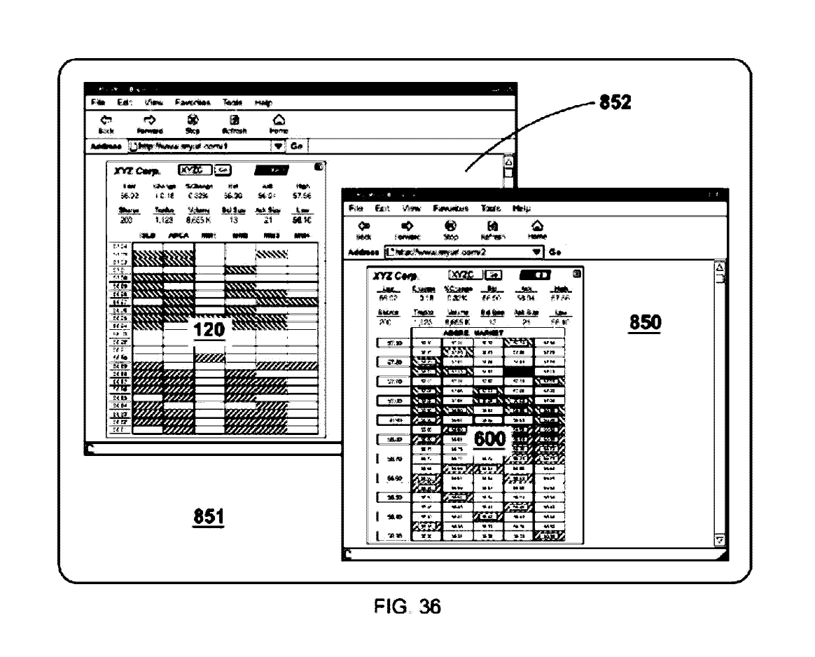

FIG. 36 shows the Grid Proper 600 and associated market data operating within a web browser 850 as displayed on a computer monitor screen 851. An alternative representation of the Grid Proper 120 is shown in a second window 852 of the web browser. Information for each browser window may be updated in real time or refreshed as required by the user. Multiple browser windows may be used to display different securities in a fashion similar to that of tab set 121 of FIG. 4.

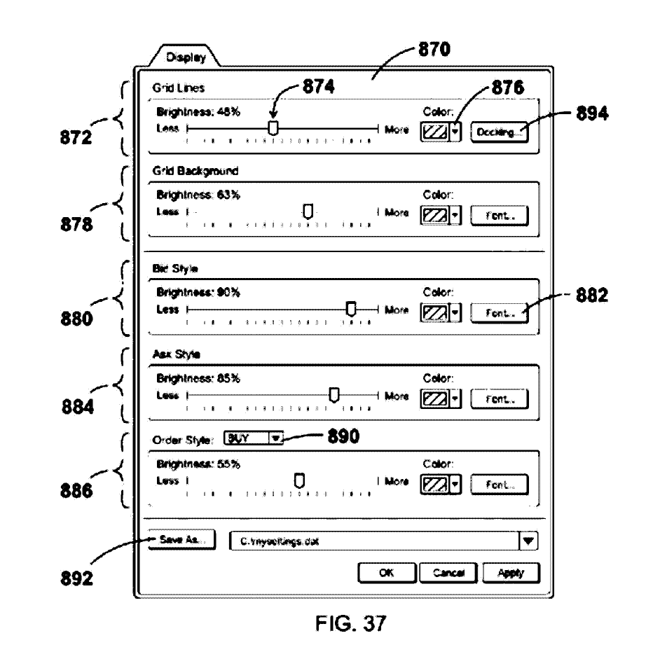

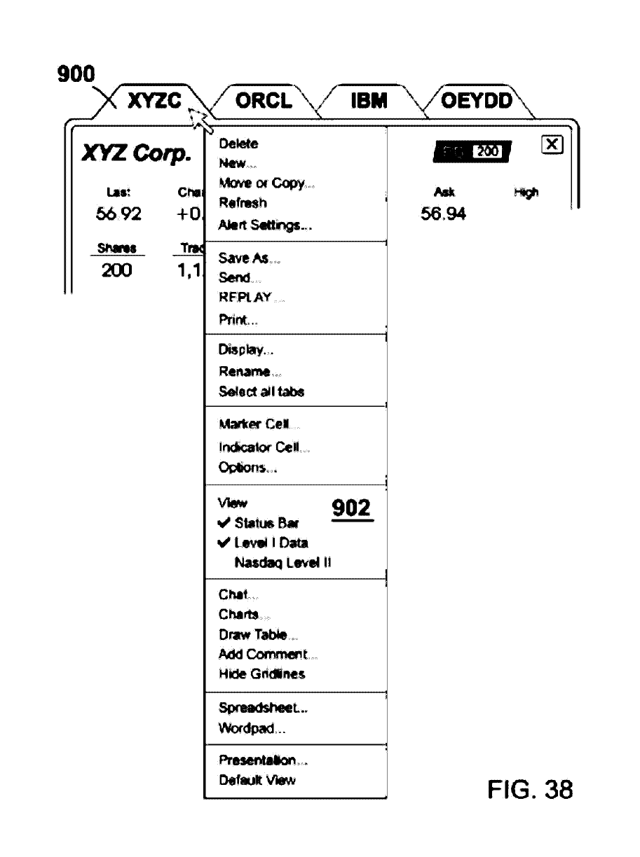

FIG. 37 is a representation of a Display Setting tab page 870 associated with each Grid Proper display. This settings tab allows the user to adjust color, brightness levels, and text font, size, and style settings for the assorted visual elements of the Grid Proper. The Grid Lines settings area 872 can adjust brightness levels 874 and color settings 876 for the grid lines of a specific Grid Proper or all Grid Proper surfaces under control of the interface. Similarly, the Grid Background settings area 878 may also be adjusted. The displayed Text Label Font style 882 of various cell types may also be set according to user preferences. As an order is dragged on the Grid Proper, the border of the cell closest to the mouse cursor and the docking order icon is highlighted. The user may adjust the color and brightness of this Docking border highlight 894.

The Bid Style cell settings area 880, the Ask Style cell settings area 884, and the Order Style cell settings area 886 may be adjusted in similar fashion. The user may also choose to set a color and brightness level for each Order type using a drop down list 890. User orders may be color coded to distinguish them from bid and ask quote cells or icons. For example, if bid icons are coded blue and ask icons are coded red, order icons may be coded green. As an alternative presentation to a single color scheme for all orders, order types may also be visually distinguished from each other. For example, buy orders may be color coded cyan, sell orders may be color coded yellow, and short orders may be color coded magenta. Once the settings have been adjusted, they may be saved 892 for convenient reference.

FIG. 38 details a typical tab 900 right click pop-up menu 902. It should be understood that there are many features and functions that may be incorporated into the user interface through drop down lists and context-sensitive right click menus. The following are examples of functions that are or may be displayed: a Delete function to delete a tab page; a New function to create a new tab page; a Move, or Copy function, to create a copy of or move the tab 900 to a second location; an Alert Settings function to preset alerts; a Save-As command to save the tab page display, a Send feature to send the tab page to an e-mail address or to another user through a Chat program (the tab 900 may also be dragged and dropped into the Chat input area to send it to a second user's interface screen); a Print command to print the tab page; an Import and Export function for data files, and to record and replay trading animations; a Help command to access a help library; a Rename function to rename a tab; a Display function to launch the Display settings box 870; a Marker Cell and Indicator cell control panel to set-up, configure, and modify Marker and Indicator cells; an Options panel to access the general settings of the user interface; a Select All tabs function; a Profile function to display a profile of the displayed security; a Chat function to discuss the markets and related issues with other users or a company representative; a View section to turn on or turn off features such as Nasdaq Level 2, the Level 1 summary data, and the status bar; a Replay function to access historical trading activity; a Presentation function to select the features and icons displayed within the tab page; a Chart function to display a chart of the underlying security; a Send Feedback function to forward correspondence to a service provider or brokerage; a Refresh function to update data on the page; a Text function to adjust the font, font size, and font style of displayed data; a Language function to display the text in a specific language; a Full and Half Screen function to adjust the displayed area of the tab page relative to the total displayable area; a Draw Table function to draw detail on the Grid Proper; an Add Comment function to add comments to a row, a column, an order, a quote, or a relative or absolute cell location; a Hide Grid Lines command to disable the visible grid lines of the Grid Proper; a Default View to revert all changes to the tab page set-up back to the default view; a Spreadsheet function to activate a separate spreadsheet application or one embedded within the tab page for calculations; a Word Processing function to activate a separate word processing application or one embedded within a standard tab page for keeping notes, and the like.

Alerts signal to the user that preset conditions have been achieved. Alerts may be visual, audible, or tactile (through the use of a force feedback mouse, for example). As the Grid Proper is typically packaged within multiple tab sets, it is appropriate that the visible tab portion 900 of each tab set 121 may indicate an alert with a color change or a flashing indication to draw the attention of the user.

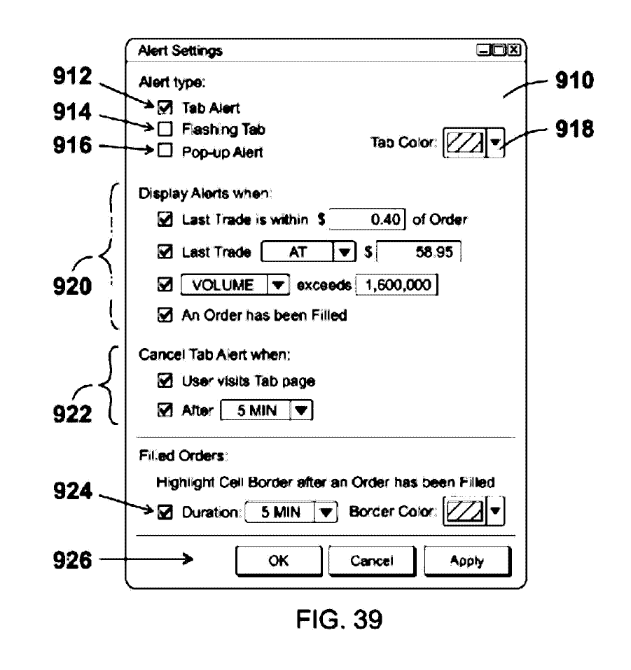

FIG. 39 is a representation of the Alerts settings dialog box 910. The Alert settings allow one to set the alert criteria. A tab visual alert indication is set by checkbox 912. More attention may be derived by a flashing tab visual alert set by checkbox 914, or a pop-up alert box set by checkbox 916. The tab alert indicator color may be preset by drop down color list 918.

Alert settings area 920 allow alerts to be preset according to a number of criteria such as how near the last trade price of the security is to the user's order, the specific price of the last trade, the overall volume of the security, and whether the user's order has been filled. Once an alert is triggered, cancel settings area 922 determine how it is cancelled. If a tab alert is indicated, a visit to its associated tab page may turn off the alert automatically. Similarly, the tab alert may be cancelled after a predetermined time period.

When an order is filled, the order cell will no longer exist visually on the Grid Proper. For convenience, the Alert settings allow one to set an indicator, for a set period of time 924, at the location where the order was filled on the Grid Proper. The user may adjust the filled order's border highlight alert color to suit his preferences. Once the Alert settings are adjusted they may be applied or cancelled as is Windows convention 926.

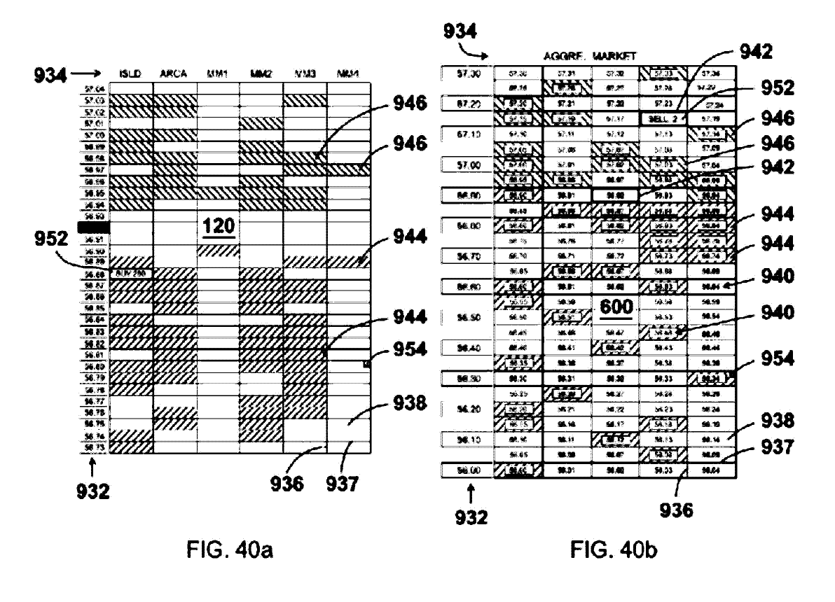

Referring now to FIGS. 40A and 40B. FIGS. 40A and 40B show the features and elements of representative examples of the Grid Proper from FIGS. 13 & 19 respectively. Turning our attention to FIG. 40A, Grid Proper 120 is bound by the column header 934 and the row header information 932. Reference to FIG. 40B reveals similar features, Grid Proper 600 is bound by the column header 934 and the row header information 932. Also shown is the cell array, a prominent element of Grid Propers 120, 600.

Scroll bars may be used to view specific sections of the cell array when the size of the cell array is larger than the displayed area. Vertical Grid lines 936, and Horizontal Grid lines 937 help distinguish and separate one cell from another. When no quote or order information is present in a cell, or represented by a cell, the cell is colored with the grid background color 938. Text labels 940, highlighted cell borders 942, and texture information may be displayed to help distinguish, for example, the characteristics of each cell. Bid quote cell 944 and Ask quote cell 946 are also displayed, as provided by the back-end system for each market or aggregate market. Also present on the Grid Proper are the user's orders 952 which being especially relevant, are visually distinguished from all Bid and Ask quote cells, or other cells displayed on the Grid Proper. Additional Marker cells, Indicator cells, Comment cells 954, and Alerts may exist at any cell location in an absolute or relative sense to inform the user of market conditions or events that are relevant to the user, and therefore enhance the functionality of the Grid Proper and the overall user interface.

The Grid Proper is typically represented as a two-dimensional array of cells arranged in one or more rows and one or more columns. It should be understood, that a 3D visualization of the Grid Proper may also be constructed. The third dimension may, for example, represent a time dimension. Such a time dimension may be measured along the time axis in a continuous fashion or in discreet time increments. If discreet time increments are used to represent the time dimension, the user may adjust the time interval or time duration represented by each discreet time increment. The graphical representation of a 3D Grid Proper may be “scrolled” back and forth through the time dimension to review, for example, historical trading activity. A conventional 2D computer display or specialized 3D display devices may be used to represent and display the 3D Grid Proper's graphical information to the user.

In a 3D version of a Grid Proper adapted to display Nasdaq Level 2 information, the first dimension may represent the price axis, the second dimension may represent the buyer or seller side of the market, and the third dimension may represent the market maker identity and the priority of their respective bids and asks quotes at a specific price point.

In a 3D version of FIGS. 19 and 20, the first and second dimensions represent price, while the third dimension may represent bids, asks, and orders stacked in priority sequence at a specific price point. Such 3D versions of the Grid Proper may be suitable for a specific market or an aggregate market. When the 3D display is configured for an aggregate market, the third dimensional stacking of quotes or orders may also pertain to the identity of market makers, their bid and ask data, and their fill priority at a specific price point.

Although FIGS. 40A and 40B show two representations of the Grid Proper, it should be understood that alternative configurations and adaptations may be developed to suit any transaction environment. The following FIGS. 1, 16, 20, 21, 22, 24, 25, 26, 27, 28, 30, 31, 32, 33, 34, 35, and 36 show, without limitation, alternative representations of the Grid Proper.

It should be understood from the scope of the disclosure that the Interface's visual presentation and its underlying processes may also extend to other transaction areas involving a buyer and a seller. These areas may include various auction, rental, time-share, or purchase schemes for new or used items, and tangible or intangible goods and services, and placing bets on interactive on-line casino gaming, games of chance, horse racing, sports betting, and related gaming or gambling type activities. Such transactions may include, without limitation, the placing a bet, or the purchase of a seat or berth for a transportation vehicle, a live event, a pay-per-view event, a concert, a movie, a theatre production, an exhibit, an exhibition, a sporting event, a museum, a restaurant, and various types of short or long term accommodation. Such accommodations may include a hotel room, a bed & breakfast unit, or an apartment.

### The Position Guide

The Position Guide is a computation tool that helps traders determine the quantity of an item, such as a security, to buy, sell, or short, in a trading transaction. Such a tool enables a user to apply common money management principles and other user selected criteria to determine a suitable quantity of a security to buy, sell, or short. The Position Guide automatically computes for the quantity and displays it as a recommendation to the trader. The Position Guide's recommended quantity is expressed in a unit appropriate for the security and transaction under consideration. For example, in securities trading the Position Guide's recommended quantity is typically expressed in lots when trading equities, and in contracts when trading options.

The PG input security is the input security for which the Position Guide computes the recommendation quantity for. The Position Guide's recommended quantity is also referred to as the “PG Output quantity” or “output quantity”. Throughout this disclosure, the terms “Position Guide” and “PG” are used interchangeably and refer to the Position Guide computation tool.

The Position Guide may be integrated into an online customer's trading application, available as a plug-in, software object, or integrated into a brokerage or Third Party website accessible on the Internet or over any network.

As noted earlier, the user may manually override or disregard any recommendations from the Position Guide tool. The PG Output quantity is displayed in an icon, the PG icon, which is conveniently located on any tab page that contains a Grid Proper. The selected security displayed on the Grid Proper is typically identified as the PG input security. The PG icon may be drag and dropped to an order entry form in order to populate said order entry form with the PG icon's associated order quantity, order type, and security symbol information. Similarly, the PG icon may also be used to initiate an order by dragging and dropping the PG icon to the Grid Proper. The PG icon is associated with a quantity, a security symbol, an order type, and other transaction parameters as may be necessary to initiate an order. The user may manually override or disregard any recommendations from the Position Guide tool.

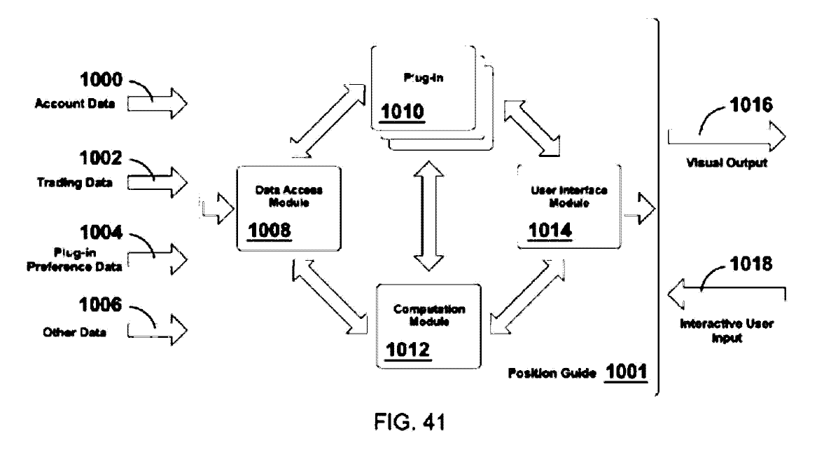

As shown in FIG. 41, the Position Guide 1001 has several aspects. One aspect of the Position Guide 1001 is its ability to obtain and synthesize several types of data coming from any number of data sources. These data sources may reside in the same machine where the Position Guide 1001 is executing, or in a remote system accessible to the Position Guide 1001 via a communication network.

One type of data used by the Position Guide 1001 is Account Data 1000 such as a trader's buying power, account information, portfolio details, profit and loss data, holdings data, and other related information.

Another type of data used by the Position Guide 1001 is Trading Data 1002 which include current and historical security prices, trading volume, fundamental and technical data on a company, and other related market information.

The Position Guide 1001 also employs data that it uses to compute for the PG Output quantity. This type of data is typically encapsulated inside a “plug-in” and is hence referred to as Plug-in Preference Data 1004. Plug-in Preference Data 1004 is described in more detail hereafter. This type of data include pre-configured trading rules, user-specified trading heuristics (“rules of thumb”), and trading rules defined and encoded by a brokerage firm or a third party such as a company specializing in investment research. A trader using the Position Guide 1001 may select any combination of Plug-in Preference Data 1004 in order to control the way the Position Guide 1001 computes for the PG Output quantity.

Plug-in Preference Data 1004 is encoded and packaged in a programming construct called a “plug-in”. A plug-in is a software object which is intended to augment the functionality of an application program, and is typically created independent of the application program. Furthermore, a plug-in is designed so that it can be added to or removed from an application program without modifying the application. Plug-ins may be implemented and utilized in a number of ways, as described hereafter.

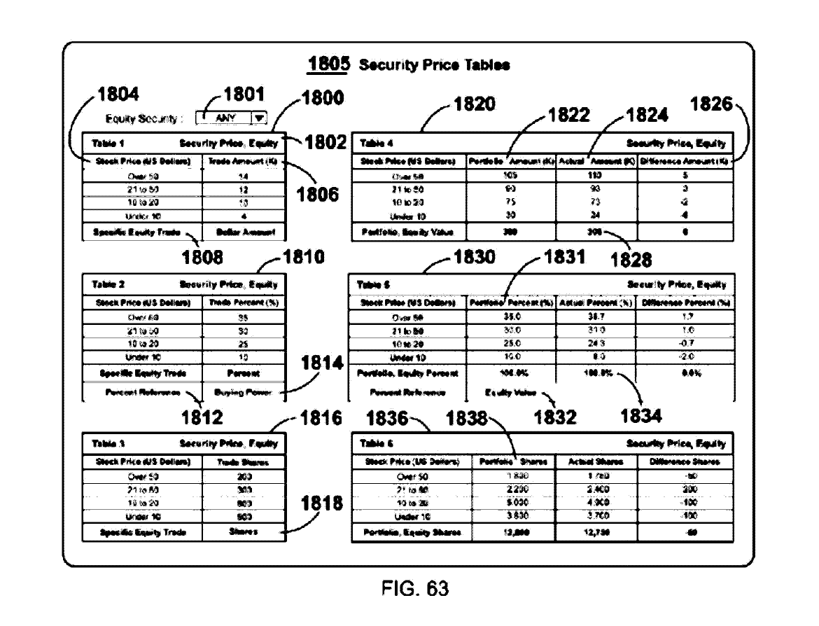

The Position Guide 1001 uses one or more Plug-ins 1010 that encapsulate Plug-in Preference Data 1004. The Plug-ins may also incorporate computation logic that operates on the data. In addition, the Plug-ins 1010 may include user-interface components that allow the user to configure the data graphically. An example of some user-interface components are the assorted tables or table interfaces shown in FIGS. 63 to 76.

The Position Guide 1001 may also use Other Data 1006 as may be necessary to exploit the full range of features of the PG. Such data may include control data from a third party when various settings of the Position Guide are under the control of a third party.

The Position Guide 1001 may employ a component such as the “Data Access Module” 1008 to centrally manage the retrieval and synthesis of different types of data from various data sources. Alternatively, the Plug-ins 1010 may control, partially or fully, the retrieval and synthesis of their associated data types and data sources.

Another aspect of the Position Guide 1001 is its use of an extensible, open architecture “Computation Module” 1012 which handles and/or coordinates the process of computing for the Position Guide's Output quantity. The Computation Module 1012 works in conjunction with Plug-ins 1010. The Computation Module 1012 may use a combination of mathematical formulas and heuristic rules in order to compute for the output quantity. Various schemes are available for implementing the Position Guide's Computation Module 1012, as described hereafter.

Another aspect of the Position Guide 1001 is its Visual Output 1016. The Position Guide 1001 displays its PG Output quantity on a GUI object such as an icon. The PG Output quantity is typically displayed to the user essentially instantaneously after the user enters the security symbol or identifier representing the item or security of interest. The Position Guide 1001 may also be configured so that it is capable of facilitating a trading transaction. For example, the Position Guide 1001 may be integrated into an application program such as an application program for securities trading (hereafter referred to as “trading application”). The trading application may allow the Position Guide icon, or PG icon, to be dragged and dropped onto a visual component of the trading application. For example, the PG icon may be dragged and dropped onto the Grid Proper. The trading application may then subsequently interpret the drag-and-drop action as an instruction to place a trading order or transaction whose size or quantity parameter corresponds to the quantity displayed on the Position Guide icon.

Another aspect of the Position Guide 1001 is the intuitive and graphical manner in which its settings are configured. The graphical configuration of the Position Guide's 1001 settings may be accomplished using several methods and styles. In a first preferred implementation, the Position Guide's 1001 settings are configured using a user interface style based on “tables”. This type of table based user interface, or “table interface”, facilitates the task of encoding decision parameters, trading rules, formulas, heuristics, and the like. The Position Guide 1001 may also allow for Interactive User Input 1018 from the various PG Settings panels and table interfaces which may, for example, modify settings related to the Position Guide's computation logic.

The Position Guide 1001 may use a component such as the “User Interface Module” 1014 to manage and/or coordinate the task of displaying the Position Guide's Output quantity on a GUI object, and the task of accepting and interpreting user input. The functionality of the Position Guide's User Interface Module 1014 may be implemented in a number of ways, as described hereafter.

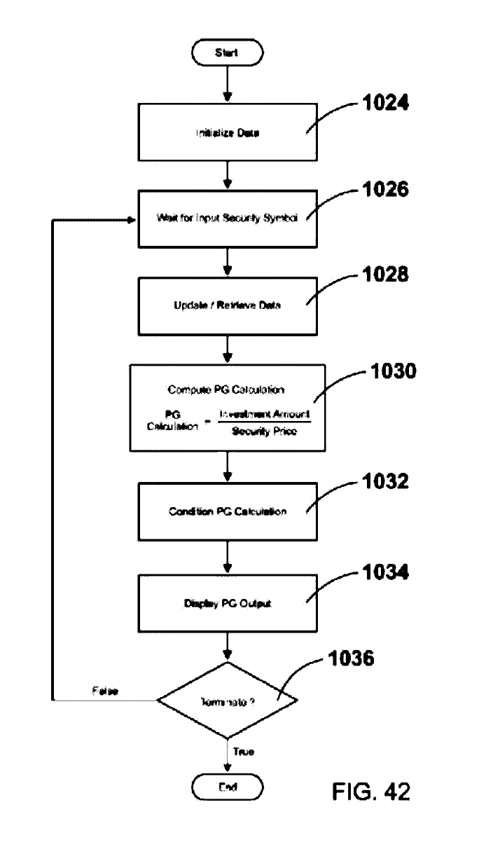

The Position Guide may be implemented in several forms. In its basic form, the Position Guide's mode of operation is as shown in FIG. 42. In this configuration, the Position Guide does not require plug-ins or other advanced computation methods; instead the Position Guide uses a simple mathematical formula. The Position Guide may thus be implemented as a subroutine of an application program. FIG. 42 shows the sequence of steps followed by the Position Guide in this configuration.

The step “Initialize Data” 1024 involves fetching data, such as account information, that the Position Guide may require to compute for the PG Output quantity. This step may involve reading data from a file, accessing a database, downloading data from a remote computing resource, and the like.

The step “Wait for Input Security Symbol” 1026 is a wait state, in which input from the user is required before the Position Guide can proceed to the next step. The input Is typically a symbol or an identifier representing a security.

The step “Update/Retrieve Data” 1028 involves refreshing data that was previously received or retrieved (for example through the “Initialize Data” step) and that may have been outdated. This step may also involve fetching new data, such as the most recent real-time security trading prices, that may be required as a result of the input received during the “Wait for Input Symbol” 1026 step.

The step “Compute PG Calculation” 1030 involves computing for the “PG Calculation”—a value which represents the quantity of the Position Guide's initial computation. This step uses a basic formula wherein the Investment Amount representing the funds available for a transaction, is divided by the Security Price which is typically the last trading price of the security. This formula output typically results in a decimal value, the “PG Calculation”, defined in more detail hereafter.

The step “Condition PG Calculation” 1032 involves the application of formatting rules to the PG Calculation generated from the previous step. This step typically involves rounding up or down the PG Calculation quantity, for example to the nearest multiple of a lot or contract. Additional conditioning procedures may be applied to the PG Calculation value, depending on the settings specified by the user. The result of this step is the “PG Output quantity”, defined in more detail hereafter.

The step “Display PG Output” 1034 involves the display of the PG Output quantity (generated from the previous step) to the user. In this step the Position Guide displays the PG Output quantity using GUI objects such as icons, text boxes, and the like. Furthermore the Position Guide may allow the displayed PG Output quantity to be modified by the user. The quantity displayed on the Position Guide icon is termed the “PG Output”, defined in more detail hereafter.

The “Terminate?” decision step 1036 tests whether or not the Position Guide should stop executing. If the decision outcome is “False”, the Position Guide loops back to the “Wait for Input Symbol” step 1026. If the decision outcome is “True”, the Position Guide terminates.

In a first preferred implementation, an object-oriented approach is used to implement the Position Guide as a software object. The software object is implemented using Microsoft Corporation's .NET Framework software platform and the C# programming language. However, the software object can also be implemented using other software design techniques, software platforms, and programming languages. For example, an alternative implementation may use Sun Microsystems's Java platform. Other alternatives include Macromedia Corporation's Flash technology, Curl Corporation's Surge platform and Curl programming language, Adobe Corporation's Scalable Vector Graphics (SVG) technology, and the like.

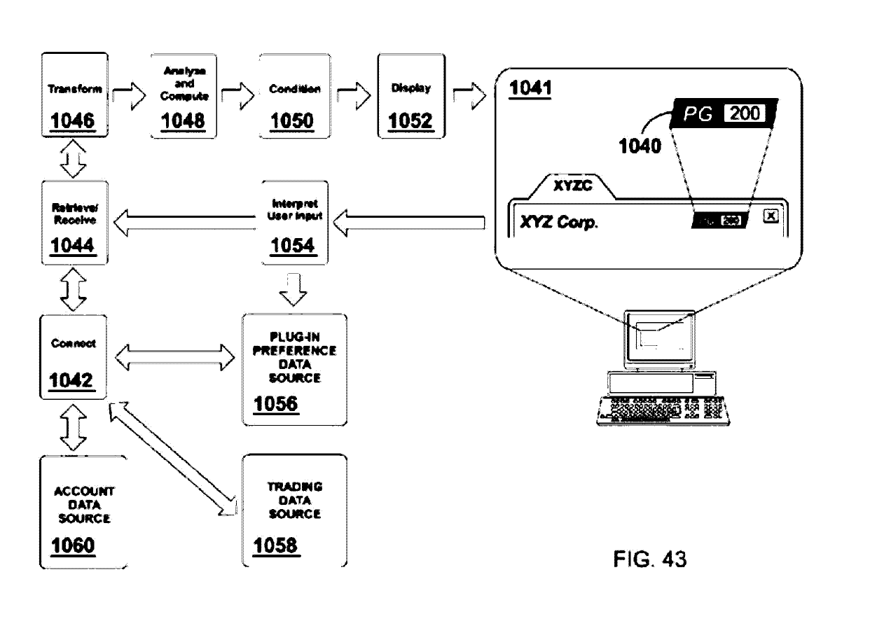

The PG software object, as illustrated in FIG. 43, executes on a computer and has two aspects: (1) its visual manifestation, as represented by the PG icon 1040, which is seen and may be interacted with by the user and which is displayed on a display screen 1041; and (2) its program logic, which is implemented in computer code. The software object's program logic includes seven processes which the software object uses to accomplish its tasks. However, it is to be noted that the seven processes mentioned below are only representative of all possible combinations of processes that the software object may employ.

The PG software object's visual manifestation typically includes an icon 1040 with an associated text box. The text box displays the Position Guide's Output quantity and also provides a way for the user to manually override or modify the quantity displayed. The software object's visual manifestation may also include context-sensitive menus for configuring various settings of the Position Guide. The visual manifestation may allow further access to dialog boxes and Settings panels for configuring the plug-ins and to change various settings associated with the Position Guide. These dialog boxes typically employ a user interface style based on “tables” to allow users to set-up and edit trading rules, heuristics, formulas, and other data associated with plug-ins.

The software object is typically incorporated within an application program, such as a trading application. In such a configuration, the software object can facilitate the selection of a transaction quantity and the placement of a trading order. For instance, the user may drag the PG icon 1040 displaying the Position Guide's Output quantity and drop it onto a visual component of the trading application such as the Grid Proper. The drag-and-drop action may consequently be interpreted by the trading application as an instruction to place a trading order for a specific quantity, security, and price.

The software object's visual manifestation may be rendered using any graphical style, as determined by persons skilled in designing user interfaces for software applications.

The software object's program logic consists of the following processes: (1) Connect process 1042; (2) Retrieve/Receive process 1044; (3) Transform process 1046; (4) Analyze and Compute process 1048; (5) Condition process 1050; (6) Display process 1052; and (7) Interpret User Input process 1054.

The Connect process 1042 is used by the software object to establish connections with one or more data sources, such as the Account Data Source 1060, the Trading Data Source 1058, and the Plug-in Preference Data Source 1056.

The Retrieve/Receive Process 1044 is used by the software object to retrieve and/or receive data from each data source the software object connects to.

The Transform process 1046 is used by the software object to validate and format the data it receives from the data sources. This process may perform data verification and/or data transformation procedures, as necessary, on the data received from the data sources. This process ensures that the data conforms to the format expected by the Analyze and Compute process.

The Analyze and Compute process 1048 is used by the software object to analyze the data it receives from previous processes. In this process the software object uses rules, formulas, and heuristics to calculate for an investment amount and a subsequent quantity. This quantity is hereafter referred to as the “PG Calculation”. The Analyze and Compute process 1048 typically employs plug-ins in the computation process. As described previously, plug-ins encapsulate trading rules, formulas, and heuristics, which are encoded in a standard data format. Plug-ins may also incorporate computation logic that operates on the data encapsulated by the plug-in, and user interface components that allow users to configure the data.

The Condition process 1050 is used by the software object to adjust the PG Calculation so that it conforms to certain formatting rules which may be specified by the user or otherwise predefined by the software object. Preliminary, or Basic, Conditioning typically uses simple formatting rules. For example, the user may configure the software object so that the PG Calculation is subsequently rounded down to the nearest multiple of a lot or contract in the Condition process 1050. On the other hand, Advanced Conditioning will typically use more sophisticated formatting rules and criteria to fine-tune the PG Calculation. The quantity that results from the application of the Basic Condition process is hereafter referred to as the “PG Quantity”. The quantity that results from the application of the Advanced Condition process is hereafter referred to as the “PG Output quantity”.

The Display process 1052 is used by the software object to display the PG Output quantity on a GUI object such as an icon, a text label, a table, an editable text box, or any combination of GUI objects. The quantity displayed by the Position Guide on a GUI object is hereafter referred to as the “PG Output”. The Display process 1052 is also responsible for displaying context-sensitive menus, dialog boxes, settings panels, and other user interface components. These user interface components may be activated in response to events and actions performed by the user on the software object's visual manifestation 1040, or on the trading application.

The Interpret User Input process 1054 is used by the software object to receive and interpret interactive input coming from the user. These inputs may be commands to change the graphical properties of the software object's visual manifestation, inputs that change the configuration of the plug-ins and the software object as a whole, or actions that initiate a trading transaction. The Interpret User Input process 1054 may interact with various components—both internal and external to the PG software object—as a result of receiving and interpreting input from the user. Typically the interactions are facilitated by the “Connect” process 1042 which establishes the necessary connections to various data sources. However, the “Interpret User Input” process 1054 may also directly interact with a “Plug-in Preference Data Source” 1056. Such is the case when the “Plug-in Preference Data Source” 1056 resides within the PG software object itself.

A Trading Data Source 1058 is any system that can supply trading data. A Trading Data Source can include, but is not limited to, any or a combination of the following: securities exchanges, stock markets, currency markets, commodities exchanges, electronic communication networks (ECNs), brokerage firms, data feed providers, market & securities research firms, market simulation software, and trading data published on any suitable media (such as CD-ROM).

An Account Data Source 1060 is any system that can supply current and historical account, portfolio, holdings, and account performance information. Typically, the Account Data Source 1060 is the online brokerage with whom the user opened a trading account.

Often times, the Trading Data Source 1058 and the Account Data Source 1060 are one and the same system. This is the case, for example when the Trading Data Source 1058 is a brokerage firm such as CyberTrader Corp. and the Account Data Source 1060 is also the same brokerage firm.

A Plug-in Preference Data Source 1056 is any system that can supply Plug-in Preference Data—which are trading rules, formulas, heuristics, and Plug-in configuration and settings data encoded in a standard data format. A Plug-in Preference Data Source can include, but is not limited to, any or a combination of the following: the software object itself, a website that offers downloadable plug-ins, or a third party that publishes Plug-in Preference Data, for example on CD-ROM.

The locations of these data sources are transparent to the software object. The data sources may be located in the same machine where the software object is executing or in a remote machine accessible to the software object via a communication network.

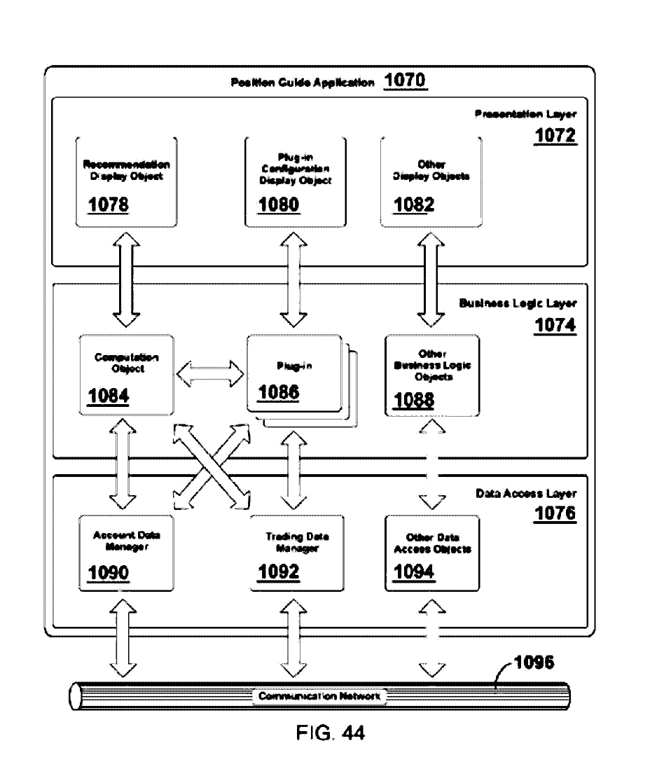

A second preferred implementation of the Position Guide is a software application, as shown in FIG. 44. The software application (hereafter referred to as the “Position Guide application”) may be developed from the ground up or it may be developed in such a manner that it encompasses and utilizes the functionality of the software object described in the first preferred implementation of the PG.

FIG. 44 shows the architecture of the Position Guide application 1070. The Position Guide application is implemented using Microsoft Corporation's .NET Framework software platform and the C# programming language. However it should be understood that other software platforms and programming languages can also be used to implement the Position Guide application.

The Position Guide Application 1070 consists of a main executable program and several software building blocks called “components” or “objects”. In a Microsoft Windows implementation of the Position Guide Application 1070, the main program is a .NET “Windows Forms”—type application, and the software components are .NET components.

The Position Guide Application 1070 is similar to conventional Microsoft Windows applications in that it adheres to the visual (e.g. menu structure, status bars, buttons, etc.) and behavioral (e.g. right click behavior, resize behavior, etc.) standards for Windows-based applications.

The Position Guide Application's main executable program displays the main window of the application and controls the application's various constituent objects. The main program coordinates the functions of the constituent objects by exchanging messages with the objects.

The Position Guide Application 1070 is composed of several software objects which are grouped together, according to functionality, into three “layers”: (1) the Presentation Layer 1072, (2) the Business Logic Layer 1074, and (3) the Data Access Layer 1076.

The Presentation Layer 1072 groups together software objects that display the Position Guide Application's (visible) user interface. The software objects in this layer may also accept interactive input coming from the user. The Presentation Layer 1072 is composed of the Recommendation Display Object 1078, the Plug-In Configuration Display Object 1080, and other Display Objects 1082 which may also be used by the Position Guide Application 1070. It is to be noted that the objects in the Presentation Layer 1072 as a group correspond to the functionality of the User Interface Module 1014 associated with FIG. 41.

The Recommendation Display Object 1078 displays the PG Output quantity computed by the Position Guide's Computation Object 1084. Typically, the Recommendation Display Object 1078 displays the quantity through an icon and an associated text box. The Recommendation Display Object 1078 may also allow the icon to be dragged and dropped onto the user interface of another application, such as the Grid Proper of a trading application. As discussed previously, the trading application may subsequently interpret the drag-and-drop action as an instruction for initiating a trading transaction; the trading application may then perform actions to facilitate the transaction.

The Plug-in Configuration Display Object 1080 coordinates the display of the user interface components which are incorporated with the Plug-ins 1086. The Plug-in Configuration Display Object 1080 may implement the visual container (e.g. windows, dialog boxes) and the logic for extracting and displaying the user interface components encapsulated inside the Plug-ins 1086. The Plug-in Configuration Display Object 1080 may also function as coordinator, delegating the task of displaying the user interface to the Plug-ins themselves.

Other Display Objects 1082 may also be used by the Position Guide Application 1070, such as dialog boxes for opening files, for printing, for configuring application-wide settings, and the like.

The Business Logic Layer 1074 groups together software objects that perform business-related tasks. This layer is composed of the Computation Object 1084, Plug-ins 1086, and other Business Logic Objects 1088. The objects in the Business Logic Layer as a group correspond, to some extent, to the functionality of the Computation Module 1012 associated with FIG. 41.

The Computation Object 1084 is responsible for generating the “PG Calculation”, the “PG Quantity”, and the “PG output quantity” values defined previously. Typically, the Computation Object 1084 uses a set of mathematical formulas, trading rules, and other techniques to compute for the PG Calculation, the PG Quantity, and the PG Output quantity. The Computation Object 1084 also uses Plug-ins 1086, which contribute to the computation process by employing more advanced trading rules, formulas, heuristics, and other techniques. The Computation Object 1084 interacts with the Recommendation Display Object 1078, which receives the PG Output quantity generated by the Computation Object and displays it on a GUI object such as the PG icon. The quantity displayed on the GUI object corresponds to the “PG Output” defined previously.

Plug-ins 1086 assist the Computation Object 1084 in generating the PG Calculation and the PG Output quantity. As previously described, plug-ins are software objects that encapsulate trading rules, mathematical formulas, and heuristics—collectively referred to as Plug-in Preference Data. Plug-in Preference Data are encoded in a data format such as a binary file, an XML document, and the like. Plug-ins 1086 may contain computation logic that operates on the Plug-in Preference Data it encapsulates. Plug-ins 1086 may, also contain embedded user interface components for configuring the plug-in preference data. These user interface components are typically activated by the Plug-in Configuration Display Object 1080, which interacts with plug-ins.

Plug-ins generate output values, such as share quantities, investment amounts, and percentage based values, which are consumed, as input data, by the Computation Object 1084. The Computation Object 1084 collects and stores the outputs from the plug-ins and may assign to each output value, a proportionate “weight”, based on a user or system-specified setting. The Computation Object 1084 then applies the said “weight” to each plug-in output value to generate an intermediate weighed value. These intermediate weighed values may be combined using a formula, such as a summation formula, and after subsequent processing, generate an output value which corresponds to the PG Output quantity. The PG Calculation typically goes through a conditioning process before it becomes the PG Output quantity. The PG Output quantity is then passed on to the Recommendation Display Object 1078 for display to the user.

It should be understood that the mathematical formulas and weights employed by the Computation Object 1084 may be pre-defined or specified by the user. Furthermore, the weighting calculation of each plug-in output value may be performed within the plug-in itself.

The Business Logic Layer 1074 may also include Other Business Logic Objects 1088 that contribute to the overall functionality of the Position Guide Application 1070. These other Business Logic Objects 1088 may for example implement utility functions such as conversion between different investment amount units, or different currencies.

The Data Access Layer 1076 consists of software objects that manage the retrieval of data required by the upper layers of the Position Guide Application 1070. These objects may perform data translation or data transformation procedures on the data as needed. These objects incorporate the logic necessary for connecting to local and remote data sources, and implement the capability to communicate using the protocols required by the data sources. The objects in the Data Access Layer 1076 as a group corresponds to the functionality of the Data Access Module 1008 associated with FIG. 41.

The Account Data Manager 1090 is responsible for retrieving and receiving account data from Account Data Sources. It encapsulates the translation and communication logic necessary for communicating with these data sources. The Account data and Account Data Sources terms are as defined previously.

The Trading Data Manager 1092 is responsible for retrieving and receiving trading data from Trading Data Sources. The Trading data and Trading Data Sources terms are as defined previously. The Trading Data Manager 1092 is similar to the Account Data Manager 1090 in that it also encapsulates translation and communication logic necessary for communicating with data sources.

As with the other two layers, Other Data Access Objects 1094 may also be present in the Data Access Layer 1076. These other objects may for example encapsulate the data retrieval, translation, and transformation logic necessary for accessing a historical database of the Position Guide Application's outputs.

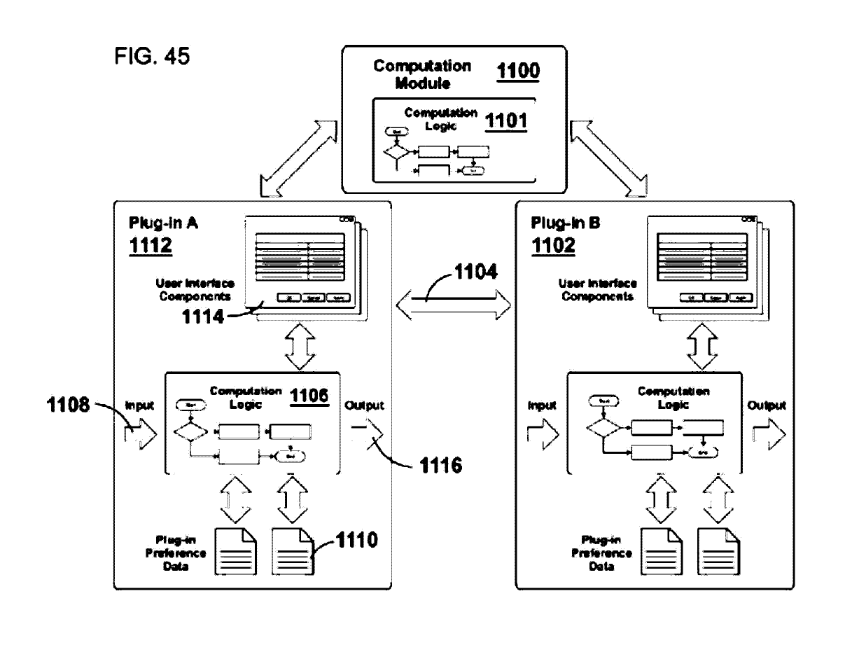

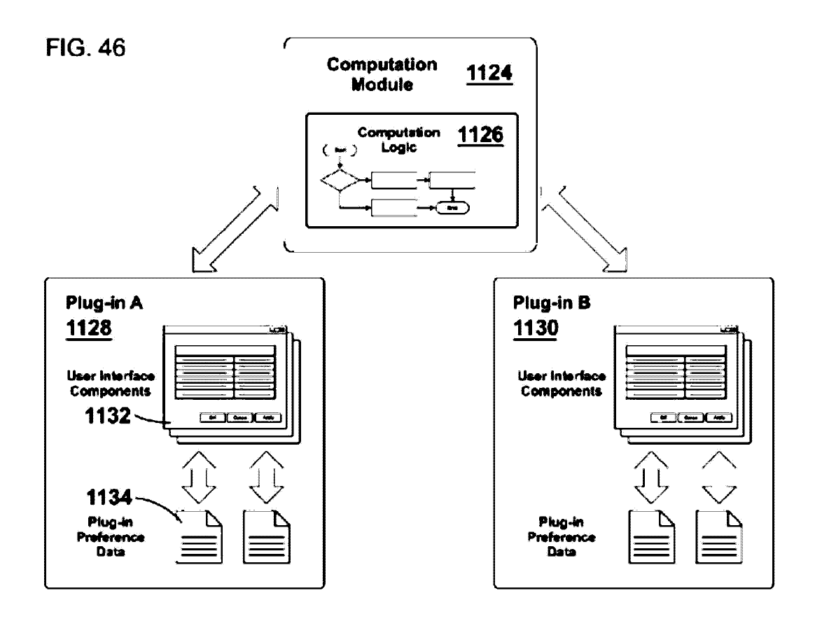

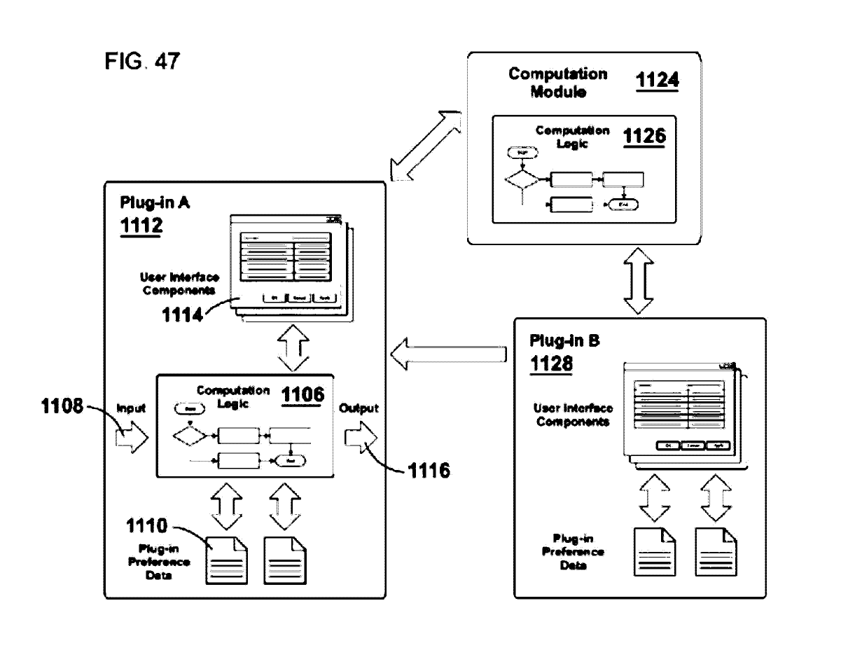

FIG. 45, FIG. 46, and FIG. 47 show three plug-in architectures; for each architecture the interactions between plug-ins and the Position Guide's Computation Module are illustrated.

FIG. 45 shows an architecture wherein Plug-in A 1112 and Plug-in B 1102 both incorporate Plug-in Preference Data 1110, Computation Logic 1106, and User Interface Components 1114. Plug-in A and Plug-in B have the same structure, although their contents are different. Hence a description of Plug-in A's structure also applies to Plug-in B 1102. Furthermore, it should be understood that the actual number of plug-ins used in an implementation of this architecture is not limited to these two plug-ins. The Position Guide may use any number of plug-ins, depending on the availability of plug-ins and the settings specified by the user.

As previously defined, Plug-in Preference Data 1110 is a collective term for trading rules, heuristics, and formulas that are typically encapsulated inside plug-ins. Plug-in Preference Data 1110 is typically encoded using a standard format such as XML and may be distributed as a data file or through a streaming data feed. Plug-in Preference Data 1110 may be configured by users through a set of user interface components that are typically incorporated into the plug-ins themselves. In addition, plug-ins may use container objects such as dialog boxes, tables, tab pages, and the like, to graphically organize these user interface components.

Plug-ins may be configured so that they are responsible for displaying their own user interface. Plug-ins may also be configured so that an external component, for example the Plug-in Configuration Display Object 1080 associated with FIG. 44, controls the activation of the user interface components embedded inside the plug-ins. Plug-in A 1112 uses its Computation Logic 1106 to generate one or more Outputs 1116, given at lease one Input 1108. The Input 1108 typically comes from an external source, for example the Position Guide Computation Module 1100. Plug-in A 1112 uses its Computation Logic 1106 and its embedded Plug-in Preference Data 1110 to generate the Output 1116. The generated plug-in Output 1116 may be a component of the final Position Guide Output quantity. The plug-in Output 1116 may be a share quantity, an investment amount, a percentage based value, and the like depending on the type of the plug-in and the settings specified by the user.

The Computation Logic 1106 is typically activated when the Computation Module 1100 sends an Input 1108, such as the ticker symbol of the PG input security, or the value of a technical indicator to the plug-in. The input data requirements of each plug-in may be determined and supplied by the Position Guide, the plug-in, or some combination of the two. The plug-in may be capable of retrieving, receiving, translating, and transforming external data autonomously, in accordance with its computational logic and preference data settings.

The Output 1116 generated by the Computation Logic 1106 is typically consumed by the Computation Module 1100. The Output 1116 may also be consumed by another plug-in through a Programmatic Link 1104. Similarly, the Output 1116 may be consumed by both the Computation Module 1100 and other plug-ins simultaneously. The output generated by the Computation Logic 1106 corresponds to the output of the plug-in. When the plug-in is based on a table or table interface approach, the Output 1116 corresponds to the table output amount, or the investment amount associated with one or more table output columns.

The Computation Module 1100 as shown in FIG. 45 contains Computation Logic 1101 for iterating through all the plug-ins used by the Position Guide, and for storing and combining the plug-in output value 1116, generated by each plug-in. The Computation Module 1100 in this architecture may delegate computation tasks that involve computing for an investment amount, a table output amount, an intermediate calculation result, a final investment amount, the PG Calculation, the PG Output quantity, and the like, to one or more plug-ins. The Computation Module 1100 iterates through all the plug-ins used by the Position Guide, supplies input data to each and then allows each plug-in to compute for its output value(s). The output of the plug-in 1116 represents an intermediate calculation result which the Computation Module 1100 collects, prioritizes, and stores. The Computation Module 1100 then applies a formula, such as a weighed summation formula, to all the plug-in output values or intermediate calculation results it has collected.

The Computation Module's summation formula may make use of weighing factors. The actual summation formula and the values of the weighing factors may be determined by user settings, pre-defined by the Position Guide, or under the control of a third party. The result of the summation formula is further processed to become the PG Calculation quantity. The PG Calculation quantity is transformed through a preliminary, or basic, conditioning process to become the PG Quantity. This Position Guide Quantity may subsequently go through further advanced conditioning to become the PG Output quantity which is displayed to the user through the PG icon. The quantity displayed in the PG icon may be referred to as the PG Display quantity.

Plug-ins may interact with other plug-ins, for example the output of one Plug-in may serve as the input to another plug-in. It is also possible for one plug-in to programmatically “control” another plug-in. Plug-ins may be combined with other plug-ins to form composite plug-ins. Plug-ins may also utilize external resources to facilitate its computation tasks. For example, plug-ins may tap into data from a knowledgebase maintained by a third party specializing in trading research in order to improve the accuracy of its computations. These external resources may be located in the same machine where the plug-in is installed, or in a remote system accessible to the plug-in via a communication network. It is to be noted that these external computing resources may be set up so that each access by a plug-in is billed to the user's account, thus generating revenue for third parties maintaining the said resources.

It is intended that the first preferred implementation of the Position Guide would only include a relatively limited set of all available plug-ins. The software specifications of plug-ins would be published and made available to interested third parties. Such third parties may create additional types of plug-ins of interest to PG users and make such specialized plug-ins available to users who may wish to extend the basic capabilities of the Position Guide.

FIG. 46 shows an architecture in which the plug-ins used by the Position Guide such as Plug-in A 1128 encapsulate Plug-in Preference Data 1134 and User Interface Components 1132 as before, but do not contain any computation logic. Plug-in B 1130 is structured similar to Plug-in. A 1128. It should be understood that the actual number of plug-ins used in an implementation of this architecture is not limited to these two plug-ins.

In this architecture all Computation Logic 1126 is contained inside the Computation Module 1124. Computation tasks are performed by the Computation Module 1124, while the plug-ins simply supply Plug-in Preference Data 1134 to the Computation Module 1124. This lack of computational logic within the plug-in structure differentiates the present architecture from the architecture shown in FIG. 45.

Interaction and communication between plug-ins is not possible in the architecture of FIG. 46 because the plug-ins involved are “passive” components—they merely encapsulate Plug-in Preference Data 1134 that are consumed by the Computation Module 1124.

The Computation Module 1124 iterates through all the plug-ins it is configured to use, reads the Plug-in Preference Data 1134 encapsulated by each plug-in, and then performs computations using the plug-in preference data. The Computation Module 1124 keeps track of the result of each computation, eventually aggregating all the results from all the computations. The Computation Module 1124 then applies weighing factors and a summation formula in a process similar to that described for the architecture shown in FIG. 45. As before, the actual summation formula and the values of the weighing factors may be specified by the user, pre-defined by the Position Guide, or dynamically configured by a third party. The result of the summation formula is further processed to become the PG Calculation. The PG Calculation undergoes a basic conditioning process, to become the PG Quantity. This Position Guide Quantity may subsequently undergo an advanced conditioning before becoming the PG Output quantity which is displayed to the user through the PG icon.

The Plug-in Preference Data 1134 and the User Interface Components 1132 encapsulated by Plug-in A 1128 have the same properties as those described in the architecture discussion of FIG. 45.

The computations performed by the Computation Module 1124 typically reside inside the Computation Module 1124. However the Computation Module 1124 may also make use of external resources, such as other components of the Position Guide or a remote computing resource of a third party as described in the architecture discussion of FIG. 45.

FIG. 47 shows a “hybrid” of the architectures shown in FIG. 45 and FIG. 46. The Computation Module 1124 and its embedded Computation Logic 1126 functions the same as that described in FIG. 46. Plug-in A 1112 functions the same as that described in FIG. 45, while Plug-in B 1128 functions the same as that described in FIG. 46. The descriptions for these components in the architecture discussions of FIGS. 45 and 46 thus also apply to the architecture discussed in FIG. 47.

This “hybrid” architecture possesses several features that make it the most powerful and flexible of the three architectures presented. The Computation Module 1124 can work with plug-ins that contain embedded computation logic, such as Plug-in A 1112, as well as plug-ins that do not contain embedded computation logic, such as Plug-in B 1128. Furthermore, the Computation Module 1124 also contains its own Computation Logic 1126. This configuration enhances the flexibility of the Position Guide as a computational tool by enabling it to adapt to a variety of plug-in types and situations.

Interaction between plug-ins is possible. For example Plug-in A 1112 which contains its own computation logic, may read data from or otherwise “control” Plug-in B 1128 which does not contain any computation logic. The interaction between plug-ins is not two-way. Plug-in B 1128 cannot read data from Plug-in A 1112, nor can it “control” Plug-in A 1112 because Plug-in B 1128 it does not contain its own computation logic. Of course, Plug-in A 1112 may interact with other plug-ins that contain computation logic as well.

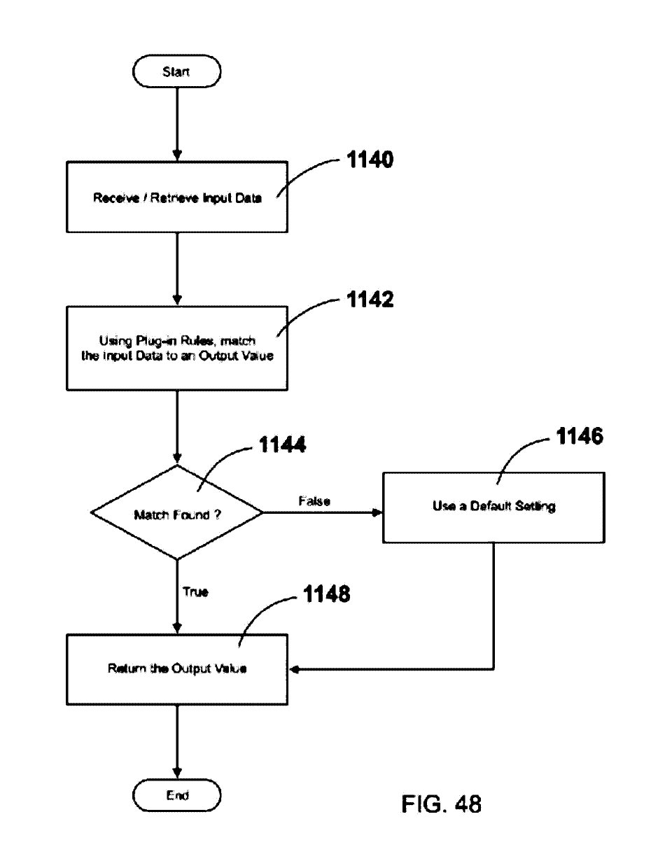

FIG. 48 shows a flowchart of the computation logic that may be implemented by plug-ins of the type shown in FIG. 45. In particular this flowchart is an example of the Computation Logic 1106 incorporated within Plug-in A 1112 depicted in FIG. 45. As described previously, the Position Guide Computation Module 1100 shown in FIG. 45 is responsible for activating the plug-in's computation logic.

The step “Receive/Retrieve Input Data” 1140 involves requesting for input data, which typically includes the PG input security symbol or identity as well as other types of data that may or may not be related to the PG input security. The input data is typically supplied by the Position Guide Computation Module. The plug-in may either wait for input data to arrive, or it may fetch the input data from the Computation Module. The plug-in may also fetch data, related or unrelated to the PG input security data, from an external source other than the PG Computation Module. The status of this external data fetch process is communicated to the PG Computational Module.

The step “Using Plug-in Rules Match the Input Data to an Output Value” 1142 involves scanning through the plug-in's encapsulated Plug-in Preference Data Plug-in Preference Data include rules, formulas, and heuristics related to securities trading, the nature of the plug-ins input & output data, and the workings of the Position Guide. In this step the computation logic searches the Plug-in Preference Data—which may be visualized and displayed as a table of input value categories and their corresponding output values—for an entry that matches the supplied input data. If an entry for the input data is found then its matching output value is read and stored.

The “Match Found?” decision step 1144 tests whether or not a matching output value for the supplied input data was found during the previous step. If the outcome of the “Match Found?” decision step 1144 is “True”, then the “Return the Output Value” step 1148 is performed next. In this step the output value found during the “Using Plug-in Rules Match the Input Data to an Output Value” step 1142 is returned to the PG Computation Module. The output value of a plug-in is typically expressed in a dollar denominated, quantity, or percentage based unit.

On the other hand if the outcome of the “Match Found?” decision step 1144 is “False”, the “Use a Default Setting” step 1146 is performed next. In this step a default value is used as the output value; the default value may be specified by the user or predefined by the plug-in. The “Return the Output Value” step 1148 is then performed next. In this step, the output value is returned to the Computation Module. The plug-in's computation logic terminates after the “Return the Output Value” step 1148.

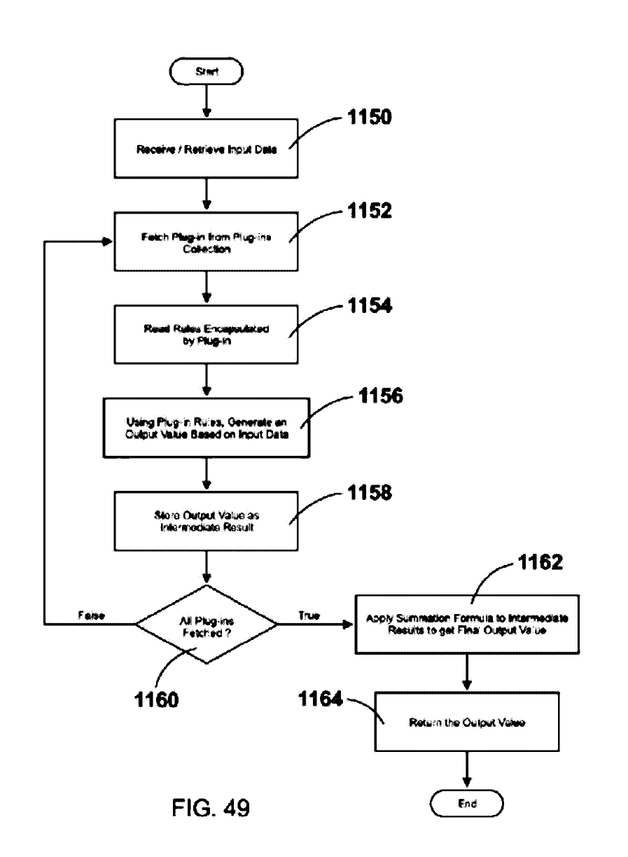

FIG. 49 shows a flowchart of the computation logic employed by the Position Guide Computation Module 1124 in the plug-in architecture shown in FIG. 46. As noted previously, in the plug-in architecture of FIG. 46, all Computation Logic 1126 is contained inside Computation Module 1124 which performs the computation tasks. The plug-ins simply provide Plug-in Preference Data to the Computation Module.

The “Receive/Retrieve Input Data” step 1150 involves requesting for input data, which typically includes the PG input security symbol as well as other types of data that may or may not be related to the PG input security. The input data is typically supplied by one or more components of the Position Guide, for example the User Interface Module 1014 and the Data Access Module 1008 shown in FIG. 41. The Computation Module may either wait for input data to arrive, or it may fetch the input data, for example, from the Data Access Module 1008 shown in FIG. 41.

The Position Guide has a collection of Plug-ins 1010 as shown in FIG. 41. In the “Fetch Plug-in from Plug-ins Collection” step 1152, a plug-in is programmatically retrieved from the plug-ins collection.

In the “Read Rules Encapsulated by Plug-in” step 1154 the Computation Module reads the Plug-in Preference Data encapsulated inside the plug-in that was retrieved during the “Fetch Plug-in from Plug-ins Collection” step 1152. The Computation Module will use the Plug-in Preference Data in the succeeding step.

In the “Using Plug-in Rules Generate an Output Value Based on Input Data” step 1156 the Computation Module employs the rules, formulas, and heuristics, read from the plug-in during the “Read Rules Encapsulated by Plug-in” step 1154, to compute for the plug-in output value. The computation process may use the same logic as the “Using Plug-in Rules Match the Input Data to an Output Value” step 1142 described for the flowchart presented in FIG. 48. The computation process may also use advanced mathematical calculations and heuristics. Whatever method is used, the plug-in output value is typically expressed in a dollar denominated, quantity, or percentage based unit.

In the “Store Output Value as Intermediate Result” step 1158 the Computation Module typically stores the output value, computed during the “Using Plug-in Rules Generate an Output Value Based on Input Data” step 1156, in a program variable. The computed plug-in output value represents an intermediate calculation result, which will be combined with all other intermediate calculation results once all the plug-ins are fetched and processed for a given PG input security.

In the “All Plug-ins Fetched?” decision step 1160, the Computation Module tests whether or not all the plug-ins in the plug-ins collection have been fetched and processed.

If the outcome of the “All Plug-ins Fetched?” decision step 1160 is “False”, then the Computation Module loops back to the “Fetch Plug-in from Plug-ins Collection” step 1152.

On the other hand, if the outcome of the “All Plug-ins Fetched?” decision step 1160 is “True”, then the “Apply Summation Formula to Intermediate Results to get Final Output Value” step 1162 is performed next. In this step all the intermediate calculation results, computed from when the enabled plug-ins were processed, are combined together to generate the final output value. A summation formula may be used in this step, as described previously for the three plug-in architectures shown in FIG. 45, FIG. 46, and FIG. 47. The summation formula results in a final investment amount value, which is divided by the relevant security price to result in the PG Calculation quantity. The PG Calculation undergoes a basic conditioning process, to become the PG Quantity. This PG Quantity may subsequently undergo advanced conditioning to become the PG Output quantity which is displayed to the user through the PG icon.

In the “Return the Output Value” step 1164, the final output value, the PG Output quantity, is returned to a component of the Position Guide such as the User Interface Module 1014 shown in FIG. 41, which may then display the output value to the user, for example, in the PG icon.

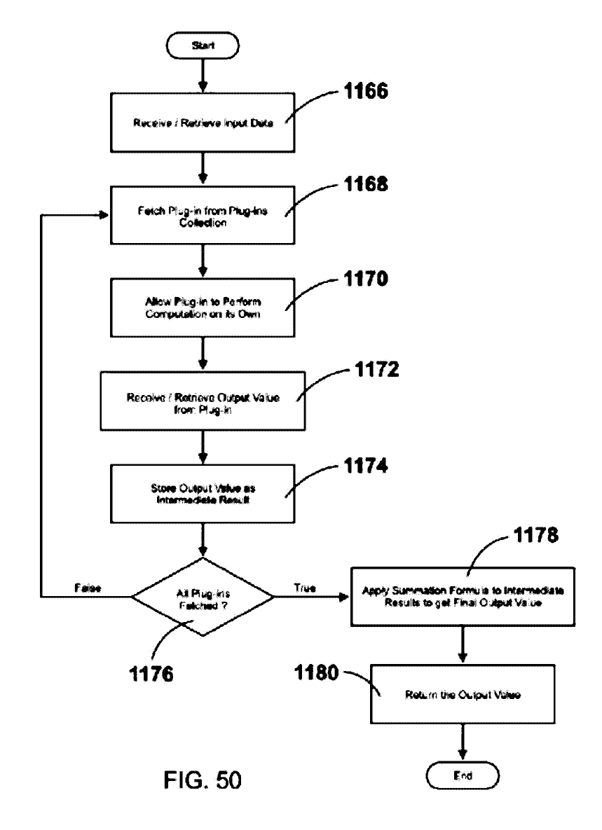

FIG. 50 shows a flowchart of the computation logic employed by the Position Guide Computation Module 1101 in the plug-in architecture shown in FIG. 45. As described previously, in this architecture the Computation Module 1100 delegates computation tasks that involve computing for an investment amount, a table output amount, an intermediate calculation result, a final investment amount, the PG Calculation, the PG Output quantity, and the like, to one or more plug-ins. The Computation Module provides input data to the plug-ins, and collects the output value from each plug-in. The collected plug-in output values are seen as intermediate calculation results, and are then combined and processed using a formula, such as a summation formula, to generate an output value which corresponds to the PG Output quantity.

It should be noted that this flowchart is similar in structure to the flowchart shown in FIG. 49. Hence this flowchart shares several steps with the latter flowchart.

The “Receive/Retrieve Input Data” step 1166 is the same as the “Receive/Retrieve Input Data” step 1150 shown in the flowchart of FIG. 49.

The “Fetch Plug-in from Plug-ins Collection” step 1168 is the same as the “Fetch Plug-in from Plug-ins Collection” step 1152 shown in the flowchart of FIG. 49.

In the “Allow Plug-in to Perform Computations on its Own” step 1170 the Computation Module supplies the necessary input data to the plug-in, and allows it to perform computations independent of the Computation Module. The plug-in may use any computation technique to compute for its output value. The Computation Module typically waits for the plug-in to finish its computation.

In the “Receive/Retrieve Output Value from Plug-in” step 1172 the Computation Module receives or retrieves the output value generated by the plug-in during the previous “Allow Plug-in to Perform Computations on its Own” step 1170. The output value of the plug-in is typically expressed in a dollar denominated, quantity, or percentage based unit.

The “Store Output Value as Intermediate Result” step 1174 is the same as the “Store Output Value as Intermediate Result” step 1158 shown in the flowchart of FIG. 49.

The “All Plug-ins Fetched?” decision step 1176 is the same as the “All Plug-ins Fetched?” step 1160 shown in the flowchart of FIG. 49.

The “Apply Summation Formula to Intermediate Results to get Final Output Value” step 1178 is the same as the “Apply Summation Formula to Intermediate Results to get Final Output Value” step 1162 shown in the flowchart of FIG. 49.

The “Return the Output Value” step 1180 is the same as the “Return the Output Value” step 1164 shown in the flowchart of FIG. 49.

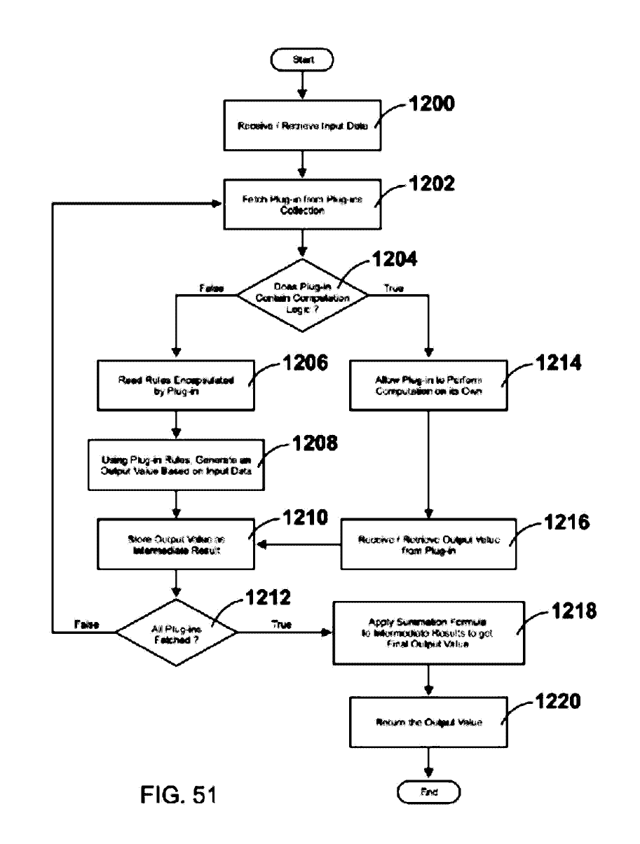

FIG. 51 shows a “hybrid” flowchart that combines steps from the two flowcharts shown in FIG. 49 and FIG. 50. The sequence of steps illustrated in this flowchart represents the Computation Logic 1126 employed by the Computation Module 1124 shown in FIG. 47.

The “Receive/Retrieve Input Data” step 1200 is the same as the “Receive/Retrieve Input Data” step 1150 shown in the flowchart of FIG. 49.

The “Fetch Plug-in from Plug-ins Collection” step 1202 is the same as the “Fetch Plug-in from Plug-ins Collection” step 1152 shown in the flowchart of FIG. 49.

The “hybrid” flowchart of FIG. 51 displays a new step after the “Fetch Plug-in from Plug-ins Collection” step 1202. This new step is the “Does Plug-in Contain Computation Logic?” decision step 1204. This decision step tests whether or not the plug-in that was fetched during the previous step contains its own computation logic.

If the outcome of the “Does Plug-in Contain Computation Logic?” decision step 1204 is “True”, then the flowchart follows a path similar to the flowchart shown in FIG. 50. The flowchart branches to the “Allow Plug-in to Perform Computations on its Own” step 1214, which is the same as the “Allow Plug-in to Perform Computations on its Own” step 1170 shown in FIG. 50. The flowchart then proceeds to the “Receive/Retrieve Output Value from Plug-in” step 1216, which is the same as the “Receive/Retrieve Output Value from Plug-in” step 1172 shown in FIG. 50.

If the outcome of the “Does Plug-in Contain Computation Logic?” decision step 1204 is “False”, then the flowchart follows a path similar to the flowchart shown in FIG. 49. The flowchart branches to the “Read Rules Encapsulated by Plug-in” step 1206, which is the same as the “Read Rules Encapsulated by Plug-In” step 1154 shown in FIG. 49. The flowchart then proceeds to the “Using Plug-in Rules Generate an Output Value Based on Input Data” step 1208, which is the same as the “Using Plug-in Rules Generate an Output Value Based on Input Data” step 1156 shown in FIG. 49.

The flowchart then proceeds to the “Store Output Value as Intermediate Result” step 1210, the “All Plug-ins Fetched?” decision step 1212, the “Apply Summation Formula to Intermediate Results to get Final Output Value” step 1218, and the “Return the Output Value” step 1220. These steps function the same as the corresponding steps of the same name shown in the flowcharts of FIG. 49 and FIG. 50.

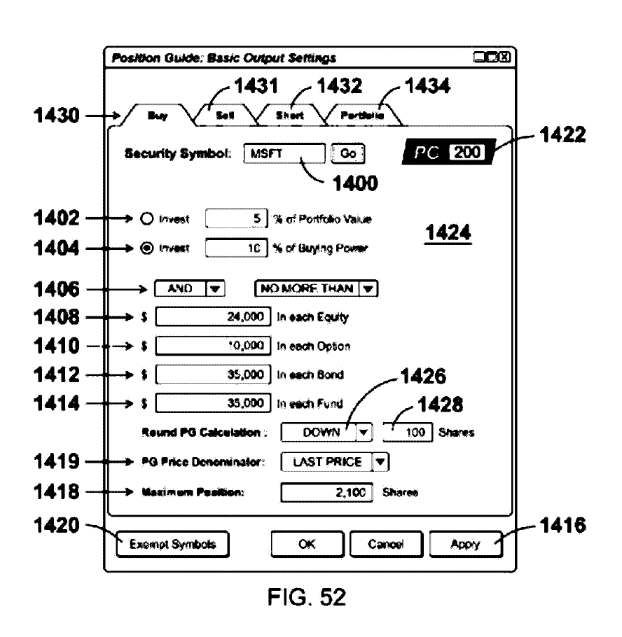

FIG. 52 is a representation of the Position Guide Basic Output Settings panel. Tab set 1430 allows Position Guide settings to be entered and distinguished according to order type. The PG settings specific to Buy orders is displayed in tab page 1424. Similar PG settings are accessible for Sell orders 1431, Short orders 1432, and Portfolio Amounts 1434.

The Position Guide Output, 1422 displays the recommended quantity of a given security to buy, sell or short based on the user's Position Guide or Plug-in preference settings 1424. Optional security symbol input area 1400 allows a user to input a security symbol representative of the PG input security and view the corresponding PG Output Quantity 1422 in accordance with the settings of the tab page 1424.

Radio buttons determine the percentage of the buying power 1404, or the percentage of the portfolio value 1402 to be invested in each trade. The actual dollar denominated amounts derived from the percentage data may also be displayed for convenient reference. Conditional settings area 1406 assists the user to further define the nature of specific trade investment amounts entered for each equity 1408, option 1410, bond 1412, or mutual fund 1414 asset class relative to the percentage amounts 1402 and 1404.

The Position Guide allocates the dollar denominated amount entered into the equity section. 1408 to equity orders. Similarly, there are amounts entered for option orders 1410, bond orders 1412, and mutual fund orders 1414. The optional PG Price Denominator section 1419 determines the relevant security price, which the investment amount is divided by to obtain the PG Calculation quantity. If the PG price denominator setting is not used, the relevant security price becomes the last traded price for the input security. The Investment amount is calculated from the logic of settings 1402 to 1414.

It should be understood that there may be numerous arrangements and presentations of the settings controls and input areas of the Position Guide. For example, settings area 1408 to 1414 may take the place of settings area 1402 to 1404 and vice versa. Different arrangements and presentations may be used without reducing the utility of the Position Guide for assisting the user to derive a quantity amount for a transaction.

The PG Calculation is a decimal number representing the quantity recommendation prior to any output conditioning. Recommendations are rounded up, down, or to the nearest standard lot size, or contract size. The rounding method is selected from a dropdown list 1426. The step increment quantity between PG Quantity values is entered in input area 1428. For example, a step increment 1428 of 100 shares implies the PG Quantity amount will be displayed in standard lot sizes. If no step increment settings are provided, the Position Guide may round down by default to the nearest 100 shares or nearest lot for equity orders, and to the nearest integer unit for options and other asset classes.

For a given PG input security 1400, the recommended PG Output quantity for a buy, sell, or short order may be drag and dropped from any PG icon 1422 where the PG Output quantity is displayed to any suitable cell on a Grid Proper 120 associated with the PG input security.

The maximum quantity a user may purchase using their entire buying power or cash balance, defined as the PG Max or PG Maximum quantity, is also shown 1418. Exempt Symbols button 1420 provides access to the Position Guide Exempt Security Symbols panel of FIG. 81. Settings are saved using the Apply button 1416. Estimated trading commissions are typically subtracted from the investment amount and hence, factored into the PG Calculation quantity.

For example, assume the user is engaged in an equity buy order for MSFT 1400. If the user's buying power is $120,000. It is understood that 10% of the buying power 1404 is $12,000. Equity buy trades 1408 are further limited to $24,000. Conditional area 1406 specifies the lower of the two amounts, or $12,000 to be selected as the investment amount. If we assume that the last trade price of MSFT is $55.13, then the PG Calculation quantity is 217.667 shares. This PG Calculation amount is rounded down as indicated 1426, to the nearest 100 shares 1428, to result in a PG Quantity of 200 shares. Provided there is no further changes on this amount from additional output conditioning of the PG Quantity, the 200 share recommendation is displayed in the PG icon 1422. The maximum shares the user may purchase 1418 is shown as 2100 shares.

The Basic Output Settings panel of FIG. 52 is one of several graphical interfaces which may be used to configure the Position Guide settings to recommend quantity amounts for a specific trade or limit portfolio values for a security, sector, asset class, and the like. There are a number of Output Settings panels. Each Output Settings panel differs in terms of its complexity, presentation, and access to the various PG configuration settings. The user may choose to enable the PG Output Settings panels that are most appropriate for their PG experience level and needs. Typical Position Guide settings panels include, but are not limited to, FIGS. 52, 54, 55, 56, 77, 87, 88, and 91.

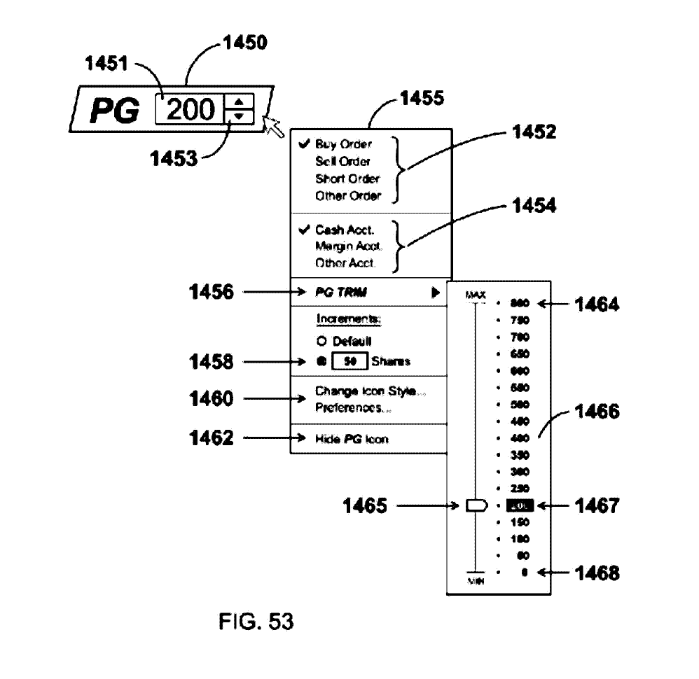

FIG. 53 illustrates the Position Guide icon 1450 and its associated right click pop-up menu 1455. The Position Guide Output quantity 1451 is typically displayed inside the PG icon 1450. Although the PG Output quantity is a specific calculated quantity value 1451, it may be manually modified by the user. The PG Output quantity, as calculated by the Position Guide for a given PG input security, is automatically displayed inside the PG icon. This displayed quantity inside the icon is referred to as the PG Output quantity or PG Output.

The initial quantity displayed in the PG icon, the PG Output quantity, may be subsequently modified by the user. When the quantity displayed in the PG icon is manually modified, it is no longer referred to as the PG Output or PG Output quantity. Rather, the manually modified and displayed quantity is referred to as the PG Display quantity. The distinction needs to be made because a manually adjusted quantity, as displayed inside the PG icon, is disassociated from any PG computation process and merely represents a quantity parameter of an intended transaction. Although the manually adjusted quantity parameter does not derive from the logic or settings of the Position Guide, and hence is not the PG Output quantity, it still provides a convenient initiating point for dragging and dropping an intended order and its associated manually input quantity parameter.

When one refers to any quantity value inside the PG icon, whether the quantity value is the PG Output quantity Or a manually adjusted quantity, the term PG Display quantity is used. The PG Display quantity may be dragged and dropped onto a suitable Grid Proper or an Order Entry form to initiate a trade. Typically, the PG Output quantity, as calculated by the Position Guide using the user's preference data, the plug-in preference data, and the like, is assumed to be the quantity displayed inside the PG icon 1450.

A user may change or adjust the displayed PG Output quantity 1451 by using the up and down trim buttons 1453. Similarly, the user may manually adjust the PG Output quantity using the interactive slider control 1465 accessed through the PG Trim area 1456. The displayed PG Output quantity 1451 may be adjusted from the PG Maximum quantity amount 1464, to a Minimum quantity amount 1468 using the interactive slider control 1465. The originally calculated PG Output quantity is identified 1467 on the quantity scale of the manual slider control area 1466. It should be understood that there are other methods of selecting a discreet quantity from a list and the PG is not limited to a slider control. The manual quantity override may be disabled by the user or a third party.

The PG Output amount 1451 is defaulted to a Buy order quantity, however, the PG Output quantity for other order types may also be displayed within the PG icon 1450 by selecting the appropriate transaction order type through the order type selection area 1452. The color, shape, or texture of the PG icon 1450 may change according to the PG Output quantity's underlying order type, account type, security asset class, or as a result of a manual trim override of the original output quantity.

The default account type used for the transaction, and hence, the maximum funds available for investment, may be selected through account selection area 1454 of the PG icon right-click menu. The right click pop-up menu 1455 also provides the user with access to other relevant PG dialog boxes and settings panels 1460, and the ability to Hide the PG Icon 1462.

The PG Display quantity 1451 will typically vary from one value to another in fixed step increments to reflect a practical transaction quantity. This incremental step amount may be specified through increment settings area 1458. As a practical matter, securities such as equities are transacted in integer amounts and typically in lot sizes of 100 or 500 shares. The decimal PG Calculation quantity is rounded up or down to the nearest step increment quantity 1458 to conform to this convention.

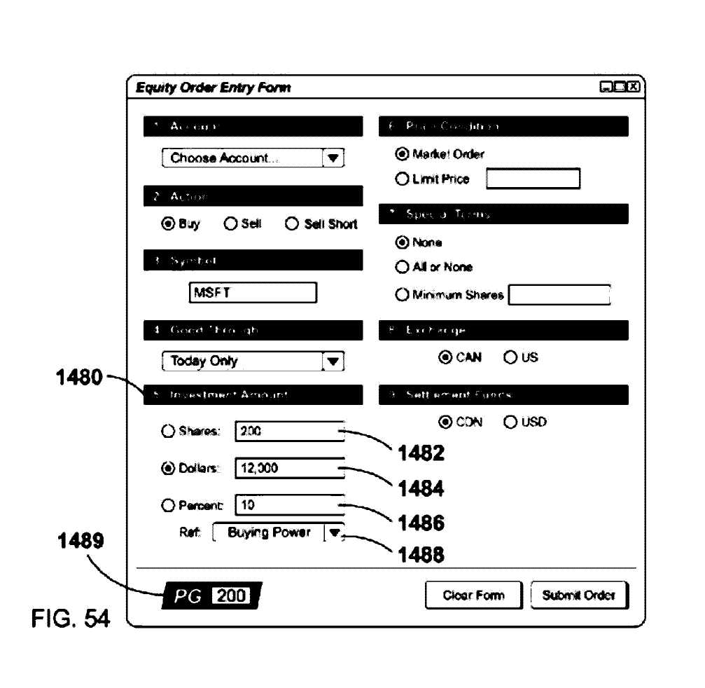

A typical online brokerage's order entry form provides input areas for order parameters including the quantity of shares intended for the transaction. FIG. 54 is representative of an Equity Order Entry Form adapted for use with the Position Guide. Investment Amount section 1480 permits a user to manually enter values pertaining to the number of shares to buy, sell, or short, as well as the investment amount for the transaction. A share quantity amount may be entered directly into the input box 1482 associated with the intended order's share quantity value.

However, unlike other online brokerage order entry forms, the user is not limited to only entering the order quantity amount in quantity units such as share units. Entering a dollar denominated amount representative of the order's quantity units in the dollar amount input box 1484 is also permitted. Similarly, a percentage value 1486 of an underlying reference amount may also be used to determine the dollar amount to invest, and hence, the quantity of shares involved in the intended order. When percentage units are involved, the percentage reference amount is specified from the drop down list 1488. The percentage reference amount may be the cash balance or buying power in an account. Similarly, the percentage reference may be the portfolio's overall market value, or the market value of a given asset class. The dollar value of the percentage reference amount may be displayed on the order entry form for convenient reference.

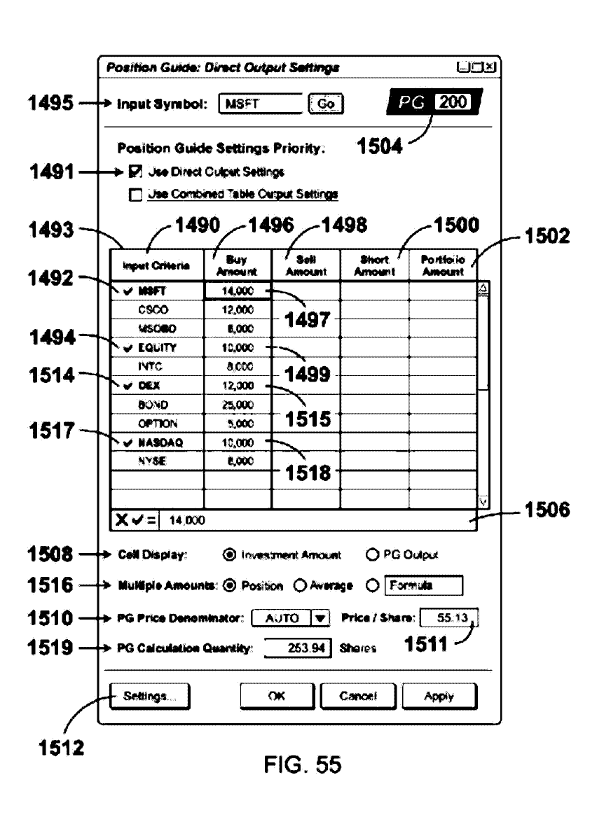

If a share quantity 1482 is entered into the order entry form, the PG icon 1489 displays the entered share quantity. If a dollar amount or a percentage amount is entered, the Position Guide derives the intended investment amount, and subsequently calculates a quantity recommendation, the PG Output quantity, in a manner consistent with that described for FIGS. 52 and 55.

Radio buttons or a drop down list may be used to select the appropriate Investment Amount 1480 input method and input units. If a share quantity 1482 is manually entered, the subsequent order is forwarded to a stock market or exchange with the said share quantity as the quantity parameter of the transaction. If a Dollar amount 1484, or a Percentage amount 1486 is entered, the Position Guide is used to compute the PG Output quantity from the dollar denominated or percentage based investment amount input data.

The Position Guide will divide the dollar amount input 1484 by the Security's relevant price to determine the PG Calculation quantity of the order. The Position Guide permits the PG Calculation quantity to be rounded down to the nearest lot or similarly conditioned before being displayed inside the PG icon 1489 as the PG Output quantity.

If no investment amount input 1480 is entered, the Position Guide may calculate a PG Output quantity automatically for the intended order based on the order type, the security symbol, and preference settings of the PG and its plug-ins. The resulting PG Output quantity recommendation will be displayed in the PG icon 1489 and the share quantity input box 1482.

It should be understood that the method of selecting an Investment Amount 1480 on an equity order entry form with the assistance of the Position Guide may be extended to other order entry forms associated, for example, with option, mutual fund, bond, and futures orders.

FIG. 55 is representative of the Position Guide Direct Output Settings panel. The Direct Output Settings panel provides a intuitive configuration method for allocating an investment amount for a given PG input security based on the security's symbol, sector, asset class, index association, listing exchange, and the like. In settings area 1493, the first column, the input criteria column 1490, indicates the input criteria or input category type for which each investment amount 1497 in each row 1492 is designated. For each input criteria or input category type, one or more columns are shown for entering the designated investment amount allocation by order type. For example, shown are columns for designating a buy order amount 1496, a sell order amount 1498, and a short order amount 1500. It should be understood that new columns may be created for additional order types, and that a single column may contain the designated investment amount data for more than one order type. For example, a single column may be configured to enter a designated investment amount for both sell and short order investment amounts.

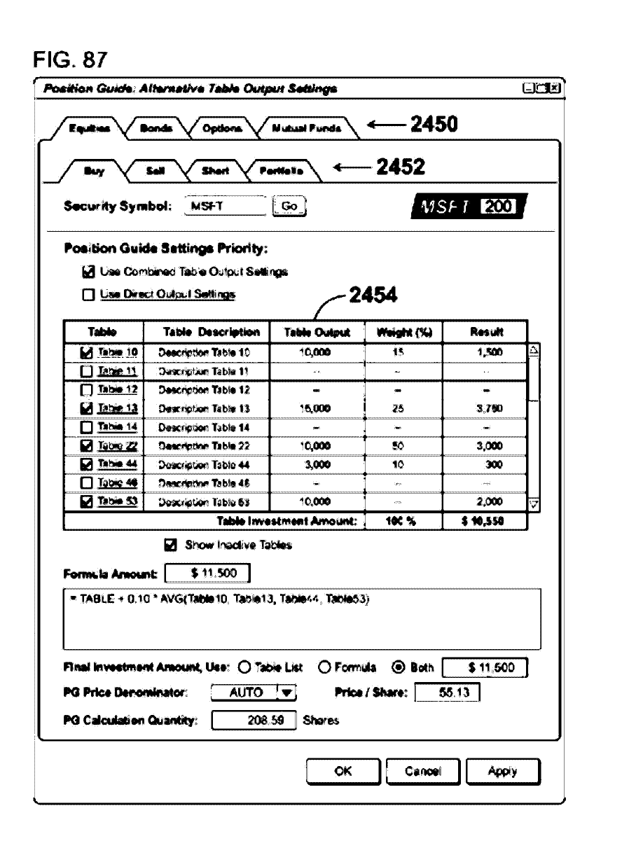

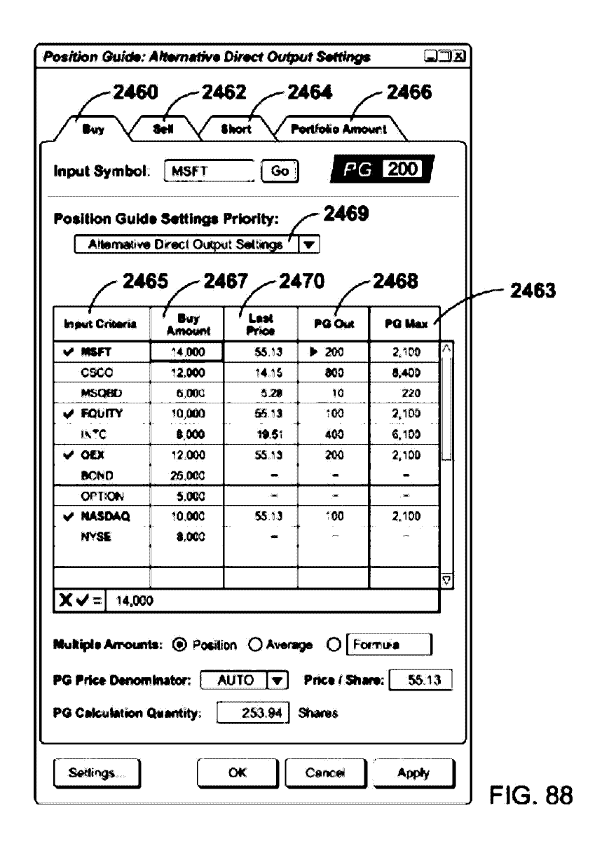

It should be understood that each of the buy, sell, and short order columns may be separated and presented visually within its own tab page. This approach is described in the Alternative Direct Output Settings panel of FIG. 88. Similarly, the tab sets may be arranged according to the asset class of the PG input security. The segmented tab set may be presented, as in FIG. 87, to further segregate PG input security symbols and their designated investment amounts by their respective asset class.

There is also a column for designating a portfolio amount limit 1502 for each input criteria or input category row or cell. A Portfolio Amount is the total value of a PG input security or input category type the user may maintain or hold in his overall portfolio. The portfolio amount or portfolio investment amount, limits the value or proportion of a given security in the user's overall portfolio. A Settings button 1512 is shown to indicate access to m ore advanced configuration options for the Settings panel.

Each input cell within the settings area 1493, may be edited by selecting the cell and entering or modifying the data inside the cell. Data and values for a selected cell may also be entered or edited through input box 1506. For example, if “Microsoft Corporation” or “MSFT” 1492, is input to the Position Guide, the PG will recommend a buy share quantity equivalent to $14,000, the designated investment amount 1497 input by the user or a third party for a buy order. This buy investment amount is indicated in selected cell 1497 and input box 1506. Similarly, the user may specify a sell order amount and a short order amount for “MSFT” in each order type's column 1498, 1500 respectively.

The PG icon 1504 displays the PG Output quantity for a given PG input security. The given PG input security may be selected from the settings area 1493, the PG Input Symbol area 1495, or the grid proper tab page. Formulas, variables, template names, table names or table symbols, and scripting language commands may be entered in select input cells to further facilitate a suitable PG Output quantity recommendation.

When formulas, variables, template names, table names or table symbols, and scripting language commands are entered in input criteria column 1490, the resulting output amounts of the formulas, variables, template names, table names or table symbols, and scripting language commands, for a given PG input security, may be displayed in any investment amount column such as buy order column 1496. The PG input security 1495 is available as input into the formulas, variables, template names, table names or table symbols, and scripting language commands. If the formulas, variables, template names, table names or table symbols, and scripting language commands are not configured or intended for a specific order type, asset class, or a given PG input security, the output value of the formulas, variables, template names, table names or table symbols, and scripting language commands will not be computed or displayed in their respective buy, sell, or short investment amount columns 1496, 1498, 1500.

Formulas, variables, template names, table names or table symbols, and scripting language commands may be entered in an investment amount column, such as buy amount column 1496, as well as the Input Criteria's column 1490. This approach also limits the calculated formulas, variables, template names, table names or table symbols, and scripting language commands output amounts to the specific cell of the investment amount column where the formulas, variables, template names, table names or table symbols, and scripting language commands have been entered.

In this situation, only PG input symbols which match the security symbol or the Input Criteria 1490 are subsequently input into the formulas, variables, template names, table names or table symbols, and scripting language commands to derive an output value. This approach effectively filters the PG input symbol 1495 through the input criteria column 1490 so that the PG input security 1495 is only input into the formulas, variables, template names, table names or table symbols, and scripting language commands, if the Input Criteria cell in column 1490 has already accepted or validated the input security for a given input criteria.

If an Index symbol is entered in a cell of the input criteria column 1490, it should be understood that the Index symbol is merely a convenient method of indicating that the associated investment amount for a given order type is intended for each of the index's component stocks. For example, the OEX index symbol 1514 shown in the Input Criteria column 1490, indicates that each PG input security which also happens to be a component of the OEX index will be allocated or designated an investment amount of $12,000, as shown in adjacent cell 1515, if the intended order is a buy order.

The units and formatting of each column and cell may be adjusted with a right-click operation on the column header or cell. For example, a sell amount may be specified in share units rather than a dollar denominated value.

Occasionally, for a range of input criteria indicated under the Input Criteria column 1490, the Position Guide may detect more than one qualified input criteria for a given PG input security. In FIG. 55, for example, the PG input security is “MSFT” and this results in four input criteria matches, each with their respective investment amounts for a buy order indicated in column 1496. The first qualified or satisfied input criteria corresponds to the “MSFT” symbol 1492 as this is the PG input security symbol; the second satisfied criteria corresponds to the “EQUITY” category 1494, as MSFT is an equity security; the third satisfied criteria corresponds to the index symbol “OEX” 1514, as MSFT is a component stock of the OEX index; and the fourth satisfied criteria corresponds to the “NASDAQ” symbol 1517, as MSFT is also a Nasdaq listed security. The four corresponding PG buy order investment amounts for these four satisfied input criteria are: $14,000 for the “MSFT” PG input symbol 1497, $10,000 for the “EQUITY” input category 1499, $12,000 for the “OEX” input category 1515, and $10,000 for the “NASDAQ” input category 1518.

The Multiple Investment Amounts section 1516 permits the user to select the method used when, for a given PG input symbol 1495, more than one valid input criteria or input category type 1490, results in more than one valid corresponding investment amounts for a given order type. Generally, the investment amount associated with the highest satisfied criteria or highest row position that matches an input criteria 1490 for a given PG input security 1495 is chosen as the final investment amount. In FIG. 55, this position rank method of handling multiple valid input criteria is selected 1516. For example, since the “MSFT” input criteria 1492 has the highest position rank of the four satisfied input criteria in the input criteria column 1490, the final investment amount is $14,000. The Position rank approach to multiple satisfied input criteria permits the user to position the higher priority security symbols and input criteria near the top of the input criteria list 1490.

Alternatively, when there are multiple satisfied input criteria for a given input security, the final investment amount may be the minimum, maximum, median, mode, or average of their various associated investment amounts. Similarly, an alternative ranking method may provide that a PG input security's symbol in the input criteria column 1490 has the highest priority, followed by an index symbol if the PG input security is a component, followed by the sector type to which the PG input security belongs, followed by the asset class of the PG input security, and the like.

The Position Guide Settings Priority area 1491 permits the user to select which PG Output Settings panel takes priority when the PG detects a conflicting configuration between two or more settings panels. The user may access the Settings panel from a html link to edit the conflicting settings information.

The relevant PG input security price 1511 that is used to calculate the PG Calculation quantity may be selected from the drop down list associated with the PG Price denominator 1510. The PG Price Denominator may be the limit price of the intended order, the last traded price, or the high, low, bid, ask, or opening price for the security. An “AUTO” setting in the drop down list permits the relevant security price 1511 to be adjusted automatically for each order type. For example, in the “AUTO” setting, an intended buy order may use the ask price of the PG input security before the order is placed on the Grid Proper. Once the intended Order is dragged onto the Grid Proper, the corresponding limit price is used as the relevant security price. The final investment amount as derived from the settings area 1493 is divided by the relevant security price 1511 to determine the PG Calculation quantity 1519. For example, the derived investment amount for “MSFT”, as discussed previously is $14,000, and this amount 1497 is divided by $55.13, the relevant security price for “MSFT”, to calculate the PG Calculation value of 253.94 shares. The decimal PG Calculation quantity undergoes output conditioning and the final value is subsequently displayed in the PG icon 1504 as the PG Output quantity.

For convenience, the PG Output quantity corresponding to each cell's investment amount may be displayed inside their respective investment amount cells, for example 1497. The Cell Display radio buttons are provided for this purpose 1508. To view the P G Output quantity, in share units, inside each suitable cell, the “PG Output” radio button is selected.

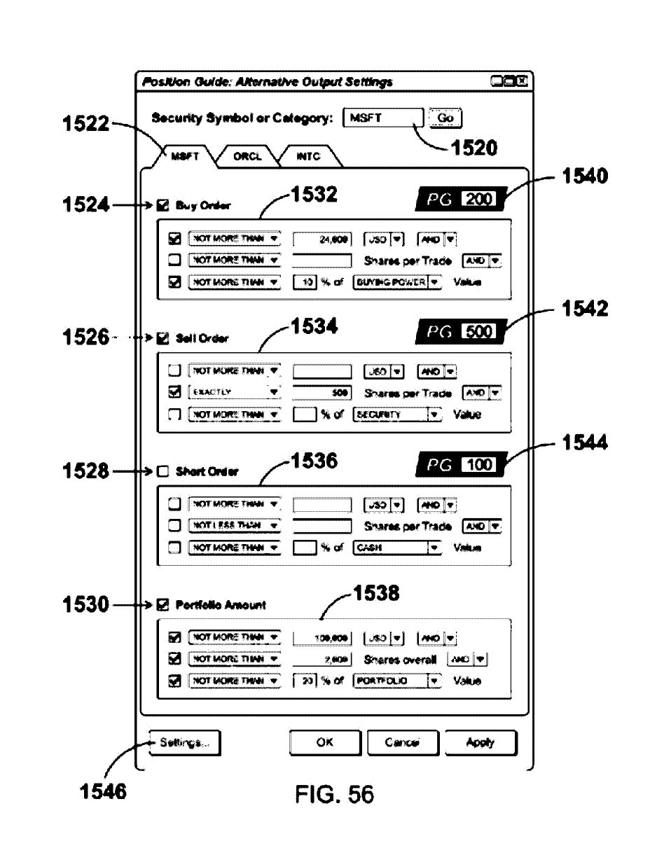

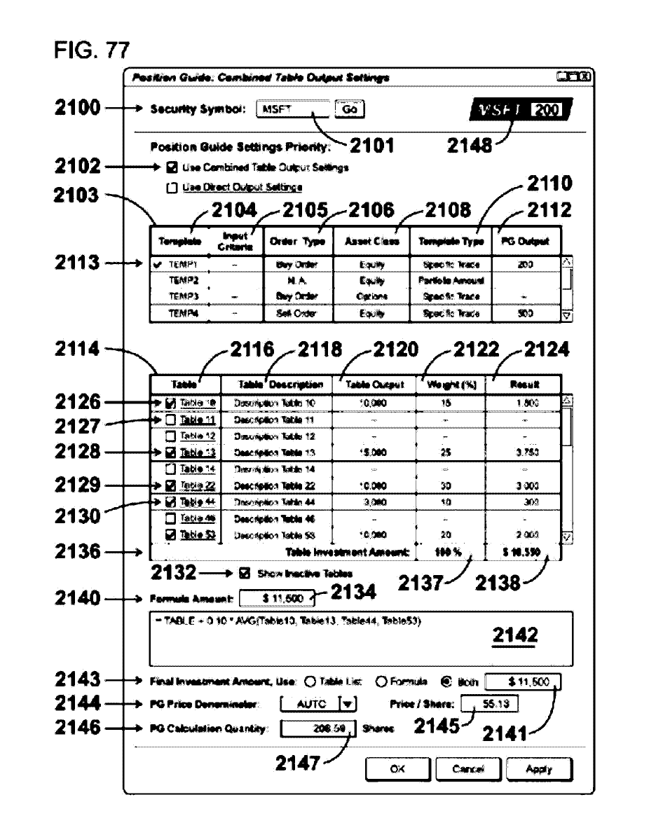

There are a number of Position Guide Output Settings panels including, without limitation, the Basic Output Settings of FIG. 52, the Direct Output Settings of FIG. 55, the Alternative Output Settings of FIG. 56, the Combined Table Output Settings of FIG. 77, and their variations as shown in FIGS. 54, 87, 88, and 91. It should be understood that the PG Output Settings panels may be used to configure the Position Guide independent of the Table configuration approach shown in more detail in FIGS. 63 to 79.

FIG. 56 is representative of the Position Guide Alternative Output Settings panel. The panel provides an alternative configuration method of specifying and allocating investment amounts for securities and security symbols that are input to the Position Guide.

To configure the Position Guide for a given security symbol or category, the user first creates or selects its corresponding tab page. A security symbol or category type is entered into input box 1520. The tab page associated with the security symbol or category type becomes the active tab page. If no tab page exists for the security symbol or category type, a new tab page is automatically created. In FIG. 56 for example, when the MSFT symbol is entered into the input box 1520, the MSFT tab page is displayed and made active 1522. The MSFT tab may also be made active by selecting it's tab 1522.

Each tab page is divided into sections, with each section corresponding to an order type or a portfolio amount. The user checks a checkbox to enable specific order type and portfolio amount settings for each security. In FIG. 56, for example, the PG is enabled for MSFT buy orders 1524, sell orders 1526, and portfolio amount settings 1530. Short order PG quantity recommendations is not checked and thus disabled 1528.

Within each order or portfolio section is an input area, 1532 to 1538, for entering the investment amount details for a specific order type or the overall portfolio. The buy order input area 1532 permits the user to specify an investment amount in dollar units, share units, percentage units or a combination of such units and amounts. After interpreting the data provided by the user in the input area 1532, the Position Guide displays its buy quantity recommendation in the PG icon 1540. Similarly, there are PG icons associated with a sell order 1542 and its input area 1534, and a short order 1544 and its input area 1536.

The portfolio amount input area 1538 permits the user to specify the quantity amount or dollar value of a security, for example, MSFT, that may be present in his portfolio. A combination of checkboxes, drop down lists, and data input boxes allow the user to communicate his preference settings for a specific security to the Position Guide. The visual presentation, style, and formatting of the tab panels may be accessed using the settings button 1546. As in FIG. 55, additional information may be displayed such as the final investment amount for each order type, the PG Price Denominator settings, and the PG Calculation quantity section.

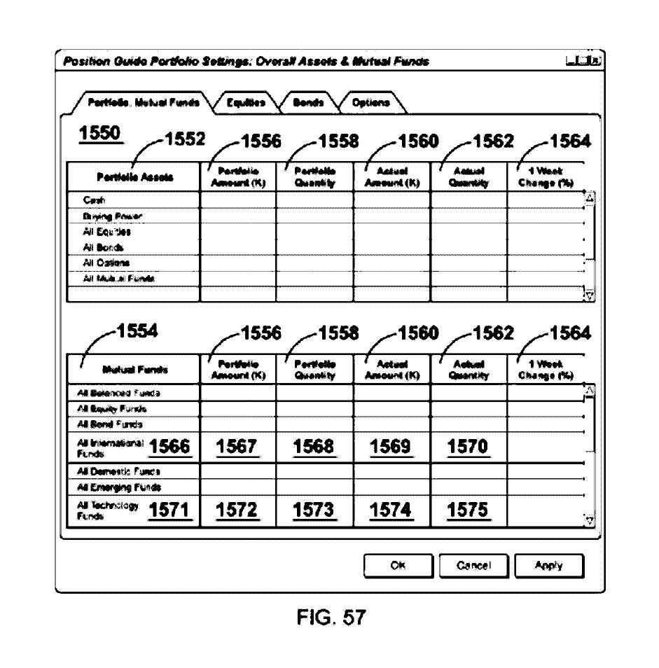

Turning now to FIGS. 57-60, FIG. 57 is representative of the Position Guide Portfolio Settings Overall Assets and Mutual Funds panel. The panel presents an alternative graphical interface method of specifying and allocating Position Guide portfolio amounts for various asset classes and mutual funds. The Position Guide portfolio amount settings allows a user to specify a limit on the total market value or quantity of a specific security, asset class, security category relative to the overall portfolio value.

The Portfolio, Mutual Funds tab page 1550 contains two sections. The upper section pertains to the portfolio's asset class categories. These asset categories include but are not limited to: the cash balance, the buying power, and the value of the Equity asset class, the Bond asset class, the Option or derivative asset class, and the Mutual Fund asset class.

The first column 1552 lists the various asset classes the user may choose to enter a portfolio amount for. Dollar denominated portfolio amounts are entered and modified in the Portfolio Amount column 1556. The user may also choose to enter the portfolio limit data in quantity units such as shares in the Portfolio Quantity column 1558. It should be understood that a percentage units column may be inserted in any portfolio settings tab page to input percentage data specifying the relative weighing of a security, asset class, or security category relative to the overall portfolio value.

The Actual Amount column 1560 allows the user to view the actual real-time market value of his portfolio holdings by the asset class listed 1552. The Actual Quantity column 1562 indicates the actual real-time share or quantity data in each asset category. A One Week Percentage Change column 1564 is provided to allow the user to view the percentage change in the value of each asset class over a given period of time. The units, formatting, position, and style of each column and it's associated data may be set with a right-click operation on the respective column header area.

The lower section of FIG. 57 lists the portfolio's Mutual Fund securities or Mutual Fund categories 1554. Various Fund categories and individual mutual funds may be listed in the first column 1554. Portfolio amounts 1556 and Portfolio quantities 1558 may be entered for each Mutual Fund security or Mutual Fund category as described for columns 1556, 1558. The breakdown of a broad asset class into specific securities and category types allows the user to allocate portfolio amounts in a precise and selective manner. Note that there is a distinction between actual and portfolio amounts. A portfolio amount represents a goal or objective amount, or quantity limit for what a given security, category, or asset class may contribute to an overall portfolio's actual value.

The Position Guide may require a third party to provide category data so a given security may be properly categorized. For example, the third party data may identify whether a given Mutual Fund security or symbol held in inventory may be categorized as an International Fund 1566, a Technology Fund 1571, both, or neither. If the given Mutual Fund is both, its market value and unit quantity is added to both the International Fund actual amount 1569 and International Fund actual quantity data 1570, and the Technology Fund actual amount 1574 and Technology Fund actual quantity data 1575. Should either of these Mutual fund categories 1566, 1571 exceed their respective Portfolio Amount settings limits 1567, 1572, or respective Portfolio Quantity settings limits 1568, 1573, when compared to their respective Actual amounts 1569, 1574, or respective Actual quantities 1570, 1575, the Position Guide would not recommend further purchase of the given Mutual Fund above the portfolio amount or portfolio quantity set for each Mutual Fund category.

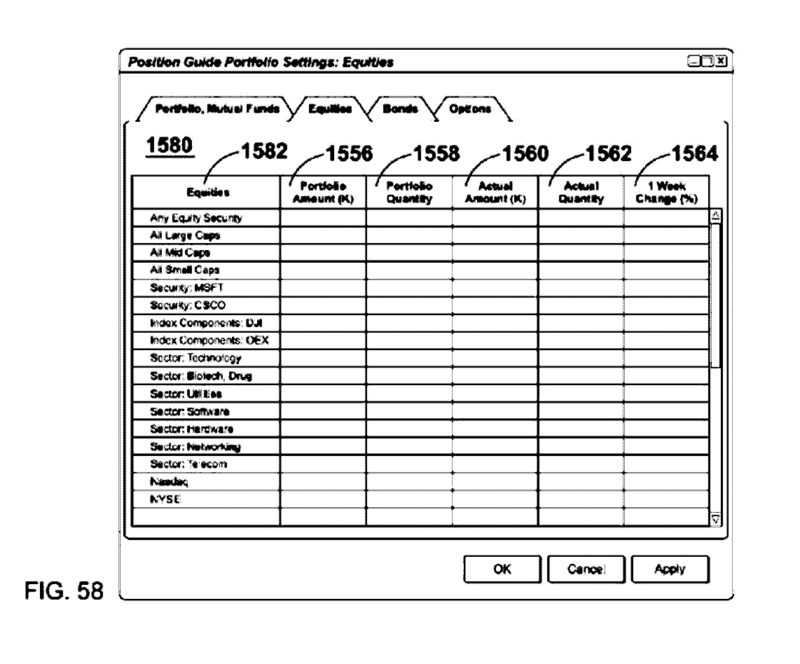

FIG. 58 is representative of the Position Guide Portfolio Settings Equities panel. The panel presents a graphical interface of specifying and allocating portfolio amounts for equity securities and equity related categories. The equities tab page 1580 presentation, layout, and configuration method is similar to the Portfolio, Mutual Funds tab page 1550 of FIG. 57.

The first column 1582 lists the portfolio's equity securities or equity categories. These categories include but are not limited to: specific equity securities, any generic equity security, equity sector allocations, equity index allocations, equity exchange or listed market allocations, and market capitalization allocations. There are additional columns to input the Portfolio Amount 1556, and the Portfolio Quantity 1558, and to view the market value of each equity or equity category's Actual holdings Amount 1560, or Actual holdings Quantity 1562. A One Week Percentage Change column 1564 is provided to allow the user to view the percentage change in the value of each equity category over a given period of time.

The Position Guide equities portfolio amount settings 1580 allows a user to specify limits on the total market value or total quantity of specific equity securities, equity index components, equity sectors, and other equity categories in an overall portfolio.

The Position Guide may require a third party data source to provide category data to properly categorize a given equity security. For example, the third party data may identify which sector a given equity symbol belongs to, its market capitalization, and the exchange where the shares are listed for trading.

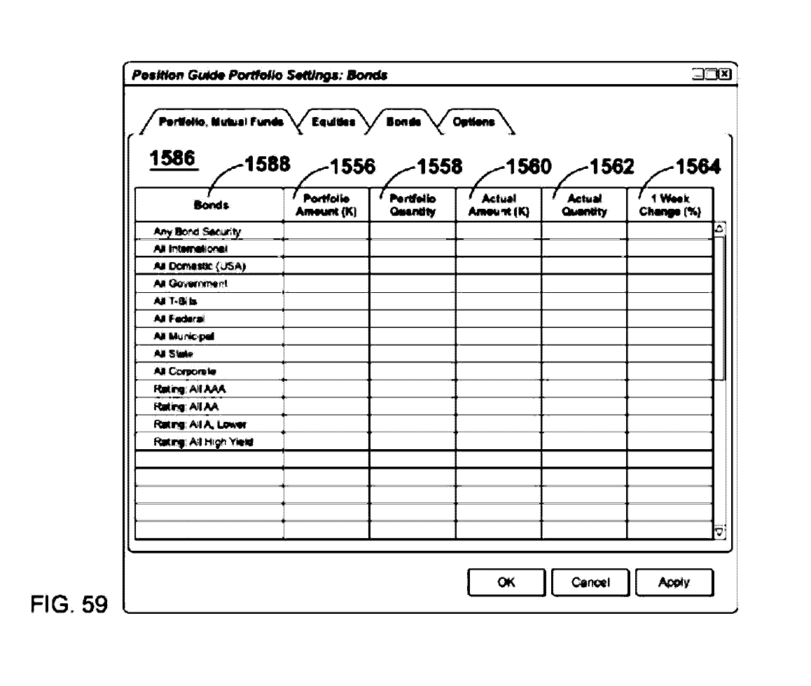

FIG. 59 is representative of the Position Guide Portfolio Settings Bonds panel. The panel presents a graphical interface method of specifying and allocating, portfolio amounts for bond securities and bond related categories. The Bonds tab page 1586 presentation, layout, and configuration method is similar to the Equities tab page 1580 of FIG. 58.

The first column 1588 lists the portfolio's bond securities or bond categories. These categories include but are not limited to: specific bond securities, a generic bond security, bond sector allocations, bond index allocations, bond rating allocations, and bond issuer allocations. As before, there are additional columns to input the Portfolio Amount 1556, and the Portfolio Quantity 1558, and to view the market value of each category's Actual holdings Amount 1560, or Actual holdings Quantity 1562. A One Week Percentage Change column 1564 is provided to allow the user to view the percentage change in the value of each bond category or security over a given period of time.

The Position Guide bond portfolio amount settings allow a user to specify limits on the total market value or total quantity of specific bond securities, bond ratings categories, bond sectors, and other bond categories.

The Position Guide may require a third party data source to provide category data to properly categorize and allocate a given bond security and value. For example, the third party data may identify the bond rating of a given bond symbol.

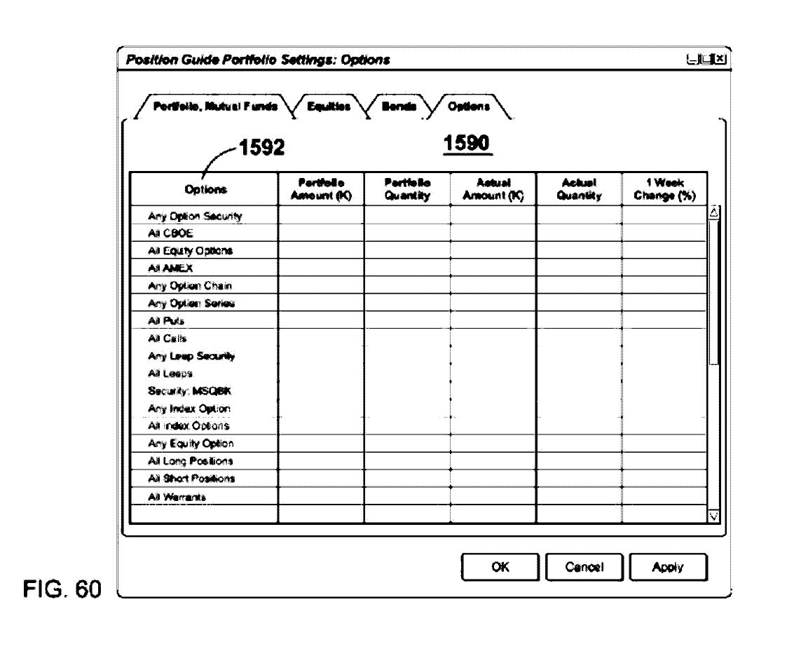

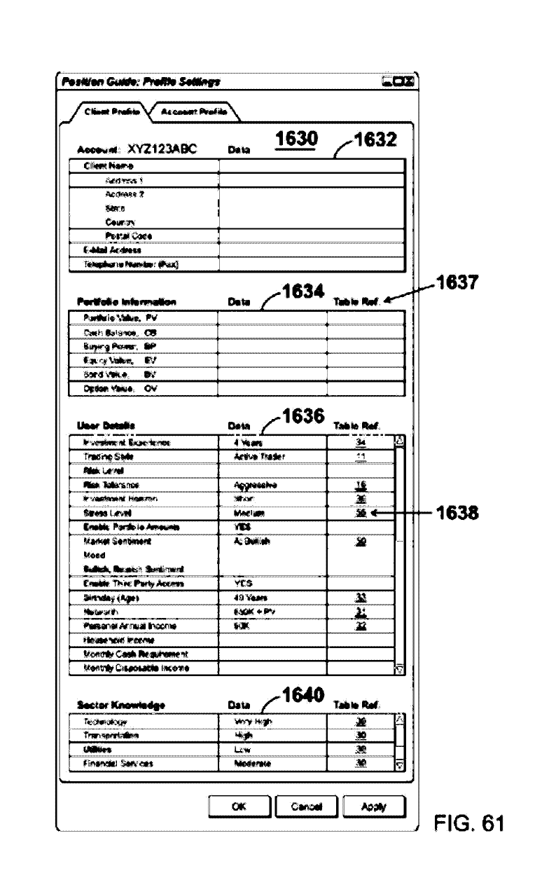

FIG. 60 is representative of the Position Guide Portfolio Settings Options panel. The panel presents a user interface method of specifying and allocating portfolio amounts for option securities and options related categories. The Options tab page 1590 presentation, layout, and configuration method is similar to that of the tab layouts of FIGS. 58 and 59.

The first column 1592 lists the portfolio's option securities or option categories. These categories include but are not limited to: a specific option's security, a generic option security, option sector allocations, option class allocations, and option exchange allocations. There are additional columns for Portfolio Amounts and Portfolio Quantities and Actual Amounts and Actual Quantities as described previously.

The Position Guide options portfolio amount settings allow a user to specify limits on the total market value or quantity of specific option securities, option class allocations, option types, and other option categories.

The Position Guide may require a third party data source to provide category data to properly categorize a given option security. For example, the third party data may identify whether a given option symbol is an index option or an equity option, a put or a call option.

It should be understood that a single tab page may be used to allocate portfolio amounts for all asset classes and security types displayed in FIGS. 57 to 60. The tabbed segregation of securities according to their asset class is for the convenience of the user. Similarly, a tabbed segregation of securities according to their asset class may also be used to allocate funds for single trade buy, sell, or short amounts.

FIG. 61 is representative of the Position Guide Client Profile Settings tab 1630. The purpose of the PG Client Profile Settings tab is to allow the user to access and modify personal, account, and PG settings data that may change or require review on a regular basis. The Account section 1632 allows the user to access and change their personal contact details. The Portfolio Information section 1634 details the market value of specific securities, sectors, asset classes, and the user's cash balance and buying power. The User Details section 1636 details the user's personal financial data, trading preferences, Position Guide market and risk sentiment settings, and the like. Data is entered, displayed, and modified in the second column, the data column of each section.

The third column, the Table Reference column 1637 cross references the data shown in the Data column to the Position Guide table interfaces which utilize and access the data. More than one table or plug-in may access the data shown. Any table numbers shown 1638 may hyperlink to the actual plug-in or table interface for the user's convenient reference. Sector Knowledge section 1640 records and stores the user's knowledge of specific securities, sectors, and asset types. Specific Position Guide plug-ins and tables, for example, Table 30, use such data. It should be understood that data from all Client and Account Profile tabs may be made available to or accessed by authorized third parties in conjunction with the Position Guide's third party analysis, accessibility, and control features.

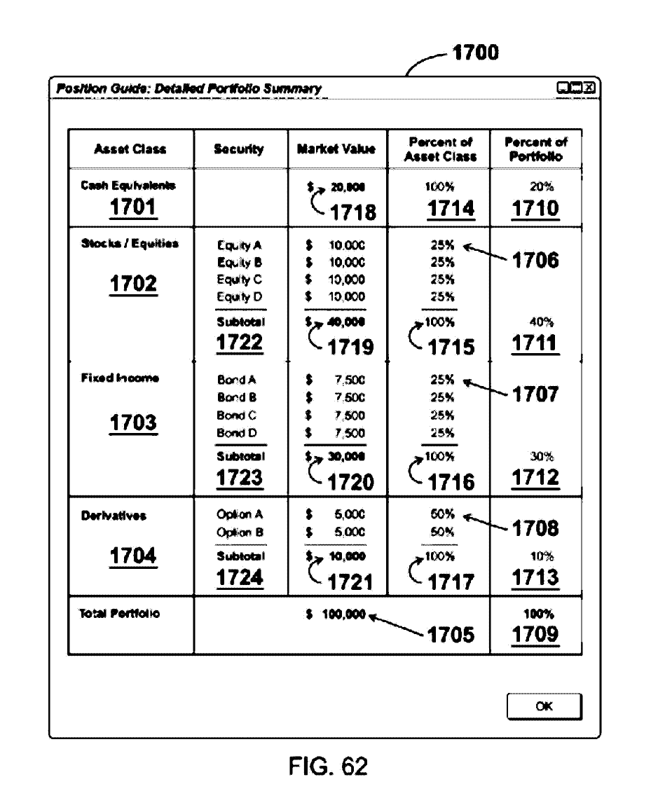

FIG. 62 is representative of the Position Guide Detailed Portfolio Summary panel 1700. The purpose of the Detailed Portfolio Summary of the user's investment account is to breakdown and identify total and subtotal values of the portfolio or a given asset class in dollar amounts, and percentage terms for convenient reference. There are four asset classes shown: Cash Equivalents 1701, Stocks/Equities 1702, Fixed Income securities 1703, and Derivatives 1704. Each asset class, 1701, 1702, 1703, and 1704, has a market value associated with it, 1718, 1719, 1720, and 1721 respectively.

The overall portfolio value 1705, for example, is composed of $20,000 in Cash Equivalents, $40,000 in Stocks/Equities, $30,000 in Fixed Income securities, and $10,000 in Derivative products. The total market value 1705 of all four asset classes is $100,000. This $100,000 amount represents the overall Portfolio value of the user's account.

The portfolio inventory includes four Equity securities 1722, four Fixed Income securities 1723, and two Option securities 1724. Each Equity security has a market value of $10,000 which represents 25% 1706 of the total market value 1719 of the Stocks/Equities asset class. Each Fixed Income security has a market value of $7,500 which represents 25% 1707 of the total market value 1720 of the Fixed Income asset class. Each Option security has a market value of $5,000 which represents 50% 1708 of the total market value 1721 of the Derivatives asset class.

The overall portfolio value 1705 may serve as a percent reference amount or base 1709 for certain PG calculations. The proportion of each asset class 1701, 1702, 1703, and 1704 to the overall Portfolio value is shown in sections 1710, 1711, 1712, and 1713 respectively. Thus, it can be seen that 20% of the portfolio's total value is in Cash Equivalents 1710, 40% of the portfolio's total value is in Stocks/Equities 1711, 30% of the portfolio's total value is in Fixed Income securities 1712, and 10% of the portfolio's total value is in Derivative products 1713.

There are five key 100% reference points in FIG. 62 which may serve as a percentage reference PG percentage based calculations. There are four 100% reference points for each asset class, 1714, 1715, 1716, 1717 and one 100% reference points for the overall Portfolio value 1709. The use of percentage reference points allow percentage units to be converted to dollar amounts and thus share amounts for use in the Position Guide or plug-in table interface settings.

It should be understood that the overall value of specific securities, sectors, index components, the user's buying power in a margin account, and the cash balance may also be used as a percent reference amount or base of 100%.

The Position Guide may be configured to allow any dollar amount or quantity amount to serve as a percentage reference of 100%. The underlying dollar value or share value of a percentage based PG setting or calculation may fluctuate as market conditions change and this may dynamically change the Position Guide's Output quantity recommendation in real time.

### Position Guide Tables

The Position Guide (PG) assists the user with determining a practical quantity of a security to buy, sell, short, and the like. The flexible nature of the Position Guide allows the user to allocate funds or shares to a given trade based on a wide variety of criteria and money management principles.

As mentioned, the table or table interface is a first preferred method of giving the user a way to edit and configure the trading rules, formulas, heuristics, and the like, which are encapsulated by plug-ins. Specific decision parameters are categorized in easy to use tables and such parameters assist with determining the PG Output quantity. Plug-ins with computational logic may receive and retrieve data from both the PG and external data sources such as from a Third party over the Internet.

The use of “tables” or “table interface” is just one of several user interface styles that may be employed to facilitate the task of setting up and editing trading rules, formulas, heuristics, etc. The terms “table” and “table interface” are used interchangeably and refer to the first preferred method of implementing the visual manifestation or graphical interface of a plug-in. A plug-in may contain one or more tables and other graphical interface components, computation logic, and plug-in preference data.

A convenient method of displaying, editing, and configuring Position Guide settings and criteria is shown in the plug-in table interfaces of FIGS. 63 to 76. Position Guide settings and criteria may be configured through the use of such interactive tables. The visual appeal and ease of categorizing and editing input and output values in a table is apparent, however it should be understood that many Position Guide settings and criteria may also be configured and adjusted through the use of formulas, a scripting language, or a built-in plain-English programming language.

The table configuration and settings data may be used as part of the main Position Guide tool, serve as part of a plug-in module or software object, or provide data to a hybrid programming approach. A user configures the tables in a manner similar to the following mathematical expression: If the value of “X” is between “X1 and X2”, invest “Y” amount. The visual arrangement of the table, and its rows, columns, and cells, allow convenient cross-reference from a given plug-in input value to its corresponding output value.

The user may use and configure pre-defined or customized tables to assist in determining the quantity parameter of a given trade. In addition to assisting with a specific trade or order, a table may also be used to set a limit on the overall quantity or dollar value of a security or asset class in a user's portfolio. The table output column settings allow the PG to distinguish between an investment amount for a particular trade, and a portfolio amount limit for a security or security category in an overall portfolio.

Tables may use settings data that identify: a cash amount, a margin or buying power amount, an asset class, a portfolio value; a security symbol, price, volume, or related parameter of a specific security, a group of securities, an index, a component of an index, a sector, an industry group, or an exchange; an order type such as a buy order, a sell order, a short order, an equities order, a futures order, a bond order, an options order, a derivatives order, or a mutual fund order; a security listed on a specific exchange, a market parameter, a technical indicator, a financial ratio, a company's fundamental data, economic data, a trading parameter, a performance parameter, a volume parameter, a last trade price, a high price, a low price, or the number of trades; data involving a date, a time, a time interval, an average, or a statistical measure; data involving the performance of a trader, a security, or a portfolio; a volatility value, a liquidity value, a market sentiment value, and the like.

Each table provides an investment amount output that is used to help derive the PG Output quantity recommendation for a given transaction. The table output can be configured for a number of order types and output units. For example, the table output may be a quantity of share units, lot units, contracts units, bond units, an intermediate quantity unit, a dollar denominated amount, an amount in a given currency, or a percentage of a reference amount or quantity. All or a portion of each table's output may contribute to the PG Output quantity of a given transaction.

It is desirable for a table to output a value in the amount or quantity unit most relevant for a given trade. For example, a table used for an equity buy order, may be configured to output the table amount in “share” units. Dollar amounts may also be used as table output values. The funds in an investor's account are finite and allowing an investor to configure a t—output amount in dollar terms provides a convenient reference for the user. A dollar denominated table output amount or a final investment amount divided by the security's relevant unit price results in the corresponding quantity of the security. For example, if the output for a table is $10,000 and the relevant security price is $50 per share, then the PG would interpret the $10,000 dollar output value as an equivalent table output of 200 shares. In this manner, the PG may adapt to and work interchangeably with many different table output amounts, quantities, percentage units, and formats.

A Percentage amount may also serve as an output value of a table. The table settings allow the Position Guide to reference the percentage amount to a base reference amount. The percentage value may be referenced to a specific dollar value or a specific share amount. For example, a table may output a value of 15%. If the percentage value is referenced to the Buying Power of an account, and the Buying Power of the account is $120,000, then the PG would interpret the 15% output as a table output amount of $18,000. As before, the PG may adapt to and work interchangeably with many different table output amounts, quantities, percentage units, and display formats.

As a further example of the use of percentage values, consider a plug-in table configured for equity securities and sell orders. Assume the table output value is 25%. If the percentage value reference's to the share inventory of a given security in a user's portfolio, and the total share holdings in the user's portfolio for the given security is 2000 shares, then the PG would interpret the 25% table output value as a table output of 500 shares. Although the table output amount, in this example, is in share units, the Position Guide may transform the share output to an equivalent dollar amount or percentage unit to derive its PG Output quantity recommendation.

Tables may output an amount intended for a specific trade, or output an amount intended to limit the value, quantity, or percentage of a given security within the overall portfolio. When a security's total market value or total shares in inventory exceeds its portfolio amount setting, the PG Output recommendation is reduced to maintain the security's value within its overall portfolio amount setting.

The term “Portfolio” in the table output column header area identifies amounts intended to represent a portfolio amount setting. Not all input data types and their associated tables are suitable to output table amounts for both a specific trade and a portfolio amount setting. As with a specific trade amount, a portfolio amount output may be in terms of a dollar amount, a share amount, or a percentage amount. When a percentage amount is output for a portfolio amount, the base reference may be the value of the underlying portfolio or any identifiable absolute amount.

FIG. 63 displays a representative sample of PG interface tables 1805, their use, and configuration as may pertain to a security's trading price used as the input data. The price of an equity security may determine the amount allocated to an equity order. Similar tables may also be configured for bond prices, option prices, or other security prices. Text labels assist in identifying the various input and output data, and the configuration settings of the table.

Table 1, 1800 is a typical presentation of a table configured to output an investment amount for a trade based on the PG Input security's trading price. The table is configured to output a value for “ANY” equity security 1801 without restriction. Each plug-in table interface is assigned a number and possesses a title area 1802 for identification. The PG input security's price data is arranged according to its price range category in cells below the input column header 1804. The table output amounts are listed under the table output column header 1806. Each table output amount corresponds to its respective input row and its associated input price range category.

The table output amount is based on the last price of the PG input security. For example, if the PG input security is priced over $50 a share, an amount of $14,000 is output from the table for subsequent processing. If the PG input security price is between $10 and $20 a share, an amount of $10,000 is output from the table. The bottom row 1808 electively displays configuration data and indicates that the table's specific trade amount is configured for equity orders and the table output amount is in Dollar denominated units.

Table 2, 1810 is similar in function to Table 1 with the exception that the table output value is a percentage amount of a base reference value. A percentage units table output value is associated with a reference or base amount 1812. In the case of Table 2, the percent reference amount is the available Buying Power 1814 in the user's account. For example, if the user's buying power is $120,000 and the PG input security's last price is $40, the corresponding 30% table output represents a dollar denominated table output amount of $36,000.

Table 3, 1816 is similar in function to Table 1 with the exception that the table output value is a share quantity amount 1818 of the PG input security. It should be understood that the ability to configure PG tables with their corresponding output values stated in Dollar amounts, percentage amounts, share amounts, and the like, is to enhance the flexibility and utility of the interface for the user. The Position Guide may convert some or all table output values into one or more standardized units for its internal calculations. The final PG Output quantity as displayed within the PG icon is defaulted to a quantity amount. However, the PG Output unit displayed may be changed to suit each individual user. For example, a trader with a large account may choose to display the final PG output in lot units. One (1) lot typically equates to 100 shares.

Table 4, 1820 is similar in function to Table 1 with the exception that the table output amount 1822 represents the portfolio amount value. The portfolio amounts listed 1822 in Table 4 limit the market value of the equity security holdings corresponding to each price range category to the portfolio amount specified. Note that as the inventory security prices raise or fall in value, the market value associated with the security in the user's portfolio also raise or fall. This price variation may result in Actual amounts 1824 which are higher than the specified portfolio amount limit 1822. Manual override of the PG Output quantity may also result in Actual amounts 1824 that are higher than the user specified portfolio amount limit 1822.

To the right of the portfolio amount column 1822 is the actual amount column 1824 which lists the actual real-time value of all equity securities in inventory for a given input stock price category. A difference column 1826 is typically shown to display the difference between the user's original portfolio amount setting and the actual market value of the various equity securities for a given input criteria. Actual market prices fluctuate over time and may affect the market value and asset allocation of a portfolio.

Most tables such as Table 4 may be configured for option or bond securities as well. Table output columns have be configured for each asset class or a single column may be used for more than one asset class. Multiple table output columns give the user additional flexibility to tailor investment amounts and portfolio amounts for a specific security, sector, index, input category, exchange, or asset class. Table 4 also displays the market value of all equity securities in the portfolio 1828.

Table 5, 1830 is similar in function to Table 4 with the exception that the table output amount 1831 represents a percentage portfolio amount. The percentage portfolio amounts listed 1831 in Table 5 limit the percentage weight of the equity security holdings value corresponding to each security price range category to the percentage of the portfolio equity value specified.

The percentage reference value for Table 5 is the market value of the equity securities in the portfolio 1832. When percentage units are used in a table output column, the sum of the various percentage weights need not equal 100% as displayed 1834 in the case of Table 5. For example, if the percentage reference value was the cash balance in the user's account rather than the portfolio's Equity Value, the sum of the percentages in the portfolio amount column 1831 may well exceed 100% if the cash balance is small relative to the overall portfolio's equity holdings value.

Table 6, 1836 is similar in function to Table 4 with the exception that the table output amount 1838 represents a share quantity portfolio amount. The share quantity portfolio amounts listed 1838 in Table 6 limit the share quantity of the equity security holdings corresponding to each price range category to the portfolio amount specified. For example, in Table 6, the user has set an upper limit of 1800 shares in his portfolio for all equity securities that trade over $50 a share. Table 6 shows that the user currently has 1750 shares of equity stock that trade over $50 a share.

Tables 4, 5, and 6 show that by configuring table output amounts as share quantity amounts, dollar amounts, or percentage amounts, the user may diversify his equity security holdings according to equity price levels in a variety of output units. When the PG encounters a situation where a user is already fully invested in a given security, and investing more would violate a portfolio amount setting for a given table, the PG Output quantity may be reduced to zero and/or an alert box (see FIG. 93) would appear indicating that a further investment is not advised.

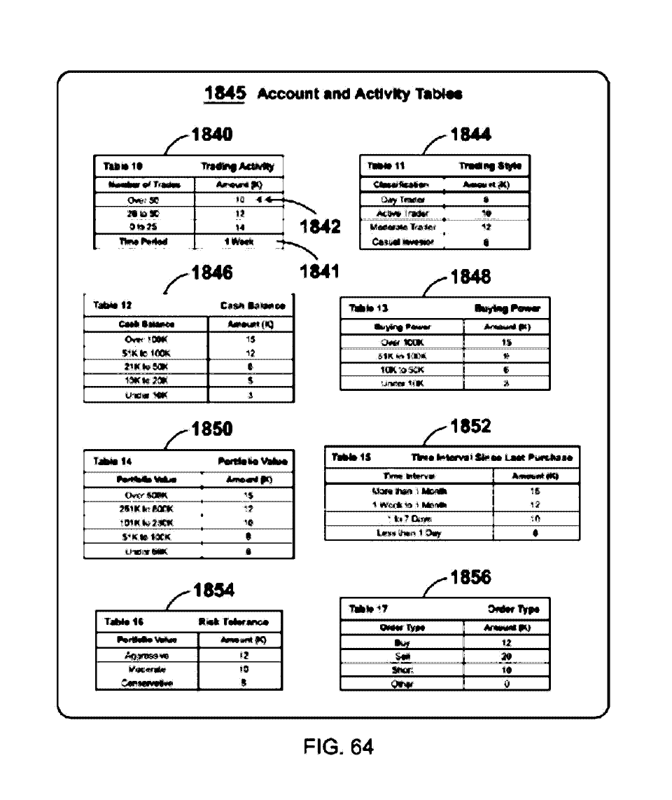

FIG. 64 displays a representative sample of PG table interfaces 1845, their use, and configuration as may pertain to a user's account or activity level.

Table 10, 1840 is a typical presentation of a table configured to output an investment amount based on the number of trades a user has done over a given time period 1841. Table 10 is configured to output a higher investment amount if the user is less active. For example, if the user has traded over 50 trades during the past week 1841, the table is configured to output an investment amount of $10,000.

A visual indication 1842 is used to show the relevant input category row and the investment amount which is output from the table for a given table configuration and its input data. It should be understood that the function of Table 10 is based on the activity level of a user's account, not on some parameter of the PG input security. A similar table may be configured for the user's trading activity of a specific security, sector, asset class, exchange, and the like.

Table 11, 1844 is a typical presentation of a table configured to output an investment amount based on a classification of the user's trading style. For example, if the user, his brokerage, the PG, or a third party has classified the user as a day trader, $8,000 is allocated as the table output amount.

Table 12, 1846 is a typical presentation of a table configured to output an investment amount based on the Cash balance in a user's account. The table is configured in such a manner, that the higher the cash balance, the higher the output amount of the table.

Table 13, 1848 is a typical presentation of a table configured to output an investment amount based on the Buying Power in a user's account. The table is configured in such a manner, that the higher the Buying Power, the higher the output amount of the table. This allows the user to trade a number of times before his Buying Power has diminished to the point where his buying activity must stop.

Table 14, 1850 is a typical presentation of a table configured to output an investment amount based on the market value of a user's Portfolio. The table is configured in such a manner, that the higher the Portfolio value, the higher the output amount of the table. The table may also be configured based on the market value of a specific asset class such as the equity or bond asset class.

It should be understood that Tables 12, 13, and 14 may be configured for percentage based table output amounts. The percentage reference amount may be the users cash balance, buying power, or portfolio value as referred to in Tables 12, 13, and 14 respectively. Although most tables are configured for a buy order, the table output amount and output column(s) may be configured for a sell, short, or other order as well.

Table 15, 1852 is a typical presentation of a table configured to output an investment amount based on the length of time between trades. Table 15 is a variation on the activity allocation method of Table 10. The less time between a user's trades, the lower the investment amount allocated to each trade.

Table 16, 1854 is a typical presentation of a table configured to output an investment amount based on the Risk Tolerance category of the user. The more tolerance a user has to risk, the larger the table output amount. Although a user may arbitrarily categorize his risk tolerance in the Profile Settings panel of FIG. 61, the PG or a third party may also provide an assessment of the user's risk tolerance by analyzing his trading activity and the volatility of his account.

Table 17, 1856 is a typical presentation of a table configured to output an investment amount based on the order type of the transaction. For example, if the order type is a buy order, the table output is $12,000.

When the table or its column(s) settings are configured, there is considerable flexibility for the user to select the time period, the input value range, the number of categories, the output amounts, the output type, its units and formatting, the order type, and the table or column's use criteria be it for a specific security, asset class, index class, and the like. The table or it's output column(s) may be configured to pertain to any order type and asset class or to a specific order and asset class, for example, an equity buy order. This level of flexibility is generally available for all table configurations.

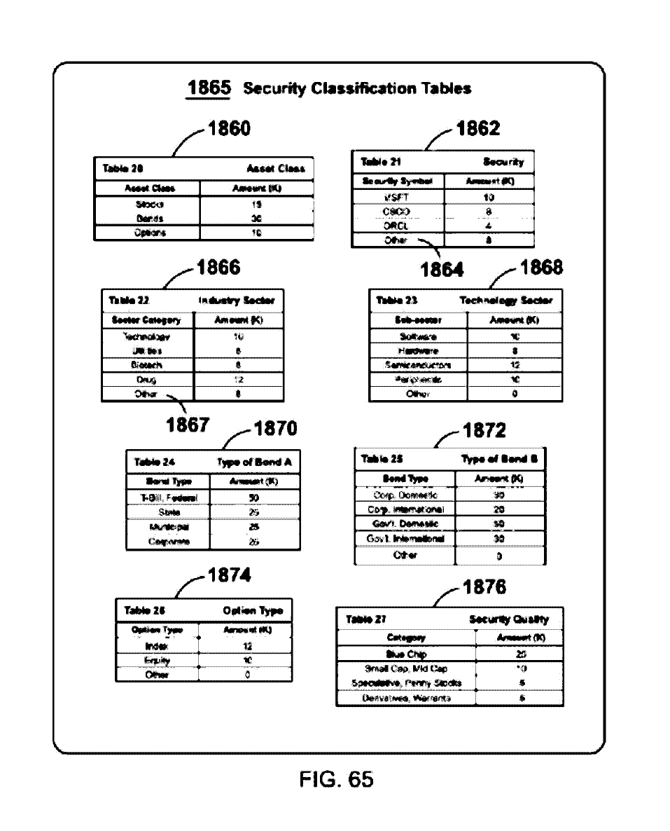

FIG. 65 displays a representative sample of PG table Interfaces 1865, their use, and configuration as may pertain to a PG input security's asset or category classification.

Table 20, 1860 is a typical presentation of a table configured to output an investment amount based on the asset class of the PG input security. The user may adjust the table output amount in relation to the risk level or his experience level associated with each specified asset class. Related financial instruments such as mutual funds and warrants may be included as an asset class. Asset classes may be combined and displayed in one category row, or allocated distinct category rows and table output amounts.

Table 21, 1862 is a typical presentation of a table configured to output an investment amount based on the symbol of the PG input security. Securities that the user has a preference for may be allocated a higher table output amount. Table 21 may be configured for an unlimited number of symbols and their respective table output amounts. Investment amounts for different order types may be displayed in their own table output columns.

The “Other” input category 1864 allocates a default investment amount for those securities that are not listed in the table's input category area. Entering a zero value as the table output amount of the “Other” input category row 1864 disables the PG recommendation for securities not specifically listed in the input column of the table.

Like all tables, Table 21 may be purposely restricted in scope by configuring it for a specific order type or asset class. It should be understood that Table 21 resembles the settings area of the Direct Output Settings panel of FIG. 55 and the Portfolio settings: Equities panel of FIG. 58. An alternate table may be configured by the company's name rather than its security symbol.

Table 22, 1866 is a typical presentation of a table configured to output an investment amount based on the PG input security's industry or sector group. Industry or sector groups that the user has a preference for may be allocated a higher table output amount. The table may be configured for an unlimited number of sector groups and output amounts.

The “Other” input category 1867 allocates a default output amount for those industry or sector groups that are not listed. Entering a zero value in the output column of the “Other” input category disables the PG recommendation for industry and sector groups not listed in the input column of the table. The table output column may be purposely restricted in scope by configuring it for a specific order type, asset class, or the like.

Table 23, 1868 is a typical presentation of a table configured to output an investment amount for a trade based on the industry sub-sector group of the PG input security. Sub-sector groups that the user has a preference for may be allocated a higher table output amount. The table may be configured for an unlimited number of sub-sector groups and output amounts.

Table 24, 1870 is a typical presentation of a table configured to output an investment amount for a bond transaction based on the bond type of the PG input security. Bond types that the user has a preference for may be allocated a higher table output amount.

Table 25, 1872 is a typical presentation of a table configured to output an investment amount for a bond transaction based on an alternative bond classification of the PG input security. Bond types that the user has a preference for may be allocated a higher output amount. The “Other” input category allocates a default table output amount for those bond categories that are not listed in the table.

Table 26, 1874 is a typical presentation of a table configured to output an investment amount for an options trade based on the option type category of the PG input security. Index or Equity option types that the user has a preference for may be allocated a higher table output amount. The “Other” input category allocates a default table output amount for any option categories that are not listed in the table.

Table 27, 1876 is a typical presentation of a table configured to output an investment amount for an equity or derivative trade based on a security quality classification of the PG input security. Security quality categories that the user has a preference for may be allocated a higher table output amount. A third party or brokerage firm may provide the quality classification data to Table 27 for each PG input security.

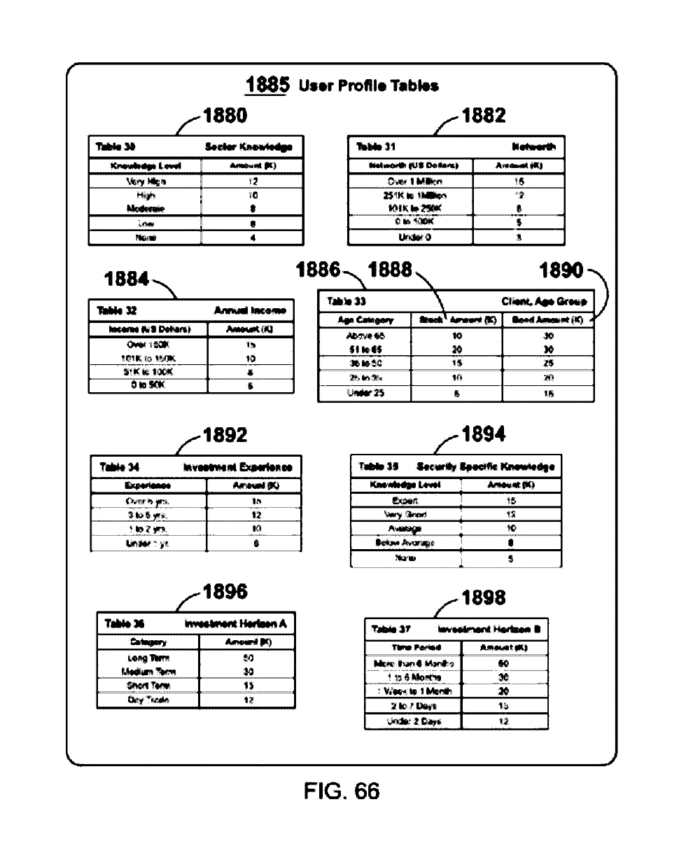

FIG. 66 displays a representative sample of PG table interfaces 1885, their use, and configuration as may pertain to a user's profile information. Many of the tables derive their input from the PG Profile Settings panel of FIG. 61. The user may choose to change his profile data from time to time and such changes may affect the input data and table output amounts of the user profile tables.

Table 30, 1880 is a typical presentation of a table configured to output an investment amount based on the user's knowledge of the specific sector to which the PG input security belongs. The table is configured to output an amount according to the knowledge or experience level the user has in a given sector. Sector by sector knowledge may be assessed and entered by the user in the client profile settings tab of FIG. 61.

Table 31, 1882 is a typical presentation of a table configured to output an investment amount based on the networth of the user. The user may set his networth in the client profile settings tab of FIG. 61. The portion of the user's networth derived from his portfolio value may change dynamically to reflect real-time market values.

Table 32, 1884 is a typical presentation of a table configured to output an investment amount based on the annual income of the user. The user may set his annual income level in the client profile settings tab of FIG. 61. A similar table may be configured for the overall family or household income.

Table 33, 1886 is a typical presentation of a table configured to output an investment amount based on the age of the user. The table is configured with two table output columns. The asset class of the PG input security determines which output column is used. The table output amount is derived from the “Stock” column 1888 if the PG input security is an equity security, and from the “Bond” column 1890 if the PG input security is a bond security. As the age of the user increases, the investment amount directed toward bond securities relative to equity securities changes. For tables in general, additional output columns may be added to allocate specific investment amounts according to asset class, order type, a portfolio amount limit, and the like.

It should be understood that it is possible to construct complex multiple dimension tables or arrays, which output an investment amount based on a complex multi-variable model or formula. However, an important aspect of the Position Guide is its ease of use. Thus, the use of 2 dimensional table interfaces are intended for simplicity. A single input variable is categorized in a row of the table and the corresponding output investment amount helps to derive the PG Output quantity recommendation for a given PG input security.

Table 34, 1892 is a typical presentation of a table configured to output an investment amount based on the investing experience of the user. The user's experience is categorized according to the length of time the user has been investing or trading in securities. The more investing experience the user has, the higher the table output amount. An alternate table may assess the user's investing experience using the input category list of Table 35.

Table 35, 1894 is a typical presentation of a table configured to output an investment amount based on the user's experience or knowledge level of a specific security or sector. The user may be prompted by the PG to enter his experience level on each security or sector the PG encounters. The user may also enter this data on specific securities and sectors in the PG Profile settings panel. All user data is retained by the PG and may be reviewed and edited at the user's convenience. The more specific security experience the user has, the higher the table output amount. An alternate table may assess the user's security knowledge using the input category list of Table 34.

Table 36, 1896 is a typical presentation of a table configured to output an investment amount based on the user's Investment Horizon. The shorter the user's investment time horizon the lower the investment amount output from the table. The investment horizon input for a given PG input security may be stated according to one or more of the following categories: its security symbol, asset class, index class, sector, industry, or listing exchange.

The user may be prompted, as in Table 35, by the PG to enter his investment horizon on each security or sector the PG encounters. The user may also enter this data on specific securities and sectors in the PG Profile settings panel. The user may also configure different output columns as his table output amounts may vary according to order type, asset class, or some additional output criteria.

Table 37, 1898 is a typical presentation of a table configured to output an investment amount based on an alternative input category system for the Investment Horizon. As in Table 36, the shorter the user's investment horizon the lower the investment amount output from the table. The table output column may be configured for any PG input security and order type or for a specific input security category and order type.

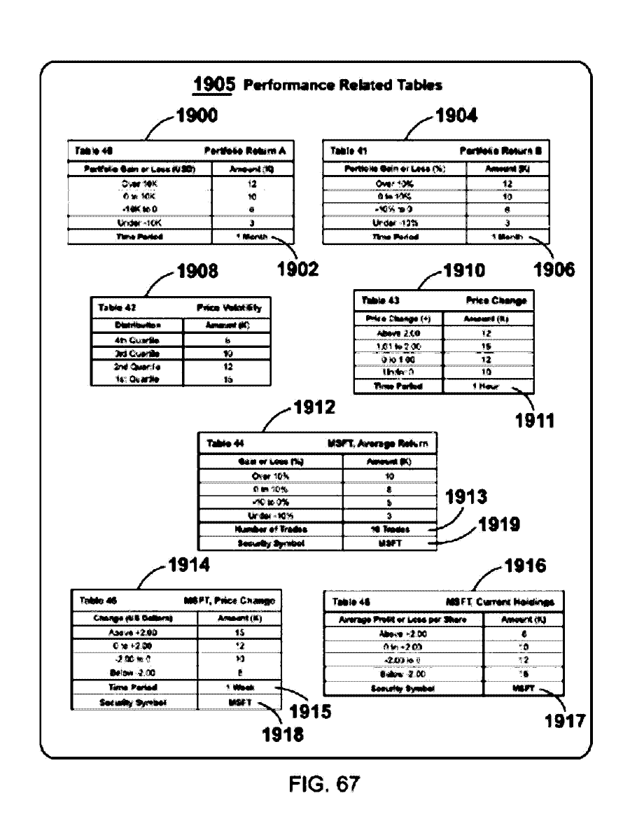

FIG. 67 displays a representative sample of PG table interfaces 1905, their use, and configuration data as may pertain to a user's portfolio performance or a security's price performance.

Table 40, 1900 is a typical presentation of a table configured to output an investment amount based on a portfolio's dollar gain, or dollar loss, over a given time period 1902. The table output amount increases as the portfolio's dollar gain over a given time period increases. The time period 1902 over which the portfolio's dollar gain is calculated may span from minutes to years.

Table 41, 1904 is a typical presentation of a table configured to output an investment amount based on a portfolio's percentage gain or loss over a given time period 1906. The table output amount increases as the portfolio's percentage gain increases.

Table 42, 1908 is a typical presentation of a table configured to output an investment amount based on the PG input security's price volatility relative to other securities categorized in a distribution. The higher the price volatility of the security relative to other securities, the lower the table output amount. An alternate table may be configured for the actual volatility value of a security or an index.

Table 43, 1910 is a typical presentation of a table configured to output an investment amount based on the price change of the PG input security over a given time period 1911. The more positive the price change of the security over the time interval, the higher the table output amount. Table 43 may also be configured to use a percentage based measure of the price change value.

Table 44, 1912 is a typical presentation of a table configured to output an investment amount based on the user's average return on a select security 1919 over a specified number of trades 1913. The table input data is the user's average per trade percentage return for the select security 1919. The select security 1919 may also be the PG input security.

Table 44 is configured for a 10 trade average percentage return value 1913. The higher the average trading returns for the security 1919, the higher the table output amount. The table may also be configured to accept an average or overall profit or loss dollar value input.

Table 45, 1914 is a typical presentation of a table configured to output an investment amount based on the price change of a select security 1918 over a given time period 1915. The more positive the price change of the select security 1918 over the time period 1915, the higher the table output amount. If the select security 1918 is the PG input security, the function of the table is similar to that of Table 43. Table 45 may also be configured to use a percentage based price change value.

Table 46, 1916 is a typical presentation of a table configured to output an investment amount based on the average profit or loss per share of a select security 1917 currently in the user's portfolio holdings. As the average loss per share of a security increases, a larger amount is allocated as the table output amount.

For example, Table 46 is configured for the average profit or loss per share of Microsoft stock 1917 in the user's portfolio holdings. The select security 1917 may also be the PG input security, in which case, the table output amount is enabled only if the PG input security is represented or held in the user's portfolio. The table may also be configured to use a percentage based profit or loss value.

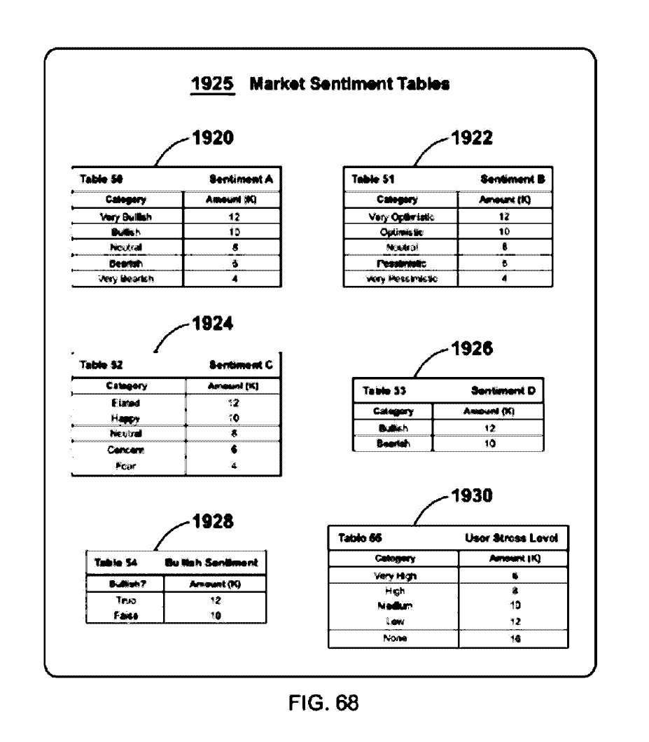

FIG. 68 displays a representative sample of PG table interfaces 1925, their use, and configuration as may pertain to a user's market sentiment. Market sentiment table settings may be configured manually by a user or automatically by a third party or expert system. The user may choose to adjust his market sentiment setting from time to time in the Profile Settings panel of FIG. 61. A user may also define a personalized list of market sentiment categories and allocate a table output amount for each input category.

Table 50, 1920 is a typical presentation of a table configured to output an investment amount based on a user's market sentiment setting. The more positive the user's market sentiment, the higher the table output amount.

Table 51, 1922 is a typical presentation of a table configured to output an investment amount based on a alternative classification of a user's market sentiment. The more positive the user's market sentiment, the higher the table output amount.

Table 52, 1924 is a typical presentation of a table configured to output an investment amount based on a second alternative classification of a user's market sentiment. The more positive the user's market sentiment, the higher the table output amount.

Table 53, 1926 is a typical presentation of a table configured to output an investment amount based on a simplified classification of the user's market sentiment. The table is configured to output a higher amount if the user has a bullish market sentiment.

Multiple table output columns may be configured for different investment amounts based on specific order type or asset class criteria. For example, if a user has a bearish market sentiment, he may choose to allocate a higher investment amount to a short order, relative to a buy order. A market sentiment table configured for two output columns, one for a buy order, and one for the short order permits the user to allocate separate investment amounts for each order type and market sentiment category.

Table 54, 1928 is a typical presentation of a table configured to output an investment amount based on a logical setting of the user's bullish market sentiment. If the user is bullish, the table input category value is “True”. The table is configured to output a higher amount if the user has a bullish market sentiment.

Table 55, 1930 is a typical presentation of a table configured to output an investment amount based on a user's stress level. A user may choose to trade lower amounts if they are under stress or distracted by personal issues. The higher the user's stress level category, the lower the table output amount. The user may choose to adjust the stress level setting from time to time in the Profile Settings panel of FIG. 61. Custom tables may be configured for other physiological or psychological factors that may affect a user's trading performance. Such factors include, but are not limited to the user's family commitments, financial concerns, work load, recent trading performance, distractions, preparedness, and level of rest.

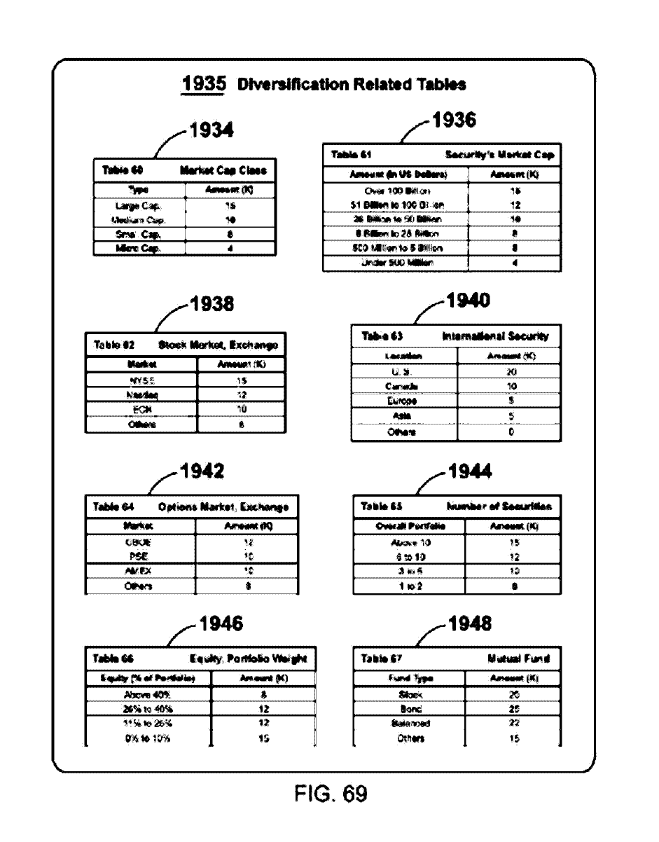

FIG. 69 displays a representative sample of PG table interfaces 1935, their use, and configuration as may pertain to the diversification of securities in a user's portfolio.

Table 60, 1934 is a typical presentation of a table configured to output an investment amount based on the market capitalization class of the PG input security. The larger the market capitalization class or category, the higher the table output amount.

Table 61, 1936 is a typical presentation of a table configured to output an investment amount based on the market capitalization value of the PG input security. The larger the market capitalization value, the higher the table output amount.

Table 62, 1938 is a typical presentation of a table configured to output an investment amount based on the exchange or market the PG input security is listed in. For example, if the security is listed on the “NYSE”, the table output amount is $15,000. The table output amount May be configured for a specific asset class such as equities.

Table 63, 1940 is a typical presentation of a table configured to output an investment amount based on the primary country the PG input security is listed in, or the location of the company's head office. For example, securities primarily listed in the U.S. may be allocated a higher table output amount.

Table 64, 1942 is a typical presentation of a table configured to output an investment amount for an option security based on the primary option market the PG input security is listed in. The table output amount may be configured for a specific asset class or order type.

Table 65, 1944 is a typical presentation of a table configured to output an investment amount based on the number of securities held in a user's portfolio. The more equity, bond, and option securities there are in a user's portfolio, the higher the table output amount.

Table 66, 1946 is a typical presentation of a table configured to output an investment amount based on the percentage of the portfolio's value which is attributed to the value of its equity securities. As the proportion of the equity asset class value increases relative to the overall portfolio value, the table output amount decreases.

Table 67, 1948 is a typical presentation of a table configured to output an investment amount for a mutual fund transaction based on the PG input mutual fund's type or asset mix. For example, if the mutual fund is a stock or equity fund, the table output amount is $20,000.

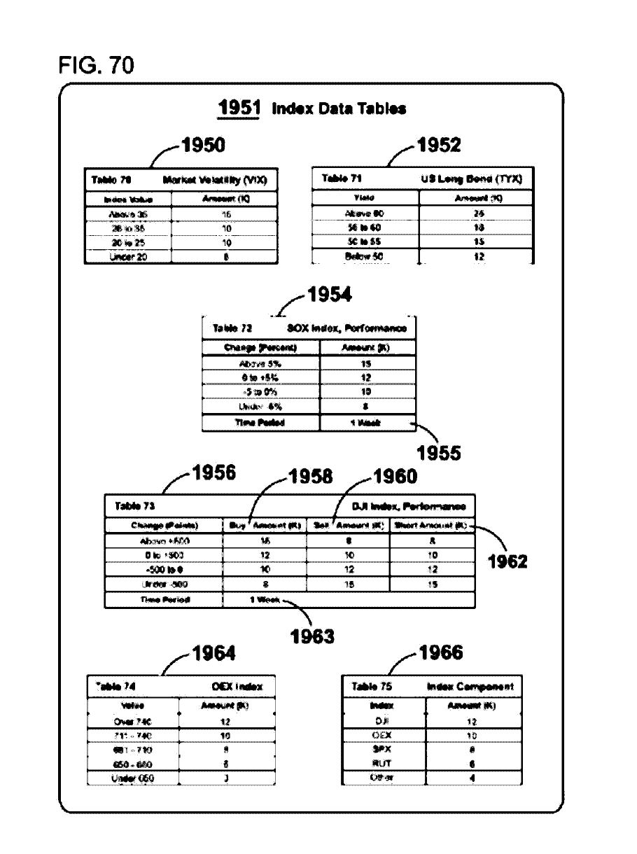

FIG. 70 displays a representative sample of PG table interfaces 1951, their use, and configuration as may pertain to Index related data.

Table 70, 1950 is a typical presentation of a table configured to output an investment amount based on the value of an index, VIX. The CBOE VIX index tracks the volatility of the S&P 100 index. For example, the higher the volatility value of the VIX index, the higher the table output amount, if the user chooses to use the VIX index value as a contrarian indicator.

Table 71, 1952 is a typical presentation of a table configured to output an investment amount based on the value of an index, TYX. The TYX index tracks the yield on the U.S. long bond. This type of table may use any kind of index and index value.

Table 72, 1954 is a typical presentation of a table configured to output an investment amount based on the percentage change of the SOX semiconductor index over a given time period 1955. This type of table may use any kind of index and index value.

Table 73, 1956 is a typical presentation of a table configured to output an investment amount based on the point change of an index, DJI, over a given time period 1963. The DJI index tracks the value of the Dow Jones Industrial index of 30 stocks. The table output columns are configured for a buy order amount 1958, a sell order amount 1960, and a short order amount 1962 respectively. The PG chooses the table output which corresponds to the PG Input security's probable transaction order type. This type of table may use any kind of index and index value.

Table 74, 1964 is a typical presentation of a table configured to output an investment amount based on the value of an index, OEX. The OEX index tracks the value of the S&P 100 index. The higher the value of the OEX index, the higher the table output amount. This type of table is similar to that of Tables 70 and 71, and may use any kind of index and index value. Similarly, the table may be configured to output an investment a mount based on the value or status of a technical indicator, a financial ratio, or related company or market data.

Table 75, 1966 is a typical presentation of a table configured to output an investment amount based on the index class the PG input security is a component of. The user may choose to allocate more funds to a PG input security which belongs to a benchmark index such as the DJI index, or the S&P 500 SPX index.

If the input security is a component of more than one index in the table, the table output amount corresponding to the highest ranked index is chosen. F or example, assume General Electric Co., GE, is the PG input security. GE is a component of both the DJI index and the OEX index listed in Table 75. Of these two indexes, DJI is the highest ranked index and its table output amount of $12,000 is chosen. Alternatively, the table output values corresponding to both index categories, DJI and OEX, may be averaged or weighed to determine the final investment amount output from Table 75 for PG input security GE.

FIG. 71 displays a representative sample of PG table interfaces 1971, their use, and configuration as may pertain to Technical Indicators, Financial Ratios, and Fundamental company data.

Table 80, 1970 is a typical presentation of a table configured to output an investment amount based on the status of a PG input security's 50 day moving average. If the PG input security's last price is above its 50 day moving average, a higher table output amount is output. Indicator names and comparison values may be entered in input areas 1973, 1975.

Table 80, like Table 54, may be configured for “True” and “False” logical categories if the input security is above its 50 day moving average. The table may also be configured to accept other moving average vales such as a 200 day moving average. Similarly, the table may be configured to output an investment amount based on the status of other “True/False” or “Positive/Negative” type indicators and measures.

Table 81, 1972 is a typical presentation of a table configured to output an investment amount based on the percentage difference between a PG input security's price and its 50 day moving average. The higher the percentage of the security's price above its moving average, the larger the table output amount. Similarly, the table may be configured to output an investment amount based on the percentage change in the value of any technical indicator, fundamental & market data, or financial ratio.

Table 81 demonstrates how an investment amount may be configured when a parameter of a security is compared with its average value. For example, a table may be configured to output an investment amount based on the percentage difference between the current volume and the average volume of a security over a time interval.

Table 82, 1974 is a typical presentation of a table configured to output an investment amount based on the length of time a company has been in business. The company is typically associated with the PG input security symbol. The data for this table may be provided by a third party on a subscription basis. The more established the company is, the higher the table output amount.

Table 83, 1976 is a typical presentation of a table configured to output an investment amount based on the year a company was established. The company is typically associated with the PG input security symbol. The data for this table may be provided by a third party on a subscription basis. The more established the company is, the higher the table output amount.

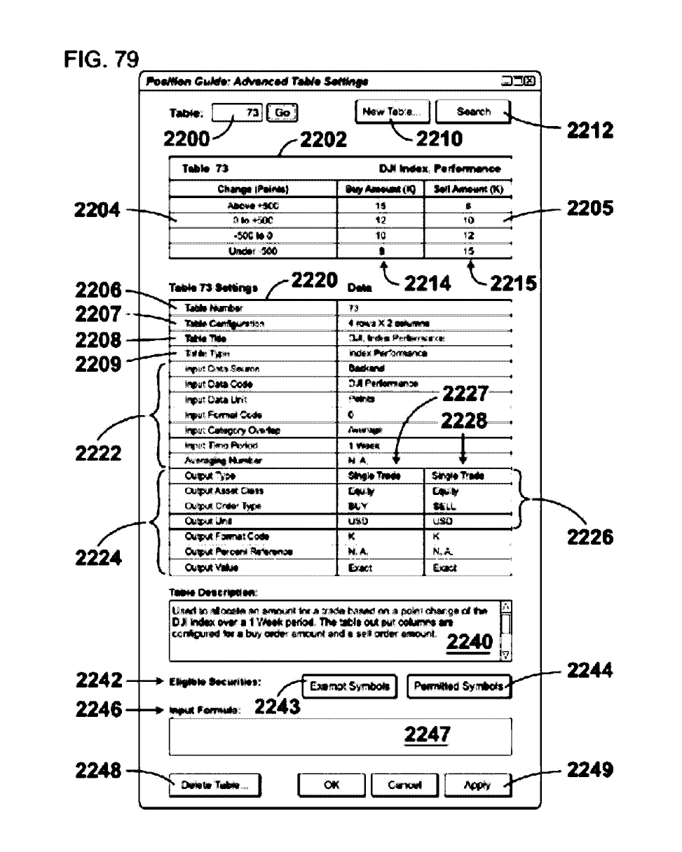

Tables 82 and 83 may utilize the same input data. A table formula or script may be used to transform the company's time data so that it may be used with the input requirements of the second table. A table formula is typically entered in a cell of the table interface or in formula area 2247 of the PG Advanced Table Settings panel of FIG. 79.

Table 84, 1978 is a typical presentation of a table configured to output an investment amount based on a financial ratio, such as the Debt to Equity ratio, of the PG input security. The lower the debt to equity ratio, the higher the table output amount. There are numerous financial ratios and business data one can derive from a company's financial statements that may serve as a data input to a table.

The following list includes without limitation, some of the common financial ratios that tables may be configured for: Current Ratio, Quick Ratio, Net Working Capital Ratio, Return on Assets (ROA), Return on Equity (ROE), Return on Common Equity (ROCE), Profit Margin, Earnings Per Share (EPS), Asset Turnover Ratio, Accounts Receivable Turnover Ratio, Inventory Turnover Ratio, Debt to Equity Ratio, Interest Coverage Ratio, Price to Sales Ratio, Price Earnings (PE) Ratio, Market to Book Ratio, Dividend Yield, Average Collections Period, Payables Turnover Ratio, Inventory to Net Working Capital, and the Return on Sales Ratio. A third party data provider typically provides the input financial data for a table.

Table 85, 1980 is a typical presentation of a table configured to output an investment amount based on the value of a custom or generic technical indicator. Typically the technical indicator values are related to the PG input security. There are hundreds of technical indicators which a table may use as input data.

The following list includes without limitation, some of the common technical indicators and market indicators that tables may be configured for: Accumulated Swing Index, Accumulation/Distribution Line, Advance Decline Line, Advance Decline Noncumulative, Advance/Decline Volume Line, Arm's Ease Of Movement, Arm's Short Term Trading Index (TRIN), Aroon, Average True Range, Bollinger Bands, Breadth Advance Decline Indicator, Call/Put Ratio, Chaikin Oscillator, Chande Momentum Oscillator, Commodity Channel Index, Commodity Selection Index, Comparative Strength Index, Correlation Analysis, Cycle Lines, Demand Index, Detrended Price Oscillator, Directional Movement Indicator, Dynamic Momentum Index, Ease of Movement, Envelope, Equivolume, Exponential Moving Average, Fast Fourier Transform Analysis, Forecast Oscillator, Haurlan Index, Historical Volatility, Inertia Indicator, Intraday Momentum Index, Klinger Volume Oscillator, Linear Regression Slope, Mass Index, McClellan Oscillator, Median Price, Momentum, Money Flow Index, Moving Average Convergence Divergence (MACD), Moving Average Difference Oscillator, Negative Volume Index, Odd Lot Balance, On Balance Volume (OBV), Overbought/Oversold Indicator, Performance, Positive Volume Index, Price Oscillator, Price Rate of Change, Price Volume Trend, Projection Oscillator, Qstick, Raff Regression Channels, Rate Of Change (ROC), Relative Strength Index (RSI), Relative Volatility Index, Return Home, r-squared, Simple Moving Average, Standard Deviation, Standard Error, Stochastic Oscillator, Support and Resistance Levels, Swing Index, Time Series Forecast, Time Series Moving Average, Trade Volume Index, Triangular Moving Average, TRIN (Short Term Trading Index), TRIX, True Range, Typical Price, Ultimate Oscillator, Upside/Downside Ratio, Variable Moving Average, Vertical, Horizontal Filter, Volatility, Volume Adjusted Moving Average, Volume, Open Interest, Volume Oscillator, Volume Rate of Change, Weighted Close, Weighted Moving Average, Williams' % R, and Williams Accumulation/Distribution. The technical input data for any table may be provided by a third party data provider, or the brokerage's backend system.

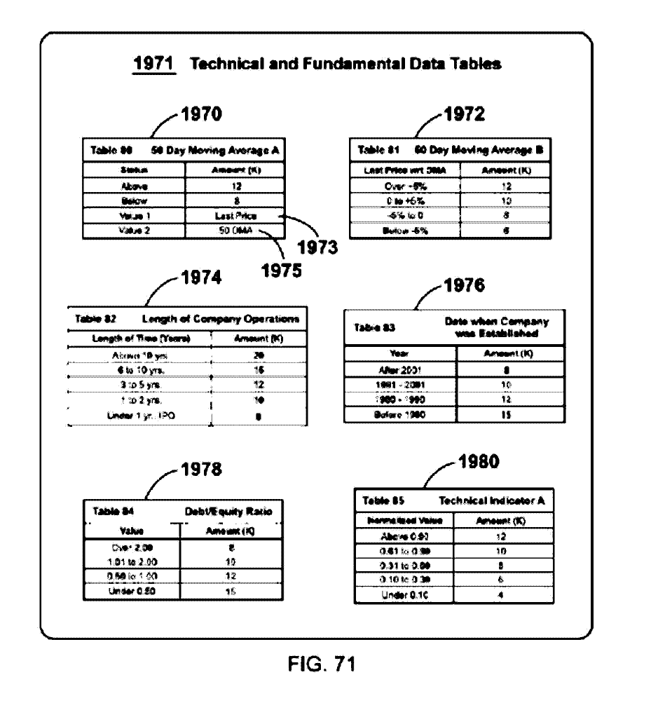

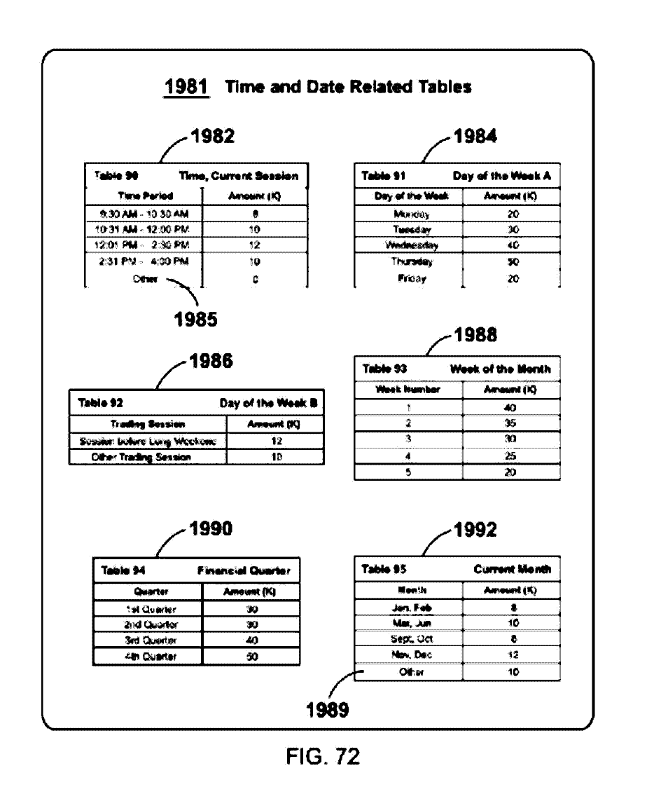

FIG. 72 displays a representative sample of PG table interfaces 1981, their use, and configuration as may pertain to a time or date parameter of an order or transaction.

Table 90, 1982 is a typical presentation of a table configured to output an investment amount based on the time during the trading session. A user may find from experience that certain times during the trading session are more profitable than other times for initiating a trade. The number of time categories and the begin time and end time of each category are fully adjustable within the table. A table input category may specify a time period and use the “Other” category term to indicate all “other” time intervals during the trading session or for extended trading hours.

Table 91, 1984 is a typical presentation of a table configured to output an investment amount based on the day of the week. A user may find from experience that certain days are more profitable for initiating a trade than other days. The number of days in each category and the number of categories are fully configurable within the table. The “Other” input category term may be used in the table.

Table 92, 1986 is a typical presentation of a table configured to output an investment amount based on the current trading session being the last trading session before a long weekend. A user may find from experience that initiating a trade on the day before a long weekend is more profitable than initiating a trade on a random day.

Table 93, 1988 is a typical presentation of a table configured to output an investment amount based on the current week of the month. A user may find from experience that certain weeks are more profitable for initiating a trade than other weeks. The number of the week in each category and the number of category rows are fully configurable within the table. The “Other” input category term may be used in the table.

Table 94, 1990 is a typical presentation of a table configured to output an investment amount based on the current quarter of the year. A user may find that certain quarters are more profitable for initiating a trade than other quarters. The number of quarters in each category and the number of category rows are fully configurable within the table. The “Other” input category term may be used in the table.

Table 95, 1992 is a typical presentation of a table configured to output an investment amount based on the current month of the year. A user may find that certain months are more profitable for initiating a trade than other months. The number of months in each category and the number of category rows are fully configurable within the table. The “Other” input category term 1989 may be used as well.

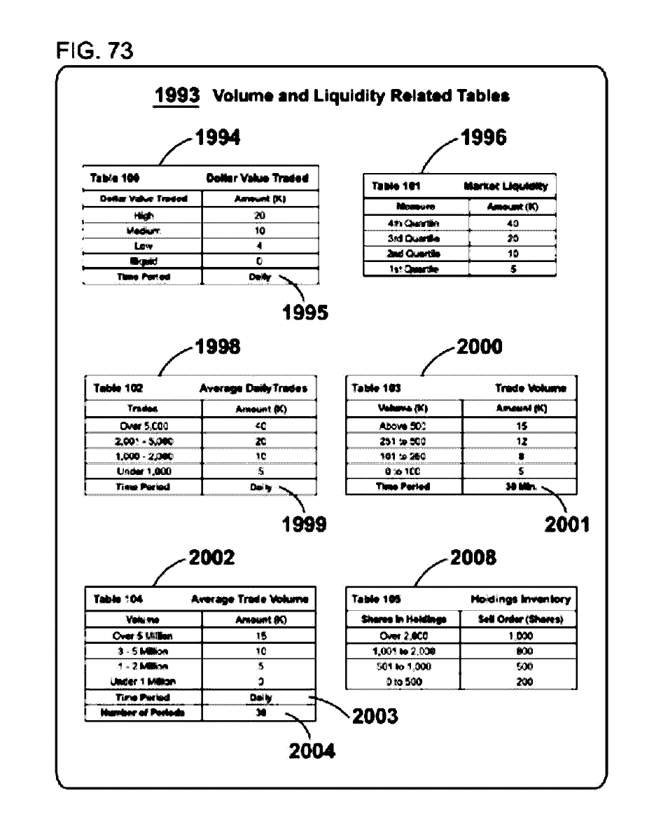

FIG. 73 displays a representative sample of PG table interfaces 1993, their use, and configuration as may pertain to a given security's volume and liquidity measure.

Table 100, 1994 is a typical presentation of a table configured to output an investment amount based on the average dollar value traded of a given security or its market over a selected time period 1995. The given security is typically the PG input security. The higher the average dollar value traded, the larger the table output amount. The dollar value traded data may be from a specific market or from a total of all markets where the security is listed for trading.

A table may also be configured for a given security's average trade value over a selected time period. The table may also be configured for the user's average order value traded of a given security or all securities over a selected time period. The number of time periods or trades used in the average calculation may be specified by the user.

Table 101, 1996 is a typical presentation of a table configured to output an investment amount based on a measure of the liquidity of a given security or its market. The given security is typically the PG input security. It should be understood that there are numerous statistical and technical measures of a security's liquidity or a market's liquidity and that such data may be supplied by a third party data source. The higher the liquidity for a security or market during a given trading session, the larger the table output amount.

Table 102, 1998 is a typical presentation of a table configured to output an investment amount based on the average number of trades for a given security or its market over a select time period 1999. The given security is typically the PG input security. The average number of trades data may be from a specific market or from a total of all markets where the given security is listed for trading. The higher the average number of daily trades 1999, the larger the table output amount. A table may also be configured for a user's average number of transactions for a given security, or all securities, over a given time period.

Table 103, 2000 is a typical presentation of a table configured to output an investment amount based on the volume traded of a given security or a market over a select time period 2001. The given security is typically the PG input security. The higher the volume traded over a specified time period, the larger the table output amount. The trade volume data may be from a specific market or from all markets where the security is listed for trading. A table may also be configured for a user's transaction volume for a given security or all securities over a given time period.

Table 104, 2002 is a typical presentation of a table configured to output an investment amount based on the average volume traded of a given security or its market over a select time period 2003. The given security is typically the PG input security. The number of time periods 2004 used to calculate the average volume of a given time period 2003 may also be specified. The higher the average volume traded, the larger the table output amount. The average trade volume data may be from a specific market or from all markets where the security is listed for trading.

Table 105, 2008 is a typical presentation of a table configured to output an investment amount based on the share inventory or holdings of a given security or market in the user's account. The given security is typically the PG input security. The higher the share inventory, the larger the table output amount. The share inventory data may represent a specific security, market, or a total of all securities in the user's portfolio. The table output amount of Table 105 is specified for a “sell” amount and the output units are “share” quantity units.

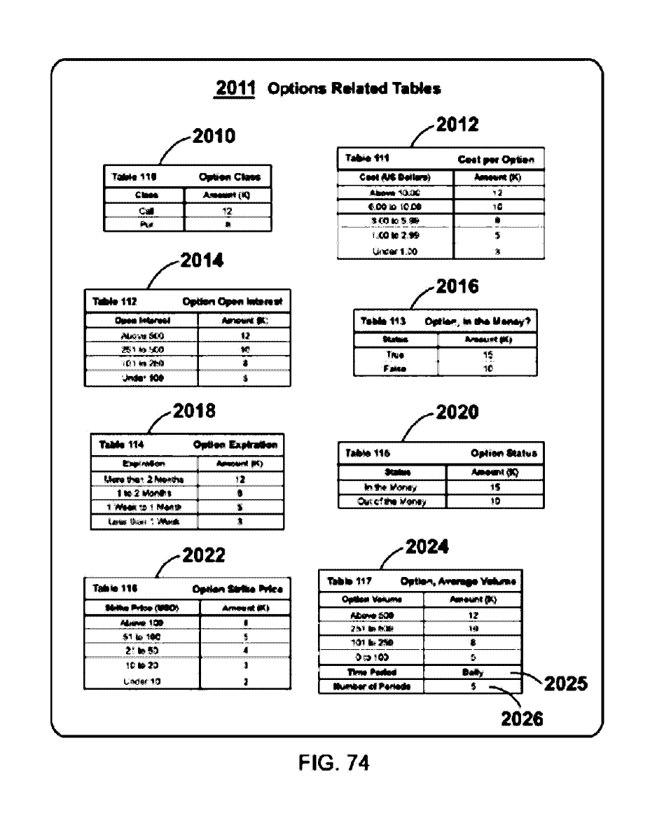

A user may trade options and configure specific PG tables for option orders. FIG. 74 displays a representative sample of PG table interfaces 2011, their use, and configuration as may pertain to an option order.

Tables 110 to 117 may be configured to accept input data and analysis from any suitable data source or from a specific third party content provider of options data. Such sources may provide their services for a fee billed directly to the user or billed through the user's brokerage account. As disclosed earlier, the table output column and its associated investment amounts may be expressed as a dollar amount, a contract quantity, and a percentage of a reference value.

Multiple table output columns may be configured for each table to suit both option writers and option purchasers. For example, table output columns may be configured for buy to open, sell to close, sell to open, and buy to close transactions and their respective investment amounts. Similarly, table output columns may also be configured for index options, equity options, put options, call options, an options exchange, and the like.

Table 110, 2010 is a typical presentation of a table configured to output an investment amount based on the option class of the PG input security. For example, if the PG input security is a call option, the table output amount is higher. The option class of the security may be derived from the option symbol, the backend, or a third party.

Table 111, 2012 is a typical presentation of a table configured to output an investment amount based on the price or cost of a given option security. The given option security is typically the PG input security. The higher the cost per contract, the larger the table output amount. The table output amount may be in contract quantity units.

Table 112, 2014 is a typical presentation of a table configured to output an Investment amount based on the open interest of a given option security, option chain, or option series. The given option security is typically the PG input security. The higher the open interest, the larger the table output amount.

Table 113, 2016 is a typical presentation of a table configured to output an investment amount based on the “In the Money” option status of a given option security. The given option security is typically the PG input security. If the option security is “In the Money”, the table output amount is higher. Logical and Boolean operators may be used in input category cells and formulas where appropriate.

Table 114, 2018 is a typical presentation of a table configured to output an investment amount based on the length of time remaining before the option security expires. The option security is typically the PG input security. The more time remaining before option expiration, the higher the table output amount. The length of time to option expiry may be expressed in any time units. Similarly, the option's expiration month may be indicated explicitly.

Table 115, 2020 is a typical presentation of a table configured to output an investment amount based on a status parameter of the option security. The option security is typically the PG input security. For example, if the option security status is “In the Money”, the table output amount is higher. Table 115 presents an alternative configuration to the approach taken in Table 113.

Table 116, 2022 is a typical presentation of a table configured to output an investment amount based on the strike price of the option security. The option security is typically the PG input security. The higher the option strike price, the larger the table output amount.

Table 117, 2024 is a typical presentation of a table configured to output an investment amount based on the average option volume traded of a given option security, option chain, or option series over a set time period 2025. The given option security is typically the PG input security. The number of time periods 2026 used to calculate the average volume of a given time period 2025 may also be specified. The larger the option volume traded, the higher the table output amount.

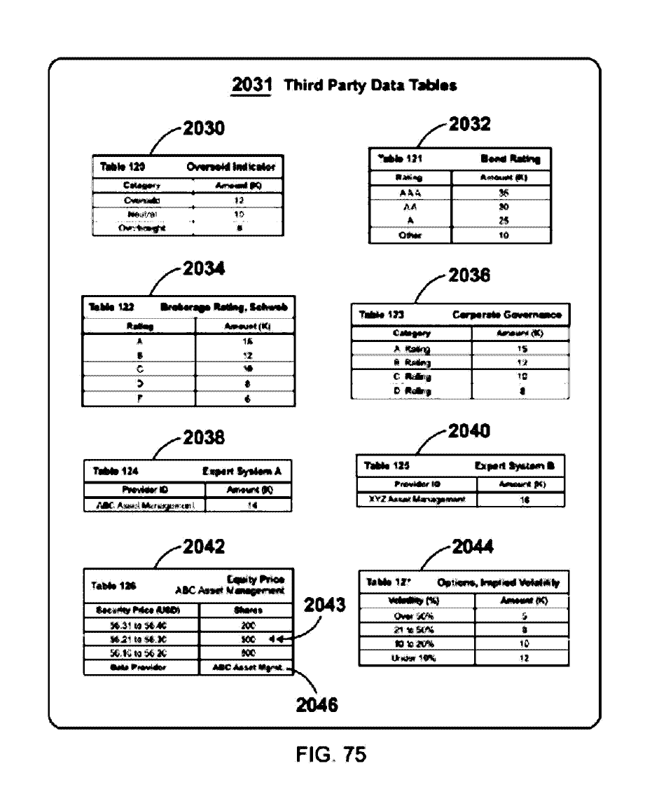

FIG. 75 displays a representative sample of PG table interfaces 2031, their use, and configuration as may pertain to a third party source of specialized data. A user may access or subscribe to a third party data source for specialized and proprietary data analysis. The third party source may be independent of the user's brokerage firm. However, some brokerages may choose to integrate third party data or provide access to similar analysis from their own internal research departments.

The table interface's visual presentation and configuration details may be placed under partial or complete control of a Third party. This allows the Third party source to package investment amount and quantity information in a manner that it finds most appropriate for its users and subscribers. A third party, with suitable authorization, may also dynamically reconfigure a portion of or the entire Position Guide tool, its table interfaces, and plug-in configuration settings. This option allows the PG Output quantity recommendation for any given security to fall partially or fully under the control of a third party if the user so desires. A user may choose this option to benefit from the PG Output quantity recommendation without further instruction or training on the Position Guide tool.

Tables 120 to 127 may be configured to accept data and analysis from any suitable information source or from a specific company or service provider. Such data sources may provide their services for a fee billed directly to the user or billed to the user's brokerage account.

Table 120, 2030 is a typical presentation of a table configured to output an investment amount based on the value of a technical indicator. There are hundreds of common and proprietary technical indicators which may be used as the basis for a table and its input data. For example, Table 120 accepts category data from a third party source indicating the overbought or oversold status of a given security, index, sector, or market. Typically, the overbought or oversold data is associated with the PG input security or a market index. If the table input data indicates an “Oversold” status for a given security or market, the table output amount is $12,000.

Table 121, 2032 is a typical presentation of a table configured to output an investment amount based on the Bond Rating value of a bond security. Typically, the ratings data is associated with the PG input security. There are several bond rating companies, such as S&P or Moody's, which provide ratings information that may be used as the basis for a table and its input categories. For example, Table 121 accepts category data from a third party source indicating the bond rating of a company or government bond security.

Depending on the security's bond rating, a corresponding investment amount is provided as the table output. The investment amount may be manually set by the user, or automatically configured by a third party. The user may enable a third party to access his account data and trading history in order to optimize the table settings and output investment amounts.

Table 122, 2034 is a typical presentation of a table configured to output an investment amount based on the stock rating value of an equity security. Typically, the ratings data is associated with the PG input security. Securities ratings values may be organized into input categories for use in a table. There are many brokerage firms, such as Charles Schwab, and independent organizations, such as ValueLine or MorningStar, which provide rating services for equity securities and mutual funds.

Depending on the table input value, a corresponding table output value is configured by the user or a third party. The investment amount for any table may be manually set by the user, or automatically configured by a third party. The user may enable a third party to access his account data and trading history in order to optimize the table settings and output investment amounts of the Position Guide.

Table 123, 2036 is a typical presentation of a table configured to output an investment amount based on a Corporate Governance rating value of a company as provided by a third party data source. Typically, the ratings value is associated with the PG input security. Depending on the table input value, a corresponding table output value is configured by the user or a third party.

Table 124, 2038 is a typical presentation of a table configured to output an investment amount or a PG Output quantity based on the recommendation of a Third Party Expert System or a Brokerage firm. Typically, the investment amount or PG Output quantity is associated with the PG input security. For example, Table 124 outputs an investment amount of $14,000 for the PG input security. The investment amount or table output amount is provided by a hypothetical third party, ABC Asset Management.

The user's brokerage account details, demographic information, trading history, and his Position Guide and plug-in settings may be made available to the third party in order for it to optimize its investment amount analysis and recommendation for the user. The investment amount recommended by a third party may fluctuate on a dynamic real-time basis based on the user's account and the market conditions during the trading session.

The table output amount from a third party may also be in share units or percentage units. The term “investment amount” may be used interchangeably with the term “transaction amount” when referring to the transaction size of any buy, sell, or short order.

Table 125, 2040 is a typical presentation of a table configured to output an investment amount or a PG Output quantity based on a further recommendation from an alternative Third Party Expert System or Brokerage firm. For example, Table 125 outputs an investment amount of $16,000 for the same PG input security of Table 124. The investment amount is provided by an alternative hypothetical third party, XYZ Asset Management.

The user may configure a number of third party tables that provide an investment amount or PG Output amount from a third party expert system or application. Furthermore, the respective table output amounts from said third party sources may be combined in the Combined Table Output Settings panel of FIG. 77 to result in a final investment amount for each PG input security.

Table 126, 2042 is similar in function to Tables 124 and 125. Specifically, Table 126 is a typical presentation of a table configured to output an investment amount or a share quantity amount as recommended by a third party source, ABC Asset Management 2046 for a select security or the PG input security.

The table presentation displays and categorizes the share price range of the select security, or the PG input security. This presentation permits the user to understand how the table output amount as recommended by the third party will change with fluctuations in the security's underlying price. A visual indication 2043 is provided to highlight the current table output amount and its associated share price category.

Table 127, 2044 is a typical presentation of a table configured to output an investment amount based on the implied volatility value of the PG input security. The volatility value may be provided by a brokerage firm, or a third party data source. As before, table input categories and table output amounts may be automatically configured and formatted by the third party data provider, or manually configured by the user.

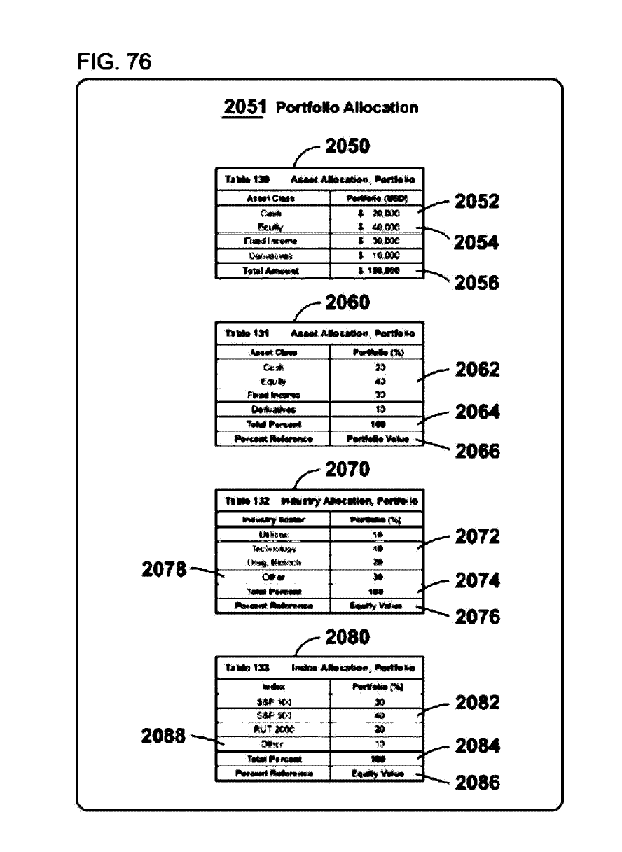

FIG. 76 displays a representative sample of PG table interfaces 2051, their use, and configuration as may pertain to the allocation of funds in an overall portfolio. The portfolio amounts shown in the table output column may be in dollar, percent, or share based units.

Table 130, 2050 is a typical presentation of a table interface configured to output portfolio amount limits on the total investment amount in each specific asset class of a user's portfolio. For example, the Equity asset class is allocated a portfolio amount of $40,000. As the market value of all equity securities in the user's inventory approaches or exceeds the portfolio amount 2054, the PG Output quantity of each subsequent equity security purchase is reduced or becomes zero. The PG Output quantity is constrained by the user or third party defined Equity asset class portfolio amount 2054. The total value of the various asset class portfolio amounts is indicated 2056. The table may also indicate the actual market value of the user's various asset class and portfolio for convenient reference.

The values in the Portfolio amount output column may refer to minimum, maximum, approximate, or exact amounts. If the cash category is shown 2052, the amount indicated may represent the minimum cash balance to be maintained in the portfolio. A minimum balance amount provides a contingency to deal with cash calls in a margin account, for basic cash expenses, and emergencies. For other asset class categories, the corresponding amount may represent the maximum quantity or amount limit of the category in an overall portfolio.

Table 131, 2060 is a typical presentation of a table interface configured to output portfolio amount limits on the percentage weight to each asset class of the user's overall portfolio. For example, the Equity asset class is allocated a portfolio amount of 40% 2062. As the market value of all equity securities in the user's inventory approaches or exceeds this portfolio amount 2062, the PG Output quantity of each subsequent equity security purchase is reduced or becomes zero, constrained by the Position Guide's Equity asset class portfolio amount 2062.

The percentage reference amount is the market value of the overall portfolio 2066. The total sum of the various percentage portfolio amounts is displayed 2064. The table may also indicate the actual market value of the user's portfolio for reference.

Table 132, 2070 is a typical presentation of a table configured to output portfolio amount limits on the percentage of the portfolio equity value allocated to specific industry sectors to which the equity securities in the holdings inventory fall under. For example, the technology sector is allocated a percentage portfolio amount of 40% 2072 of the overall equity value. As the market value of all technology sector securities in the user's inventory approaches or exceeds this percentage amount 2072, the PG Output, quantity of each subsequent technology sector equity purchase is reduced or becomes zero, constrained by the Position Guide's technology sector equity allocation amount 2072.

The “Other” sector category 2078 allocates a percentage portfolio amount for all remaining sector groups that are not listed. Entering a zero value in the table output column of the “Other” category disables the PG Output recommendation for industry and sector groups not listed in the input column of the table. The percentage's reference amount is the market value of the user's equity holdings 2076. The total sum of the various sector portfolio amounts is also displayed 2074. If a security is classified as belonging to more than one sector listed, the top sector may be allocated the entire value, or the value of the security may be partially allocated to each eligible sector listed.

Table 133, 2080 is a typical presentation of a table configured to output portfolio amount limits on the percentage of the portfolio equity value allocated to specific index classes to which the equity securities in the holdings inventory are components. For example, the S&P 500 index components are allocated a percentage amount of 40% 2082 of the overall equity value. As the market value of all the index component securities in the user's inventory approaches or exceeds this percentage amount 2082, the PG Output quantity of each subsequent index component stock purchase is reduced or becomes zero, constrained by the Position Guide's equity index portfolio amount 2082.

The “Other” index category 2088 allocates a percentage portfolio amount for all remaining indexes that are not listed. Entering a zero value in the output column of the “Other” category disables the PG Output recommendation for securities which are not a component stock of the indexes listed in the input column of the table. The percentage reference amount is the market value of the user's equity holdings 2086. The total sum of the various index portfolio amounts is also displayed 2084. If a security is a component of more than one index listed, the top index may be allocated the entire value, or the value of the security may be partially allocated to each eligible index listed.

FIG. 77 is representative of the Position Guide Combined Table Output Settings panel. One objective of the Combined Table Output Settings panel is to derive a final investment amount 2141 from the selected table output amount from all the active table interfaces and their underlying plug-ins. One or more table or table interface can reside within a given plug-in. Once the final investment amount 2141 is derived, the PG Calculation quantity 2147 may be obtained by dividing said final investment amount 2141 by the relevant security price 2145.

The Combined Table Output Settings panel may be used to manage: all possible PG input securities in general; a specific PG input security; or a group of securities categorized by asset class, index symbol, industry sector, a specific market or exchange listing, and the like.

The Position Guide Settings Priority area 2102 permits the user to select which PG Settings panel takes priority when the PG detects a conflicting setting between two or more Settings panels. If both the Combined Table Output Settings and the Direct Output Settings check boxes are checked, the Direct Output Settings panel of FIG. 55 has priority. The user may review the conflicting panel settings by clicking on the underlined html title link in priority area 2102.

A “Template” is a list or set of active tables 2116, and the “Use Criteria” for how said list of active tables is used 2113. One or more Templates may be configured by the user. Each Template is assigned a specific name or symbol 2104 to distinguish it from other Templates. The Templates are where the output values from the various plug-ins and table interfaces are combined to result in a single value. This single value is then further processed to result in the PG Output quantity. The PG icon 2148 will display the PG Output quantity for a given PG input symbol 2101.

Templates allow a user to group and weight the outputs of the various PG plug-ins or tables to suit a specific intended transaction such as a sell order. The Template Use Criteria define the criteria under which a particular Template may or may not be used. The Use Criteria for a Template, may indicate that the Template may only be used if the intended transaction meet's one or more of the following criteria: a specific input security, order type, asset class, table output type, index class, listing market or exchange, and the like. Templates and their Use Criteria may be named, saved, modified, and accessed in Template settings area 2103. One Template is automatically selected by the PG, or a third party, for a particular PG input security 2101. The Template that is selected has specific Use Criteria that match the parameters of the intended transaction. The Security Symbol input section 2100 allows the user to preview which Template is automatically chosen, and which tables become active, for a given PG input symbol 2101.

The PG input symbol 2101 is optional. The list of active tables and the Template “Use Criteria” for a given Template may be configured and modified without the need for an input symbol 2101. The user may manually select a Template to study or modify its list of active tables and its Use Criteria. However, if no PG input symbol 2101 is indicated, the table settings area 2114 and the lower portions of the Settings panel may be unable to calculate the PG Calculation quantity due to some missing data.

When a table name or number is shown in table settings area 2114 for a selected Template, the user may enable or disable the table using the table checkbox area displayed in the first column, the Table column 2116, of the table settings area 2114. For example, the checkmark in “Table 10” 2126 indicates that this table is enabled for the selected Template, “TEMP1” 2113. In this manner, only the enabled tables and their associated table output amounts need be shown for a selected Template, “TEMP1” 2113. The remaining table numbers shown are inactive, and may be hidden by marking the Show Inactive Tables checkbox 2132. The user or a third party may enable or disable any table associated with a given Template. The Table settings area 2114 indicates that the following tables are active or enabled: Table 10, 2126; Table 13, 2128; Table 22, 2129; Table 44, 2130; and Table 53.

Ideally, each Template and its associated list of tables and Use Criteria should serve a useful purpose with minimal overlapping functionality with other Templates. The Template Use Criteria is configured by the user to easily distinguish when one Template should be used over another, for a given PG input security and its intended transaction parameters. When there are multiple Templates with matching Template Use Criteria for a given PG input symbol and the intended transaction, the Template which is positioned or ranked higher on the list of Template names 2104 is given priority. The user is able to move the position or rank of each Template in the list shown in Template settings area 2103.

Template settings area 2103 is comprised of rows and columns of Template Use Criteria data. Column headers describe the type of data or criteria within each column. Shown in Template settings area 2103 are column headers for: the Template name or symbol 2104; the PG input security, security group, sector, index, or exchange input Use Criteria 2105; the order type Use Criteria 2106, the asset class Use Criteria 2108, the Template type Use Criteria 2110, and the PG Output quantity 2112. The PG Output quantity 2112, as presented within a column, is specific to the PG input security 2101 and the Template associated with the each row of the Template settings area 2103. It should be understood that additional Template names and additional Use Criteria columns may be added in Template settings area 2103.

A user may use a Template name or a table name as a variable in a formula, or in a scripting language command. The variable value would be some parameter of the Template or Table such as its output amount. A Template's name or symbol entered in a cell may indicate to the Position Guide to use the Final Investment Amount 2141 associated with the Template and a given PG input security as the value of the cell. For example, such formulas or scripting language commands may be input in the cells of settings area 1493 of the Direct Output Settings panel of FIG. 55.

The table settings area 2114, the formula settings area 2140, and the PG calculation area 2143, 2144, and 2146 display data and calculation information specific to a given PG input security, a Template 2113, and the Template's Use Criteria. For example, the checkmark indication 2113 indicates that the data values and settings information in the table settings area 2114, the formula settings area 2140, and the PG calculation area 2143, 2144, and 2146, pertain to the selected Template, “TEMP1” 2113, and the PG input security “MSFT” 2101.

Table settings area 2114 is comprised of rows and columns of table selection data, table output data, table output weighing factors data, and the like. Column headers describe the type of data within each column. There are column data for the Table name or symbol 2116, a brief Table Description or html link 2118, the Table Output amount 2120 for a given PG input security, the table output amount Weight or weighing factor 2122, and the resulting weighed table output amount shown in the Result column 2124.

The table settings area 2114 is used to derive a “Combined” table investment amount 2138 from one or more enabled tables 2116 and their respective table output amounts 2120, based on the PG input security symbol 2101 and the selected Template 2104. As shown, the list of checked tables 2116 indicate which tables are enabled or active for a selected Template 2113.

The PG input security 2101 and the required table input data is provided to each enabled table, and its associated plug-in, for a given Template 2104. The appropriate table output amount from each enabled table is displayed in Table Output column 2120. The user′ or a third party may assign percentage weight, or weighing factor, in Weight column 2122 to weigh the table output amount from each enabled table 2116. The percentage weight 2122 of each table is multiplied by the original table output amount 2120 to derive the weighed table output amount shown in Result column 2124. The resulting weighed table output amounts shown in Result column 2124 are summed, using a summation formula which adds all values in the column, to derive the combined table investment amount shown 2138.

It should be understood that the sum of all the percentage weights in Weight column 2122, for all active or enabled tables, need not total 100% as shown in the summary percentage weight total 2137 of the table summary area 2136. For example, the PG tables may be configured to output a smaller contributing table output amount for each specific PG input security. The smaller table output amounts need not be “weighed” to reduce their value prior to being summed. As a result, the percentage weights in Weight column 2122 for each active table would be 100%, and the smaller table output amounts would pass “un-weighted” to the Result column 2124. The smaller contributing table output amounts from each table are summed, as before, and the resulting combined value is displayed in the combined table investment amount area 2138.

For example, the respective table output amounts 2120, corresponding to the selected Template, “TEMP1” 2113, and the PG input symbol “MSFT” 2101 are: $10,000 for Table 10; $15,000 for Table 13; $10,000 for Table 22; $3,000 for Table 44; and $10,000 for Table 53. Similarly, the percentage weights 2122 for each enabled table, as specified by the user or a third party, are: 15% for Table 10, 25% for Table 13, 30% for Table 22, 10% for Table 44, and 20% for Table 53.

The Table output amounts 2120 for each enabled table is multiplied by the percentage weights 2122 for each enabled table, and the result is displayed in the Result column 2124. For example, the resulting weighed amounts are: $1,500 for Table 10; $3,750 for Table 13; $3,000 for Table 22; $300 for Table 44; and $2,000 for Table 53. The Result column 2124 weighed amounts are summed, and the total summed amount is indicated in the combined table investment amount area 2138.

The Formula Settings area 2140 may be used independently or in conjunction with the combined table investment amount 2138, to generate a formula investment amount 2134. The purpose of the formula settings area is to allow, for added flexibility, formulas and scripting language commands to be used to derive the final investment amount 2141. The Position Guide may support its own scripting language with a wide variety of variables and commands representing the various Position Guide, plug-in, and table settings, market and historical data, order entry, technical indicator parameters, and the like. Formula data is entered in input area 2142.

For example, the displayed formula, in formula input area 2142, averages the table output amounts from the table output column 2120 for tables 10, 13, 44, and 53, to derive an average value of $9,500. This average amount is multiplied by 0.10 factor, and added to the “TABLE” investment amount, $10,550 as indicated in the combined table investment amount 2138. The resulting formula investment amount, $11,500 is shown in display area 2134. It should be understood that the formula area 2142 is associated with a given Template.

Final investment amount section 2143, permits the user to select the final investment amount value 2141 directly from the combined table investment amount 2138, the formula investment amount 2134, or both. The “Both” option may give priority to the formula investment amount value 2134, but permits the combined table investment amount 2138 to be accessed using the “TABLE” variable in formula area 2142. The final investment amount is displayed in text box 2141.

The PG Price Denominator section 2144 determines the relevant security price 2145 to use in order to determine the PG Calculation quantity. For example, the “AUTO” setting is chosen from the drop down list displayed. The relevant security price is shown in text box 2145 based on the selected PG input symbol 2101 and the PG Price Denominator setting 2144. It should be understood that the relevant security price text box 2145 may accept a direct manual price entry from the user. If a manual price is used, the term “Custom” would appear in the PG price denominator drop down list.

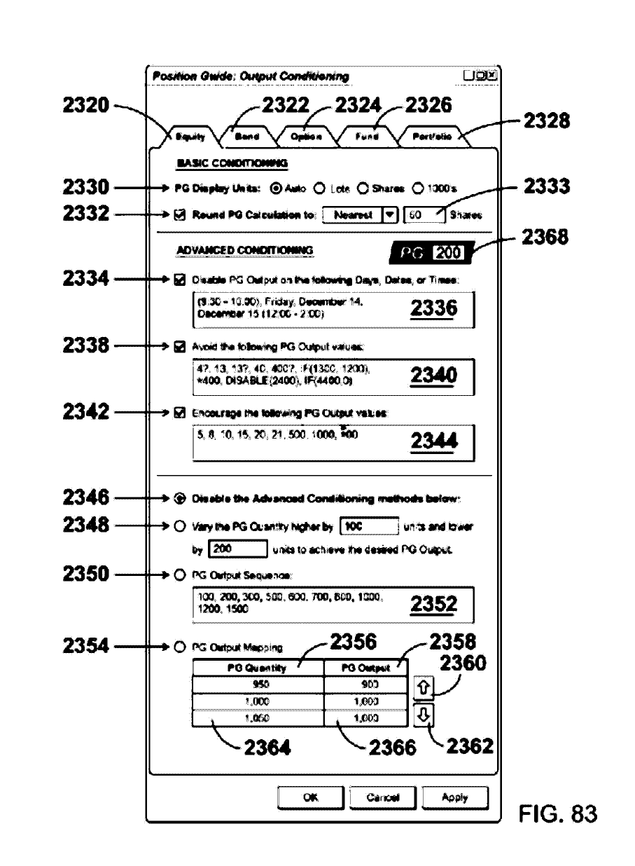

The PG Calculation Quantity section 2146 displays the resulting decimal value when the final investment amount 2141 is divided by the relevant security price 2145. The result is displayed in decimal form in text box 2147. The PG Output Quantity is displayed in PG icon 2148 after the basic and advanced output conditioning steps of FIG. 83 have been processed.

It should be understood that the Table configuration approach, shown in FIGS. 63 to 79, may be used to configure the Position Guide independent of the PG Output Settings panels shown in FIGS. 52, 54, 55, 56, 87, 88, and 91.

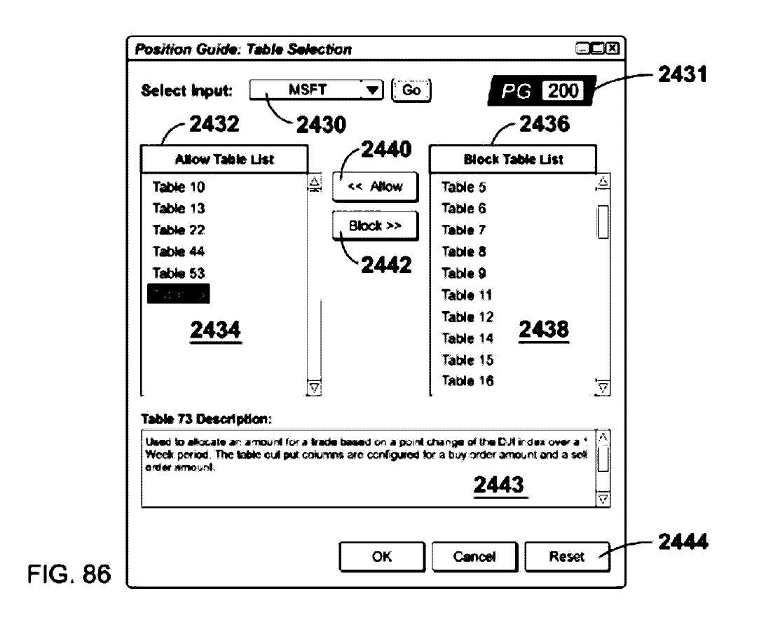

The list of enabled tables for a given Template name, or PG input security, may be viewed and edited using the Table Selection panel displayed in FIG. 86. The table settings area 2114 may also be displayed in a separate panel from the Template settings area 2103. If the table settings area 2114 is displayed in a separate panel, the resulting table panel may require both the Template name 2104 and the PG input security symbol 2101 as input data in order to display a list of enabled tables.

Although the Combined Table Output Settings panel of FIG. 77 utilizes the concept of a “Template” and its associated “Use Criteria”. It should be understood that tab sets may also be used to define a list of enabled tables, categorized according to one or a combination of the following criteria: order type, asset class, industry sector, index class, listing exchange or market, input security, and the like. FIG. 87 is representative of the use of tab sets as an alternative to the concept of “Templates” and their “Use Criteria”.

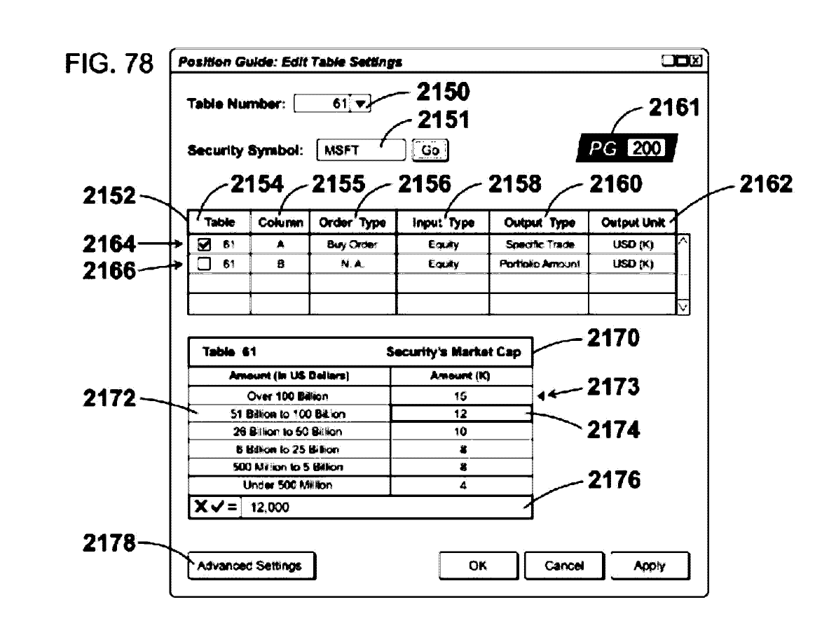

FIG. 78 is representative of the Position Guide Edit Table Settings panel. The purpose of the Edit Table Settings panel is to display and edit both table data and column configuration data for a selected table.

The table to be edited is entered in input area 2150. The resulting table interface is shown in table display area 2170. The user may edit the data in the table display area 2170. Table data such as an input category cell 2172, or its associated table output amount 2174, may be modified by selecting a cell and editing the data directly within said cell. The cell data may also be input or edited from the text input & edit box 2176.

Column configuration area 2152 permits the user to configure a table output column for a given table input 2150. The column configuration area 2152 also permits the user to create and configure one or more table output columns for a given table. A new table output column for an existing table may be created by entering the table number, the new column number 2155, and the remaining configuration data in an empty or available row of the column configuration area 2152. The table output column settings may also be adjusted using the Advanced Table Settings panel of FIG. 79.

The column configuration area 2152 is composed of rows and columns. Each column has a header area to identify the data in the column. The Table column 2154 identifies the number or name of the table. The Column header 2155 identifies the table's available output columns and their respective suffix letter for each given table 2154. A checkmark indication for table output column 61A configuration settings 2164 identifies the specific table number and output column shown in the table display area 2170. For example, the user may view and edit both table output column 61A configuration settings 2164, and table output column 61B configuration settings 2166 for Table 61 in the table display area 2170 by placing a checkmark in the two checkboxes shown in the Table column 2154.

The Order Type column 2156 identifies the order type, if specified, associated with a table output column and its output investment amounts. If a table output column is enabled for one or more order types, each order type may be entered in the appropriate cell of the Order Type column 2156 separated by a comma.

The Input Type column 2158 identifies additional criteria that may disable or enable the use of a table output column and its output amounts. The term “Input” in the previous sentence is associated with the PG “Input” security. The PG input security should satisfy the indicated criteria to enable the table output amounts. Such criteria may enable or disable a table output column according to its asset class, index class, industry sector, and security category for a given PG input security. If a table output column is enabled for one or more asset classes or criteria, each asset class or criteria may be entered in the appropriate cell of the Input Type column 2158 separated by a comma. The Input type column 2158 may be used to restrict or limit the table output column's use to a limited number of securities or security categories.

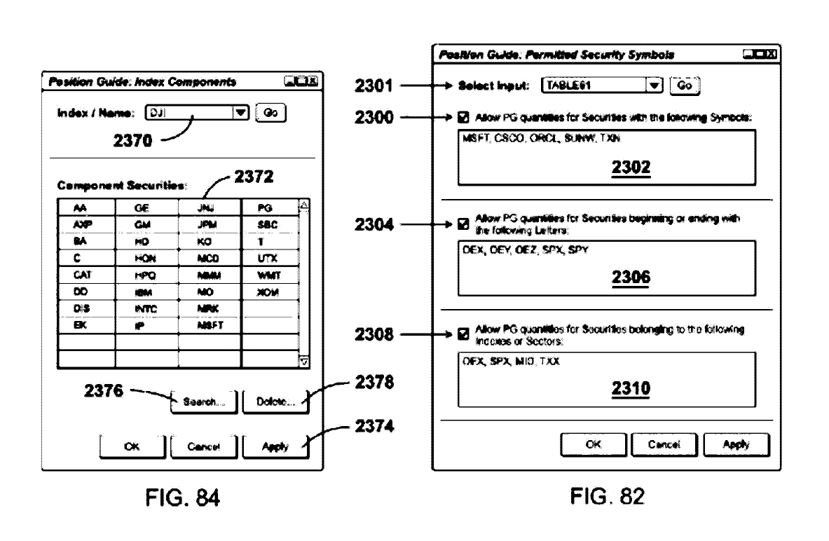

As noted in the previous paragraph, the user may specify output column criteria that enables or disables a specific table output column when a specific PG input security is present. It should be understood that the user may also specify table input criteria that enables or disables a specific table when a specific PG input security is present. Such criteria may be specified, for example, in the Exempt Security settings of FIG. 81, the Permitted Security Settings of FIG. 82, and the Advanced Table Settings of FIG. 79. Similarly, the user may specify broader PG input criteria that enables or disables all tables, plug-ins, Output Settings panels, and the like when a specific PG input security is present.

Output Type column 2160 identifies the output value of a table output column as representing an investment amount for a specific trade, or a portfolio amount value. The Output Unit column 2162 identifies the table output column's investment a mount units and formatting. Changing the column configuration area 2152 settings permits the user to further customize the use of each table, its output columns, and output investment amounts.

A user may enter an optional PG input security 2151 to review the corresponding table output amount indicated 2173. For example, when “MSFT” is presented to Table 61, as the PG input security 2151, the corresponding table output column 61A output investment amount is $15,000. The PG Output quantity is indicated in PG icon 2161 for each PG input security 2151 and selected table output column 61A configuration settings 2164. The user may access more detailed table or plug-in settings through the Advanced Settings button 2178.

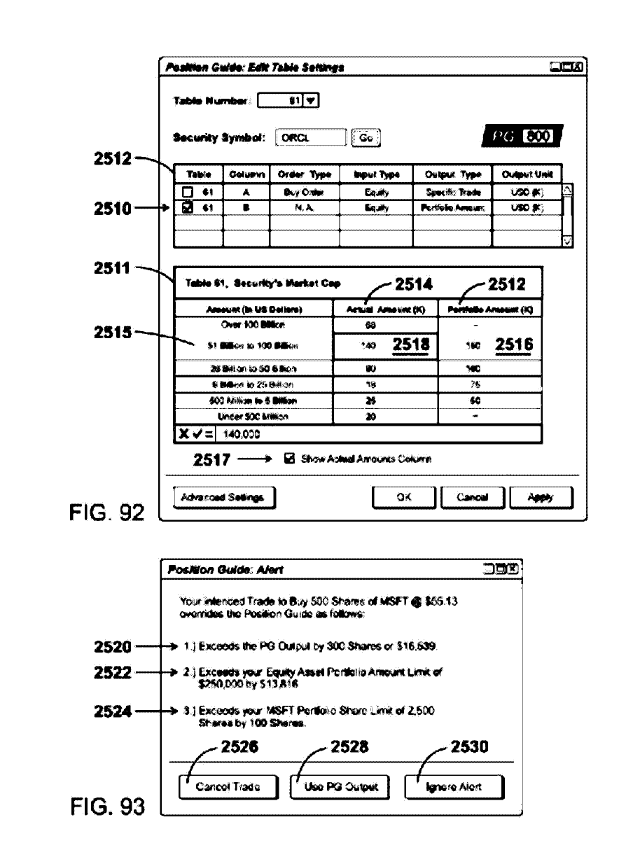

The displayed table 2170 and its table output column 61A configuration settings 2164 indicate that the table output column “61A” displays investment amount data for equity buy orders. Furthermore, the column output amount is for a specific buy order trade and displayed in USD(K) units. Table output column 61B configuration settings 2166 is similar to table output column 61A configuration settings 2164, but configured for a portfolio amount column output type. Column 61B and its portfolio amount output is shown in more detail in FIG. 92.

FIG. 79 is representative of the Position Guide Advanced Table Settings panel. The purpose of the Advanced Table settings panel is to display and edit settings and configuration data for a given table input.

The Advanced Table Settings for a given table may be viewed by entering the table's ID number in input box 2200. The user may configure hundreds of different tables for use with the Position Guide if he chooses. If a particular table number 2200 cannot be remembered, the user may choose to search for the table number using Search button 2212. A new table may be created and named using New Table button 2210. Similarly, an existing table's settings may be modified and saved as a new table number.

The table interface associated with the table input 2200 is shown in display area 2202 for convenient reference. The user may edit the visible contents or data within the display area 2202 by selecting any cell from the table interface and editing its data or contents directly. For example, a specific input category cell and its associated range of input data values 2204, or a specific table output amount 2205 may be modified within their respective cells. It should be understood that the visible table interface area 2202 may also be edited using the Edit Table Settings panel of FIG. 78.

The selected table's 2200 underlying plug-in settings and configuration data is accessible in display area 2220. Shown in the left column of display area 2220 are the setting names or text labels. It should be understood that the settings names and data required may vary according to the type of table and its configuration.

The table settings data includes the table identification number 2206, the number of visible input category rows and table output columns 2207, the title header of the table interface or plug-in 2208, and the type of category the table or plug-in belongs 2209.

Input data settings area 2222 pertains to settings of the: data source of the table's input data, the input data code to help the data source identify the correct data to supply, the input data unit type, the formatting of the input data for display inside the table interface, the method to be used if an input value falls in two or more input category rows simultaneously, the time period or time interval the input data is associated with, and the number, frequency, or periods over which an average value is calculated if the input data is related to an averaged input value.

Output data settings area 2224 pertains to settings of the: output amount type, whether it is intended for a single trade or a portfolio amount limit, the asset class the table output amount is intended for, the order type the table output amount Is intended for, the output amount units, the output amount format code for display inside the table interface, the percentage reference amount or base if the output amount is in percentage units, and the nature of the output value, whether the output value is intended to represent an exact amount, or a minimum or maximum amount. The output value may, for example, be set for an exact amount when the table output amount is in share units.

It should be understood, that a single table with multiple output columns can essentially replace a number of independent tables, each with a single output column if the input data and configuration settings of the tables are similar. Regardless of the approach Used, the table output columns may be differentiated by order type, asset class, input security, output type, output units, and the like. Table data from the configuration area 2152 of FIG. 78 is displayed in the Output settings area 2226 for convenient reference.

The Output settings area 2224 permits each table output column to be independently configured for a specific input security, output type, asset class, order type, and output unit. For example, the output column settings for the Buy amount column 2214 and the Sell amount column 2215 of Table 73 may be adjusted in the Output settings area 2227, 2228 respectively of the Advanced Table Settings panel.

The table input and output data settings affect how the Position Guide interprets the table input data requirements, and the table output amounts. For example, a table configured to output an amount only for a buy equity order, will have no bearing on a PG Output quantity recommendation for a sell order, or a bond order.

A description of the selected table 2200, its configuration, and user comments may be entered in text description area 2240. The Eligible Securities area 2242 is used to restrict the table's use to specific security symbols, asset classes, index components, baskets of securities, industry sectors, markets, exchanges, and the like. The Exempt Security Symbols settings of FIG. 81, and the Permitted Security. Symbols settings of FIG. 82, are accessed through buttons 2243, 2244 respectively for the displayed table 2202.

Input Formula area 2246 is used when the user desires to condition, modify, or further process the original input data from the data source. This may be necessary when the exact input data the user desires is not available from a data source, or the input data requires further processing. Formulas, conditional statements, or scripting language commands necessary to generate or modify the table input data may be entered in input box 2247. A table and its configuration settings data may be deleted using Delete button 2248. Any changes to the table settings and configuration data may be saved using the Apply button 2249.

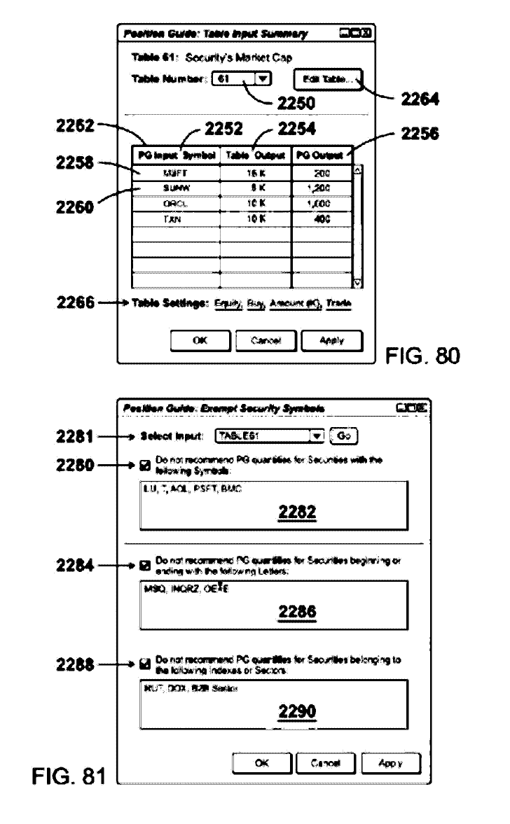

FIG. 80 is representative of the Position Guide Table Input Summary panel. The purpose of the Table Input Summary is to display, for a s elected table 2250, the table output amount for each potential input security symbol. This allows the user to view the table output amounts for a range of PG input security symbols at a glance and to verify the proper operation and configuration of the selected table 2250.

A specific table number is entered or selected from a drop down list 2250. For example, Table 61, the Security Market Capitalization table from FIG. 69 is selected as the table input 2250. The table summary area 2262 displays, for a selected table and its configuration, the potential PG input security symbol under the column header 2252, the table output amount under the column header 2254, and the PG Output quantity under the column header 2256.

The potential PG input security symbols under the column header 2252 may be selected from the user's portfolio holdings, from securities the user has been monitoring or researching, and from securities the user has been trading. The user may also manually enter security symbols in the PG Input Symbol column 2252. The table output amounts 2254 are typically shown in the output unit of the selected table 2250.

The PG Output quantities 2256 represent the final PG quantity value after all the table and plug-in preference data have been factored into the PG calculation, and the PG output conditioning process of FIG. 83 is complete.

For example, the PG Input Symbol column 2252 displays four input security symbols: MSFT, SUNW, ORCL, and TXN. The table summary area 2262 indicates that when MSFT 2258 is input to the Position Guide, Table 61's table output amount is $15,000 and the PG Output quantity is 200 shares. Similarly, SUNW 2260, produces a table output amount of $8,000 and a PG Output quantity of 1200 shares.

The Table Settings area 2266, displays the basic table output configuration data for the selected table 2250. The displayed data 2266 indicates that the table output amount for the selected table 2250 is configured for dollar denominated Equity security Buy orders. The settings area 2266 also indicates that the selected table's output amount is in dollar (K) units and intended for a specific Trade, not a portfolio amount. The user may right-click and change each data item in the table settings area 2266 and view the revised table summary area 2262 for the changed output configuration, if such a table output configuration exists for the selected table 2250.

It should be understood that additional columns may be added to the table summary area 2262 to show table configuration data for the selected table 2250. A table number with a letter suffix typically indicates additional table output configurations for a given table. If the user prefers to view or modify the selected table's configuration settings in more detail, he may access the table and its configuration data through the Edit Table button 2264.

FIG. 81 represents the Position Guide Exempt Security Symbols panel. The purpose of the Exempt Security Symbols panel is to disable the Position Guide Output or the PG tables and plug-ins from processing certain PG input symbols such as those belonging to specific security symbols, indexes, industry sectors, asset classes, exchanges, or a similar security category. The user may enter in advance, such security, index, and industry sector data, or the like, in order to disable the PG Output for specific security symbols or security categories. Such disable settings also prevent the user from being charged by third party sources for security, index, and industry sector recommendations and analysis he does not wish to obtain.

Exempt Security data may be set for the overall PG tool in general or for a specific table or plug in. If a user desires to enter exempt data for a specific table, the table number is entered in input area 2281. The terms “ANY”, “GENERAL”, or “ALL” indicates that the exempt settings are for the overall PG tool. General exempt settings are listed in specific table or plug-in exempt settings as well.

Input area 2280 permits the user to enter PG exempt security symbols in associated input box 2282. The security symbols may for example, represent equity, option, bond, mutual fund, and futures securities.

Input area 2284 permits the user to enter the beginning or ending digits of a PG exempt security symbol in associated input box 2286. This feature is useful, for example, to exempt specific option securities by class, strike price, or similar data encoded within the security symbol. Wildcard characters may also be used in input area 2286 or any input area to conveniently enter a broader range of security symbol data.

Input area 2288 permits the user to enter index or mutual fund symbols, industry sector names, exchange name, and related security category data in associated input box 2290. This feature is useful, for example, to exempt all the component stocks of an index, mutual fund, or industry sector.

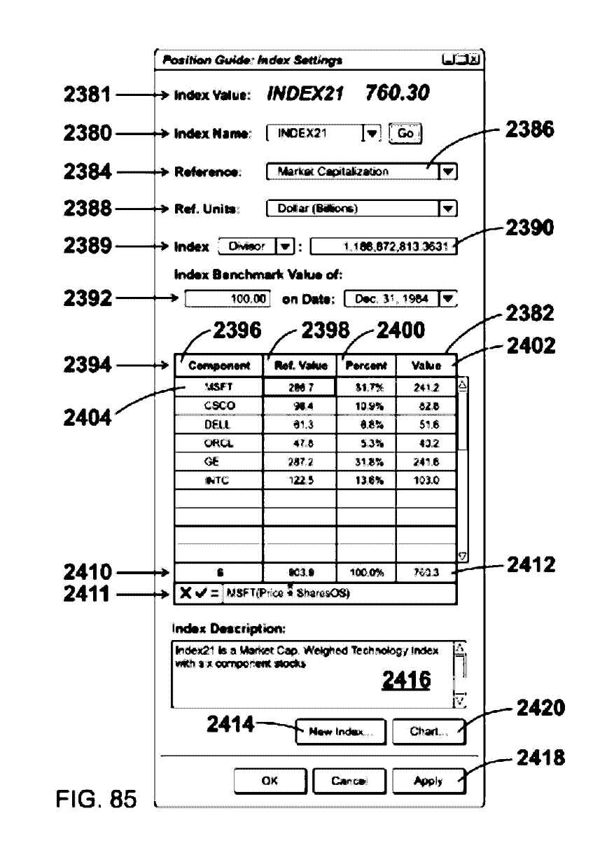

The Position Guide may access the listing of component stocks of an index, mutual fund, exchange, and the like from the backend system or a third party data source. The user may also define a custom index and its component stocks as disclosed in FIGS. 84, 85. The input area 2290 or any input area may also accept formulas, scripting language, and conditional statements to further define an exempt or permitted security.

FIG. 82 represents the Position Guide Permitted Security Symbols panel. The purpose of Permitted Security Symbols panel is to enable the Position Guide Output, or the PG tables and plug-ins to accept specific security symbols, indexes, industry sectors, asset classes, or other security categories as input symbols to the PG. The user may enter in advance, such security, index, industry sector, and related category data in order to enable the PG Output for specific security symbols. Such permitted symbols settings also allow the user to specify for which securities a third party data source may charge fees. Such fees are related to security and industry sector recommendations and analysis one wishes to obtain through a PG plug-in.

Input area 2300 permits the user to enter enabled, allowed, or permitted security symbols in associated input box 2302. Input area 2304 permits the user to enter the beginning or ending digits of permitted security symbols in associated input box 2306. This feature is useful, for example, to permit as input to the PG, specific option securities by class, strike price, or similar data encoded within the security symbol.

It should be understood that exempt or permitted security, index, asset class, exchange, and industry sector settings data may be configured for specific tables or plug-ins, as well as the overall Position Guide. Exempt and permitted security input symbols for specific tables or plug-ins may be accessed through their respective edit and configuration settings panels. If a user desires to enter permitted security symbol data for a specific table, the table number is entered in input area 2301. The terms “ANY”, “GENERAL”, or “ALL” entered into the input area 2301, or the lack of a table number, indicates that the permitted security settings are for the overall. PG tool in general. Generally enabled symbols are listed in all specific table or plug-in permitted symbols settings as well.

Input area 2308 permits the user to enter index, mutual fund, exchange, and industry sector names in associated input box 2310. This group or basket enable feature is useful, for example, to conveniently enable with one symbol, all the component stocks of an index, mutual fund, exchange, or industry sector for input to the PG.

A user may choose to use the PG Exempt Security Symbols panel of FIG. 81 or the PG Permitted Security Symbols panel of FIG. 82 based on preference and convenience. It may be that it is simpler to enter a list of permitted securities than a list of exempt securities. If there is a settings conflict between the Exempt Security Symbols panel or the Permitted Security Symbols panel or between a General PG setting and a specific table plug-in setting the user may choose which Security Symbol panel or settings type takes priority. The default priority rests with the Exempt Security Symbols panel and the specific table plug-in settings.

It should be understood that the three input areas 2282, 2286, 2290 for the Exempt Security Symbols panel may be combined into a single input area for user convenience. Similarly, the three input areas 2302, 2306, 2310 for the Permitted Security Symbols panel may also be combined into a single input section. Furthermore, these two combined input sections for exempt and permitted PG input security symbols may be displayed within a single panel.

FIG. 83 represents the Position Guide Output Conditioning panel. The PG Output Conditioning settings allow the user to “condition” the PG Calculation quantity, the PG Quantity, and the PG Output quantity. The PG Calculation quantity, the PG Quantity, and the PG Output quantity values are adjusted so that the PG Display quantity is a practical quantity and changes in step increments appropriate for a given transaction.

There are two conditioning processes involved from the time the PG Calculation quantity is derived to the time the PG Output quantity is displayed. The “Basic Conditioning” process is the first process. The “Advanced Conditioning” process is a second, optional process that completes the output conditioning process. The Basic Conditioning process takes the decimal PG Calculation quantity and derives a practical integer quantity called the PG Quantity. The optional Advanced Conditioning process allows the user to exercise additional control of the PG Output quantity value.

The PG Advanced Conditioning process may also be configured to avoid or encourage certain numbers or combinations of numbers. For example, some traders may choose to avoid the numbers 13 and 4, and encourage the numbers 7 and 8. Using the PG Advanced Conditioning process, such numbers can be avoided or encouraged respectively.

The PG Calculation is defined as the resulting decimal value after the division of an investment amount by the relevant security price. The PG Quantity is the resulting integer value after the PG Calculation is rounded up or down to the nearest “step increment” quantity 2333. The PG Output quantity is defined as the final output quantity of the Position Guide for a given PG input security. The PG Display quantity is defined as the displayed value inside the PG icon 2368.

When there is no manual override of the quantity inside the PG icon 2368, the PG Display quantity is the same value as the PG Output quantity. The quantity value displayed in the PG icon 2368 also represents the share quantity of the intended order or transaction. The PG icon may be used to initiate an order or populate an order entry form.

When the Advanced Conditioning process is disabled, the PG Output quantity is the same value as the PG Quantity. The Advanced Conditioning process may be enabled or disabled by adjusting the settings in the Output Conditioning panel of FIG. 83, or through the use of the Panel and Features Selection panel of FIG. 90.

The PG Output Conditioning tab page for the representative Equity asset class 2320 is shown in FIG. 83. The PG Display Units section 2330 determines the display formatting or display units of the PG Display quantity. For example, a PG Display quantity of 2000 shares may be displayed in the PG icon corresponding to “20” if the “Lots” radio button is selected, and “2” or “2K”, if the “1000's” radio button is selected.

The Round PG Calculation section 2332 determines the step increment quantity 2333 by which the PG Quantity may move higher or lower. The PG Calculation may be rounded up, down, or to the nearest step increment using the rounding preference displayed in the drop down list shown in section 2332. For example, if the PG Calculation is 208.59 shares, as shown in the PG Calculation box 2147 of FIG. 77, a 50 share step increment quantity 2333 would round the PG Calculation value of 208.59 shares, to the “nearest” 50 share units and the resulting PG Quantity becomes 200 shares.

Turning now to the Advanced Conditioning process, the Disable PG Output section 2334 disables the PG Output quantity on specific dates, days of the week, time intervals, and the like. The disable PG data is entered in input area 2336. For example, a user may disable the PG Output on Fridays, or during the first 30 minutes of each trading session.

The Avoid PG Output Values section 2338 is used when a user prefers to avoid certain numbers or number combinations in the PG Output quantity. The avoid data is entered in input box 2340. The Encourage PG Output Values section 2342 is used to encourage certain numbers or number combinations which the user may, for example, perceive as lucky. The encourage data is entered in input box 2344. Wildcard characters may be used in input areas 2340, 2344 to conveniently represent a broader range of number sequences.

The Position Guide will adjust the PG Output quantity higher or lower in the step increments specified 2333 to conform to the user's preference settings for avoiding 2338 or encouraging 2342 certain numbers or number combinations. All input areas such as 2340, 2344 may be used to enter formulas, scripting language commands, or other programming code to further define and manage the PG Output quantity.

The bottom half of the Equity Output Conditioning tab 2320 displays a variety of Advanced Conditioning methods. A specific Advanced Conditioning method is selected via radio buttons 2346, 2348, 2350, and 2354. Radio button 2346 disables the PG Advanced Conditioning methods shown in the bottom half of the Advanced Conditioning section of FIG. 83. When all the Advanced Conditioning sections 2334, 2338, 2342, 2348, 2350, and 2354 are disabled, the PG Quantity calculated in the Basic Conditioning process 2332 becomes the PG Output quantity 2368.

The PG Output range section 2348, selects the PG Output quantity in a manner that adjusts the basic PG Quantity higher or lower by a specified quantity of shares to satisfy the user preferences in input box 2340, 2344.

The PG Output sequence section 2350, selects the PG Output from a list of suitable PG Output quantity values shown in input area 2352. In this instance, the decimal PG Calculation quantity may be rounded up, down, or to the nearest displayed quantity value shown in the input box 2352 according to the rounding preference displayed in the drop down list shown in section 2332. The input area 2352 may also accept formulas or scripting language instructions to further define and manage the PG Output quantity.

The PG Output mapping section 2354, matches a PG Quantity 2356 to a PG Output quantity 2358. For example, if the PG Quantity is “1050” shares as indicated in cell 2364, the corresponding PG Output quantity is “1000” shares as indicated in cell 2366. The PG Output quantity may be entered or modified directly in the PG Output column 2358. The user may scroll through the full range of PG Quantity and PG Output quantity values using the up or down scroll buttons 2360, 2362 respectively.

The PG Quantity values 2356 are shown in the specified step increment shares 2333. The data specified in the PG Advanced Conditioning sections 2350, 2354 take priority over the settings data in Avoid and Encourage sections 2338 and 2342 respectively.

It should be understood that the Position Guide Output Conditioning feature may be categorized according to asset class or order type tab sets. For example, FIG. 83 displays Output Conditioning tabs specific to Bond 2322, Option 2324, and Mutual Fund 2326 asset classes. The Portfolio Amount Conditioning tab 2328 may be used to maintain a specific holdings or inventory level or a specific dollar amount of certain securities, asset classes, index classes, industry sectors, and the like.

FIG. 84 is representative of the Position Guide Index Components panel. The purpose of the Index Components panel is to display for a selected index, sector, or category input 2370, the index, sector, or category's component stocks or securities in display area 2372. The Index panel is also used to create a customized basket or group of securities and list its associated component securities.

The user may wish to identify or list a given index or sector's component securities when an Index symbol or Sector name is used to select a specific Buy, Sell, or Short investment mount for all of the given index's or given sector's component stocks. For example, in the Direct Output Settings panel of FIG. 55, the OEX index symbol 1514 is used in the input criteria column to set the Buy investment amount for all OEX index components input to the Position Guide to $12,000.

A user may edit securities from a known index or sector's displayed component stocks 2372 to create a custom index or basket of securities. The index components may be added or removed by editing directly inside the cells of the display area 2372. The custom index or sector's new name or symbol is entered in input area 2370 and the Apply button 2374 is pressed to complete the new name process. The custom index, sector, or basket of securities may be recalled, and its component securities displayed, by entering the name or symbol of the custom index or selecting the name or symbol of the index from the input drop down list 2370.

The Search button 2376 is used to search for the proper index symbols or sector names that may be available to the Position Guide. The Delete button 2378 is used to delete customized indexes and sector names created by the Position Guide tool.

The display of an index's component securities 2372 may be ranked alphabetically or according to the component's relative weight of the index's current value. The Index Components panel may also be used to display a mutual fund's portfolio securities. Such index and Mutual Fund breakdown data prevents a user from being overweighed in a given security, industry sector, or asset class.

FIG. 85 is representative of the Position Guide Index Settings panel. The purpose of the Index Settings panel is to display, for a selected index input 2380, the index's component stocks or component securities and the index's construction details in display area 2382. The Index Settings panel may also be used to construct and name a customized index or technical indicator.

After the index name or symbol is entered in input section 2380, the panel information is updated to display the selected index details. The current value of the selected index 2380 is shown in index value area 2381. To construct or modify a custom index, the user selects a suitable index configuration and enters the appropriate index components, and formulas in display area 2382.

There are many different types of indexes based on market capitalization, price weighed averages, equal dollar amounts, equal share amounts, and the like. The Index Reference section 2384 is used to select the type of index to be constructed from a drop down list 2386. The Reference Units section 2388 selects the display units and formatting of the Index Reference parameter in the display area 2382. The Index Multiplier or Divisor section 2389 is used to select the index calculation method for the base value 2390. The base value 2390 is used when the index is calculated and adjusted when the index is rebalanced or adjusted for stock splits, changes to the index's component securities, mergers, acquisitions, stock rights, substitutions, or other index relevant events.

The Index Benchmark Value section 2392 permits the user to set a benchmark value for the index on a particular date. For example, the user may set the value of an index to 100.00 on the close of Dec. 31, 2001 and so the user may easily determine the percentage change in the index value from that date. Setting the Index Benchmark value may affect the Index base value 2390 and vice versa. A chart of any index's value over time may be displayed using the chart button 2420.

Basic index construction data is entered and modified in the display area 2382. The display area is arranged in rows and columns. Each column has a column header area 2394 identifying column data such as: the component security symbol 2396, the reference value of each component 2398, the percent weight of each component 2400, and the contributing value of each component security 2402. Columns may be added, deleted, hidden, or repositioned as required to construct the index details in display area 2382.

Formulas and data may be entered and edited inside each selected cell directly or by using the data & formula bar 2411. Scripting language instructions may also be entered in the cells of display area 2382. A security's market capitalization is determined by multiplying the price of a stock by the number of shares outstanding. For example, a market capitalization formula may be used in the Reference Value column 2398 to calculate each component's market capitalization value using the said component's share price and shares outstanding variables.

As shown in FIG. 85, INDEX 21 is a market capitalization weighed index composed of six technology stocks. The MSFT index component 2404 shown in the first row of display area 2382 has a market capitalization of $286.7 billion as indicated in the reference value column 2398. The reference value column's display unit is specified in Reference Units section 2388. Also shown is MSFT's proportion of the total market capitalization of the index's six component stocks and MSFT's contribution in point terms to the index's overall index value.

Index data summary area 2410 identifies the total number of component securities, the total reference value, and the real-time value of the index 2412. For example, the data summary area 2410 indicates that INDEX 21 has six component stocks, a total market capitalization of $903.9 billion, and a current index value of 760.3 points.

When constructing a new index, a user may enter index symbols or industry sector names in the component column 2396. Such index or sector symbols provide a convenient alternative to individually entering the component stocks of a given index or sector one at a time. When index or sector symbols are used to represent a group of component inputs, the row values reflect the combined summed data of the individual components of the group. A negative sign before a stock symbol is used to subtract a component security and its associated data from a given index or sector group.

A user may add or delete securities from a popular index's component list to create a custom index or basket of securities. The custom index's new name or symbol is entered in input area 2380 and the Apply button 2418 is pressed to complete the index construction process. The new index may also be named using the New Index button 2414. The index description area 2416 is used to describe the index construction and related details to the user.

The display of component securities in the display area 2382 may be ranked alphabetically or according to the component's relative weight to the current index value. The Index Settings panel may also be used to display a mutual fund's portfolio securities and the relative weight of each security in the fund's portfolio. Similarly, the Index Settings panel may be used to define a technical indicator and the display area may be used to layout and enter the formula data for the indicator.

FIG. 86 is representative of the Position Guide Table Selection panel. The purpose of the Table Selection panel is to conveniently enable and disable a table from a list of tables associated with a given security, Template, asset class, index, basket of stocks, industry sector, and the like.

The symbol or name associated with the security, Template, asset class, index, basket of stocks, industry sector, and the like, is entered in or selected from input box 2430. The active or enabled tables associated with each input symbol or name 2430 are shown in display area 2434 of the “Allow Table List” section 2432. The inactive or disabled tables associated with each input symbol or name are shown in display area 2438 of the “Block Table List” section 2436. If the input symbol 2430 is a valid security symbol, its associated PG Output quantity may be displayed in PG icon 2431 for convenient reference.

The tables associated with each input symbol or name, may be moved between the active or enabled area 2434, or the inactive or disabled area 2438 using the Allow button 2440 and the Block button 2442 respectively. The table name or table number displayed in the Allow table display area 2434, or the Block table display area 2438, represents the table's respective enable or disable status for a given input symbol or name 2430. Any changes to a pre-defined or default selection of enabled or disabled tables for a given input symbol or name may be reset using the Reset button 2444. A brief description of a selected table is shown in table description area 2443.

The Position Guide Table Selection panel allows a user to conveniently enable and disable a table from a list of tables. A similar type of panel may be created and used to conveniently enable and disable a given Template from a list of Templates. This may be necessary if the user creates a large number of custom Templates using the Template settings area 2103, and the table settings area 2114, of the Combined Table Output Settings panel shown in FIG. 77. If the Template names 2104 shown in FIG. 77 are enabled, an input security symbol 2430, is first matched to a specific Template and its Use Criteria before the enabled and disabled tables list from the said specific Template are shown in display areas 2434, 2438 of FIG. 86.

FIG. 87 is representative of the Position Guide Alternative Table Output Settings panel. The purpose of the Alternative Table Output Settings panel is to allow the user to create a list of active tables categorized by the asset class of the PG input security, and further categorized by the order type of the intended transaction.

The description of the Combined Table Output Settings panel of FIG. 77 utilizes the concept of a “Template” and its associated “Use Criteria” to create a list of enabled tables for a specific set of criteria. FIG. 87 is representative of the use of tab sets as an alternative to the role of a Template and its associated Use Criteria as displayed in Template settings area 2103 of FIG. 77.

It should be understood that tab sets may be used to categorize and present a specific list of enabled tables according to the PG input security's asset class 2450, order type 2452, index class, listing exchange or market, industry sector, basket of stocks, and the like. Each asset class tab 2450 and each order type sub-tab 2452 combination provides for 16 distinct Table Settings Areas 2454. There is one Table Settings Area 2454 provided for each asset class and order type or portfolio amount combination. The number of tabs in a given tab set, the transaction parameter associated with a tab set, and the number of tab set levels may be configured by the user.

Although the Template settings area 2103 of FIG. 77 may be substituted with the use of tab sets 2460 and 2452, the remainder of the Alternative Table Output Settings panel of FIG. 87 functions similar to the Combined Table Output Settings panel of FIG. 77. Tables may be enabled and disabled, and their output amounts may be weighed in Table settings area 2454. The combined table investment amount or Formula amount leads to the PG Calculation quantity as in FIG. 77.

FIG. 88 is representative of the Position Guide Alternative Direct Output Settings panel. The purpose of the Alternative Direct Output Settings panel is to provide a intuitive method for allocating an investment amount for a given order type based on the PG input security's symbol, sector, asset class, index association, listing exchange, and the like. The function of the Alternative Direct Output Settings panel is similar to the Position Guide Direct Output Settings panel of FIG. 55. However, in the Alternative Direct Output Settings panel of FIG. 88, the investment amounts and portfolio amounts associated with a specific input criteria 2465 are entered and modified separately in their respective Buy order tab page 2460, Sell order tab page 2462, Short order tab page 2464, and Portfolio amount tab page 2466. Drop down list 2469 permits the user to select which PG Settings panel takes priority when the PG detects a conflicting configuration setting between two or more settings panels.

For each order type and its associated tab page, a PG Output quantity column 2468 displays the PG Output quantity recommendation for a given input criteria 2465, and investment amount 2467. Where appropriate, the last trade price of the PG input security is displayed in the Last Price column 2470 for each matching input criteria listed 2465.

An optional PG Max column 2463 may be added to the display area to indicate to the user the PG Maximum quantity of shares he may buy, sell, short, or hold in his portfolio for each PG input security. The PG Max quantity is based on the user's buying power, cash balance, or share holdings. Like the PG Output column 2468, the PG Max column 2463 quantities may be rounded up, down, or to the nearest 100 share units. For options securities, the user may choose to round the quantity up, down, or to the nearest integer quantity, or a multiple thereof.

The order type tab set, 2460, 2462, 2464, and 2466 shown in FIG. 88 permits the user to categorize the PG input criteria 2465 and investment amount 2467 settings by order type. It should be understood that the user may choose to categorize the PG input criteria 2465 and investment amount 2467 settings according to other tab set categories such as by: asset class, index class, listing exchange or market, industry sector, market capitalization, and the like.

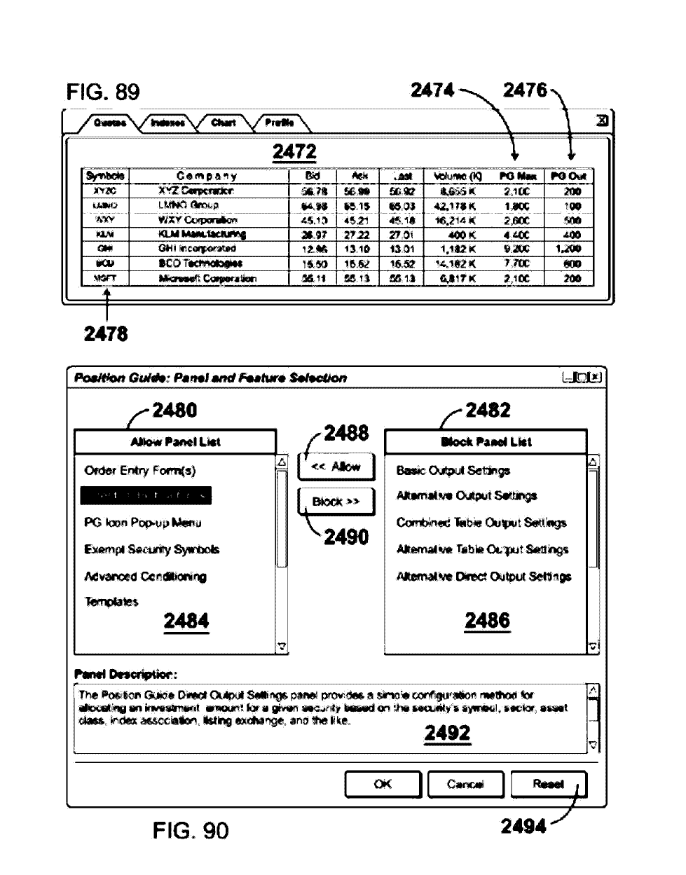

FIG. 89 displays an alternative PG Output quantity presentation to that of the PG icon 1450 of FIG. 53. The Quotes tab 2472 of tab set 126 of FIG. 4 is displayed. Column 2478 displays the input security symbol associated with each quote row. PG Maximum column 2474 displays the maximum quantity of shares the user can purchase as calculated by the Position Guide for each corresponding input security 2478. PG Output column 2476 displays the Position Guide Output quantity for each input security. The PG Output represents the recommended quantity of shares calculated by the Position Guide for each input security 2478.

The PG Maximum quantity 2474, and the PG Output quantity 2476 permits the user to easily view the maximum and recommended quantities that he may purchase for a given security. It should be understood that although the column data may pertain to a buy or purchase quantity, the user may configure the column to display quantity data for a sell or short order. Dragging and dropping quantity data from a cell in column 2474 or column 2476 to an order entry form will cause the order entry form to be populated with the said quantity data, the trading symbol of the PG input security, and other transaction parameters as may be necessary to initiate an order.

FIG. 90 is representative of the Position Guide Panel and Feature Selection panel. The purpose of the Panel and Feature Selection panel is to conveniently enable and disable PG features and Settings panels used to configure the Position Guide or its plug-ins. The ability to enable or disable a specific PG settings panel prevents conflicting settings from being input to the Position Guide by the user.

A user may enable or activate a PG feature or Settings panel by positioning the feature name or Setting panel name or title in the display area 2484 of the “Allow Panel List” section 2480. The inactive or disabled PG features or Settings panels are positioned in display area 2486 of the “Block Panel List” section 2482.

Specific PG features or Setting panels may be moved between the active or enabled area 2484, or the inactive or disabled area 2486 using the Allow button 2488 and the Block b utton 2490. Any changes to a default selection of active features or settings panels may be reset using the Reset button 2494. A brief description of any selected PG feature or Settings panel is shown in panel description area 2492 for convenient reference. The Panel and Feature Selection panel may be adapted to enable or disable the use of specific Templates, plug-ins, and table interfaces.

When there exists conflicting PG settings information between two or more enabled settings panels, the panels and their values may be ranked by preference to allow the PG to give priority to one panel's settings over another. It should be understood, that the numerous settings areas of the Position Guide may be arranged and presented to the user in a variety of layout styles and panel arrangements without detracting from the Position Guide's function or ability to be configured.

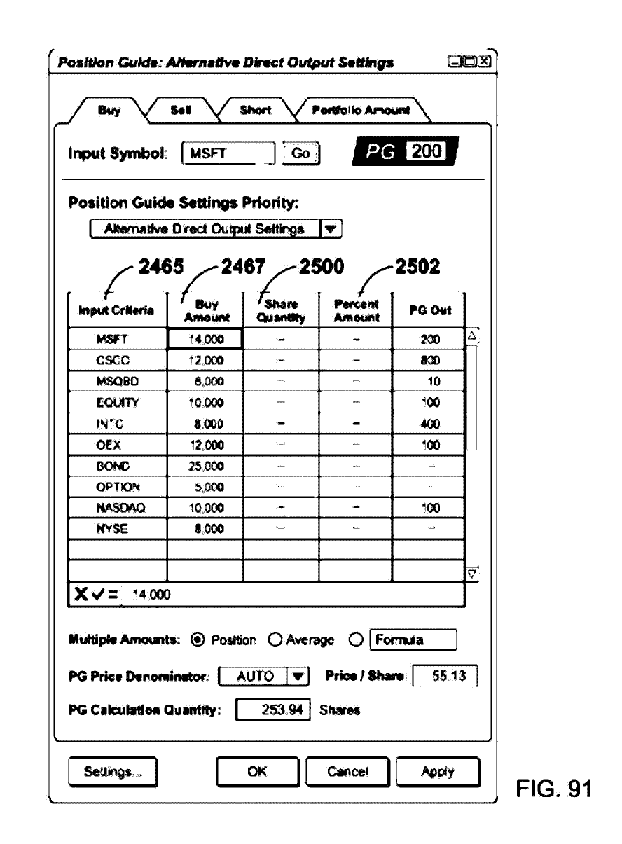

FIG. 91 displays a variation of the Position Guide Alternative Direct Output Settings panel of FIG. 88. As in FIG. 88, the Position Guide investment amount settings are segregated by order type, however, the specific investment amounts or portfolio amounts for each input criteria 2465 may be entered in dollar denominated units 2467, share quantity units 2500, and percentage amount units 2502. For a given buy order input criteria such as “MSFT”, the user may enter the investment amount in the dollar denominated column 2467, in the share quantity units column 2500, or the percentage units column 2502.

Typically, for a given input criteria row, only one column 2467, 2500, or 2502 should be used for entering the investment amount data. However, investment amount data may be contained in multiple cells of the same row when a selection method, such as a formula, is used to choose and calculate a final investment amount. For example, the smallest data value may be selected or the investment amount data may be averaged to derive the final investment amount.

It should be understood that a single column may be used to accept data in dollar denominated units, share quantity units, and percentage units provided the data is input in a manner that permits the PG to distinguish among the various data units. Investment amount columns may be inserted, deleted, hidden, repositioned, and formatted by the user.

FIG. 92 is a representative of the Position Guide Edit Table Settings panel of FIG. 78 displaying a table 2511 with a portfolio amount output column. The PG Edit Table Settings panel may also be used to create and configure, for a selected table, table output columns that contain and output portfolio amount data.

The table display area 2511 is similar in presentation to the table display area 2170 shown in FIG. 78, with the exception of two table output columns. The displayed table output column 61B, 2512, is configured to output portfolio amount data. This configuration is indicated in the table output column 61B configuration settings 2510 shown in column configuration area 2512. The “portfolio amount” table output column 2512 is selected for display by checking the checkbox in the table output column 61B configuration settings 2510. Portfolio amount values may be entered in column 61B 2512 for each market capitalization input category cell shown in the table display area 2511. Thus, there may be up to six portfolio amounts, one for each input category range, associated with Table 61.

The total market value of all equity securities in the user's portfolio is shown in the actual amount column 2514 for convenient reference. The actual amount column is an optional column and is selected for display by placing a checkmark in checkbox 2517. The actual amount column does not permit data entry or the displayed values to be changed. The displayed values in the actual amount column assist the user in setting and modifying the corresponding portfolio amount values in Column 61B 2512.

The market value of a security held by the user is added to the actual amount column 2514 cell that corresponds to the market capitalization category for said security as displayed in table display area 2511. The Position Guide repeats this market value and sorting process for each equity security held by the user. Once all the equity securities are processed, the total market value for each market capitalization category is displayed in Actual amount column 2514. It should be understood that only equity securities need be tabulated, in this case, as the portfolio amount column 61B 2512 is configured in the table output column 61B configuration settings 2510 for equity securities.

The Position Guide will limit the PG Output quantity for a given PG input security in such a manner that the portfolio amount setting entered in the portfolio amount column 2512, for a specific table and a specific input category cell, for example 2515, will not exceed the market value shown in the actual amount column 2514 for said specific table. The actual market value for each input category cell of a table is derived from categorizing the market value of all the securities in the user's portfolio according to the table's input categories and the portfolio amount columns configuration settings. The total market values for each table input category are shown in the actual amount column 2514.

The actual amount column 2514 of Table 61 indicates, for example, that the user has a market value of $361,000 in his overall equity holdings. The market value of equity securities in the user's account that have a market capitalization in the “51 Billion to 100 Billion” input category 2515 is $140,000, 2518. The corresponding portfolio amount setting 2516 for the “51 Billion to 100 Billion” input category 2515 is $160,000. If a PG input security corresponds to the “51 Billion to 100 Billion” input category 2515, the PG Output quantity may be adjusted lower by the Position Guide to ensure that the actual amount value 2518, if the intended order is filled at the last trade price and at the PG Output quantity, is at or below the portfolio amount value 2516.

It should be understood that the PG may dynamically update the actual amount column 2514 in real-time over the course of a trading session to adjust for changes in the price, market value, and holdings of the assorted securities in a user's portfolio. If the Portfolio amount settings are enabled, the $10,000 difference between the portfolio amount setting 2516 and the actual amount value 2518 effectively limits the investment amount for a PG input security, with a market capitalization between “51 Billion to 100 Billion” 2515, to $10,000. This $10,000 practical investment amount limit will take priority, when the portfolio amount settings are enabled, over other user specified or PG derived investment amounts such as the final investment amount 2141 of FIG. 77, and the table output amount 2174 of FIG. 78.

Portfolio amount settings associated with the tables of FIGS. 63 to 76, the Direct Output Settings panel of FIG. 55, the PG Portfolio Settings panels of FIGS. 57 to 60, and the like, are verified and updated in a manner similar to that noted in the discussion of FIG. 92. The Position Guide will limit the PG Output quantity for a given PG input security in such a manner that the portfolio amount settings entered for a given input security, index type, asset class, exchange, industry sector, table, and the like, are not exceeded.

Tab sets similar to the asset class tab set 2450 and the order type tab set 2452, from the Alternative Table Output Settings panel of FIG. 87, may substitute for the column configuration area 2152 of the Position Guide Edit Table Settings panel of FIGS. 78 and 92 if one assumes that the user may wish to edit tables and configure table output columns according to some combination of asset class and order type.

FIG. 93 is representative of the Position Guide Alert dialog box. The purpose of the PG Alert dialog box is to alert the user to situations where the investment amount, portfolio amount, or a similar PG setting constraint is exceeded or violated. This may occur if the user chooses to override the PG Output quantity by manually adjusting the value shown in the PG Icon. The PG Display quantity is the term used to refer to the value displayed in the PG icon after the originally displayed PG Output quantity has been manually overridden and modified, by the user, higher or lower.

It should be understood that a manual override action of the PG Output quantity as described for FIG. 53 is most likely to cause a PG setting or constraint to be violated if the PG Output quantity is increased. The Alert dialog box may provide details of which settings and constraints are violated and to what extent. The nature of the Alert warnings is a function of the PG input security, the displayed PG Icon quantity, and the degree to which a given constraint is being violated.

For example, assume a user manually overrides the PG Output quantity from a recommended 200 shares to 500 shares for the MSFT buy order of FIG. 55. If a PG setting or constraint is exceeded or violated, an Alert dialog box may appear which details the violation within the Alert message. The Alert message may contain the dollar value and share quantity amount that is in excess of the PG Output quantity 2520, the dollar value amount that is in excess of a portfolio amount limit of a given security category or asset class 2522, and the share quantity or percentage amount that is in excess of a security's portfolio amount setting 2524.

When such a warning or alert is presented, the user may choose to cancel the intended trade 2526, use the original PG Output quantity 2528, or ignore the Alert and proceed with the intended trade 2530.

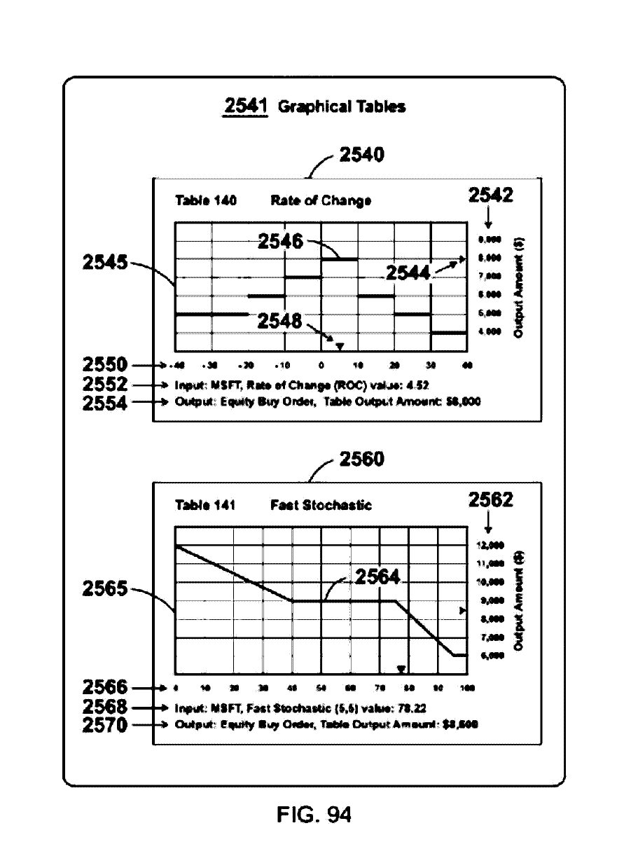

FIG. 94 displays a representative sample of graphical PG table interfaces 2541, their use, and configuration. Graphical table interfaces function similar to the tabular interfaces displayed in FIGS. 63 to 76. Graphical tables permit an input data value represented on the “x” axis of a graph to be correlated with a table output amount represented on the “y” axis of a graph. The graphical display area 2545, for example, uses a coordinate system and a graphed function to associate a table input value with a corresponding table output amount.

Table 140, 2540 is a typical presentation of a graphical table interface configured to accept as input the Rate of Change (ROC) value for a given PG input security. The rate of change value is referenced to the “x” axis 2550 of the graphical display area 2545. The input data area 2552 indicates the PG input security symbol and the name and value of the input data variable. The location of the input value along the “x” axis is shown with a marker indication 2548 for convenient reference.

A user defined function is graphed 2546 and relates the function's input variable to a table output amount 2542. The function's corresponding output amount is shown on the “y” axis 2542 of the graphical display area 2545. The output data area 2554 indicates the table use criteria and the table output amount. The location of the table output value along the “y” axis is shown with a marker indication 2544 for convenient reference.

It should be understood from the style of the graph for Table 140 that the input values may take any value along the “x” axis while the “y” axis output amounts are in discreet increment steps. Hence, graphical tables should be seen as the graphical equivalent to the “tabular” table interfaces of FIGS. 63 to 76. Many table interfaces, for example, Table 74, the OEX Index Table from FIG. 70, may also be presented in graphical form similar to Table 140. It is assumed that the user may switch between the “tabular” and the “graphical” views of any such table interfaces.

Table 141, 2560, is a typical presentation of a graphical table interface configured to graph an input Fast Stochastic value for a given PG input security. The fast stochastic value is referenced on the “x” axis 2566 of the graphical display area 2565. The input data area 2568 indicates the PG input security symbol and the name and value of the input technical indicator. A user defined function is graphed 2564 and relates the function's independent variable to a table output amount 2562. The function's corresponding dependent table output amount variable is shown on the “y” axis 2562 of the graphical display area 2565. It should be understood from the style of the graph that the graph's input values along the “x” axis correlate, in a continuous fashion, to a corresponding table output amount along the “y” axis. The data area 2570 indicates the table use criteria and the table output amount.

The configuration or settings of graphical table interfaces and their respective plug-ins are similar to that of FIG. 79 with additional settings for the visual properties of the graphical table such as the size and formatting of the table, the range of the “x” and “y” axis, and the specification of the displayed function or graph. It should be understood, that the user may interact with the graphical display area 2545, 2565 and change the function by changing the shape of the displayed function graphs 2546, 2564 respectively. The user may rearrange portions of the displayed function with a mouse drag and drop action. The user may also change the axis values and the displayed range of each axis using a mouse or similar pointing device.

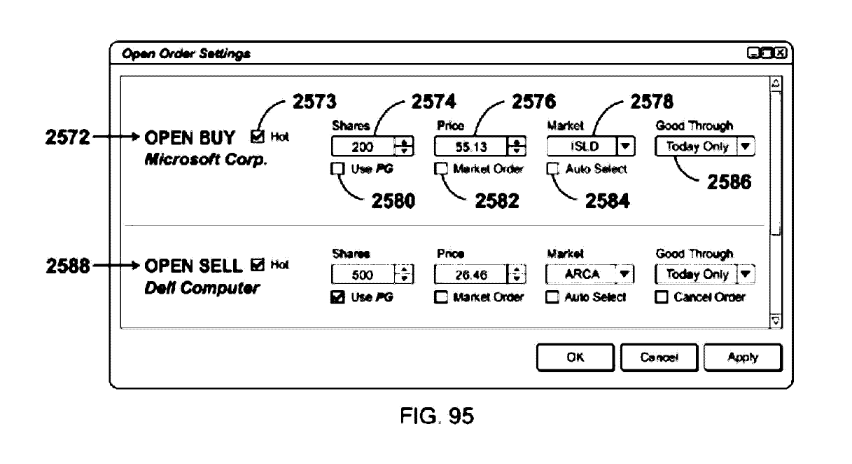

FIG. 95 is representative of the Open Order Settings dialog box. The purpose of the Open Order Settings dialog box is to enable a user to conveniently modify one or more transaction parameters for any open order. FIG. 95 displays, for example, two open orders. The first open order is an open buy order for Microsoft Corporation 2572. The second open order is an open sell order for Dell Computer Corporation 2588.

The user may modify the open order transaction parameters directly within the Open Order Settings dialog box. The Order Quantity may be modified by using the up or down arrows or by entering a numerical value in the Order Quantity input area 2574. The “Use PG” checkbox 2580 may be checkmarked to enter the Position Guide Output quantity in the input area 2574.

The Order Price parameter may be modified by using the up or down arrows or by entering a numerical value in the Order Price input area 2576. The “Market Order” checkbox 2582 may be checkmarked to change an open limit order to a market order.

The order Market Routing parameter may be modified by using the drop down list or by entering a Market identifier symbol in the Market input area 2578. The “Auto Select” checkbox 2584 may be checkmarked to have the system automatically select the most active or best priced market for a given order and its underlying security. The “Auto Select” feature scans across various markets in real-time and automatically routes the order to the optimal market for execution. It uses variables such as price, speed, liquidity and individual trader preferences to seek the best execution.

The Order Duration parameter may be modified by using the drop down list or by entering-a “Good Through” date in the Order Duration input area 2586. A “Cancel Order” checkbox may be used to cancel a given open order.

A checkmark in the “Hot” checkbox 2573 indicates to the system that once the modifications to the transaction parameters are finished, the changes will automatically be forwarded to the backend, brokerage, or exchange to modify the existing open order parameters.

Several approaches may be used to determine if the user has finished modifying an order. For example, if no additional changes are made to an open order after a fixed period of time, any final transaction parameter changes may be relayed to the backend to modify said open order. Similarly, the user may move the mouse cursor outside the perimeter of the Open Order Settings dialog box to signal to the system that all open order modifications are finished, and to forward any final open order transaction parameter settings to the backend.

The Apply button at the bottom right of the dialog box may also be used to forward any open order changes to the backend. Similarly, a “Refresh” button (or a similar GUI object) may be added to each open order listed, so that the user can explicitly control when the changes are sent to the back-end.

A user typically interacts with the trading interface through a keyboard and a computer mouse. However, it should be understood that a user may also interact and control the trading interface through the use of additional alternative input methods such as voice commands relayed via a microphone, and interpreted with the assistance of suitable voice recognition software or hardware. A drag and drop operation initiated with the use of a computer mouse may, for example, be initiated using voice commands and voice recognition software. Such voice recognition software may also initiate an order from the PG icon to the Grid Proper using voice instructions from the user.

Eye-tracking technology, thought-activated adaptive brain interfaces, and brain-machine or brain-computer interfaces, may also be used to interpret user initiated actions and provide equivalent commands to the trading interface. Such methods may work by controlling a mouse's cursor position and its interaction with the trading interface displayed on the computer screen, or by controlling the trading interface through direct commands output from the voice recognition software or hardware. The user initiated commands may be derived from brain signals from specific neurons, a portion of the brain such as the motor cortex, particular kinds of brain activity such as slow cortical potential, eye movements, voice commands, or some combination of eye movement, voice commands, and brain signal techniques which can convert the user's movements, voice, brain signals into computer commands. It is assumed that the user would undergo some training in order for such alternative control methods to function effectively.

It should be understood that audible feedback such as beeps, tones, and clicks of varying duration, pitch, and intensity, as well as visual feedback from the graphical interface and the computer display will permit the user to monitor, adjust, and correct how said voice instructions, eye movements, and brain signals will interact with the trading interface.

Aural feedback may also be used to provide market and trading information to the user. For example, trade executions and order fills may be audibly, as well as visually, relayed to the user. Real time quote price movements, cancelled orders, and new orders in specific markets may also be accompanied by audible sounds cues such as beeps, tones, and clicks of varying duration, pitch, and intensity to convey market and trading information to the user.

This “auralisation” of market and trading activity may assist the user to recognize trading patterns and changes in market sentiment. Human ears are particularly good at picking up temporal patterns. Real-time price upticks and downticks, for example, may be presented to the user as distinct sounds delivered through a speaker or headset. This aural component associated with market data and trading data would typically create a “sound pattern” or “sound field” of market and trading activity that is available to the user in addition to the visual activity displayed on the Grid Proper.

When the Position Guide is used for a quantity recommendation, the PG settings, table output amounts, and Output Settings panels help to derive an investment amount which is further processed to become the PG Output quantity. Specific decision parameters are categorized in easy to use tables. It should be understood that a spreadsheet or database may be adapted to enter the settings and configuration information of one or more table interfaces and to calculate the PG Output quantity.

When the PG is used to recommend a quantity for a trade, the independent input variable is the PG input security symbol and the dependent output variable is the PG Output quantity. The Position Guide may be adapted to other situations that involve a recommendation on a resource allocation subject to one or more constraints. The Position Guide tool and its associated Tables, Templates, Table Settings panels, Output Settings panels, Output Conditioning panels, and the like, may be used as a general decision support tool for other financial or non-financial applications.

The PG may be adapted to a general decision support application where the input variable may represent the identity of an item unrelated to securities trading. For example, the input variable may represent the identity of an employee, an item for sale, or a part number in a warehouse. Similarly, the dependent output variable may represent an output quantity or value unrelated to securities trading. For example, the output variable may represent the salary of an employee, a time interval, a location, the price of an item for sale, or the quantity of an item in inventory.

As a variation on the use of the Position Guide and its associated settings to derive a PG Output quantity, it should be understood that the Position Guide may be adapted to represent an output price or time parameter of a security transaction. The tables and various panels may be adapted in such a manner that the table output amounts contribute to a recommended output price or time for a transaction, given a PG input security. When the tables are properly adapted, they would help the user to derive a final trade price for a given PG input security and order type.

Similarly, as a further variation on the use of the Position Guide and its associated tables, table configurations, Table Settings panels, and Output Settings panels, the Position Guide may be used to help identify the specific security, industry sector, index, asset class, market, exchange, or order type to involve in a given transaction. The tables and settings panels may be adapted in such a manner, that the table output columns may output the symbol, sector, asset class, index, market, exchange, or order type of a security transaction. When the tables are suitably adapted, they would assist the user to identify the proper parameter to involve in a security transaction or any transaction.

Additional applications include modeling for employee salaries, employee evaluations within a company, identifying a key variable from a group of variables, determining the importance of key variables in a process, identifying the order in which items should be processed, and the like.

This completes the disclosure of the Position Guide recommendation tool used to assist in recommending a quantity for a security transaction. As has been shown, the Position Guide quantity recommendation tool provides for: an intuitive, easy to use, user interface which may be integrated into an online trading application or available on an Internet website; several simple methods for deriving a recommended quantity that permits a user to use dollar denominated units, percentage units, and quantity units to represent an order quantity; an easy method of entering and adjusting the various PG settings and preferences without the need for complex algorithms, mathematical techniques, and programming knowledge; flexible table interfaces that adapt to a multitude of decision parameters involving market data, account data, technical indicators, and the like; third party access to control the PG settings and plug-in preference data, or to provide input data to the PG or a plug-in to assist with a quantity recommendation; an output quantity that is available automatically and essentially instantaneously to the user once the PG has been configured; an output quantity that is presented visually, via an icon or a GUI object; an output quantity that may be manually modified or changed within the icon or GUI object; and an ability to facilitate a trading transaction via a drag-and-drop operation from the icon or GUI object.

The embodiments of the invention in which an exclusive property or privilege is claimed are defined as follows:

1. A method of buying or selling items having at least one active market, said method comprising the steps of:
under control of a client system, displaying information identifying at least one item and a bid/ask price for said item in said at least one active market;
specifying transaction conditions based on a user directed position of a moveable icon, said transaction conditions related to the buying or selling of said identified item in said active market; and
in response to an action of said user sending a user transaction request at the transaction conditions specified at the time of said action;
facilitating a financial transaction for the user in accordance with the transaction conditions to complete the transaction;
whereby, the item may be bought or sold by said user at said transaction conditions.

2. The method of claim 1 wherein said step of displaying information identifying at least one item and a bid/ask price for said item in said at least one active market comprises connecting to a source of information for said at least one active market and receiving and displaying at least one said bid/ask price for said item in substantially real time.

3. The method of claim 1 wherein said step of displaying a bid/ask price for said item in said at least one active market comprises displaying said bid/ask price graphically.

4. The method of claim 1 wherein said client system is associated with a server system; said server system includes previously stored user financial account information, and wherein said step of facilitating said financial transaction includes updating the previously stored user information in light of said financial transaction.

5. The method of claim 4 wherein said transaction conditions are based on said previously stored user financial account information as well as said user directed position of said moveable icon.

6. The method of claim 3 wherein said step of displaying said bid/ask price graphically further comprises forming a two-dimensional grid having rows and columns, wherein at least one axis of said grid represents price, and the other axis represents active markets for said item.

7. The method of claim 4 wherein in response to said transaction being completed said client system receives and displays a transaction confirmation for said user.

8. The method of claim 4 wherein in response to said transaction remaining open due to an inability to match said transaction conditions, said client system maintains and displays said transaction for said user.

9. A client system for buying and selling items, said client system comprising:
a first display for displaying at least one bid/ask price for at least one of said items in an active market;
a second display for displaying transaction conditions relating to the buying or selling of said item based upon a user directed GUI object;
and a transaction component that in response to an action of the user, sends a transaction request to a server system at the transaction conditions specified.

10. A method of configuring a user interface for the buying and selling of items, said method comprising:
connecting a user interface to at least one source of bid/ask market information for at least one item;
displaying, in said user interface, a graphical representation of said bid/ask prices for said at least one item; and
revising, in substantially real-time, said graphical representation of said bid/ask prices for said at least one item to visually depict market movement over time of said bid/ask prices of said at least one item.

11. A method of configuring a user interface for the buying and selling of items as claimed in claim 10 further including the step of permitting said user to select additional items for simultaneous graphical representation.

12. A method of configuring a user interface for the buying and selling of items as claimed in claim 10 further including the step of connecting to more than one source of bid/ask market information for said item and simultaneously displaying by said graphical representation additional active markets for said item.

13. A method of configuring a user interface for buying and selling of items as claimed in claim 10 further including the step of providing, in said user interface, a user directed moveable icon for displaying an order for said item, for initiating/modifying trading orders based on the position of said icon relative to the graphical representation and an action of said user.

14. A method of configuring a user interface for buying and selling of items as claimed in claim 13 wherein said icon is moved by said user by being dragged across said interface and said step of initiating/modifying said trading order comprises said user dropping said icon on a preselected cell of said graphical interface.

15. A method of configuring a user interface for buying and selling of items as claimed in claim 10 further including the step of displaying transaction scenarios based on one or more user selected transaction conditions and said user directed position of said icon over said interface.
